(19) United States
(12) Patent Application Publication
(10) Pub. No.: US 2024/0367040 A1
(43) Pub. Date: Nov. 7, 2024

(54) NON-TRANSITORY COMPUTER READABLE MEDIUM, INFORMATION PROCESSING METHOD, GAMING DEVICE, AND INFORMATION PROCESSING SYSTEM

(71) Applicant: CYGAMES, INC., Tokyo (JP)

(72) Inventors: Satoshi Akitake, Tokyo (JP); Seiya Kamizato, Tokyo (JP); Toshiyuki Hibi, Tokyo (JP); Ikko Suto, Tokyo (JP); Ryo Kato, Tokyo (JP); Kazutaka Arai, Tokyo (JP); Takuma Akitsu, Tokyo (JP); Hironori Sato, Tokyo (JP); Yujiro Deguchi, Tokyo (JP); Kentaro Umeda, Tokyo (JP); Reo Takahashi, Tokyo (JP); Koji Iwata, Tokyo (JP); Yuki Tamura, Tokyo (JP)

(73) Assignee: CYGAMES, INC., Tokyo (JP)

(21) Appl. No.: 18/753,649

(22) Filed: Jun. 25, 2024

Related U.S. Application Data
(63) Continuation of application No. PCT/JP2022/046694, filed on Dec. 19, 2022.

(30) Foreign Application Priority Data
Dec. 28, 2021 (JP) 2021-214031
Dec. 28, 2021 (JP) 2021-214032
Dec. 28, 2021 (JP) 2021-214033
Dec. 28, 2021 (JP) 2021-214034

(51) Int. Cl. A63F 13/46

(52) U.S. Cl. CPC A63F 13/46

(57) ABSTRACT

A non-transitory computer readable medium stores a program causing a computer to execute: allowing a player to select a character to be used in each of a plurality of category games included in a specific game; setting the character selected by the player for each category game; deriving an individual game result for each category game; determining, for each category game, a predetermined parameter associated with the character used in the category game; ranking a plurality of characters based on the predetermined parameters of the plurality of category games, the plurality of characters being used in the specific game in accordance with the selection by the player; and deriving an overall game result based on the individual game result of each of the plurality of category games or the predetermined parameters of the plurality of category games.

### CROSS REFERENCE TO RELATED APPLICATIONS

This application is a continuation application of International Application No. PCT/JP2022/046694, filed on Dec. 19, 2022, which claims priority to Japanese Patent Applications Nos. 2021-214031, 2021-214032, 2021-214033, 2021-214034, each of which was filed on Dec. 28, 2021, the entire contents of which are incorporated by reference herein.

### BACKGROUND ART

### Technical Field

The present invention relates to information processing programs, information processing methods, gaming devices, and information processing systems.

In the related art, for example, as indicated in Patent Literature 1, games in the so-called genre of raising games are known. A raising game is provided with multiple types of raising items. By selecting any of the raising items, a player can raise a target character to be raised.

### CITATION LIST

### Patent Literature

Patent Literature 1: JP 6563579 B

### SUMMARY OF INVENTION

### Technical Problem

Normally, a raising game may involve using a raised character raised by the player to compete with another player or a computer. Sometimes, the player plays a predetermined game by using the raised character raised by the player, so as to compete with another player for a better score. For example, when a team of multiple raised characters is organized and a predetermined game is played as the team, there is a problem in that it is difficult for the player to ascertain an effective way to organize the team.

An object of the present invention is to provide an information processing program, an information processing method, a gaming device, and an information processing system that offer enhanced player friendliness.

### Solution to Problem

In order to solve the aforementioned problem, an information processing program causes a computer to execute: a process in a specific game including a plurality of category games, the process allowing a player to select a character to be used in each of the plurality of category games; a process for setting the character selected by the player for each category game; a process for deriving an individual game result for each category game, the individual game result serving as a game result of the category game; a process for determining a predetermined parameter associated with the character used in the category game; a process for ranking a plurality of the characters based on the predetermined parameter, the plurality of characters being used in the specific game in accordance with the selection by the player; and a process for deriving an overall game result based on the individual game result of each of the plurality of category games or the predetermined parameter, the overall game result serving as a game result of the specific game.

The process for deriving the overall game result may include a process for deriving total points as the overall game result by calculating the total points in a single specific game based on the predetermined parameter, and the computer may be caused to further execute a process for ranking multiple players in accordance with the total points of the specific game.

The process for deriving the individual game result for each category game may include deriving the individual game results of the plurality of category games in a predetermined order.

In order to solve the aforementioned problem, an information processing method is executed by a computer. The computer executes: a process in a specific game including a plurality of category games, the process allowing a player to select a character to be used in each of the plurality of category games; a process for setting the character selected by the player for each category game; a process for deriving an individual game result for each category game, the individual game result serving as a game result of the category game; a process for determining a predetermined parameter associated with the character used in the category game; a process for ranking a plurality of the characters based on the predetermined parameter, the plurality of characters being used in the specific game in accordance with the selection by the player; and a process for deriving an overall game result based on the individual game result of each of the plurality of category games or the predetermined parameter, the overall game result serving as a game result of the specific game.

In order to solve the aforementioned problem, a gaming device includes at least one computer. The computer executes: a process in a specific game including a plurality of category games, the process allowing a player to select a character to be used in each of the plurality of category games; a process for setting the character selected by the player for each category game; a process for deriving an individual game result for each category game, the individual game result serving as a game result of the category game; a process for determining a predetermined parameter associated with the character used in the category game; a process for ranking a plurality of the characters based on the predetermined parameter, the plurality of characters being used in the specific game in accordance with the selection by the player; and a process for deriving an overall game result based on the individual game result of each of the plurality of category games or the predetermined parameter, the overall game result serving as a game result of the specific game.

In order to solve the aforementioned problem, an information processing system includes at least one computer. The computer executes: a process in a specific game including a plurality of category games, the process allowing a player to select a character to be used in each of the plurality of category games; a process for setting the character selected by the player for each category game; a process for deriving an individual game result for each category game, the individual game result serving as a game result of the category game; a process for determining a predetermined parameter associated with the character used in the category game; a process for ranking a plurality of the characters based on the predetermined parameter, the plurality of characters being used in the specific game in accordance with the selection by the player; and a process for deriving an overall game result based on the individual game result of each of the plurality of category games or the predetermined parameter, the overall game result serving as a game result of the specific game.

### Effects of Disclosure

The present invention offers enhanced player friendliness.

### BRIEF DESCRIPTION OF DRAWINGS

FIG. 1 schematically illustrates the configuration of an information processing system.

FIG. 2A illustrates the hardware configuration of a player terminal, and FIG. 2B illustrates the hardware configuration of a server.

FIG. 3A illustrates an example of a home screen, FIG. 3B illustrates an example of an option setting screen, FIG. 3C illustrates an example of a profile setting screen, and FIG. 3D illustrates an example of a home setting screen.

FIG. 4 is a diagram for roughly explaining the flow of a raising game.

FIG. 5A illustrates a main-character selection screen,

FIG. 5B is a first diagram illustrating a character details screen, and FIG. 5C is a second diagram illustrating the character details screen.

FIG. 6A illustrates an attribute parameter (initial value) table, FIG. 6B illustrates an aptitude parameter (initial value) table, FIG. 6C illustrates a skill table, and FIG. 6D illustrates a dedicated event table.

FIG. 7 is a first diagram illustrating an example of a raising-information display screen.

FIG. 8A illustrates an example of special targets to be cleared, and FIG. 8B illustrates an example of targets to be cleared set for characters.

FIG. 9 is a second diagram illustrating an example of the raising-information display screen.

FIG. 10A is a first diagram illustrating an inheritance-character selection screen, FIG. 10B is a first diagram illustrating a raised-character-list screen, FIG. 10C is a second diagram illustrating the inheritance-character selection screen, and FIG. 10D is a third diagram illustrating the inheritance-character selection screen.

FIG. 11 illustrates an inheritance lineage.

FIG. 12 illustrates factor information.

FIG. 13A illustrates compatibility determination targets, and FIG. 13B illustrates compatibility determination items.

FIG. 14A illustrates sorting conditions, and FIG. 14B illustrates filtering conditions.

FIG. 15 is a first diagram illustrating a character details dialog.

FIG. 16 is a second diagram illustrating the character details dialog.

FIG. 17 is a third diagram illustrating the character details dialog.

FIG. 18 illustrates a skill display dialog.

FIG. 19A is a first diagram illustrating a support-card organization screen, FIG. 19B illustrates a support-card selection screen, and FIG. 19C is a second diagram illustrating the support-card organization screen.

FIG. 20A illustrates a support card table, FIG. 20B illustrates a support effect table, FIG. 20C illustrates a possessed skill table, and FIG. 20D illustrates a support event table.

FIG. 21A illustrates a final confirmation screen, and FIG. 21B illustrates a preset selection screen.

FIG. 22 is a first diagram illustrating a character-identification-information table.

FIG. 23 is a second diagram illustrating the character-identification-information table.

FIG. 24 illustrates a selection item table.

FIG. 25A is a first diagram illustrating a game screen, and FIG. 25B is a second diagram illustrating the game screen.

FIG. 26A is a first diagram illustrating a training screen, FIG. 26B is a second diagram illustrating the training screen, FIG. 26C illustrates a training-result notification screen, and FIG. 26D illustrates an event screen.

FIG. 27A is a first diagram illustrating an inheritance event, FIG. 27B is a second diagram illustrating the inheritance event, FIG. 27C is a third diagram illustrating the inheritance event, and FIG. 27D is a fourth diagram illustrating the inheritance event.

FIG. 28A is a first diagram illustrating a skill screen, and FIG. 28B is a second diagram illustrating the skill screen.

FIG. 29A is a first diagram illustrating an individual-race selection screen, FIG. 29B illustrates an individual-race start screen, FIG. 29C is a first diagram illustrating an individual-race-result screen, and FIG. 29D is a second diagram illustrating the individual-race-result screen.

FIG. 30A illustrates a team-race selection screen, FIG. 30B illustrates a team-race organization screen, FIG. 30C illustrates a team-race start screen, and FIG. 30D illustrates a team-race interim-result screen.

FIG. 31A is a first diagram illustrating a team-race detailed-result screen, FIG. 31B is a first diagram illustrating a team-race overall-result screen, FIG. 31C is a second diagram illustrating the team-race detailed-result screen, and FIG. 31D is a second diagram illustrating the team-race overall-result screen.

FIG. 32 illustrates the general flow of a turn start process.

FIG. 33 illustrates an allocation table.

FIG. 34A illustrates a training level table, FIG. 34B illustrates a fixed-increase-value (speed) table, FIG. 34C illustrates a fixed-increase-value (power) table, and FIG. 34D illustrates a bonus-addition-rate table.

FIG. 35 illustrates event types and event categories.

FIG. 36 illustrates the relationship between the event types and the number of turns.

FIG. 37A is a third diagram illustrating the game screen, and FIG. 37B is a third diagram illustrating the training screen.

FIG. 38A illustrates an intensive-training execution determination table, FIG. 38B illustrates a special-icon determination table, and FIG. 38C illustrates a bonus-icon determination table.

FIG. 39A illustrates a fixed-bonus-value (main-character) table, and FIG. 39B illustrates a bonus-addition-value (main character) table.

FIG. 40A illustrates a fixed-increase-value (intensive-training target) table, and FIG. 40B illustrates a bonus-increase-value (intensive-training target) table.

FIG. 41A illustrates a raising completion screen, FIG. 41B is a second diagram illustrating the raising completion screen, and FIG. 41C is a third diagram illustrating the raising completion screen.

FIG. 42A illustrates a race-game selection screen, FIG. 42B illustrates a team competition game screen, FIG. 42C illustrates a team organization screen, and FIG. 42D illustrates the raised-character-list screen.

FIG. 43A illustrates an opponent-team selection screen, FIG. 43B illustrates a start confirmation screen, FIG. 43C is a first diagram illustrating a result list screen, and FIG. 43D is a second diagram illustrating the result list screen.

FIG. 44 illustrates an overall race result screen.

FIG. 45 illustrates a score list screen.

FIG. 46A illustrates a practice-match top screen, FIG. 46B illustrates a participating-character setting screen, FIG. 46C is a first diagram illustrating the participating-character selection screen, and FIG. 46D is a second diagram illustrating the participating-character selection screen.

FIG. 47 illustrates race conditions.

FIG. 48 illustrates a practice-member selection screen.

FIG. 49A is a first diagram illustrating a practice partner screen, FIG. 49B is a second diagram illustrating the practice partner screen, and FIG. 49C is a fourth diagram illustrating the character details dialog.

FIG. 50A illustrates a practice-match result screen, FIG. 50B illustrates a practice-member registration screen, and FIG. 50C illustrates a race-result save dialog.

FIG. 51A illustrates a room-match top screen, FIG. 51B illustrates a held-race selection screen, and FIG. 51C illustrates a mode selection screen.

FIG. 52 illustrates a simple mode.

FIG. 53 illustrates a detailed mode.

FIG. 54A illustrates a room-match participating-character selection screen, FIG. 54B illustrates a strategy selection tab, FIG. 54C illustrates an entry information screen, and FIG. 54D illustrates a waiting room screen of a host player.

FIG. 55 illustrates a race details screen.

FIG. 56A illustrates a room search screen, and FIG. 56B illustrates a waiting room screen of a guest player.

FIG. 57A illustrates a daily race screen, FIG. 57B illustrates a difficulty-level selection screen, FIG. 57C illustrates a play-mode selection screen, and FIG. 57D illustrates a daily-race participating-character selection screen.

FIG. 58A illustrates a skip setting screen, FIG. 58B is a first diagram illustrating a skip-result display screen, FIG. 58C is a second diagram illustrating the skip-result display screen, and FIG. 58D is a third diagram illustrating the skip-result display screen.

FIG. 59 illustrates the configuration of a memory in the player terminal and the function thereof as a computer.

FIG. 60 illustrates the configuration of a memory in the server and the function thereof as a computer.

FIG. 61 is a sequence diagram illustrating processing by the player terminal and the server involved with the raising game.

FIG. 62 is a first flowchart illustrating a preparation stage process in the player terminal.

FIG. 63 is a second flowchart illustrating the preparation stage process in the player terminal.

FIG. 64 is a second flowchart illustrating the preparation stage process in the player terminal.

FIG. 65 is a flowchart illustrating a preparation stage process in the server.

FIG. 66 is a flowchart illustrating a raising stage process in the player terminal.

FIG. 67 is a flowchart illustrating the turn start process in the player terminal.

FIG. 68 is a flowchart illustrating an allocation process in the player terminal.

FIG. 69 is a flowchart illustrating a numerical-value determination process in the player terminal.

FIG. 70 is a flowchart illustrating an event determination process in the player terminal.

FIG. 71 is a flowchart illustrating a mid-turn process in the player terminal.

FIG. 72 is a flowchart illustrating a raising execution process in the player terminal.

FIG. 73 is a flowchart illustrating an inheritance-event execution process in the player terminal.

FIG. 74 is a flowchart illustrating a raising-game termination process in the server.

FIG. 75 is a first sequence diagram illustrating a process related to a team competition game in the player terminal and the server.

FIG. 76 is a second sequence diagram illustrating the process related to the team competition game in the player terminal and the server.

FIG. 77 is a flowchart illustrating a race-result deriving process in the server.

FIG. 78A illustrates an example of a home screen according to a second embodiment, FIG. 78B illustrates an example of an option setting screen according to the second embodiment, FIG. 78C illustrates an example of a profile setting screen according to the second embodiment, and FIG. 78D illustrates an example of a music-playback-condition setting screen according to the second embodiment.

FIG. 79 illustrates a character management table according to the second embodiment.

FIG. 80A illustrates an example of a left home screen according to the second embodiment, FIG. 80B illustrates an example of a right home screen according to the second embodiment, FIG. 80C illustrates an example of a home setting screen according to the second embodiment, and FIG. 80D illustrates an example of a campaign screen according to the second embodiment.

FIG. 81 is a first diagram illustrating viewpoints for capturing an image of a virtual game space according to the second embodiment.

FIG. 82A illustrates an example of an enhancement screen according to the second embodiment, and FIG. 82B illustrates an example of a raised character screen according to the second embodiment.

FIG. 83A illustrates an example of a story screen according to the second embodiment, and FIG. 83B illustrates an example of a team-competition-field screen according to the second embodiment.

FIG. 84A is a first diagram illustrating an example of a conversation screen according to the second embodiment, and FIG. 84B is a second diagram illustrating an example of the conversation screen according to the second embodiment.

FIG. 85 is a second diagram illustrating viewpoints for capturing an image of the virtual game space according to the second embodiment.

FIG. 86A illustrates an example of a bulletin board screen according to the second embodiment, FIG. 86B is a first diagram illustrating an example of a poster screen according to the second embodiment, FIG. 86C is a second diagram illustrating an example of the poster screen according to the second embodiment, FIG. 86D is a third diagram illustrating an example of the poster screen according to the second embodiment.

FIG. 87 illustrates an example of the home screen according to the second embodiment when maintenance is scheduled.

FIG. 88A illustrates an example of a music selection screen according to the second embodiment, FIG. 88B illustrates an example of a selected-music information screen according to the second embodiment, FIG. 88C illustrates an example of an evaluation-history information screen according to the second embodiment, and FIG. 88D illustrates an example of a playback-history information screen according to the second embodiment.

FIG. 89A illustrates an example of the home screen according to the second embodiment when a random selection function is activated, FIG. 89B illustrates an example of the right home screen according to the second embodiment when the random selection function is activated, FIG. 89C illustrates an example of a requester's details screen according to the second embodiment, and FIG. 89D illustrates an example of the selected-music information screen according to the second embodiment when the random selection function is activated.

FIG. 90A illustrates an example of the evaluation-history information screen according to the second embodiment when an another-player's requesting function is activated, and FIG. 90B illustrates an example of the evaluation-history information screen according to the second embodiment when the player evaluates the music.

FIG. 91 illustrates the configuration of the memory in the player terminal according to the second embodiment and the function thereof as a computer.

FIG. 92 illustrates the configuration of the memory in the server according to the second embodiment and the function thereof as a computer.

FIG. 93 is a sequence diagram illustrating basic processes in the player terminal and the server according to the second embodiment.

FIG. 94 is a first flowchart illustrating an entertainment control process in the player terminal according to the second embodiment.

FIG. 95 is a second flowchart illustrating the entertainment control process in the player terminal according to the second embodiment.

FIG. 96 is a third flowchart illustrating the entertainment control process in the player terminal according to the second embodiment.

FIG. 97 is a fourth flowchart illustrating the entertainment control process in the player terminal according to the second embodiment.

FIG. 98 illustrates the final confirmation screen when a specific event is being held.

FIG. 99 is a flowchart illustrating a preparation stage process in the player terminal when the specific event is being held.

FIG. 100 is a flowchart illustrating a raising-game termination process in the server when the specific event is being held.

### DESCRIPTION OF EMBODIMENTS

Embodiments of the present invention will be described in detail below with reference to the appended drawings. Numerical values and the like indicated in the following embodiments are merely examples for facilitating the understanding thereof and are not intended to limit the present invention, unless otherwise specified. In the description and the drawings, elements having substantially identical functions and configurations are given the same reference signs to omit redundant descriptions, and elements not directly related to the present invention are not shown in the drawings.

### (Overall Configuration of Information Processing System S)

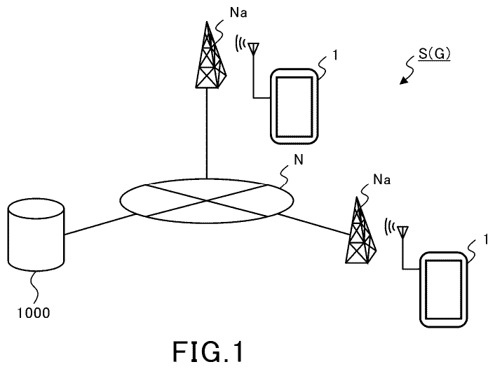

FIG. 1 schematically illustrates the configuration of an information processing system S. The information processing system S is a so-called client server system including a player terminal 1 functioning as a client, that is, a gaming terminal, a server 1000, and a communication network N having a communication base station Na.

In the information processing system S according to this embodiment, the player terminal 1 and the server 1000 function as a gaming device G. The player terminal 1 and the server 1000 are given respective roles for controlling the progress of a game. The player terminal 1 and the server 1000 operate in cooperation with each other to allow the game to proceed.

The player terminal 1 can establish communication with the server 1000 via the communication network N. The player terminal 1 includes a wide range of electronic units communicatively connectable to the server 1000 in a wireless or wired manner. Examples of the player terminal 1 include a smartphone, a mobile phone, a tablet device, a personal computer, and a gaming unit. In this embodiment, the player terminal 1 is described as being a smartphone.

The server 1000 is communicatively connected to multiple player terminals 1. The server 1000 accumulates various types of information for each player playing the game. Based on an operation input from each player terminal 1, the server 1000 mainly executes a process involving updating accumulated information and downloading an image and various types of information to the player terminal 1.

The communication base station Na is connected to the communication network N and wirelessly exchanges information with each player terminal 1. The communication network N is constituted of, for example, a mobile phone network, the Internet, a LAN (local area network), or a dedicated line, and realizes wireless or wired communication between each player terminal 1 and the server 1000.

### (Hardware Configuration of Player Terminal 1 and Server 1000)

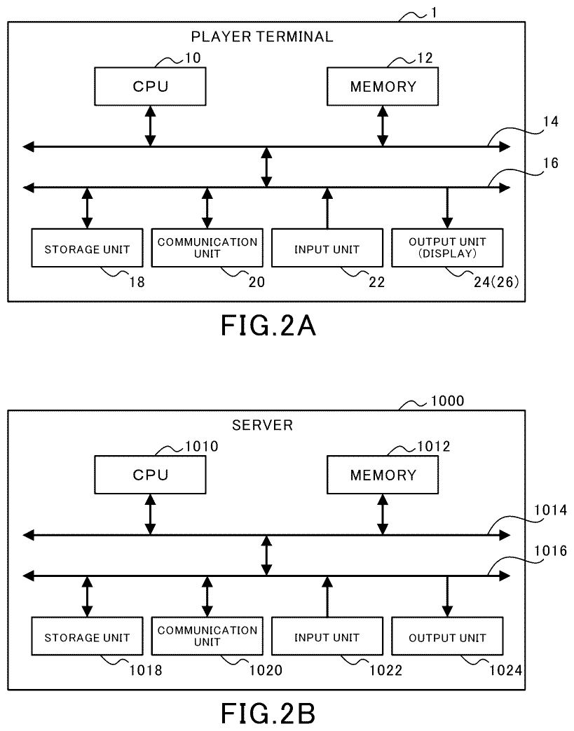

FIG. 2A illustrates the hardware configuration of each player terminal 1. FIG. 2B illustrates the hardware configuration of the server 1000. As shown in FIG. 2A, the player terminal 1 includes a CPU (central processing unit) 10, a memory 12, a bus 14, an input-output interface 16, a storage unit 18, a communication unit 20, an input unit 22, and an output unit 24.

As shown in FIG. 2B, the server 1000 includes a CPU 1010, a memory 1012, a bus 1014, an input-output interface 1016, a storage unit 1018, a communication unit 1020, an input unit 1022, and an output unit 1024.

The configurations and functions of the CPU 1010, the memory 1012, the bus 1014, the input-output interface 1016, the storage unit 1018, the communication unit 1020, the input unit 1022, and the output unit 1024 of the server 1000 are substantially identical to those of the CPU 10, the memory 12, the bus 14, the input-output interface 16, the storage unit 18, the communication unit 20, the input unit 22, and the output unit 24 of the player terminal 1, respectively. Therefore, the hardware configuration of the player terminal 1 will be described below, whereas the description of the server 1000 will be omitted.

The CPU 10 activates a program stored in the memory 12 and controls the progress of the game. The memory 12 is constituted of a ROM (read only memory) or a RAM (random access memory) and stores a program and various types of data required for controlling the progress of the game. The memory 12 is connected to the CPU 10 via the bus 14.

The input-output interface 16 is connected to the bus 14. The storage unit 18, the communication unit 20, the input unit 22, and the output unit 24 are connected to the input-output interface 16.

The storage unit 18 is constituted of a semiconductor memory, such as a DRAM (dynamic random access memory), and stores various types of programs and data. In the player terminal 1, the programs and data stored in the storage unit 18 are loaded into the memory 12 (RAM) by the CPU 10.

The communication unit 20 is communicatively connected to the communication base station Na in a wireless manner and exchanges information, such as various types of data and programs, with the server 1000 via the communication network N. In the player terminal 1, for example, a program received from the server 1000 is stored in the memory 12 or the storage unit 18.

The input unit 22 is constituted of, for example, a touchscreen, a button, a keyboard, a mouse, a directional pad, and/or an analog controller via which player operations are input. Alternatively, the input unit 22 may be a dedicated controller provided in the player terminal 1 or connected (externally) to the player terminal 1. As another alternative, the input unit 22 may be constituted of an acceleration sensor that detects tilting and motion of the player terminal 1 or a microphone that detects the voice of the player. In other words, the input unit 22 widely includes devices capable of receiving the input of player's intention in an identifiable manner.

The output unit 24 includes a display device and a loudspeaker. The output unit 24 may be connected (externally) to the player terminal 1. In this embodiment, the player terminal 1 includes a display 26 as the output unit 24 and a touchscreen, as the input unit 22, superimposed on the display 26.

### (Details of Game)

Next, the game provided by the information processing system S and the gaming device G according to this embodiment will be described. A player can own a character obtained by lottery called “gacha” or a character distributed from the administrator side. A player can also own a support card obtained by lottery or a support card distributed from the administrator side.

As will be described in detail later, in the game according to this embodiment, a raising game is provided. In the raising game, the player can raise a character that the player owns. Furthermore, the raising game according to this embodiment has gameplay involving raising the character while allowing the character to participate in a race that mimics a horse race.

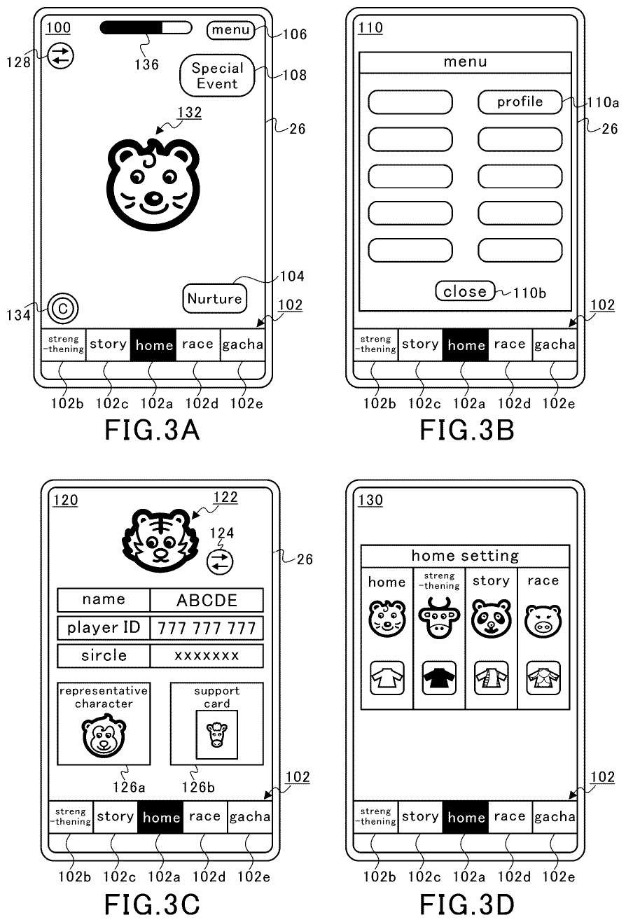

FIG. 3A illustrates an example of a home screen 100. When a game application is activated in the player terminal 1, the home screen 100 is displayed on the display 26. The lower part of the home screen 100 displays a menu bar 102. The menu bar 102 is provided with a plurality of operation sections that can be operated (tapped) by the player.

In this case, the menu bar 102 is provided with a home-screen selection operation section 102a, an enhancement-screen selection operation section 102b, a story-screen selection operation section 102c, a race-game selection operation section 102d, and a gacha-screen selection operation section 102e. On the menu bar 102, the operation section corresponding to the screen being displayed on the display 26 is highlighted so that the screen being displayed can be identified.

When the home-screen selection operation section 102a is tapped, the home screen 100 shown in FIG. 3A is displayed on the display 26.

When the enhancement-screen selection operation section 102b is tapped, an enhancement screen (not shown) is displayed. On the enhancement screen, a character or a support card owned by the player can be enhanced. By enhancing the character or the support card, the player can increase the set level of the character or the support card. The character and the support card have various parameters set therefor, and each parameter increases with increasing level. By increasing each parameter of the character or the support card, the player can raise the character having a higher status in the raising game.

When the story-screen selection operation section 102c is tapped, a story screen (not shown) is displayed. A story image is provided for each character appearing in the game. On the story screen, the player can select and view the character and the story image.

When the race-game selection operation section 102d is tapped, a race-game selection screen to be described below is displayed. This embodiment provides various race games in which a raised character raised in the raising game to be described later is allowed to participate. On the race-game selection screen, the player can select a race game that the raised character is to participate in. One race game is a team competition game involving competition between a team consisting of multiple raised characters and another player's team selected by a computer. The team competition game has gameplay involving competing with another player for rankings.

When the gacha-screen selection operation section 102e is tapped, a gacha screen (not shown) is displayed. On the gacha screen, the player can consume an in-game currency to perform a so-called gacha lottery that involves obtaining a character or a support card by lottery.

The home screen 100 is also provided with a raising-game operation section 104 above the menu bar 102. When the raising-game operation section 104 is tapped, a raising game screen is displayed, and the raising game to be described later starts. The raising game is roughly divided into a preparation stage and a raising stage. First, in the preparation stage, the player selects a single character from characters that the player owns, so as to set the selected character as a main character serving as a target character to be raised.

Furthermore, in the preparation stage, the player sets a deck to be used when raising the main character. The deck includes multiple inheritance characters to be described in detail later and multiple support cards. Therefore, in the raising game, the inheritance characters and the support cards included in the deck are used.

When the main character and the deck (inheritance characters and support cards) are completely set, the preparation stage transitions to the raising stage, and the game for raising the main character starts. The player can own a character raised in the raising game as a raised character. As mentioned above, the player can include the raised character that the player owns in a team and use the raised character in, for example, a team competition game.

Accordingly, the main objective of the game according to this embodiment is to raise a raised character in accordance with the raising game and to move up the rankings in the team competition game by using the raised character.

This embodiment is provided with a function for sharing a raised character or a support card between players and a function for sharing information between multiple players. The player can set a raised character and a support card that are usable by another player in the raising game. In detail, as shown in FIG. 3A, a setting operation section 106 is provided at the upper right part of the home screen 100. When the setting operation section 106 is tapped, an option setting screen 110 is displayed.

FIG. 3B illustrates an example of the option setting screen 110. The option setting screen 110 can be used for checking and setting various types of information. The option setting screen 110 is provided with a plurality of operation sections. When any of the operation sections is tapped, information corresponding to the operation section can be checked and set.

The operation sections on the option setting screen 110 include a profile-setting operation section 110a and a close operation section 110b. When the close operation section 110b is tapped, the option setting screen 110 is closed, and the home screen 100 is displayed. When the profile-setting operation section 110a is tapped, a profile setting screen 120 is displayed.

FIG. 3C illustrates an example of the profile setting screen 120. The player can check and set profile information of the player on the profile setting screen 120. The profile information includes a profile character, a player name, a player ID, an affiliated club, a representative character, and a rental card.

The profile character functions as a character to be displayed when information about the player is browsed by another player. For example, the profile character is displayed when a club function serving as a place where information is shared with another player is being used. The profile setting screen 120 displays a currently-set profile character image 122. A change button 124 is provided near the profile character image 122. When the change button 124 is tapped, a profile-character change screen (not shown) is displayed. The player can change the profile character on the profile-character change screen.

The profile setting screen 120 also displays the player name set by the player, the player ID given to the player, and the name of the club to which the player belongs. Furthermore, the profile setting screen 120 is provided with a representative-character setting operation section 126a and a rental-card setting operation section 126b.

When the representative-character setting operation section 126a is tapped, a representative-character setting screen (not shown) is displayed. On the representative-character setting screen, the player can set any one of raised characters raised by the player as a representative character. The representative-character setting operation section 126a displays an icon image indicating the currently-set representative character. As will be described in detail later, the representative character can be included as an inheritance character in a deck in a raising game played by another player.

When the rental-card setting operation section 126b is tapped, a rental-card setting screen (not shown) is displayed. On the rental-card setting screen, the player can set any one of the support cards owned by the player as a rental card. The rental-card setting operation section 126b displays an icon image indicating the currently-set rental card. As mentioned above, the support card set as the rental card can be included in a deck by another player and can be used in a raising game played by another player.

Although a detailed description will be omitted, when the setting of the profile information is changed on the profile setting screen 120, the changed setting information is transmitted to the server 1000. The server 1000 stores the profile information for every player.

Furthermore, as shown in FIG. 3A, the home screen 100 displays a setting icon 128. When the setting icon 128 is tapped, a home setting screen 130 is displayed.

FIG. 3D illustrates an example of the home setting screen 130. On the home setting screen 130, the player can set a home-screen setting character 132 to be displayed on the home screen 100. The player can set four home-screen setting characters 132 to be displayed on the home screen 100.

Although not shown in the drawings, when a horizontal flicking operation is input to the home screen 100, the screen displayed on the display 26, that is, the home screen 100, is switched. The home screen 100 displays the four currently-set home-screen setting characters 132. The functions of the respective operation sections displayed on the menu bar 102 are allocated to the home-screen setting characters 132. Therefore, when any of the home-screen setting characters 132 displayed on the home screen 100 is tapped, the screen switches similarly to when the corresponding operation section on the menu bar 102 is tapped.

The home setting screen 130 displays character images respectively corresponding to the four currently-set home-screen setting characters 132 and the corresponding operation sections in a distinguishable manner. When any of the character images displayed on the home setting screen 130 is tapped, a character selection screen (not shown) is displayed. On the character selection screen, the player can select the corresponding home-screen setting character 132. Furthermore, on the home setting screen 130, the player can set a costume for the home-screen setting character 132.

As shown in FIG. 3A, the home screen 100 displays a club icon 134. When the club icon 134 is tapped, a club screen is displayed. On the club screen, the player can exchange information with another player belonging to the same club.

In this embodiment, various limited time events are held irregularly. During the period of a specific event as a limited time event, a specific event icon 108 is displayed on the home screen 100. When the specific event icon 108 is tapped, a specific event screen is displayed. On the specific event screen, for example, the player can exchange specific event points offered only during the specific event with various rewards.

When the raising-game operation section 104 is tapped on the home screen 100, a raising game screen is displayed, and the raising game starts. The player can play the raising game by consuming game points. With regard to a game point, a predetermined value (e.g., +1) is given to the player every predetermined period (e.g., 10 minutes). An upper limit value (e.g., 100) is set for the game points that each player can possess, such that each player can possess the game points within the range of the upper limit value. The upper part of the home screen 100 is provided with a game-point display bar 136 that visually displays the percentage of the currently-possessed game points relative to the upper limit value.

With regard to the game points, a predetermined value (e.g., −30) is subtracted therefrom when the raising game starts. Therefore, if the player does not possess the required game points, the player cannot start the raising game. However, if the player possesses an item for restoring the game points, the player can restore the game points by using the item. For example, this item can be given as a reward of the raising game or the team competition game or can be obtained by consuming the in-game currency. The raising game will be described in detail below.

### (Raising Game)

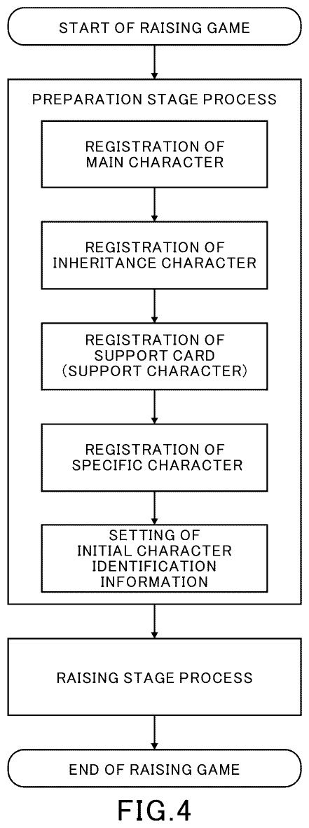

FIG. 4 is a diagram for roughly explaining the flow of the raising game. The raising game is roughly divided into a setting game and a main raising game. As will be described in detail later, the main raising game involves raising a main character selected from the characters owned by the player as a target character to be raised.

The setting game involves the player registering the main character and the deck (inheritance character and support card), and corresponds to the preparation stage of the raising game. A process executed in the setting game will be referred to as a preparation stage process, and a process executed in the main raising game will be referred to as a raising stage process. In order to facilitate the understanding, the rough flow in the preparation stage process and the raising stage process will be described first.

### (Preparation Stage Process)

The preparation stage process mainly involves registering a main character, registering a deck (inheritance character and support card), registering a specific character, and setting initial-character identification information. A support card is used for assisting with the raising of the main character. Each support card is always associated with one character, and the character associated with the support card registered in the preparation stage process assists with the raising of the main character. A character associated with a support card will be referred to as a support character hereinafter.

### (Registration of Main Character)

When the player taps on the raising-game operation section 104 on the home screen 100, a scenario selection screen (not shown) is displayed. In this embodiment, multiple scenarios of the main raising game are provided. Each scenario of the main raising game has, for example, an ultimate target or a mid-game target set therein, and the player needs to sequentially clear the set target. Each target and the period required for achieving the target vary from scenario to scenario. On the scenario selection screen, the player can select any one of the multiple scenarios. The following description relates to a case where a predetermined scenario is selected.

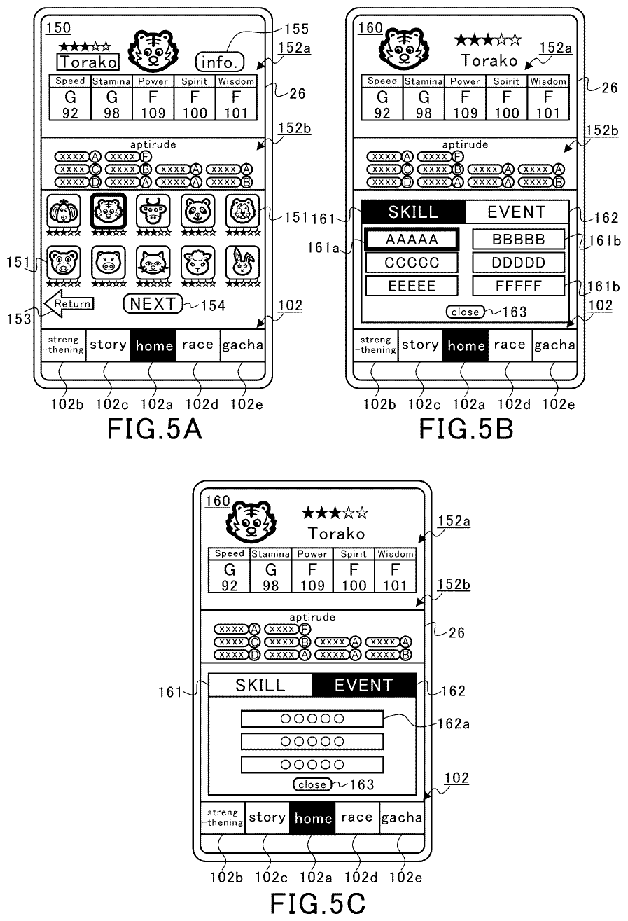

FIG. 5A illustrates a main-character selection screen 150. The central part of the main-character selection screen 150 displays multiple character icons 151 to display a list of characters owned by the player. The upper part of the main-character selection screen 150 displays an attribute-parameter display section 152a and an aptitude-parameter display section 152b. The lower part of the main-character selection screen 150 displays a return operation section 153 indicated as “Return” and a next operation section 154 indicated as “NEXT”.

In this embodiment, initial attribute-parameter values are set for each character, and the attribute-parameter display section 152a numerically displays the initial attribute-parameter values of the character corresponding to the character icon 151 selected by the player. In this embodiment, the larger the numerical value of an attribute parameter, the higher the attribute.

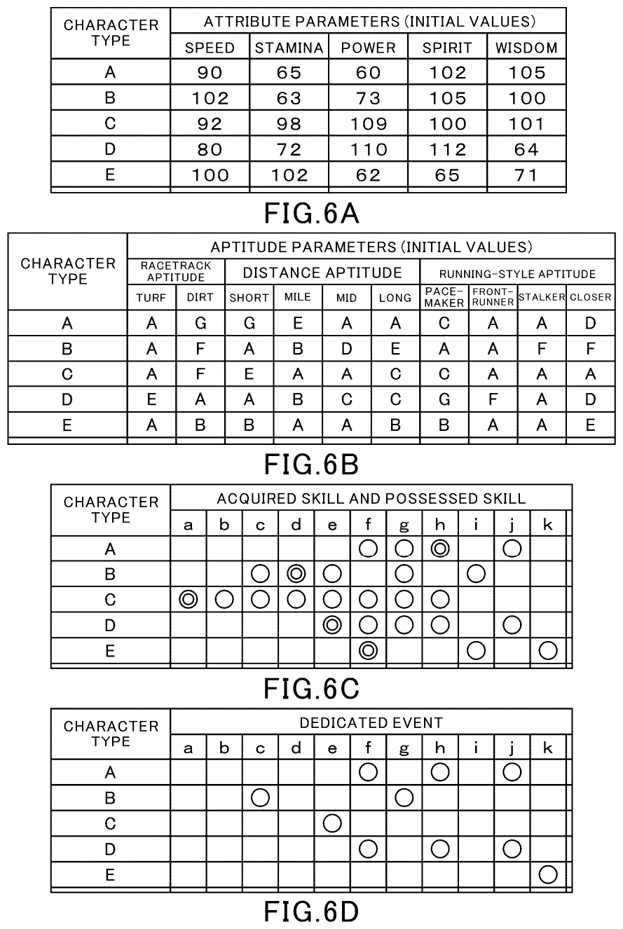

FIG. 6A illustrates an attribute parameter (initial value) table. In this embodiment, as shown in FIG. 6A, initial attribute-parameter values are stored for each character in the attribute parameter (initial value) table. Based on the initial attribute-parameter values stored in the attribute parameter (initial value) table, the initial attribute-parameter values are displayed in the attribute-parameter display section 152a.

In this embodiment, an initial attribute-parameter value is set for every one of multiple kinds of attributes of each character. In detail, the attribute parameters provided include a speed attribute parameter indicated as “Speed” in the attribute-parameter display section 152a, a stamina attribute parameter indicated as “Stamina” in the attribute-parameter display section 152a, a power attribute parameter indicated as “Power” in the attribute-parameter display section 152a, a spirit attribute parameter indicated as “Spirit” in the attribute-parameter display section 152a, and a wisdom attribute parameter indicated as “Wisdom” in the attribute-parameter display section 152a.

The initial attribute-parameter values of each character may increase in response to, for example, an operation by the player. For example, five levels may be provided for each character, and the player may increase the level of the character by consuming the in-game currency or a predetermined item. In this case, the initial attribute-parameter values may increase in accordance with the increase in the level of the character. The player can increase an attribute parameter value in the main raising game. Specifically, the objective of the main raising game is to raise a character having higher numerical values of attribute parameters.

Furthermore, in this embodiment, aptitude parameters (initial values) are set for each character. As shown in FIG. 5A, the aptitude-parameter display section 152b alphabetically displays initial aptitude-parameter values of the character corresponding to the character icon 151 selected by the player.

FIG. 6B illustrates an aptitude parameter (initial value) table. In this embodiment, as shown in FIG. 6B, initial aptitude-parameter values are stored for each character in the aptitude parameter (initial value) table. Each initial aptitude-parameter value is set to any of seven levels using the letters A to G. With regard to each initial aptitude-parameter value, A indicates that the aptitude is at the highest level, whereas G indicates that the aptitude is at the lowest level. Based on the initial aptitude-parameter values stored in the aptitude parameter (initial value) table, the initial aptitude-parameter values are displayed in the aptitude-parameter display section 152b.

In this embodiment, an initial aptitude-parameter value is set for every one of multiple kinds of aptitudes of each character. In detail, the aptitude parameters provided include aptitude parameters related to racetrack aptitudes for turf and dirt racetracks, aptitude parameters related to distance aptitudes for short-distance, mile, mid-distance, and long-distance, and aptitude parameters related to running-style aptitudes for pace-maker, front-runner, stalker, and closer.

In the raising game, the player can have the main character participate in various races. In this case, the main character has a greater advantage in a race as the aptitudes of the main character matching the details of the race become higher.

An initial aptitude-parameter value of each character may be increased by consuming the in-game currency. Moreover, an aptitude parameter value may be changed in the main raising game. Furthermore, in the main raising game, an aptitude parameter may be set to an aptitude level of S, which is higher than A.

FIG. 5B is a first diagram illustrating a character details screen 160. FIG. 5C is a second diagram illustrating the character details screen 160. When one of the character icons 151 on the main-character selection screen 150 is long-pressed, the character details screen 160 is displayed on the display 26. The character details screen 160 displays the details of the attributes of the character corresponding to the character icon 151 long-pressed on the main-character selection screen 150.

The central part of the character details screen 160 displays a skill operation section 161 and an event operation section 162. As shown in FIG. 5B, when the character details screen 160 is first displayed, the skill operation section 161 is highlighted, and skills set for the respective characters are displayed. A skill is an attribute that may be activated when a predetermined condition is satisfied during an individual race and a team race to be described later. Each character has a greater advantage in a race as a skill is activated.

FIG. 6C illustrates a skill table. As shown in FIG. 6C, the skill table stores skills of each character owned by the player. As shown in FIG. 5B, the skills are displayed on the character details screen 160 based on the skills stored in the skill table. A skill is not activated by simply possessing it, but can be activated only by being acquired. A skill that can be activated by a character will be referred to as “acquired skill” hereinafter.

A character has one acquired skill set from the start of the main raising game. In addition to the acquired skill, a character has multiple possessed skills set therefor. A possessed skill can be acquired by consuming skill points, to be described later, after the start of the main raising game. In other words, a possessed skill may become an acquired skill in exchange of skill points.

In this embodiment, a skill corresponding to a double circle in the skill table shown in FIG. 6C is displayed as an acquired skill on the character details screen 160 in FIG. 5B. A skill corresponding to a single circle in the skill table shown in FIG. 6C is displayed as a possessed skill on the character details screen 160 in FIG. 5B. In this embodiment, an acquired skill is highlighted so that the acquired skill and a possessed skill can be readily distinguished from each other, as indicated on the character details screen 160 in FIG. 5B.

In FIG. 5B, the skills provided for each character include one acquired skill displayed in an acquired-skill display field 161a and seven possessed skills displayed in a possessed-skill display field 161b. However, the embodiment is not limited to this. For example, the number of acquired skills and possessed skills may vary from character to character. Furthermore, for example, the number of acquired skills or possessed skills of each character may increase in accordance with an increase in the level of the character or consumption of the in-game currency or an item.

When the player taps on the event operation section 162 on the character details screen 160, the details of the character details screen 160 change, so that a dedicated-event display field 162a indicating dedicated events provided for each character is displayed, as shown in FIG. 5C. In this case, as shown in FIG. 5C, the event operation section 162 is highlighted. A dedicated event occurs when a predetermined condition is satisfied in the main raising game, and involves displaying a story related to a character appearing in the raising game or changing an attribute parameter value.

FIG. 6D illustrates a dedicated event table. As shown in FIG. 6D, the dedicated event table stores dedicated events for each character owned by the player. Based on the dedicated events stored in the dedicated event table, the dedicated events are displayed on the character details screen 160, as shown in FIG. 5C. The dedicated events may include a hint event that allows for possession or acquisition of a skill and an attribute event for increasing or decreasing a numerical value of an attribute parameter of a character.

Regarding the dedicated events displayed on the character details screen 160 shown in FIG. 5C, all of them may be executed during the main raising game, at least some of them may be executed during the main raising game, or none of them may be executed during the main raising game if a predetermined condition is not satisfied. Furthermore, for example, the number of dedicated events provided for each character may increase in accordance with an increase in the level of the character or consumption of the in-game currency or an item. Moreover, when the predetermined condition is satisfied, a dedicated event not displayed as a dedicated event may be executed during the main raising game.

As shown in FIG. 5B and FIG. 5C, the lower part of the character details screen 160 displays a close operation section 163 indicated as “close”. When the close operation section 163 on the character details screen 160 is tapped, the displaying of the character details screen 160 is terminated, and the main-character selection screen 150 is displayed on the display 26.

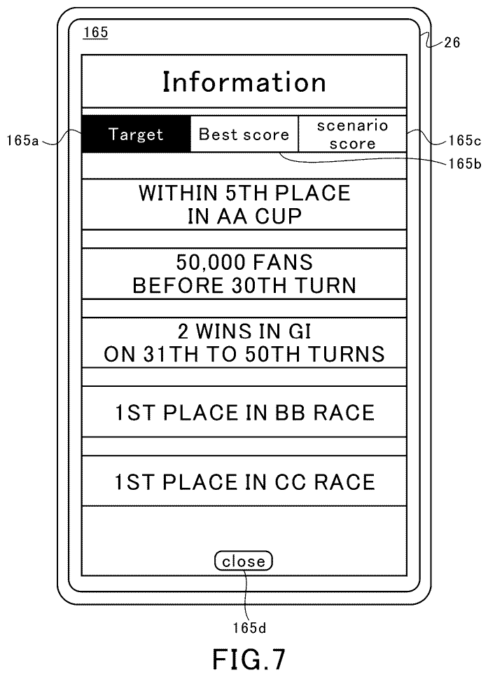

When the return operation section 153 is tapped on the main-character selection screen 150 shown in FIG. 5A, the home screen 100 shown in FIG. 3A is displayed on the display 26. The main-character selection screen 150 is provided with a raising-information display button 155. When the raising-information display button 155 is tapped, a raising-information display screen 165 shown in FIG. 7 is displayed. On the raising-information display screen 165, the player can check information related to the character selected on the main-character selection screen 150.

FIG. 7 is a first diagram illustrating an example of the raising-information display screen 165. The raising-information display screen 165 is provided with a target tab 165a, a best score tab 165b, a scenario score tab 165c, and a close operation section 165d. The objective of the raising game is to raise a more enhanced raised character by raising a character selected as a main character to be raised from the characters owned by the player. As will be described in detail later, the main raising game has multiple turns, and the player needs to have the main character train and participate in a race during each turn.

Multiple targets to be cleared are set for each character. When the target tab 165a is tapped, the raising-information display screen 165 displays a list of targets to be cleared that are set for the selected character. Each turn has a preset race in which the main character can participate. Each target to be cleared includes making the main character participate in a predetermined race during a predetermined turn and acquiring a predetermined finished place.

When the main character to be raised participates in a race, the main character can acquire fans. Each race has the base number of acquired fans set for every finished place, such that the higher the finished place, the larger the number of acquired fans. Moreover, each race has a difficulty level set therefor, such that the higher the difficulty level of the race, the larger the number of fans that can be acquired.

The number of fans acquirable by participating in a race is calculated by adding the bonus number of acquired fans to the base number of acquired fans set for each finished place. In detail, a correction value is determined based on a race result, and the bonus number of acquired fans is calculated by multiplying the base number of acquired fans by the correction value. The sum of the bonus number of acquired fans and the base number of acquired fans is the number of fans acquired by the main character. For example, if the race result indicates first place, the correction value increases with increasing difference between the main character and the character in second place. If the race result ranges between second place and fifth place, the correction value increases with decreasing difference between the main character and the character in first place.

The main character activates skills with a predetermined probability during the race. In this case, the correction value increases with increasing number of activated skills. Accordingly, an addition condition for the number of fans is set for each race, and the number of fans to be acquired increases in accordance with various race results and halfway progress of the race other than the finished places. It should be noted that the number of fans acquired by the main character is at least larger than or equal to the base number of acquired fans corresponding to the finished place.

Depending on the race, a certain number of fans may be required as a participation condition. If the number of fans acquired by the main character does not satisfy the certain number of fans required as the participation condition, the player cannot have the main character participate in the race. The higher the difficulty level of the race, the larger the number of fans required for the participation. Therefore, if a race for which a certain number of fans is required as a participation condition is set as a target race to be cleared (referred to as “target race” hereinafter), it is necessary that the main character has acquired the number of fans required for the target race prior to the turn for performing the target race.

The targets to be cleared include acquiring a predetermined number of fans or more prior to a predetermined turn. Furthermore, the targets to be cleared include finishing in first place for a predetermined number of times or more in a highly difficult race (e.g., GI) within a range of the predetermined turn. Accordingly, multiple targets to be cleared are set for each character. By achieving the targets to be cleared, the player can continue playing the main raising game until the final turn. In contrast, if the targets to be cleared cannot be achieved, the main raising game ends on the relevant turn.

Therefore, supposing that the number of fans required in the target race has not been acquired prior to the turn for performing the target race, the main character cannot participate in the target race. In this case, the targets to be cleared are not achieved, and the raising game ends.

In the main raising game, since the various parameters of the main character increase during each turn, a more enhanced raised character can be produced as the number of turns increases. Therefore, when the main raising game is played, it is necessary to enhance the parameters of the main character so that all of the targets can be cleared.

The targets to be cleared, set for each character, are basically static, and the same targets to be cleared are set as challenges every time the raising game is played. On the other hand, the characters have set targets to be cleared that change in accordance with the progress of the main raising game, or may include a character for which the player can select a target to be cleared.

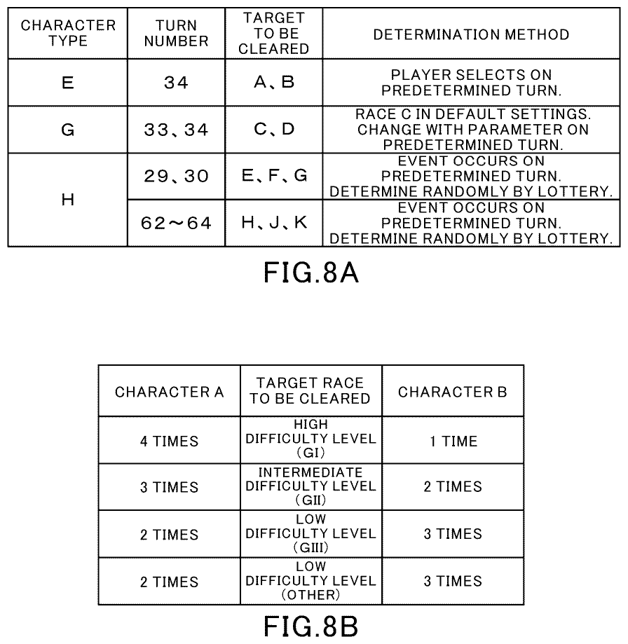

FIG. 8A illustrates an example of special targets to be cleared. For example, for a character of a character type “E”, acquisition of a predetermined finished place in a race selected by the player from race A and race B is set as a target to be cleared on the 34th turn.

For a character of a character type “G”, acquisition of a predetermined finished place in race C on the 33rd turn is set as a default target to be cleared. However, if a predetermined parameter of the main character is below or above a threshold value on a predetermined turn prior to the 33rd turn, the race serving as the target to be cleared is changed to race D on the 34th turn.

For a character of a character type “H”, an event occurs on a predetermined turn prior to the 29th turn. In this event, the race serving as the target to be cleared is randomly determined by lottery from race E and race F on the 29th turn and race G on the 30th turn. Furthermore, for the character of the character type “H”, an event occurs on a predetermined turn prior to the 62nd turn. In this event, the race serving as the target to be cleared is randomly determined by lottery from race H on the 62nd turn, race J on the 63rd turn, and race K on the 64th turn.

Accordingly, multiple static or variable targets to be cleared are set for each character. In accordance with the targets to be cleared, set for the characters, the difficulty level of clearing all the targets to be cleared varies for each character.

While the variable targets to be cleared are being set, the raising-information display screen 165 displays an indication that the targets to be cleared are not set yet. Once the targets to be cleared are set, the raising-information display screen 165 updates the display to notify the player of the set targets to be cleared.

FIG. 8B illustrates an example of targets to be cleared, set for the characters. The main raising game is provided with multiple races selectable by the player. Each race has a difficulty level set therefor. The multiple races include races of different difficulty levels. A target race varies from character to character, and the number of highly difficult races set as target races varies from character to character.

For example, as shown in FIG. 8B, for character A, four races at a high difficulty level, such as GI, are set as target races. Likewise, for character A, three races at an intermediate difficulty level, such as GII, two races at a low difficulty level, such as GIII, and two races at another low difficulty level are set as target races. On other hand, for character B, one race at a high difficulty level, such as GI, two races at an intermediate difficulty level, such as GII, three races at a low difficulty level, such as GIII, and three races at another low difficulty level are set as target races.

It is assumed here that acquisition of first place in all the target races is set as a target to be cleared. In this case, it is more difficult for character A to achieve all the targets to be cleared than character B. A larger number of fans that can be acquired is set for races at higher difficulty levels. Therefore, by achieving the targets to be cleared, character A acquires a larger number of fans than character B.

On the other hand, the player can have the main character participate in races other than the target races set for the main character so long as the participation condition is satisfied. Character B has a smaller number of target races than character A. On a turn with a set target race, the player must always have the main character participate in the target race.

Therefore, character B provides more options for the player on each turn than character A. However, in a case where character B is the main character, in order to acquire the same number of fans as when character A is the main character, the player must have the main character voluntarily participate in a race at a high difficulty level. Accordingly, by varying the difficulty levels of the target races and the number of target races for each character, different strategies are demanded of the player, thereby enhancing the enjoyment of the game.

Although the number of target races as targets to be cleared varies from character to character, as shown in FIG. 8B, the number of targets to be cleared is the same for all the characters. Therefore, for example, for a character with a small number of targets to be cleared, as in acquiring a predetermined finished place in a target race, a large number of targets to be cleared, as in acquiring a predetermined number of fans prior to a predetermined turn, is set. However, the number of targets to be cleared may vary from character to character.

On the raising-information display screen 165 shown in FIG. 7, a target to be cleared, set for the selected character, can be confirmed. When the best score tab 165b is tapped on the raising-information display screen 165, the raising-information display screen 165 displays information, generated based on the selected character, about raised characters with the top three scores.

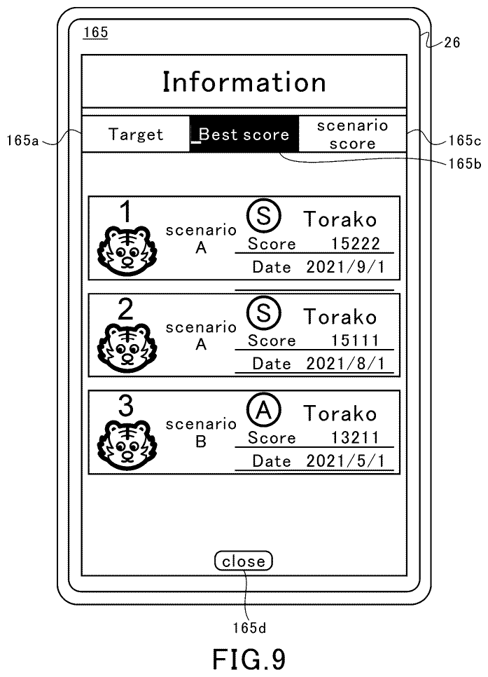

FIG. 9 is a second diagram illustrating an example of the raising-information display screen 165. When the raising game is completed, a raised character is generated. Upon completion of the raising game, a score is calculated for the raised character, and a raising rank is derived based on the score. The score is calculated based on a preset calculation expression using, for example, points calculated from various parameters of the main character at the time of completion of the raising and points calculated in accordance with acquired skills. The raising-information display screen 165 displays information about the raised characters with the top three scores among the raised characters raised based on the selected character. The information indicates ranks, scores, names, and registration dates.

Although a detailed description will be omitted, the raising game is provided with multiple scenarios. The basic specifications of the game are the same among the scenarios, but the functions partially vary from scenario to scenario. As shown in FIG. 9, the raising-information display screen 165 displays scenarios selected when the raised characters are raised. Although not shown, when the scenario score tab 165c is tapped, the raised characters with the top three scores are displayed separately for every scenario.

Accordingly, the player can select the main character while checking various information about each character on the main-character selection screen 150 shown in FIG. 5A. Then, when the next operation section 154 is tapped on the main-character selection screen 150, the selected character is set as the main character, and an inheritance-character selection screen 170 is displayed on the display 26.

(Registration of Inheritance character)

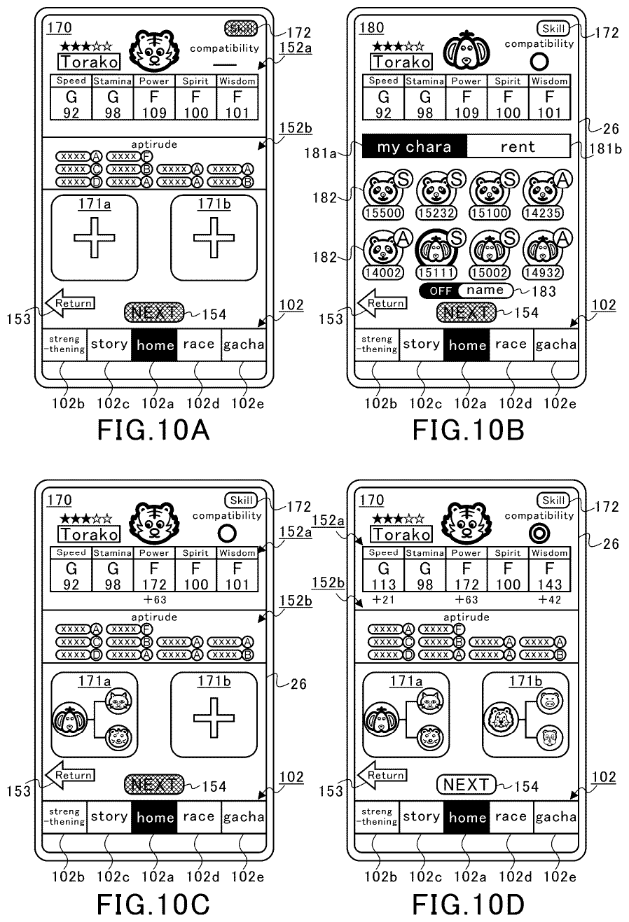

FIG. 10A is a first diagram illustrating the inheritance-character selection screen 170. FIG. 10B is a first diagram illustrating a raised-character-list screen 180. FIG. 10C is a second diagram illustrating the inheritance-character selection screen 170. FIG. 10D is a third diagram illustrating the inheritance-character selection screen 170. The inheritance-character selection screen 170 is a screen used by the player for registering an inheritance character.

An inheritance character is a character that inherits, for example, attribute values and skills from the main character. The player can select two inheritance characters from a raised character owned by the player and a representative character, such as a representative character of a friend, such as a follower, of another player extracted in accordance with a predetermined extraction condition, so as to form and register a deck. With regard to the representative character of another player, only one representative character can be included as an inheritance character in the deck in a single raising game.

The inheritance-character selection screen 170 is provided with the attribute-parameter display section 152a, the aptitude-parameter display section 152b, a first-inheritance-character selection region 171a, and a second-inheritance-character selection region 171b. When the screen transitions from the main-character selection screen 150 to the inheritance-character selection screen 170, the first-inheritance-character selection region 171a and the second-inheritance-character selection region 171b are displayed as blank fields, as shown in FIG. 10A.

When the first-inheritance-character selection region 171a or the second-inheritance-character selection region 171b is tapped, the raised-character-list screen 180 shown in FIG. 10B is displayed. The raised-character-list screen 180 is provided with a my-character tab 181a and a rental tab 181b. Furthermore, a raised-character-list display region is provided below the my-character tab 181a and the rental tab 181b. The raised-character-list display region displays raised character icons 182.

In a state where the my-character tab 181a is selected, the raised character icons 182 corresponding to the raised characters owned by the player are displayed, as shown in FIG. 10B. Although not shown, in a state where the rental tab 181b is selected, raised character icons 182 corresponding to representative characters of a friend, that is, raised characters raised by the friend, are displayed.

When any of the raised character icons 182 is tapped, the raised character corresponding to the raised character icon 182 transitions to a provisionally selected state. Furthermore, when the raised character icon 182 is tapped, the inheritance-character selection screen 170 is displayed, as shown in FIG. 10C. In this case, for example, when the raised-character-list screen 180 is displayed in response to tapping on the first-inheritance-character selection region 171a, and the raised character icon 182 is tapped on the raised-character-list screen 180, an image indicating the raised character in the provisionally selected state is displayed in the first-inheritance-character selection region 171a.

In this state, for example, when the raised-character-list screen 180 is displayed in response to tapping on the second-inheritance-character selection region 171b, and the raised character icon 182 is tapped on the raised-character-list screen 180, the image indicating the raised character in the provisionally selected state is displayed in the second-inheritance-character selection region 171b, as shown in FIG. 10D.

A raised character is associated with and has stored therein information related to inheritance characters used during the raising. The first-inheritance-character selection region 171a displays the information related to the inheritance characters used during the raising of the raised character.

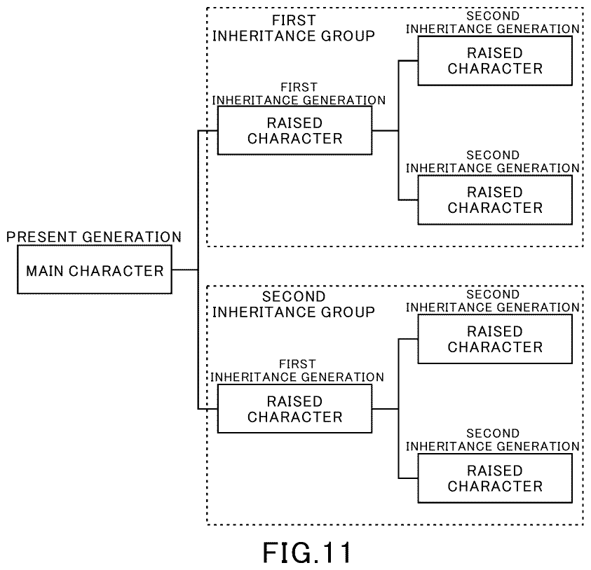

FIG. 11 illustrates an inheritance lineage. The raising game brings about various effects, such as increases in attribute parameter values and aptitude parameter values of the main character, based on factor information that the inheritance character has. Although two inheritance characters are set for one main character, these inheritance characters are raised characters generated in advance. Therefore, even when a raised character set as an inheritance character is generated, two inheritance characters are set for the raised character.

As shown in FIG. 11, the main character to be raised in the main raising game to be commenced is defined as the present generation. Two raised characters set as inheritance characters relative to the main character are defined as the first inheritance generation. Furthermore, with regard to raised characters of the first inheritance generation, two raised characters are set as inheritance characters at the start of the raising. When the raised characters of the first inheritance generation are generated, two raised characters set as inheritance characters are defined as the second inheritance generation.

In this case, raised characters of the first inheritance generation and the second inheritance generation bring about an effect on the main character of the present generation, as shown in FIG. 11. As mentioned above, since two inheritance characters (of the first inheritance generation) are set for one main character, a total of six raised characters bring about an effect on one main character.

For example, one of the two raised characters of the first inheritance generation and two raised characters of the second inheritance generation serving as inheritance characters of the above raised character constitute a first inheritance group. Likewise, the other one of the two raised characters of the first inheritance generation and two raised characters of the second inheritance generation serving as inheritance characters of the above raised character constitute a second inheritance group.

As shown in FIG. 10D, the first-inheritance-character selection region 171a indicates icons corresponding to one raised character of the first inheritance generation and two raised characters of the second inheritance generation that are included in the first inheritance group. Likewise, the second-inheritance-character selection region 171b indicates icons corresponding to one raised character of the first inheritance generation and two raised characters of the second inheritance generation that are included in the second inheritance group.

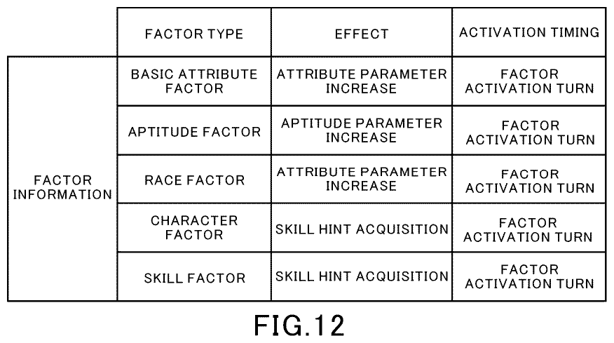

FIG. 12 illustrates the factor information. As will be described in detail later, when the raising game is completed, the main character to be raised is registered as a raised character, and the raised character has factor information stored in association therewith. In detail, at the time of completion of raising of the raised character, factors to be acquired by the raised character are determined by lottery. Factor information indicating the factors selected by lottery are associated with the raised character. In other words, at the time of completion of the raising game, the raised character can acquire the factors selected by lottery.

However, the factors acquired by the raised character do not affect the attributes of the raised character. For example, the raised character can participate in a race game, such as a team competition game. In this case, the race involves performing a simulation for determining the finished places and the race outcome, that is, a computational process, based on, for example, the attribute parameters, aptitude parameters, and acquired skills of all the participating raised characters. Since the factors that the raised character has are not used in the computational process, the raised character does not advantageously proceed with the race even if the raised character supposedly has a large number of factors.

If the raised character is set as an inheritance character, the factors that the raised character has only affect the main character to be raised. The factors acquirable by the raised character are classified into multiple types. FIG. 12 illustrates a basic attribute factor, an aptitude factor, a race factor, a character factor, and a skill factor as the types of factors. Each factor has any one of multiple levels set therefor. The factor levels provided here are three factor levels, namely, level 1, level 2, and level 3.

The factor level is determined by lottery. In this case, after the factors acquired by the raised character are determined, the factor level may be determined by lottery for each of the acquired factors. Alternatively, a selection ratio may be set for every combination pattern between a factor and a factor level, and any of the combination patterns may be determined based on the set selection ratio. In this case, the factor to be acquired and the factor level are determined at the same time.

With regard to the factor levels, level 3 has the highest effect, whereas level 1 has the lowest effect. In the lottery for determining the factor level, the selection probability of level 3 is set to be the lowest, whereas the selection probability of level 1 is set to be the highest. However, depending on the result of the raising game, the selection probability of a factor to be acquired and the selection probability of a factor level may change. In this case, for example, a higher factor level may be set for a raised character with a higher attribute parameter or a higher score.

The basic attribute factor increases an attribute parameter of the main character. There are five basic attribute factors provided, which include a speed factor, a stamina factor, a power factor, a spirit factor, and a wisdom factor. Of the five basic attribute factors, the raised character always acquires one basic attribute factor. The five basic attribute factors respectively correspond to the five attribute parameters of speed, stamina, power, spirit, and wisdom. For example, if a raised character of the first inheritance generation or the second inheritance generation has a speed factor, the speed attribute parameter of the main character increases.

In this case, an increase value of the speed attribute parameter varies depending on the factor level of the speed factor. For example, the speed attribute parameter of the main character increases by “7” when the factor level of the speed factor is level 1, the attribute parameter increases by “13” in the case of level 2, and the attribute parameter increases by “21” in the case of level 3. Therefore, supposing that a total of six raised characters including two raised characters of the first inheritance generation and four raised characters of the second inheritance generation all have a speed factor at level 3, the speed attribute parameter of the main character increases by a maximum of 126 (increase value of 21×6).

However, each factor has a set activation timing and a set activation condition. Therefore, even if an inheritance character has a factor, the main character does not receive the effect if the activation condition is not satisfied at the activation timing.

As mentioned above, the main raising game has multiple turns that include a predetermined turn set as a factor activation turn. For example, it is assumed that three turns, namely, the first turn, the 30th turn, and the 54th turn, in the main raising game are set as factor activation turns. On each of these factor activation turns, it is determined whether or not the factor is to be activated. If it is determined that the factor is to be activated, the activation condition for the factor is satisfied, and an effect corresponding to the factor is brought about.

Determination of whether or not a basic attribute factor is to be activated is performed by lottery. In this case, the selection probability in the lottery for determining whether or not the basic attribute factor is to be activated, that is, the probability of activating the basic attribute factor (referred to as “activation probability” hereinafter), may vary among the three factor activation turns. For the first turn, the activation probability of the basic attribute factor is set to 100% regardless of the factor level. For each of the 30th turn and the 54th turn, the activation probability of the basic attribute factor varies depending on the factor level. For example, for each of the 30th turn and the 54th turn, the activation probability of the basic attribute factor at level 3 is set to 100%, the activation probability of the basic attribute factor at level 2 is set to 90%, and the activation probability of the basic attribute factor at level 1 is set to 80%.

The inheritance-character selection screen 170 displays an increase value by which an attribute parameter increases on the first turn. For example, in FIG. 10C, one inheritance character included in the first inheritance group is provisionally selected. In this case, the type of attribute parameter that increases on the first turn and the increase value thereof are displayed in accordance with the one provisionally-selected inheritance character. In this case, “+63” is displayed below the power attribute parameter and indicates that the power attribute parameter increases by 63 points on the first turn. The attribute-parameter display section 152a displays a value to which the increase value has been added on the first turn.

Furthermore, in FIG. 10D, two inheritance characters included in the first inheritance group and the second inheritance group are provisionally selected. In this case, the types of attribute parameters that increase on the first turn and the increase values thereof are displayed in accordance with the two provisionally-selected inheritance characters. In this case, “+21”, “+63”, and “+42” are respectively displayed below the speed, power and wisdom attribute parameters and indicate that the speed, power and wisdom attribute parameters increase by 21 points, 63 points, and 42 points, respectively, on the first turn.

On the inheritance-character selection screen 170, the increase value of the attribute parameter that increases due to the inheritance character included in the first inheritance group and the increase value of the attribute parameter that increases due to the inheritance character included in the second inheritance group are displayed in a distinguishable manner. For example, in FIG. 10D, “+63” displayed below the power attribute parameter is indicated in a color different from that of “+21” and “+42” displayed below the speed and wisdom attribute parameters.

The aptitude factor shown in FIG. 12 increases an aptitude parameter of the main character. There are six aptitude factors provided, which include a turf-racetrack factor, a dirt-racetrack factor, a short-distance factor, a mile factor, a mid-distance factor, and a long-distance factor. Of the six aptitude factors, the raised character always acquires one aptitude factor. The six aptitude factors respectively correspond to the turf-racetrack aptitude, the dirt-racetrack aptitude, the short-distance aptitude, the mile aptitude, the mid-distance aptitude, and the long-distance aptitude. For example, if the raised characters of the first inheritance generation or the second inheritance generation include a raised character having a turf-racetrack factor, the turf-racetrack aptitude parameter of the main character increases.

Each aptitude factor also has a set activation timing and a set activation condition. During each of factor activation turns identical to those of the basic attribute factors, it is determined whether or not the corresponding aptitude factor is to be activated. If it is determined that the aptitude factor is to be activated, the corresponding aptitude parameter increases by one level. For example, for the first turn, the activation probability of the aptitude factor is set to 100% regardless of the factor level.

For example, the aptitude factors of the three raised characters belonging to the first inheritance group are a turf-racetrack factor, a short-distance factor, and a mile factor, respectively, and the aptitude factors of the three raised characters belonging to the second inheritance group are a turf-racetrack factor, a short-distance factor, and a mid-distance factor, respectively. In this case, the turf-racetrack aptitude and the short-distance aptitude of the main character increase by two levels, and the mile aptitude and the mid-distance aptitude increase by one level.

Furthermore, for example, it is assumed that the aptitude factors of the three raised characters belonging to the first inheritance group are all turf-racetrack factors and that the aptitude factors of the three raised characters belonging to the second inheritance group are all short-distance factors. In this case, the turf-racetrack aptitude and the short-distance aptitude of the main character increase by three levels. As another example, it is assumed that the aptitude factors of the three raised characters belonging to the first inheritance group are all turf-racetrack factors and that the aptitude factors of the three raised characters belonging to the second inheritance group are a turf-racetrack factor, a short-distance factor, and a mile factor, respectively. In this case, the turf-racetrack aptitude of the main character increases by four levels, and the short-distance aptitude and the mile aptitude increase by one level.

However, for the first turn, there is a limit provided for the increase value of each aptitude parameter. In detail, for the first turn, an upper limit for all the aptitude parameters is set to A. Therefore, supposing that an initial value for the turf-racetrack aptitude of the main character is A, the turf-racetrack aptitude does not increase on the first turn even if an inheritance character has a turf-racetrack factor.

In contrast, for the 30th turn and the 54th turn, it is determined by lottery whether or not each aptitude factor is to be activated based on the factor level. For example, for each of the 30th turn and the 54th turn, the activation probability of an aptitude factor at level 3 is set to 5%, the activation probability of an aptitude factor at level 2 is set to 3%, and the activation probability of an aptitude factor at level 1 is set to 1%. When it is determined by lottery that an aptitude factor is to be activated on the 30th turn or the 54th turn, the aptitude parameter corresponding to the aptitude factor increases. For the 30th turn and the 54th turn, the upper limit for each aptitude is raised from A to S. Therefore, on each of the 30th turn and the 54th turn, the aptitude factors are activated so that the values of the aptitude parameters can be increased to S.

The aptitude-parameter display section 152b of the inheritance-character selection screen 170 displays the aptitude parameter values that have increased on the first turn.

A race factor increases an attribute parameter of the main character. For example, a race factor is provided for each highly difficult race (referred to as “factor target race” hereinafter), such as GI, among participable races in the main raising game. Upon completion of the raising game, it is determined by lottery whether or not a race factor is to be acquired for every factor target race in which the main character has finished in first place. By being selected in this lottery, a raised character can acquire the race factor.

A race factor is also provided with factor levels. For every race factor set to be acquired, a factor level is determined by lottery. In this case, there is no limit to the number of race factors that a single raised character can acquire, such that each raised character can acquire multiple race factors.

For each race factor, an attribute parameter to be increased by activation and an increase value thereof are set in advance. For example, the race factors include a race factor that increases the speed attribute parameter and a race factor that increases the power attribute parameter. In this case, the increase value of each attribute parameter increases as the factor level becomes higher.

Each race factor also has a set activation timing and a set activation condition. During every factor activation turn, it is determined whether or not the corresponding race factor is to be activated. If it is determined that the race factor is to be activated, the attribute parameter corresponding to the race factor increases. The factor activation turns of the race factor are limited to the 30th turn and the 54th turn. The activation probability of the race factor on each factor activation turn varies depending on the factor level. The activation probability increases as the factor level becomes higher.

A character factor is a character-specific factor. For example, a character factor set for a character enhanced to a predetermined level is always given to a raised character upon completion of the raising game only when the character is raised as a main character. Since only one character factor is set for each character, the maximum number of character factors that a single raised character can acquire is one. If a raised character is generated based on a character not enhanced to the predetermined level, a character factor is not acquirable.

Each character factor can be activated on a preset factor activation turn, and is activated by being selected in a lottery executed on the factor activation turn. When the character factor is activated, a hint event set for every character factor occurs, and a hint for a skill can be acquired, as mentioned above.

A skill factor is given based on an acquired skill acquired by a raised character. In detail, upon completion of the raising game, it is determined by lottery whether a skill factor is to be acquired for every acquired skill acquired by a raised character. By being selected in this lottery, the skill factor is given to the raised character. Specifically, the raised character can partially or entirely acquire the skill factor corresponding to the acquired skill. When it is determined that the skill factor is to be acquired, the factor level of the skill factor is determined by lottery.

Each skill factor can be activated on a preset factor activation turn, and is activated by being selected in a lottery executed on the factor activation turn. The selection probability increases as the factor level becomes higher. When the skill factor is activated, a hint event set for every skill factor occurs, and a hint for a skill can be acquired. Accordingly, the main character can acquire a skill similar to an acquired skill acquired by, for example, an inheritance character.

Accordingly, the determination of whether or not a skill factor is to be acquired is performed within a range of an acquired skill acquired by a raised character. Therefore, the possibility of acquiring a skill factor increases for a raised character having a larger number of acquired skills. However, because the determination of whether or not a skill factor is to be acquired is performed by lottery, a skill factor is sometimes not acquirable even when the number of acquired skills is large.

In this case, a raised character acquires a skill factor separately from an acquired skill. Alternatively, a skill factor need not be provided, and a skill acquirable by the main character may be determined based on an acquired skill that a raised character has by being an inheritance character.

Accordingly, the attribute parameters of the main character vary significantly depending on the inheritance characters included in the deck. Even when a raised character has high attributes, since the determination of whether or not a factor is to be acquired is performed by lottery, the raised character with high attributes is not necessarily suitable as an inheritance character. On the other hand, even when a raised character does not have high attributes, the raised character may sometimes effectively function as an inheritance character by acquiring a large number of factors at a high factor level. The ability to organize the inheritance characters into a deck in this manner brings about the enjoyment of not only simply raising superior raised characters but also raising raised characters effective as inheritance characters.

Furthermore, in this embodiment, the compatibility among the main character, the raised characters of the first inheritance generation, and the raised characters of the second inheritance generation is determined. A combination of highly-compatible characters contributes to an advantageous factor activation condition.

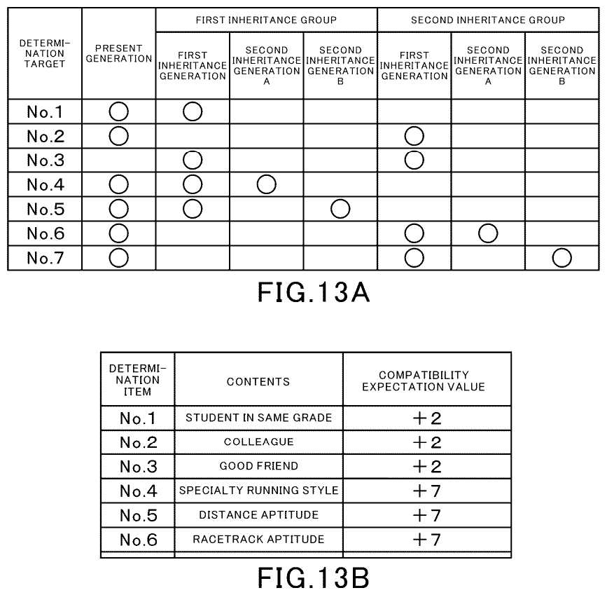

FIG. 13A illustrates compatibility determination targets, and FIG. 13B illustrates compatibility determination items. As shown in FIG. 13A, in this embodiment, seven determination targets from No. 1 to No. 7 are provided. A first determination target (No. 1) includes the main character of the present generation and the raised character of the first inheritance generation in the first inheritance group. A second determination target (No. 2) includes the main character of the present generation and the raised character of the first inheritance generation in the second inheritance group.

A third determination target (No. 3) includes the raised character of the first inheritance generation in the first inheritance group and the raised character of the first inheritance generation in the second inheritance group. A fourth determination target (No. 4) includes the main character of the present generation, the raised character of the first inheritance generation in the first inheritance group, and one (raised character A) of the raised characters of the second inheritance generation in the first inheritance group. A fifth determination target (No. 5) includes the main character of the present generation, the raised character of the first inheritance generation in the first inheritance group, and the other one (raised character B) of the raised characters of the second inheritance generation in the first inheritance group.

A sixth determination target (No. 6) includes the main character of the present generation, the raised character of the first inheritance generation in the second inheritance group, and one (raised character A) of the raised characters of the second inheritance generation in the second inheritance group. A seventh determination target (No. 7) includes the main character of the present generation, the raised character of the first inheritance generation in the second inheritance group, and the other one (raised character B) of the raised characters of the second inheritance generation in the second inheritance group.

For every determination target described above, it is determined whether or not a condition for each of multiple determination items is satisfied. FIG. 13B illustrates an example of the determination items. In this embodiment, the setting of the game is such that a character selectable as the main character is a student and that each character trains at a school.

As shown in FIG. 13B, preset characters include a student, a colleague, and a good friend. The determination items include, for example, details indicating whether two or three characters as determination targets are students in the same grade, are colleagues, or are good friends. The determination items also include an indication of whether or not the specialty running style of a character as a determination target, the distance aptitude, and the racetrack aptitude match.

Each determination item is associated with a compatibility expectation value. The compatibility expectation values of the determination items satisfied among the characters serving as determination targets are accumulated. In this case, although the compatibility expectation value varies from determination item to determination item, the compatibility expectation value may be the same for all the determination items.

For example, when determining the compatibility, it is first determined whether or not all the determination items are satisfied between the main character of the present generation and the raised character of the first inheritance generation in the first inheritance group that serve as the first determination target. In this case, the compatibility expectation values associated with the satisfied determination items are accumulated and counted. The compatibility expectation values are counted sequentially from the first determination target to the seventh determination target in this manner. Based on an ultimately-calculated compatibility expectation value, the factor activation probability is corrected. Specifically, the activation probability of all the factors increases with increasing compatibility expectation value, whereas the activation probability of all the factors decreases with decreasing compatibility expectation value.

An activation probability may be calculated by using the calculated compatibility expectation value as a correction value. Furthermore, for example, a correction value for correcting the factor activation probability may be set for every compatibility level, and the compatibility level may be determined in accordance with the calculated compatibility expectation value.

Accordingly, since the factor activation probability varies depending on the compatibility between the main character and an inheritance character or the compatibility between inheritance characters, the combination of two inheritance characters brings about a significant effect on the raising of the main character. Specifically, the compatibility between characters is important information for determining which inheritance character is to be selected.

As shown in FIG. 10B, FIG. 10C, and FIG. 10D, in a state where an inheritance character is selected, a compatibility mark indicating the level of compatibility is displayed at the upper right side of the inheritance-character selection screen 170 and the raised-character-list screen 180. In this case, the compatibility level of the selected character is indicated with one of three compatibility marks denoted by a double circle, a single circle, and a triangle. In a state where an inheritance character is not selected, as shown in FIG. 10A, a compatibility mark is not displayed.

As shown in FIG. 10B, the raised-character-list screen 180 is provided with a display switch button 183. When the display switch button 183 is operated, a display-condition setting screen (not shown) is displayed. On the display-condition setting screen, the player can rearrange or filter the raised character icons 182 displayed on the raised-character-list screen 180, that is, the raised characters selectable as inheritance characters.

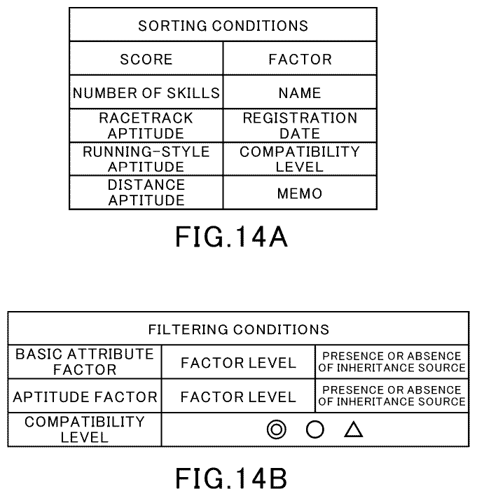

FIG. 14A illustrates sorting conditions. FIG. 14B illustrates filtering conditions. On the display-condition setting screen, the player can select and set any of the sorting conditions shown in FIG. 14A. In this case, the sorting conditions that can be selected and set include the score, factor, number of skills, name, racetrack aptitude, registration date, running-style aptitude, compatibility level, distance aptitude, and memo. When the sorting condition is set, the raised-character-list screen 180 is displayed. In this case, the display order of the raised character icons 182 is changed on the raised-character-list screen 180 in accordance with the sorting condition.

On the display-condition setting screen, the player can select and set any of the filtering conditions shown in FIG. 14B. The filtering conditions provided include the basic attribute factor, aptitude factor, and compatibility level. When the basic attribute factor or the aptitude factor is set as the filtering condition, the raised-character-list screen 180 displays only the raised character or characters having the factor selected by the player.

In this case, the player can set the factor level. For example, when the filtering is performed by setting the factor level to level 3, the raised-character-list screen 180 displays only the raised character or characters having the factor with the factor level of level 3 between the factors selected by the player. The player can filter the raised characters by selecting whether a raised character itself has the factor or whether an inheritance character of the raised character has the factor.

The player can also perform the filtering based on the compatibility level. It is possible to filter a raised character with the compatibility level denoted by the double circle, a raised character with the compatibility level denoted by the single circle, and a raised character with the compatibility level denoted by the triangle. Accordingly, the sorting and the filtering can be performed based on various conditions, thereby achieving enhanced player friendliness.

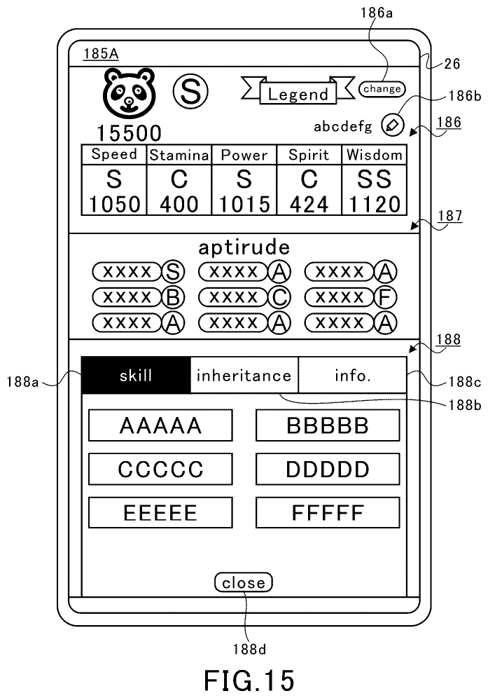

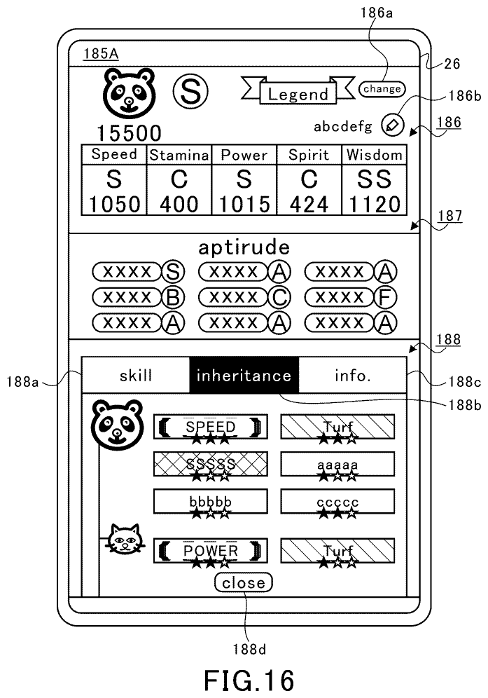

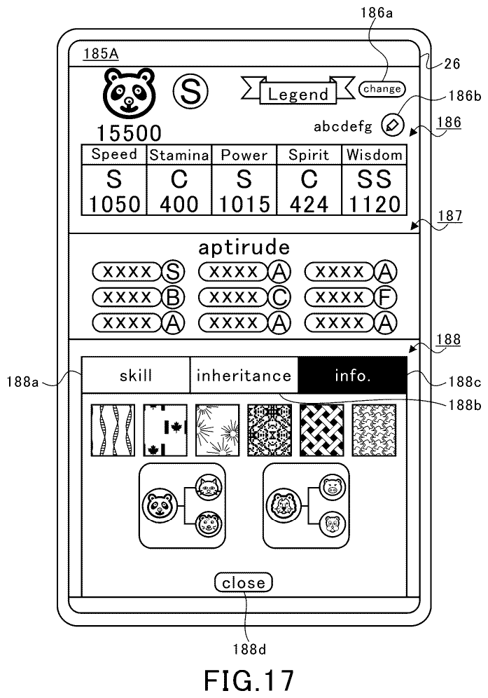

When any of the raised character icons 182 is long-pressed on the raised-character-list screen 180 shown in FIG. 10B, detailed information about the raised character corresponding to the raised character icon 182 is displayed. FIG. 15 is a first diagram illustrating a character details dialog 185A. FIG. 16 is a second diagram illustrating the character details dialog 185A. FIG. 17 is a third diagram illustrating the character details dialog 185A. The character details dialog 185A displays detailed information about the raised character. The upper part of the character details dialog 185A displays an attribute-parameter display field 186 indicating the attribute parameters of the raised character.

An icon indicating the character serving as a basis for the raised character, as well as the score and the raising rank of the raised character, are displayed at the upper left side of the attribute-parameter display field 186.

Furthermore, a second-name change button 186a and a memo input button 186b are provided at the upper right side of the attribute-parameter display field 186. When the second-name change button 186a is tapped, a second-name-list screen (not shown) is displayed. The second-name-list screen displays a list of second names acquired by the raised character. In the main raising game, a large number of second names are provided, and an acquisition condition is set for all the second names.

In the main raising game, a second name that has satisfied the acquisition condition is given to the raised character. The player can select any one of the second names acquired by the raised character and can set the second name for the raised character. On the second-name-list screen, the player can change the second name set for the raised character. A currently-set second name (in this case, “Legend”) is displayed to the left of the second-name change button 186a.

Examples of the second-name acquisition condition include acquisition of a predetermined number of fans by the main character, an attribute parameter or an aptitude parameter being a predetermined value or more, acquisition of a predetermined skill, the number of wins in races being a predetermined value or more, and acquisition of a predetermined finished place (e.g., first place) in a specific race.

When the memo input button 186b is tapped, a text input screen (not shown) is displayed. The text input screen accepts nine characters or fewer of, for example, Hiragana characters, Katakana characters, numerals, and Roman characters. The text input to the text input screen is stored as a memo in association with the raised character. If the raised character has a memo stored therein, the memo (in this case, “abcdefg”) is displayed to the left of the memo input button 186b.

The sorting conditions for the raised character icons 182 on the raised-character-list screen 180 include the aforementioned memo. Therefore, by registering the memo in association with the raised character, the player can search for the raised character to be used as an inheritance character more readily.

An aptitude-information display field 187 is displayed below the attribute-parameter display field 186. The aptitude-information display field 187 displays the aptitude parameters related to racetrack aptitudes for turf and dirt racetracks, the aptitude parameters related to distance aptitudes for short-distance, mile, mid-distance, and long-distance, and the aptitude parameters related to running-style aptitudes for pace-maker, front-runner, stalker, and closer.

A various-information display field 188 is displayed below the aptitude-information display field 187. The various-information display field 188 is provided with a skill display tab 188a, an inheritance-information display tab 188b, a raising-information display tab 188c, and a close operation section 188d. When the skill display tab 188a is tapped, the acquired skills of the raised character are displayed in the various-information display field 188, as shown in FIG. 15. When the inheritance-information display tab 188b is tapped, the inheritance information of the raised character is displayed, as shown in FIG. 16.

The various-information display field 188 displays inheritance information based on a raised character settable as an inheritance character and an inheritance character used for raising the raised character. The inheritance information includes information about the inheritance character used for raising the raised character, factor information that the raised character has, and factor information that the inheritance character has. A list of inheritance information is displayed for each raised character.

In detail, the factor information associated with the raised character and the factor information associated with the inheritance character of the raised character are displayed for each character. Therefore, by scrolling the various-information display field 188 in the vertical direction, the player can check the factor information that each of the three characters has.

The various-information display field 188 displays the basic attribute factor, the aptitude factor, and the character factor in different colors. For example, the basic attribute factor is displayed in blue, the aptitude factor is displayed in red, and the character factor is displayed in green. The various-information display field 188 displays the race factor and the skill factor in white. Stars indicating the factor levels are superposed and displayed on each piece of factor information.

When the raising-information display tab 188c is tapped, the raising information of the raised character is displayed, as shown in FIG. 17. The raising information includes the type of support card used when raising the raised character, the characters of the first inheritance generation and the second inheritance generation, the record of individual races in the raising game, and the score.

Accordingly, the player can check various types of information related to the raised character in the character details dialog 185A. Therefore, the player can readily ascertain information associated with each inheritance character included in the deck, thereby achieving enhanced player friendliness.

When the close operation section 188d is tapped on the character details dialog 185A, the character details dialog 185A is closed, and the raised-character-list screen 180 is displayed on the display 26. As shown in FIGS. 10A, 10B, 10C, and 10D, a skill display button 172 is provided at the upper right side of the inheritance-character selection screen 170 and the raised-character-list screen 180. When the skill display button 172 is tapped, a list of skills to be possibly acquired is displayed in accordance with the raised character provisionally selected as an inheritance character.

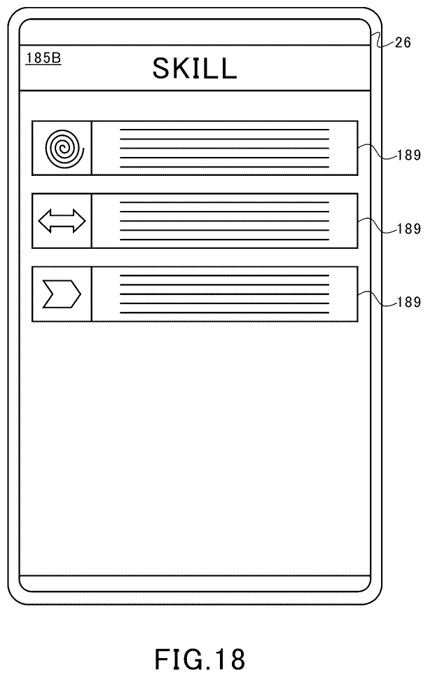

FIG. 18 illustrates a skill display dialog 185B. The skill display dialog 185B displays a skill-description display field 189 indicating an icon corresponding to a skill and the details of the skill. With regard to the skill displayed in the skill-description display field 189, if the currently-selected raised character is used as an inheritance character, a list of all the skills that the main character may possibly acquire is displayed.

Specifically, the skill display dialog 185B displays a list of information related to the skills associated with the character factor or the skill factor that the raised character has. As shown in FIG. 10C, when the skill display button 172 is tapped in a state where one raised character is selected as an inheritance character, the skills associated with the character factor and the race factor that this one raised character (inheritance character) has are displayed in the skill display dialog 185B.

On the other hand, as shown in FIG. 10D, when the skill display button 172 is tapped in a state where two raised characters are selected as inheritance characters, the skills associated with the character factors and the race factors that the two raised characters (inheritance characters) have are displayed in the skill display dialog 185B.

Accordingly, in this embodiment, a list of inheritance information (factor information) is displayed in the character details dialog 185A for every raised character settable as an inheritance character. Moreover, a list of information (skills) associated with the inheritance information (factor information) is displayed in the skill display dialog 185B. In this case, the character details dialog 185A and the skill display dialog 185B are displayed based on the raised character settable as an inheritance character and the inheritance character used for generating the raised character. By displaying the character details dialog 185A and the skill display dialog 185B, enhanced player friendliness is achieved.

In this case, the skill display dialog 185B displays a skill that is acquirable by activating a factor. Alternatively, instead of displaying skill-related information, the skill display dialog 185B may display factor information from which a hint of a skill is obtainable. In either case, the inheritance information (factor information) may be classified into multiple types (factor types), and the skill display dialog 185B may display inheritance information (character factor and race factor) classified as a predetermined type or information (skill-related information) associated with the inheritance information. Accordingly, in the skill display dialog 185B, the inheritance information is partially extracted, and the extracted inheritance information is displayed.

When two raised characters are provisionally selected, the next operation section 154 provided on the inheritance-character selection screen 170 is enabled. When the enabled next operation section 154 is tapped, the provisionally-selected raised characters are provisionally registered as inheritance characters in the deck, and a support-card organization screen 190 to be described later is displayed.

The player must always select two raised characters as inheritance characters on the inheritance-character selection screen 170. If two inheritance characters are not in a provisionally selected state, the next operation section 154 is grayed out and cannot accept an operation from the player, as shown in FIG. 10A and FIG. 10C. The inheritance-character selection screen 170 is also provided with the return operation section 153. When the return operation section 153 is tapped, the main-character selection screen 150 is displayed.

### (Registration of Support Card)

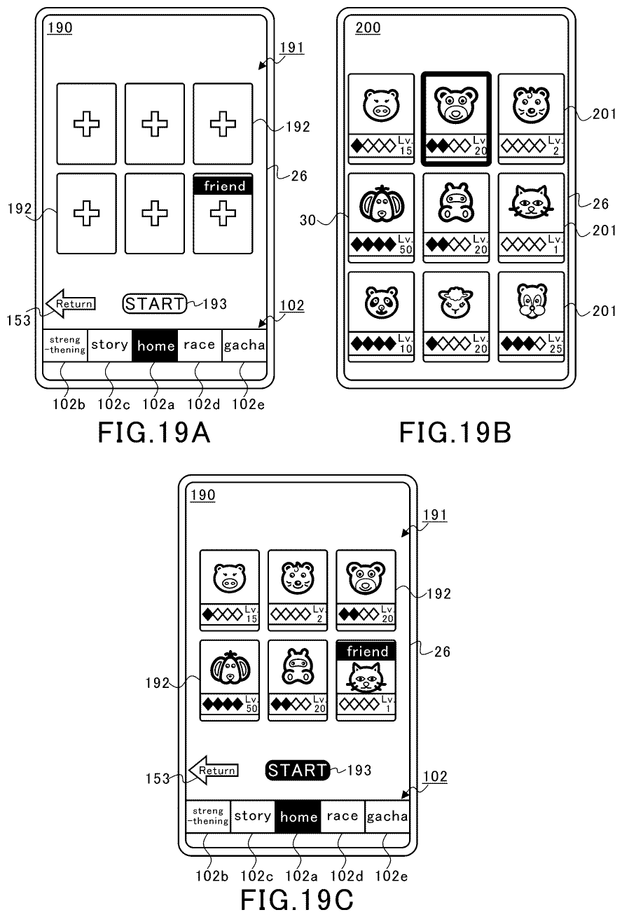

FIG. 19A is a first diagram illustrating the support-card organization screen 190. When two inheritance characters are registered on the inheritance-character selection screen 170, the support-card organization screen 190 shown in FIG. 19A is displayed. The central part of the support-card organization screen 190 is provided with a support-card display region 191. The support-card display region 191 includes a plurality of support-card display frames 192. The lower part of the support-card organization screen 190 displays the return operation section 153 indicated as “Return” and a start operation section 193 indicated as “START”.

The support-card display region 191 displays a plurality of (in this case, six) support-card display frames 192. The number of support-card display frames 192 displayed is equal to the number of support cards settable by the player. When the support-card organization screen 190 is first displayed, the support-card display frames 192 are displayed as blank fields.

In this embodiment, the player can set six types of support cards in a deck. Of the six types settable by the player, one or more (e.g., five types) are selectable from support cards owned by the player. A remaining one or more (e.g., one type) of the six types settable by the player are selectable from support cards set as rental cards by another player, such as a friend.

FIG. 19B illustrates a support-card selection screen 200. When any of the support-card display frames 192 (excluding the support-card display frame 192 displayed at the lower right corner) is tapped on the support-card organization screen 190 in FIG. 19A, the support-card selection screen 200 shown in FIG. 19B is displayed on the display 26. The support-card selection screen 200 displays a list of card icons 201 corresponding to the support cards owned by the player. By tapping on any of the card icons 201 displayed on the support-card selection screen 200, the player can select a support card.

Although not shown, when the support-card display frame 192 displayed at the lower right corner is tapped on the support-card organization screen 190, a support card set as a rental card by a friend or by a player extracted based on a predetermined condition, such as a lottery, is displayed on the support-card selection screen 200. By tapping on this support card displayed on the support-card selection screen 200, the player can select one support card of the friend. Accordingly, in the raising game, the player can use a support card owned by another player.

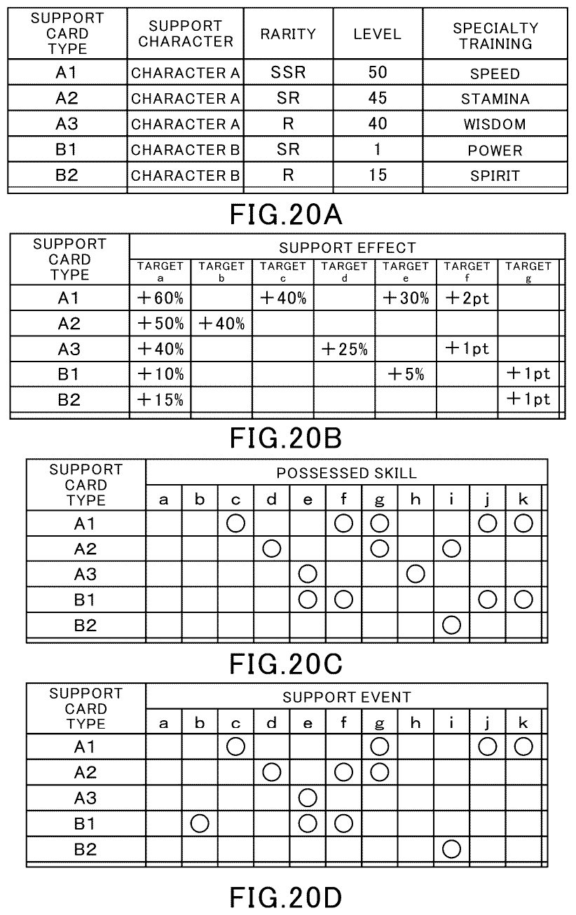

FIG. 20A illustrates a support card table. As shown in FIG. 20A, for every type (i.e., support card ID) of support card owned by the player, the support card table has stored therein the type (i.e., character ID) of support character, rarity level, level, and specialty training. A support character corresponds with the type of support card in a one-to-one fashion. Specifically, a support card ID is always associated with one character ID. In other words, one support card always corresponds with one support character.

In this embodiment, a rarity level is set for every support card. There are three rarity levels provided, which are R (rare), SR (super rare), and SSR (super special rare). R is set to be the lowest rarity level, whereas SSR is set to be the highest rarity level. In this embodiment, a support card with a higher rarity level tends to have a higher support effect, to be described later. Furthermore, in this embodiment, a support card with a higher rarity level tends to have a larger number of possessed skills and a larger number of support events, to be described later.

Each support card is provided with 50 levels from level 1 to level 50. The level of each support card can be increased by the player, and the level increased by the player is stored in each support card. The level of each support card can be increased by using, for example, the in-game currency or an item. The level of each support card is provided with an upper limit depending on the rarity level.

For example, a support card with the rarity level of R has level 20 set as an upper limit, a support card with the rarity level of SR has level 25 set as an upper limit, and a support card with the rarity level of SSR has level 30 set as an upper limit.

The upper limit for each level can be increased in a stepwise fashion when a predetermined condition is satisfied. For example, with regard to a support card with the rarity level of R, the upper limit can be increased to a maximum of level 40. With regard to a support card with the rarity level of SR, the upper limit can be increased to a maximum of level 45. With regard to a support card with the rarity level of SSR, the upper limit can be increased to a maximum of level 50.

FIG. 20B illustrates a support effect table. As shown in FIG. 20B, the support effect table has stored therein a support effect for every type of support card owned by the player.

A support effect increases each type of status in the main raising game. Each support card is provided with a plurality of support-effect targets. Examples of support-effect targets include endurance, speed, stamina, power, spirit, and wisdom.

FIG. 20C illustrates a possessed skill table. As shown in FIG. 20C, in the possessed skill table, possessed skills are set for every support card owned by the player. In this embodiment, possessed skills are set for each support card such that a character set as the main character by the player possesses the possessed skills. The possessed skills set for each support card become acquirable by the main character selected by the player or by another character promoted to a team member, to be described later, when a hint event occurs during the main raising game.

FIG. 20D illustrates a support event table. As shown in FIG. 20D, the support event table has stored therein a support event or events that may occur for every support card owned by the player. A support event may possibly occur while the main raising game is being executed. If a support event occurs, the value of each status in the main raising game may increase or decrease.

For example, a support event that occurs in accordance with the number of turns may be set, or a support event that occurs in accordance with a predetermined lottery may be set. Furthermore, multiple occurring support events may be selected on a single turn. In either case, an occurring support event or events may be set in accordance with a predetermined setting method set in advance.

FIG. 19C is a second diagram illustrating the support-card organization screen 190. In this embodiment, when all the six support cards are selected, the start operation section 193 becomes operable, as shown in FIG. 19C. On the other hand, when all the six support cards are not selected, the start operation section 193 is inoperable, as shown in FIG. 19A.

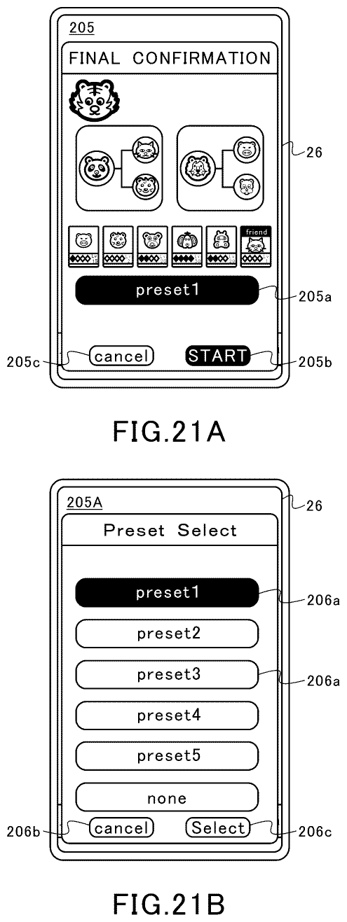

When the return operation section 153 is operated on the support-card organization screen 190, the inheritance-character selection screen 170 shown in FIG. 10D is displayed on the display 26. Furthermore, when the start operation section 193 is tapped on the support-card organization screen 190, as shown in FIG. 19C, the selected support cards are provisionally registered, and a final confirmation screen 205 (FIG. 21A) is displayed.

FIG. 21A illustrates the final confirmation screen 205. FIG. 21B illustrates a preset selection screen 205A. The final confirmation screen 205 displays the main character selected by the player, the raised characters included in the first inheritance group, the raised characters included in the second inheritance group, and the support cards. The final confirmation screen 205 also displays a preset display section 205a. The preset display section 205a indicates the number of a currently-selected preset.

A preset is reservation information of a race in which the main character is to participate in the main raising game. The player can create a preset by selecting an arbitrary race from all the races. Multiple presets can be saved, and one preset can be selected from the saved presets on the final confirmation screen 205. In detail, when the preset display section 205a is tapped, the preset selection screen 205A shown in FIG. 21B is displayed.

The preset selection screen 205A displays preset load buttons 206a corresponding to the saved presets. The player can set a preset by tapping on any of the preset load buttons 206a and then tapping on a select operation section 206c. When the select operation section 206c is tapped, the preset selection screen 205A is closed, and the final confirmation screen 205 is displayed. When a cancel operation section 206b on the preset selection screen 205A is tapped, the preset selection screen 205A is displayed without the preset being changed.

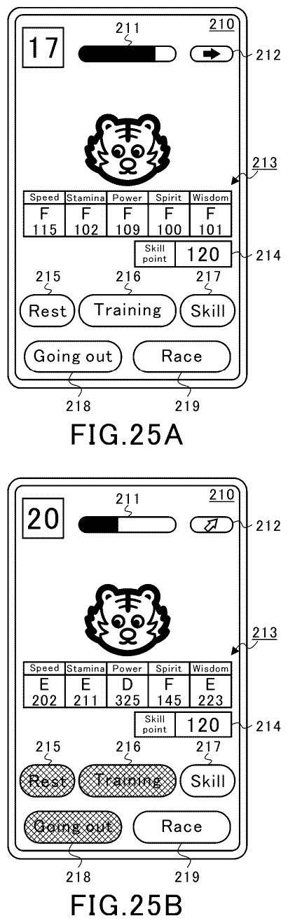

When a cancel operation section 205c is tapped on the final confirmation screen 205, the support-card organization screen 190 is displayed. On the other hand, when a start operation section 205b is tapped, a game screen 210 (FIG. 25A) is displayed on the display 26.

### (Registration of Specific Character)

As mentioned above, when the main character, the inheritance characters, and the support cards are registered, a specific character is subsequently registered. In this embodiment, four types of characters are set in advance as specific characters.

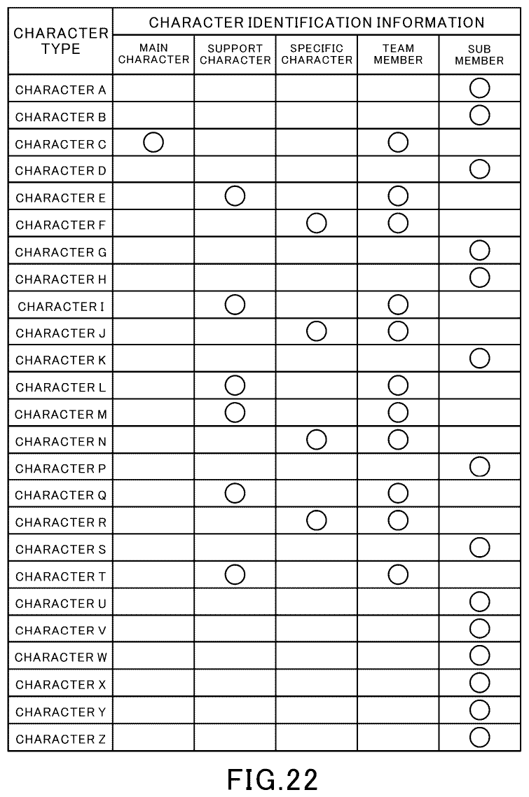

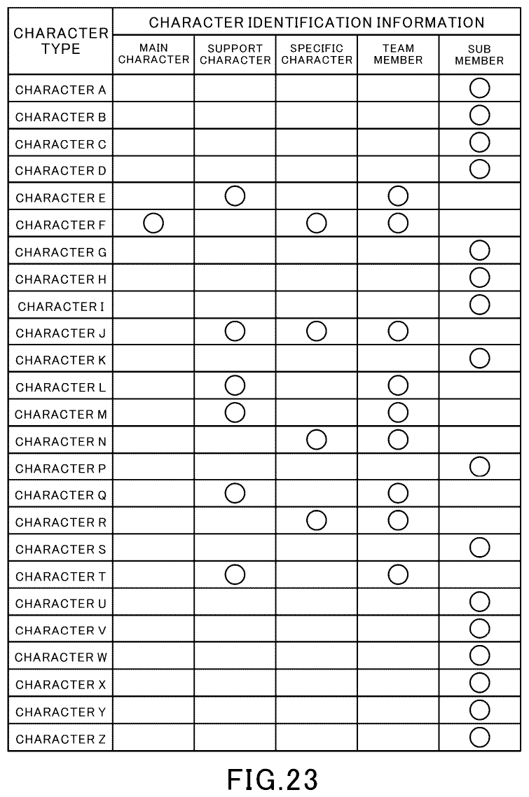

FIG. 22 is a first diagram illustrating a character-identification-information table. FIG. 23 is a second diagram illustrating the character-identification-information table. FIG. 22 illustrates a case where “character C” is registered as the main character, and “character E”, “character I”, “character L”, “character M”, “character Q”, and “character T” are registered as support characters. FIG. 23 illustrates a case where “character F” is registered as the main character, and “character E”, “character J”, “character L”, “character M”, “character Q”, and “character T” are registered as support characters.

In this embodiment, the registration of the support cards is limited such that there is no redundancy between the character type set as the main character and the character type set as the support characters.

In this embodiment, as shown in FIG. 22, “character F”, “character J”, “character N”, and “character R” are set as specific characters. When the player selects a main character from multiple characters, the selected character is registered as the main character in the character-identification-information table.

When a support card is selected in response to an operation performed by the player, the character-identification-information table is updated, and the character corresponding to the selected support card is registered as a support character.

When information related to the main character and the support card is registered in the character-identification-information table, specific-character-related information is registered. In this case, as shown in FIG. 22 and FIG. 23, “character F”, “character J”, “character N”, and “character R” are registered as specific characters regardless of the types of the registered main character and support characters.

### (Setting of Initial Character Identification Information)

As mentioned above, when the main character, the inheritance characters, the support characters, and the specific characters are registered, team members and sub members are registered. As will be described in detail later, the raising game requires playing a competition game by using characters registered as team members. When a character registered as a sub member satisfies a certain condition, the character is registered as a team member.

In this embodiment, characters registered as the main character, the support characters, and the specific characters are registered as team members in the character-identification-information table. Specifically, in the case of FIG. 22, “character C”, “character E”, “character F”, “character I”, “character J”, “character L”, “character M”, “character N”, “character Q”, “character R”, and “character T” are registered as team members. In the case of FIG. 23, “character E”, “character F”, “character J”, “character L”, “character M”, “character N”, “character Q”, “character R”, and “character T” are registered as team members.

Furthermore, in the character-identification-information table, characters not registered as team members among the characters or support cards (support characters) owned by the player are registered as sub members. Among predetermined characters, all of the remaining characters not registered as team members or one or more of the characters selected by lottery may be registered as sub members.

Although support characters and specific characters are originally registered as team members from the start of the main raising game, the support characters and the specific characters may be registered as sub members at the start of the main raising game, and may subsequently be registered as team members at a predetermined timing.

When the information (initial character identification information) related to the team members and the sub members is stored in the character-identification-information table in this manner, the preparation stage process ends.

### (Raising Stage Process)

When the preparation stage process ends, the raising stage process starts. In the raising stage process, the main character and the characters registered as team members can be raised. In order to facilitate understanding, the basic flow of the main raising game will be described first.

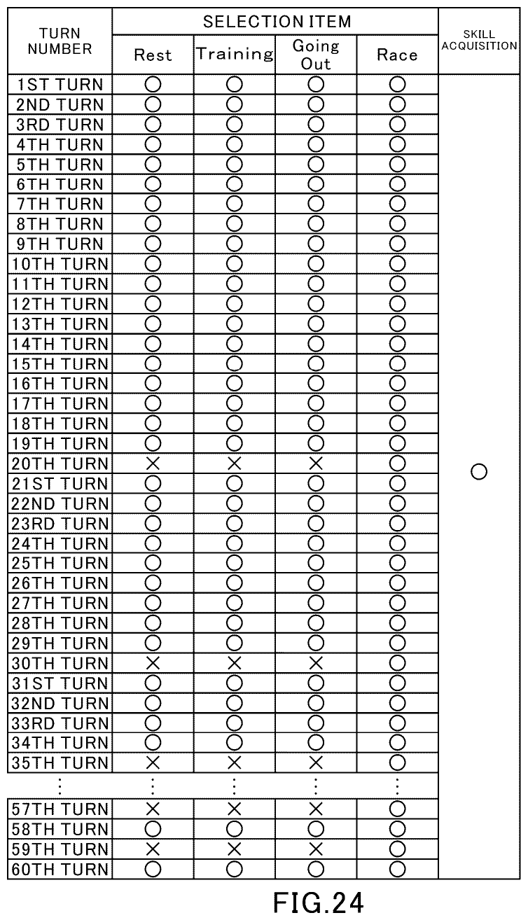

FIG. 24 illustrates a selection item table. A selection item table is provided for each type of main character. Alternatively, the same selection item table may be provided regardless of the type of main character. As shown in FIG. 24, the raising game includes the first turn to the 60th turn and has gameplay where the various parameters are updated in accordance with a selection result of the player on each turn. According to the selection item table, items selectable by the player are preliminarily set for every turn.

FIG. 25A is a first diagram illustrating the game screen 210. FIG. 25B is a second diagram illustrating the game screen 210. When the process transitions to the raising stage process, the game screen 210 shown in FIG. 25A and FIG. 25B is displayed on the display 26. The upper part of the game screen 210 displays an endurance display section 211 and a condition display section 212. The main character is provided with an “endurance” parameter. The “endurance” parameter is mainly used for calculating a failure rate as a probability of failing in training, to be described later. The endurance display section 211 displays the currently remaining “endurance” of the main character relative to an upper limit value for the “endurance” in a visually ascertainable manner.

The main character is also provided with a “condition” parameter. The condition display section 212 displays the current “condition” of the main character in multiple levels (i.e., five levels, which are very poor, poor, normal, good, and very good) in a visually ascertainable manner. As the “condition” parameter increases, the main character becomes more advantageous in the race, and the increase value of each attribute parameter as a result of training increases.

As shown in FIG. 25A and FIG. 25B, the central part of the game screen 210 displays an image of the main character, a status display section 213, and a skill-point display section 214. The status display section 213 indicates the current status of the main character by using numerical values and ranks in multiple levels (i.e., 16 levels, which are G⁺, F, F⁺, E, E⁺, D, D⁺, C, C⁺, B, B⁺, A, A⁺, S, SS, and SS⁺). In detail, in this embodiment, the numerical values and the ranks with respect to the attribute parameters “Speed”, “Stamina”, “Power”, “Spirit”, and “Wisdom” are displayed. The skill-point display section 214 indicates, by using a numerical value, the remaining skill points possessed by the main character in the raising game.

Furthermore, as shown in FIG. 25A and FIG. 25B, the lower part of the game screen 210 displays a rest operation section 215 indicated as “Rest”, a training operation section 216 indicated as “Training”, a skill operation section 217 indicated as “Skill”, a going-out operation section 218 indicated as “Going Out”, and an individual-race operation section 219 indicated as “Race”. The upper part of the game screen 210 displays the number of the current turn.

On each turn, the player can select any of the items from “Rest” (rest operation section 215), “Training” (training operation section 216), “Going Out” (going-out operation section 218), and “Race” (individual-race operation section 219). In this case, as shown in FIG. 24, the items selectable on each turn are set in advance.

When the “Rest” item is selected, the endurance is recovered. When the “Going Out” item is selected, the condition improves. When the “Training” item is selected, training, to be described later, becomes executable. When the “Race” item is selected, the main character can participate in an individual race. When a game result is derived by selecting any of the “Rest”, “Training”, “Going Out”, and “Race” items, the current turn ends and transitions to the next turn.

In this embodiment, there are set turns where the items of the rest operation section 215, the training operation section 216, and the going-out operation section 218 are non-selectable, as in the 20th turn, the 30th turn, the 35th turn, the 57th turn, and the 59th turn shown in FIG. 24. On these turns, the rest operation section 215, the training operation section 216, and the going-out operation section 218 are displayed in a grayed-out fashion and cannot accept an operation from the player, as shown in FIG. 25B. Therefore, on these turns, the player must select the individual-race operation section 219.

On the other hand, the skill operation section 217 is set to be always selectable on all the turns. As will be described in detail later, the turns do not end even if a skill is acquired. In this embodiment, a team race is forcibly executed upon completion of a predetermined turn.

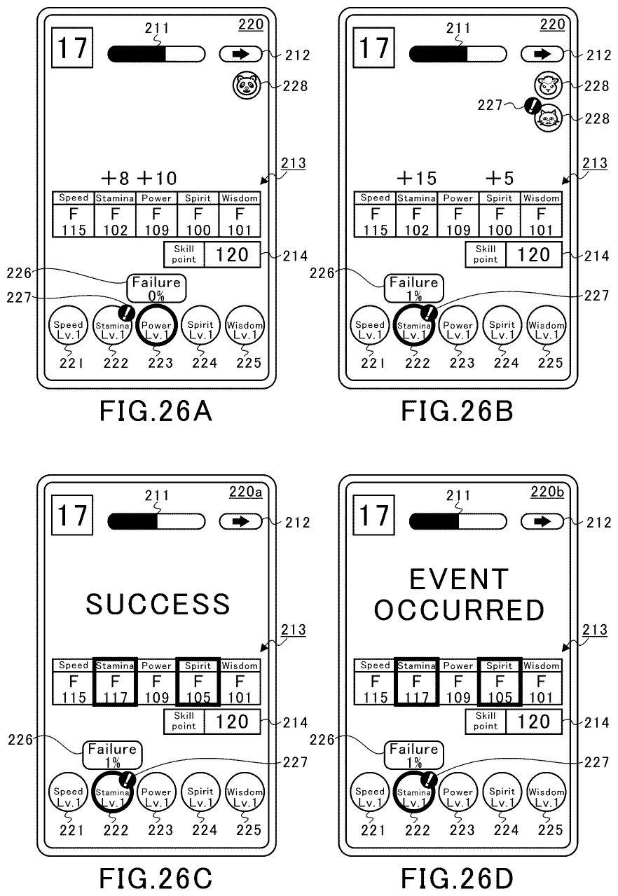

FIG. 26A is a first diagram illustrating a training screen 220. FIG. 26B is a second diagram illustrating the training screen 220. When the training operation section 216 on the game screen 210 is operated, the training screen 220 is displayed on the display 26.

As shown in FIG. 26A, the lower part of the training screen 220 displays training items. In this case, a speed operation section 221 indicated as “Speed”, a stamina operation section 222 indicated as “Stamina”, a power operation section 223 indicated as “Power”, a spirit operation section 224 indicated as “Spirit”, and a wisdom operation section 225 indicated as “Wisdom” are displayed.

When the player single-taps on any one of the operation sections 221 to 225, the training item corresponding to the tapped one of the operation sections 221 to 225 is provisionally selected, and the one of the operation sections 221 to 225 corresponding to the provisionally-selected training item is highlighted. FIG. 26A illustrates a state where the power operation section 223 is provisionally selected. FIG. 26B illustrates a state where the stamina operation section 222 is provisionally selected.

Each of the operation sections 221 to 225 has a training level displayed together therewith for the corresponding training item. A training level is a parameter that increases based on a team ranking. As the training level becomes higher, the increase value of the attribute parameter increases when the training is executed. The training level is originally set to level 1 and increases to a maximum of level 5.

A failure-rate display section 226 indicated as “Failure” is displayed on the provisionally-selected one of the operation sections 221 to 225. A failure rate displayed as a numerical value in the failure-rate display section 226 is set to increase in inverse proportion to the remaining endurance displayed in the endurance display section 211.

The status display section 213 displays a value of an attribute parameter that has increased when training corresponding to the provisionally-selected one of the operation sections 221 to 225 has been successfully executed. For example, in the example shown in FIG. 26A, the power operation section 223 is provisionally selected, and “+8” is displayed under “Stamina” and “+10” is displayed under “Power” in the status display section 213. In the example shown in FIG. 26B, the stamina operation section 222 is provisionally selected, and “+15” is displayed under “Stamina” and “+5” is displayed under “Spirit” in the status display section 213.

When training is successfully executed, an event notification indication 227 is displayed at any of the operation sections 221 to 225 corresponding to a training item where a predetermined event occurs. The event notification indication 227 can be displayed in different display modes in accordance with the types of events.

As shown in FIG. 26B, the upper right part of the training screen 220 displays an allocated character icon 228 of a character allocated to training for every item of the provisionally-selected one of the operation sections 221 to 225. When the training is successful, if a predetermined event occurs in correspondence with the character displayed in the allocated character icon 228, the event notification indication 227 is displayed at the corresponding allocated character icon 228. Training to which a character is allocated will be referred to as “joint training” hereinafter.

FIG. 26C illustrates a training-result notification screen 220a. When any provisionally selected one of the operation sections 221 to 225 is tapped again, training corresponding to the tapped one of the operation sections 221 to 225 is executed. When the training is executed, the training-result notification screen 220a providing a notification about whether the training has been successful or has failed is displayed on the display 26. In this case, text indicating “SUCCESS” is displayed, so that the player is notified that the training has been successful.

In this case, the attribute parameters displayed in the status display section 213 are updated based on the successful training. Specifically, each attribute parameter (attribute information) of the main character corresponding to the training item (raising item) selected by the player is updated.

In this case, the attribute parameter value that increases when the training displayed in the status display section 213 in FIG. 26A or FIG. 26B has been successful is added. Moreover, the display in the endurance display section 211 is updated in accordance with the executed training item. When training for any one of speed, stamina, power, and spirit is successfully executed, the endurance decreases. On the other hand, when training for wisdom is successfully executed, the endurance is recovered.

If the training fails, a predetermined penalty is given. The details of a penalty include a decrease in endurance, a numerical decrease in the attribute parameter value, and a decrease in condition. For example, a penalty given when the failure rate is high may be more disadvantageous (e.g., a larger decrease in the numerical value of the endurance, a larger decrease in the numerical value of the attribute parameter, or a larger decrease in the condition level) than a penalty given when the failure rate is low.

The details of a penalty may be determined in accordance with the training item. For example, if training for speed fails, the speed attribute-parameter value may decrease. If training for power fails, the power attribute-parameter value may decrease. For some of the training items (e.g., wisdom), it is possible not to give a penalty even if the training fails.

FIG. 26D illustrates an event screen 220b. When the display of the training-result notification screen 220a ends, the event screen 220b may sometimes be displayed on the display 26. Various events are executed on the event screen 220b. During each turn, multiple events may sometimes occur.

For example, when a hint event occurs, a hint for a skill can be obtained. When a hint for a skill is obtained, the player can acquire the skill by consuming skill points. There are various types of skills provided, and a predetermined attribute may be activated for each skill. Each skill has a set activation condition and a set effect. When the activation condition is satisfied, the predetermined effect is activated. A skill may sometimes be activated during an individual race or team race to be described later.

Examples of the events include a skill acquiring event, an endurance recovery event, an endurance decreasing event, an attribute-parameter increasing event, an attribute-parameter decreasing event, a condition increasing event, and a condition decreasing event. As will be described in detail later, the events include a predetermined event for every turn and an event occurring when selection is made in a predetermined lottery. When all of the occurring events are completed, the game screen 210 related to the next turn is displayed.

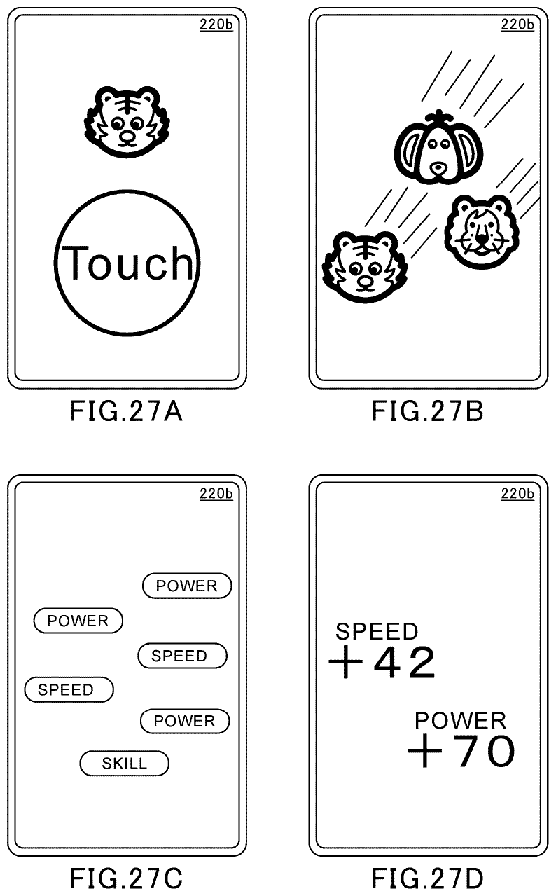

FIG. 27A is a first diagram illustrating an inheritance event. FIG. 27B is a second diagram illustrating the inheritance event. FIG. 27C is a third diagram illustrating the inheritance event. FIG. 27D is a fourth diagram illustrating the inheritance event. On each factor activation turn mentioned above, an inheritance event occurs as the turn commences. This inheritance event is a scenario-common event, to be described later, and always occurs on the same turn regardless of a scenario selected by the player. Although the first turn, the 30th turn, and the 54th turn are set as the factor activation turns in this embodiment, the following description relates to a case where the inheritance event occurs on the 30th turn.

When the 30th turn commences, the main character and an operation section indicated as “Touch” are first displayed on the event screen 220b, as shown in FIG. 27A. When the operation section displayed on the event screen 220b is tapped, an animation image including the main character and two inheritance characters are displayed, as shown in FIG. 27B. Furthermore, when the operation section is tapped, a lottery for determining whether or not all the factors that the total of six raised characters of the first inheritance generation and the second inheritance generation have are to be activated is performed.

Then, as shown in FIG. 27C, the factors that have been selected by the lottery for activation and that are set to be activated are displayed. Subsequently, as shown in FIG. 27D, the types of attribute parameters and aptitude parameters that increase as a result of the activation of the factors and the increase values thereof are displayed, and the parameters are updated. When the inheritance event ends, the game screen 210 shown in FIG. 25A is displayed, so that the player can select any one of the items. In this case, in the status display section 213, the increase values of the attribute parameters and aptitude parameters displayed during the inheritance event have been added.

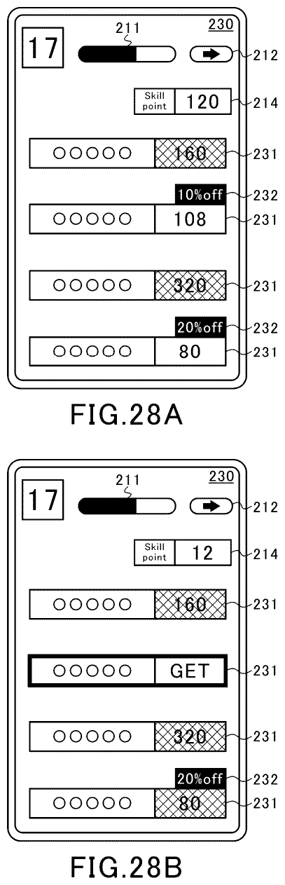

FIG. 28A is a first diagram illustrating a skill screen 230. FIG. 28B is a second diagram illustrating the skill screen 230. When the skill operation section 217 on the game screen 210 is operated, the skill screen 230 shown in FIG. 28A is displayed on the display 26.

The skill screen 230 displays a skill display field 231. The skill display field 231 displays an acquired skill, a possessed skill preliminarily set for the main character, and a possessed skill possessed in accordance with each of various events. If a hint event occurs with respect to a possessed skill, skill points to be consumed for acquiring this possessed skill are discounted. In this case, skill points required for acquiring a predetermined skill corresponding to an acquired hint are displayed in a discounted state. A discount-rate display icon 232 indicating the discount rate is displayed together with the skill display field 231.

For each skill displayed on the skill screen 230, the activation condition for the skill and the effect when the skill is activated are displayed.

The upper part of the skill screen 230 displays the endurance display section 211, the condition display section 212, and the skill-point display section 214. The upper part of the skill screen 230 also displays the number of the current turn.

When a possessed skill is acquired by consuming skill points based on an operation performed by the player, “GET” is displayed for the acquired skill so that a notification indicating that the possessed skill has been acquired is provided, as shown in FIG. 28B. In addition, the display is updated such that the consumed skill points are subtracted from the skill points displayed in the skill-point display section 214.

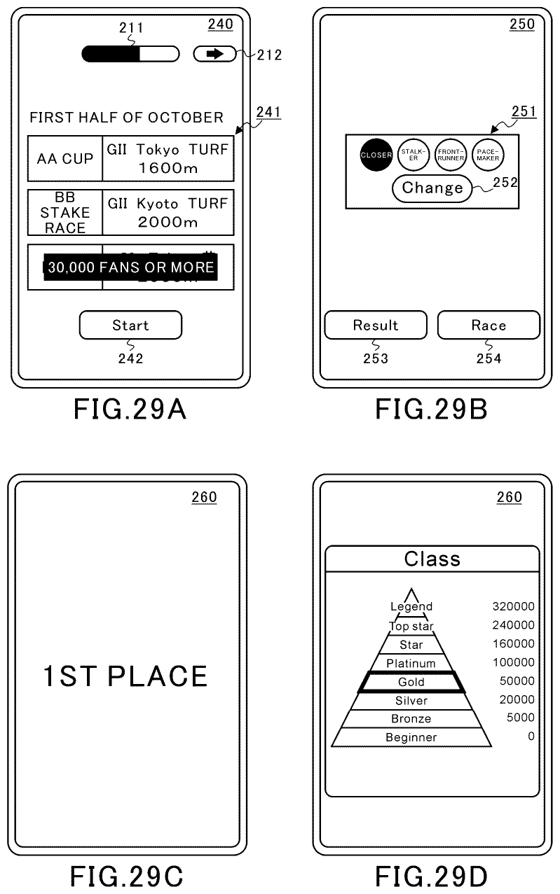

FIG. 29A is a first diagram illustrating an individual-race selection screen 240. When the individual-race operation section 219 on the game screen 210 is operated, the individual-race selection screen 240 shown in FIG. 29A is displayed. An individual race has gameplay where the main character races with a so-called non-player character (referred to as “NPC” hereinafter).

The upper part of the individual-race selection screen 240 displays the endurance display section 211 and the condition display section 212. The central part of the individual-race selection screen 240 displays an individual-race selection operation section 241 used for selecting a race category that the main character is to participate in. The lower part of the individual-race selection screen 240 displays a start operation section 242 indicated as “Start”. A race that can be selected by using the individual-race selection operation section 241 on the individual-race selection screen 240 is preliminarily set for each turn.

Each race has a preliminarily-set participation condition, and the player can have the main character participate in the race so long as the participation condition is satisfied. As mentioned above, some races require a certain number of fans as a participation condition. With regard to a race not satisfying the required number of fans, the participation condition is displayed in the individual-race selection operation section 241, as shown in FIG. 29A, and a notification indicating that the race is not selectable is provided. On a turn where a target race to be cleared is set, only the target race is displayed in a selectable manner on the individual-race selection screen 240.

FIG. 29B illustrates an individual-race start screen 250. When the start operation section 242 is operated in a state where the race category of an individual race to participate in is selected in the individual-race selection operation section 241, the individual-race start screen 250 shown in FIG. 29B is displayed. The central part of the individual-race start screen 250 displays a strategy display section 251. The strategy display section 251 displays a currently-selected strategy (closer, stalker, front-runner, or pace-maker) in a highlighted fashion, and also displays a change operation section 252 indicated as “Change”. When the change operation section 252 is operated, a strategy change screen (not shown) is displayed on the display 26. By performing an operation on the strategy change screen, the player can change the strategy in the individual race to an arbitrary strategy.

The lower part of the individual-race start screen 250 displays a result operation section 253 indicated as “Result” and a race operation section 254 indicated as “Race”.

When the race operation section 254 is operated, a race screen (not shown) is displayed on the display 26. The display 26 displays a video (referred to as “race video” hereinafter) showing the progress of the race.

FIG. 29C is a first diagram illustrating an individual-race-result screen 260. FIG. 29D is a second diagram illustrating the individual-race-result screen 260. When the playback of the aforementioned race video ends and the result operation section 253 is operated, the individual-race-result screen 260 is displayed on the display 26. As shown in FIG. 29C, the individual-race-result screen 260 displays the finished place of the main character in the individual race. Furthermore, as shown in FIG. 29D, the individual-race-result screen 260 displays the current class of the main character.

In this embodiment, class placement of the main character is performed in accordance with the number of acquired fans. Each class has a set range for the number of fans, and the main character is classified into any of eight levels of classes in accordance with the number of fans. The individual-race-result screen 260 displays the cumulative number of fans obtained by adding the number of fans acquired in the current individual race and the number of newly-acquired fans to the number of previously-acquired fans. Moreover, the current class corresponding to the cumulative number of fans is displayed in a distinguishable manner.

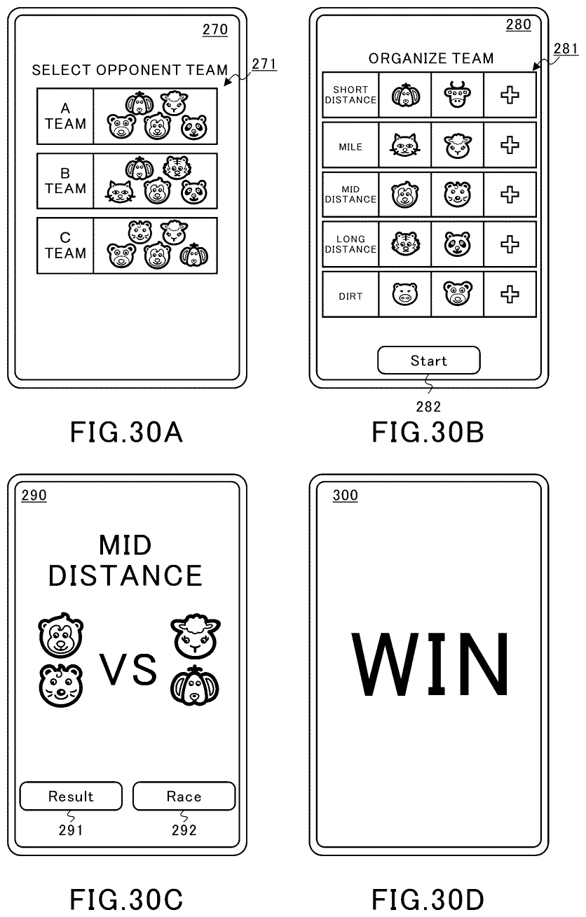

FIG. 30A illustrates a team-race selection screen 270. As mentioned above, in this embodiment, a team race is forcibly started upon completion of a predetermined turn. When the team race starts, the team-race selection screen 270 shown in FIG. 30A is displayed. The central part of the team-race selection screen 270 displays an opponent-team selection operation section 271 for selecting an opponent of the team race to participate in. The opponent may be an NPC. The opponent is not limited to an NPC and may be another player's team. In this case, a communicative competition with the team of another player is performed.

The characters to participate in the team race may be selectable from the team members and do not necessarily have to include the main character. Moreover, one team member may participate in multiple races of the team race.

FIG. 30B illustrates a team organization screen 280. When the opponent-team selection operation section 271 is operated, the team organization screen 280 is displayed on the display 26. The team organization screen 280 displays a team-organization operation section 281. By operating the team-organization operation section 281, the player can organize the characters in the team race by using the characters registered as the team members. In this embodiment, five races, namely, “short distance”, “mile”, “mid distance”, “long distance”, and “dirt-racetrack” races, are executed in the team race. Then, gameplay where the overall win-loss record in the team race is determined based on the result of each race is provided.

In detail, of the five races, if the number of races won by the player's team is larger than the number of races won by the opponent's team, the player has won the overall team race. In contrast, of the five races, if the number of races won by the player's team is smaller than the number of races won by the opponent's team, the player has lost the overall team race. The number of races won by the player's team and the number of races won by the opponent's team being equal to each other results in a draw.

For each race, the player can organize a maximum of three types of characters from the team members. Characters of the same type cannot be organized in multiple races. The lower part of the team organization screen 280 displays a start operation section 282 indicated as “Start”.

FIG. 30C illustrates a team-race start screen 290. When the start operation section 282 on the team organization screen 280 is operated, the team-race start screen 290 shown in FIG. 30C is displayed. Although the five races are executed in the team race in this embodiment, the order in which the races are executed may be predetermined or may be determined randomly.

As shown in FIG. 30C, the central part of the team-race start screen 290 displays the characters in the team organized by the player with respect to a race to be executed and the characters in the opponent's team. In this case, two characters are organized by the player with respect to a “mid distance” race, and two characters of the opponent are organized.

Furthermore, as shown in FIG. 30C, the lower part of the team-race start screen 290 displays a result operation section 291 indicated as “Result” and a race operation section 292 indicated as “Race”. When the race operation section 292 is operated, a race video (not shown) is displayed.

FIG. 30D illustrates a team-race interim-result screen 300. When the playback of the aforementioned race video ends and the result operation section 291 on the team-race start screen 290 is operated, the team-race interim-result screen 300 is displayed on the display 26. The team-race interim-result screen 300 displays the result of the race (i.e., “mid distance” race). The method for determining the result of each of the five races of the team race is not particularly limited. For example, the team to which the character that has finished first belongs may be given the victory. Alternatively, a point may be given to each finished place, and the team with the highest acquired points may be given the victory.

When the display of the team-race interim-result screen 300 in FIG. 30D ends, the team-race start screen 290 related to the next race (e.g., “short-distance” race) is displayed. Subsequently, the team-race start screen 290 and the team-race interim-result screen 300 are sequentially displayed in a manner similar to the above until all the races of the five categories are completed.

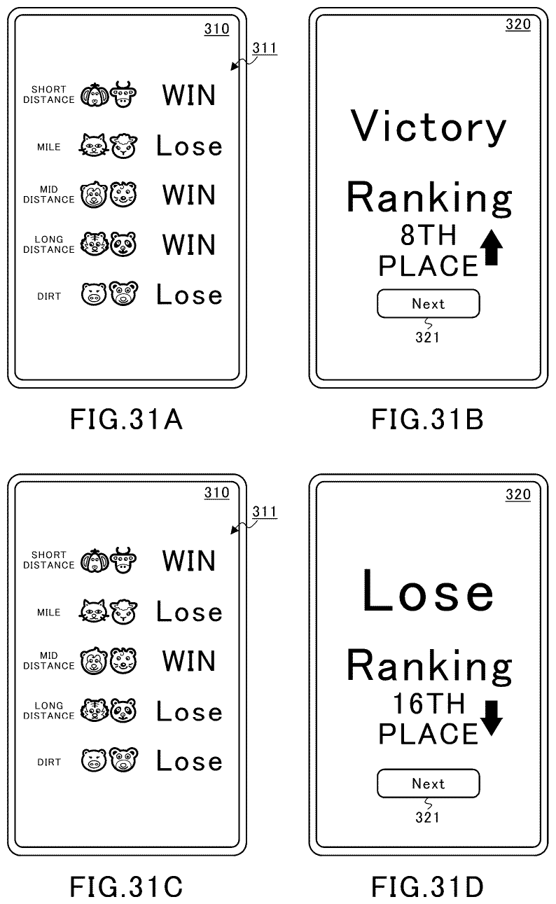

FIG. 31A is a first diagram illustrating a team-race detailed-result screen 310. As mentioned above, when the team-race start screen 290 and the team-race interim-result screen 300 related to all the races of the five categories are displayed, the team-race detailed-result screen 310 is displayed on the display 26. The central part of the team-race detailed-result screen 310 displays a win-loss-result display section 311. The win-loss-result display section 311 notifies the player of the result of each race. FIG. 31A shows a case where there are three wins and two losses in the races.

FIG. 31B is a first diagram illustrating a team-race overall-result screen 320. When the display of the win-loss-result display section 311 ends, the team-race overall-result screen 320 is displayed on the display 26. The team-race overall-result screen 320 notifies the player of the overall result of the team race. As shown in FIG. 31A, when there are three wins and two losses in the races, the team-race overall-result screen 320 provides a notification indicating that the team race has been won.

The team-race overall-result screen 320 also displays a team ranking. In this embodiment, the team ranking changes based on the result of the team race. For example, the team ranking moves up when the team race is won.

On the team-race overall-result screen 320 that provides a notification indicating that the team race is won, a next operation section 321 indicated as “NEXT” is displayed. When the next operation section 321 on the team-race overall-result screen 320 is operated, the game screen 210 related to the next turn is displayed.

FIG. 31C is a second diagram illustrating the team-race detailed-result screen 310. FIG. 31C shows a case where there are two wins and three losses in the races. FIG. 31D is a second diagram illustrating the team-race overall-result screen 320. As shown in FIG. 31C, when there are two wins and three losses in the races, the team-race overall-result screen 320 provides a notification indicating that the team race has been lost.

When the team race has been lost, the team ranking moves down. However, since the main raising game continues regardless of the result of the team race, the next turn commences in response to tapping on the next operation section 321.

Accordingly, in the main raising game, a team race is executed on every predetermined turn. When the team race is won, an award, such as an increase in an attribute parameter of the main character, is given. Moreover, in the main raising game, a sub member is promoted to a team member on a predetermined turn. In this case, a predetermined number of sub members are promoted to team members on the next turn where the team race is executed. Accordingly, the gameplay of the raising game involves winning team competitions while gradually increasing the number of team members.

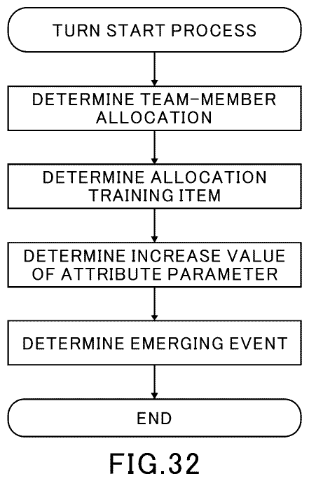

FIG. 32 illustrates the general flow of a turn start process. The raising stage process includes the turn start process to be executed at the start of each turn in the raising game. Although the turn start process will be described in detail later, the general flow of the turn start process will be described here.

The turn start process includes a “process for determining team-member allocation”, a “process for determining an allocation training item”, a “process for determining an increase value of an attribute parameter”, and a “process for determining an emerging event”, which are shown in FIG. 32. Although other various processes are also executed in the turn start process, the processes shown in FIG. 32 will be described here in sequence.

### (Process for Determining Team-Member Allocation)

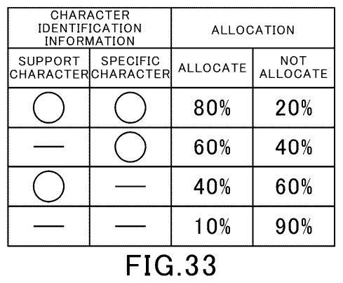

FIG. 33 illustrates an allocation table. As shown in FIG. 33, the allocation table has a selection ratio of allocation (“allocate” or “not allocate”) set for each piece of character identification information about a character. In this embodiment, it is determined whether or not all of the team members are to be allocated based on the allocation table shown in FIG. 33 by referring to the aforementioned character-identification-information table shown in FIG. 22 or FIG. 23.

In detail, as shown in FIG. 33, in this embodiment, for a team member registered as a “support character” and a “specific character” as character identification information, an “allocate” option is selected at a probability of 80%. For a team member registered as a “specific character” as character identification information but not registered as a “support character”, the “allocate” option is selected at a probability of 60%.

For a team member registered as a “support character” as character identification information but not registered as a “specific character”, the “allocate” option is selected at a probability of 40%. For a team member not registered as a “support character” nor a “specific character” as character identification information, the “allocate” option is selected at a probability of 10%.

Accordingly, a team member registered as a support character has a higher possibility of being allocated to training than a team member not registered as a support character. Moreover, a team member registered as a specific character has a higher possibility of being allocated to training than a team member not registered as a specific character.

### (Process for Determining Allocation Training Item)

Subsequently, for a team member set to be allocated in the above-described manner, it is determined whether the team member is to be allocated to any of the training items for “Speed”, “Stamina”, “Power”, “Spirit”, and “Wisdom”.

Although the method for determining the allocation training item is not particularly limited, for example, a lottery may be performed such that the training items are selected at a uniform probability. Alternatively, instead of performing the lottery, each character may be allocated to a preset training item. As another alternative, for example, the lottery may be performed such that each character tends to be allocated to specialty training (see FIG. 20A). If the lottery is to be performed, a lottery table having a preset selection ratio for the lottery may be stored in advance, or a lottery table may be created every time the lottery is performed.

### (Process for Determining Increase Value of Attribute Parameter)

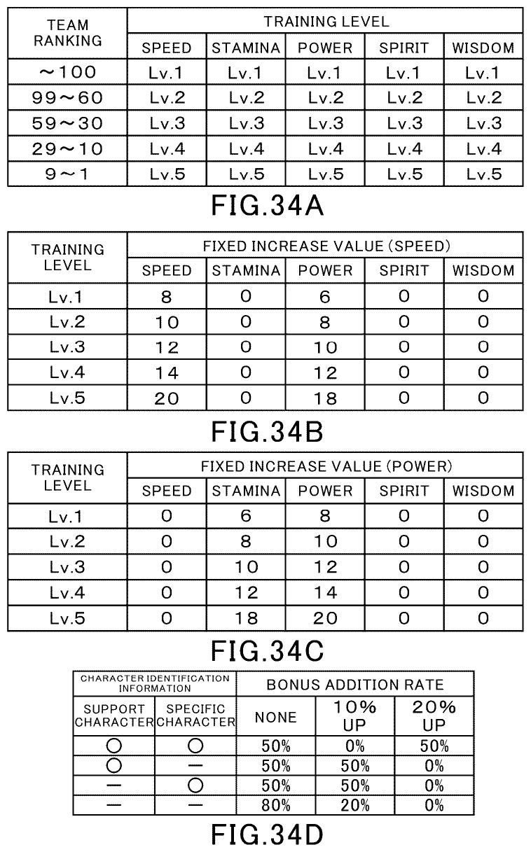

FIG. 34A illustrates a training level table. As shown in FIG. 34A, a training level is set to increase as the team ranking moves up. In detail, when the team is ranked 100th or lower, the training levels related to “Speed”, “Stamina”, “Power”, “Spirit”, and “Wisdom” are set to “level 1”. When the team is ranked 99th or higher and 60th or lower, the training levels are set to “level 2”. When the team is ranked 59th or higher and 30th or lower, the training levels are set to “level 3”. When the team is ranked 29th or higher and 10th or lower, the training levels are set to “level 4”. When the team is ranked ninth or higher, the training levels are set to “level 5”.

Although this embodiment relates to a case where the training levels are set to increase as the team ranking moves up, the embodiment is not limited to this. For example, the specialty training of a team member may be counted for each training item, and the training level may increase in accordance with the count value. Although the training levels of all the training items are the same with respect to the team ranking, the training levels may vary among the training items with respect to the same team ranking.

In this embodiment, when training selected by the player is successfully executed, predetermined attribute parameter values increase in accordance with the executed training item.

In detail, in this embodiment, when training for “Speed” is successfully executed, the attribute parameter values of “Speed” and “Power” increase.

When training for “Stamina” is successfully executed, the attribute parameter values of “Stamina” and “Spirit” increase.

When training for “Power” is successfully executed, the attribute parameter values of “Stamina” and “Power” increase.

When training for “Spirit” is successfully executed, the attribute parameter values of “Speed”, “Power”, and “Spirit” increase.

When training for “Wisdom” is successfully executed, the attribute parameter values of “Speed” and “Wisdom” increase.

In this embodiment, each attribute parameter value that increases when the corresponding training is successful is calculated by adding to the fixed increase value a value that is obtained by multiplying a fixed increase value determined in correspondence with the executed training item and the training level by a bonus addition rate, to be described later.

FIG. 34B illustrates a fixed-increase-value (speed) table. FIG. 34C illustrates a fixed-increase-value (power) table. Specifically, FIG. 34B indicates fixed increase values when the training item is “Speed”. FIG. 34C indicates fixed increase values when the training item is “Power”.

As shown in FIG. 34B and FIG. 34C, the fixed-increase-value tables have stored therein fixed increase values determined in correspondence with the executed training items and the training levels. In this embodiment, as shown in FIG. 34B and FIG. 34C, each attribute parameter is set to increase significantly as the training level becomes higher.

Although descriptions will be omitted here, fixed-increase-value tables for when “Stamina”, “Spirit”, and “Wisdom” are selected as training items are also provided.

In addition to the fixed increase value mentioned above, a bonus addition rate is determined based on the character allocated to each training item and the aforementioned character-identification-information table shown in FIG. 22 or FIG. 23.

FIG. 34D illustrates a bonus-addition-rate table. In this embodiment, a bonus addition rate is determined based on the character identification information of each character set to be allocated to training.

In detail, as shown in FIG. 34D, for each piece of character identification information of a character, the bonus-addition-rate table has set therein an indication of whether or not the bonus addition rate is to be applied and an addition-rate (10% increase or 20% increase) selection ratio.

If “support character” and “specific character” are registered as the character identification information, a “none” option is selected at a probability of 50%, and a “20% increase” option is selected at a probability of 50%. If “support character” alone is registered as the character identification information, the “none” option is selected at a probability of 50%, and a “10% increase” option is selected at a probability of 50%.

If “specific character” alone is registered as the character identification information, the “none” option is selected at a probability of 50%, and the “10% increase” option is selected at a probability of 50%.

If neither of “support character” and “specific character” is registered as the character identification information, the “none” option is selected at a probability of 80%, and the “10% increase” option is selected at a probability of 20%.

Then, a value obtained by multiplying the fixed increase value determined in accordance with the fixed-increase-value table by the bonus addition rate is derived as a bonus addition value. A value obtained by adding the bonus addition value to the fixed increase value is determined as the amount of increase in the attribute parameter value when the training is successful. With regard to training to which multiple characters are allocated, the bonus addition value of each of the multiple allocated characters is added to the fixed increase value. Accordingly, the amount of increase in each attribute parameter of the main character when the training is successful is determined for all types of training.

### (Process for Determining Emerging Event)

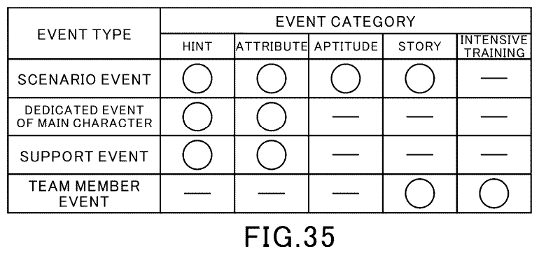

FIG. 35 illustrates event types and event categories. During the main raising game, a process for determining whether or not to cause an event to emerge is performed on each turn. Each event is generally classified as one of four types, which are a scenario event, the aforementioned dedicated event provided for each main character, a support event, and a team member event. For each scenario, a scenario event, a dedicated event, a support event, and a team member event that may emerge during the main raising game are set in advance.

A scenario event refers to an event set for every scenario of the main raising game. In this embodiment, multiple scenarios are provided, and the player can select any of the scenarios. A scenario event emerges in every scenario selected by the player. In other words, a scenario event emerging in the main raising game is determined based on the scenario selected by the player.

A scenario-specific event and a scenario-common event may be provided as scenario events. A scenario-specific event refers to an event associated with only one scenario. For example, a scenario-specific event associated with a first scenario emerges only when the first scenario is selected and does not emerge when other scenarios are selected.

A scenario-common event refers to an event that emerges commonly among multiple scenarios. Therefore, a scenario-common event emerges both when a first scenario is selected and when a second scenario is selected.

It is assumed here that the scenario-specific event and the scenario-common event are provided as the scenario events. Alternatively, only one of the scenario-specific event and the scenario-common event may be provided.

As mentioned above, a dedicated event refers to an event preliminarily set for every character. In the main raising game, a dedicated event for a character registered by the player as the main character in the setting game, that is, the preparation stage process, emerges.

As mentioned above, a support event refers to an event preliminarily set for every support card. In the main raising game, a support event associated with a support card registered by the player in the setting game emerges. In addition to a support event associated with a registered support card, for example, a support event associated with a team member may also emerge. However, the probability at which a support event associated with a support card registered by the player in the setting game is determined is set to be higher than the probability at which another support event is determined.

A team member event mainly refers to an event that emerges when training, that is, joint training, to which a team member is allocated is executed. Furthermore, a team member event may emerge when a predetermined condition is satisfied regardless of training.

Accordingly, with regard to the scenario event, the emergence thereof is determined based on the scenario. With regard to each of the dedicated event, the support event, and the team member event, the emergence thereof is determined based on the main character, the support card, or the team member. In other words, each event type is classified in accordance with information to be referred to when determining the emergence of the event.

In contrast, in this embodiment, each event is classified as any of five event categories in accordance with the details brought about by the emergence of the event. In this case, each event is classified as any of event categories including a hint event, an attribute event, an aptitude event, a story event, and an intensive-training event.

As mentioned above, a hint event refers to an event that allows for possession or acquisition of a skill. An attribute event refers to an event that causes an attribute parameter of the main character to increase or decrease. An aptitude event refers to an event that causes an aptitude parameter of the main character to increase or decrease. A story event refers to an event involving displaying a story related to a character appearing in the raising game. In addition to displaying a story, a story event may involve changing an attribute parameter or an aptitude parameter. An intensive-training event refers to an event involving increasing an attribute parameter of a team member.

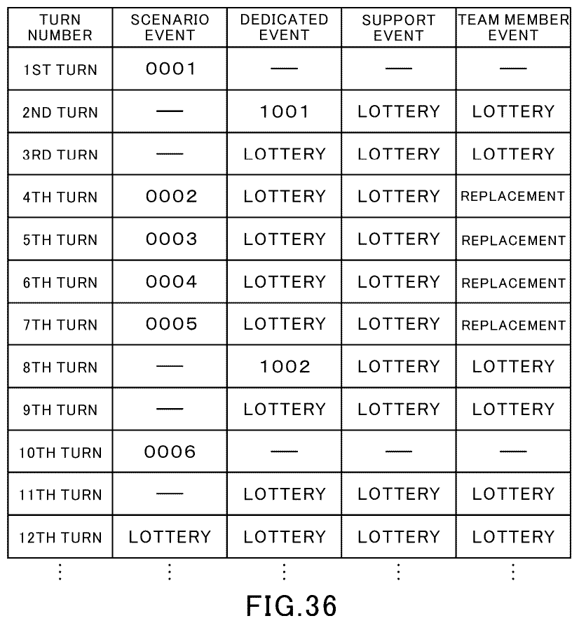

A scenario event includes a hint event, an attribute event, an aptitude event, and a story event. A dedicated event and a support event each include a hint event and an attribute event. A team member event includes a story event and an intensive-training event. The relationship between the event types and the event categories shown in FIG. 35 is merely an example. Therefore, for example, a dedicated event may include a story event and an intensive-training event. FIG. 36 illustrates the relationship between the event types and the number of turns. FIG. 36 illustrates an example where a predetermined character is registered as the main character when the main raising game is executed. The emergence of an event is determined based on an event determination table provided for every scenario.

The event determination table includes an event-emergence determination table and an event-detail determination table. In the event-emergence determination table, information indicating whether or not an event is to emerge and information indicating the emergence probability of the event are associated with each turn. It is assumed here that the information indicating whether or not an event is to emerge and information indicating the emergence probability of the event are defined for every event type for all the turns.

In the event-detail determination table, an event that is caused to emerge or an event that can emerge is preliminarily set for every turn and for every event type.

The start of a turn involves referring to the event-emergence determination table to determine first whether or not an event is caused to emerge for every event type. In this case, depending on the turn number and the event type, the “emergence” of an event may always be determined. Moreover, depending on the turn number and the event type, for example, it may sometimes be defined that an event is caused to emerge at a probability of 50%. In this case, a lottery for determining the “emergence” of the event at the probability of 50% is performed.

For the type of an event set to “emerge”, the details of the emerging event are determined by referring to the event-detail determination table. For example, according to the event-emergence determination table, a scenario event is set to always emerge on the first turn. Moreover, each event is given an event ID. In the event-detail determination table, a scenario event with the event ID=0001 is associated with the first turn as an event that can emerge. Therefore, when the main raising game is played, the scenario event with the event ID=0001 always emerges on the first turn.

Likewise, according to the event determination table (i.e., the event-emergence determination table and the event-detail determination table), scenario events with the event IDs=0002, 0003, 0004, 0005, and 0006 are set to emerge on the fourth turn, the fifth turn, the sixth turn, the seventh turn, and the 10th turn, respectively.

Each event is generally classified as a fixed event and a random event. A fixed event refers to an event in which the turns on which the event emerges are fixed. In other words, a fixed event refers to an event that can emerge on a predetermined turn but does not emerge on a turn other than the predetermined turn. In this case, the scenario events with the event IDs=0001, 0002, 0003, 0004, 0005, and 0006 are all fixed events, and are scenario-specific events.

In contrast, a random event refers to an event that emerges when the emergence thereof is determined and that is set as an emerging event. In FIG. 36, on each turn indicated as “lottery”, it is determined by lottery whether or not an event is to emerge. If “emergence” is determined, an event selected by lottery from random events emerges.

In the event-detail determination table, an event ID serving as a lottery target is set for each turn on which an event selected by lottery is to emerge. For example, it is assumed that random events with the event IDs=0010, 0011, and 0012 are provided as scenario events. In the event-detail determination table, it is assumed that the scenario event with the event ID=0010 is associated with the 12th turn.

In this case, a lottery for determining whether or not to cause the scenario event to emerge is performed at the start of the 12th turn. If selected in the lottery, the scenario event with the event ID=0010 emerges. If not selected, the scenario event does not emerge.

Furthermore, for example, in the event-detail determination table, it is assumed that the scenario events with the event IDs=0010, 0011, and 0012 are associated with the 15th turn. When an event is selected by lottery for determining whether or not to cause the event to emerge, a scenario event to emerge is determined by lottery from the events with the event IDs=0010, 0011, and 0012, and the scenario event selected by lottery emerges.

The above description relates to a case where a fixed event and a random event are provided exclusively. Alternatively, when a scenario event to emerge is to be determined by lottery, a fixed event may be set as a lottery target in addition to a random event or in place of a random event.

In this embodiment, the fourth turn to the seventh turn are set as branch turns. A branch turn refers to a turn where the details of an event are changed when a predetermined condition is satisfied. The predetermined condition set in this case includes a predetermined number of specific characters included in the team members, that is, a predetermined number of specific characters included in the main characters or the support characters.

In detail, on the fourth turn, it is determined whether four specific characters as the predetermined number are included in the team members. If four specific characters are included in the team members, a scenario event is replaced with a team member event. A team member event includes a specific character event provided for every specific character. In this case, when specific characters are included in the team members, a scenario event is replaced with a specific character event on a branch turn.

Likewise, it is determined on the fifth turn, the sixth turn, and the seventh turn whether three, two, and one specific characters as the predetermined numbers are included in the team members, respectively. If the corresponding predetermined number of specific characters are included in the team members, a scenario event is replaced with a specific character event.

In detail, scenario events with the event IDs=0002, 0003, 0004, and 0005 are story events. In each of these story events, the team members think of a team name, but a story that ultimately ends without proposition of a team name is played back. Therefore, if specific characters are not included in the team members, a team name is not proposed on four consecutive turns.

In contrast, if specific characters are included in the team members, scenario events are replaced with specific character events for the number of specific characters. A specific character event is a story event. In a specific character event, a story in which a team name is proposed by a specific character is played back. There are four specific characters provided, and a different team name is provided by each specific character. Therefore, if specific characters are included in the team members, team names equal in number to the number of specific characters are proposed from the fourth turn to the seventh turn.

A scenario event with the event ID=0006 emerging on the 10th turn is a story event. In this story event, a story in which the player is allowed to select a team name is played back. A total of five kinds of team names, namely, the four team names respectively proposed by the four specific characters in addition to a preset default team name, are provided.

Supposing that a specific character is not included in the team members and not a single team name is proposed from the fourth turn to the seventh turn, a team name selectable by the player on the 10th turn is the default team name alone. In this case, the player must select the default team name. Furthermore, for example, if two team names are proposed from the fourth turn to the seventh turn, the player can select any team name from the total of three kinds of team names, namely, the two proposed team names and the default team name.

The team name selected by the player on the 10th turn is registered as an official team name and is used thereafter in various situations until the main raising game ends. An award corresponding to the registered team name may be given to the player at a predetermined timing before the end of the main raising game. Examples of the award to be given to the player include acquisition of a skill corresponding to the registered team name, an increase in attribute parameter, an increase in aptitude parameter, and acquisition of in-game currency.

Accordingly, the scenario events with the event IDs=0002, 0003, 0004, 0005, and 0006 and the specific character events replaced from the fourth turn to the seventh turn are all scenario-specific events. Each scenario ID is managed in association with an event ID that can emerge. Therefore, each of the scenario events and the specific character events emerging from the fourth turn to the seventh turn and on the 10th turn is associated with only one scenario ID.

According to the event determination table, dedicated events with the event IDs=1001 and 1002 emerge on the second turn and the eighth turn, respectively. Furthermore, according to the event determination table, the emergence of a dedicated event and a dedicated event to emerge are determined by lottery on each of the third turn to the seventh turn, the ninth turn, the 11th turn, and the 12th turn.

A dedicated event varies from character to character. Furthermore, the relationship between the turn number and the emerging dedicated event is set for each character. Therefore, a turn where a dedicated event emerges and a dedicated event emerging on each turn vary depending on the character registered as the main character.

Moreover, as shown in FIG. 36, in the event determination table, the emergence of a support event and the details of the support event to emerge are determined by lottery on each predetermined turn. With regard to each support event, the event ID selectable by lottery may vary from turn to turn or may be the same on all the turns.

The probability at which “emergence” is determined in the lottery for determining the emergence of a support event is not affected by the registered support card. In other words, the probability at which a support event is set to emerge on each turn is the same regardless of whether any support card is registered. On the other hand, if “emergence” of a support event is determined, the details of the support event are determined. In this case, the probability at which the details of the support event are determined varies depending on the registered support card.

In detail, when the “emergence” of the support event is determined, the event ID of the support event that can emerge on the relevant turn is extracted based on the event-detail determination table. A lottery table is generated based on the extracted event ID, and one event ID is determined based on the generated lottery table.

The extracted event ID may sometimes include the event ID of a support event associated with a registered support card and the event ID of a support event not associated with a registered support card. In this case, in the lottery table, the selection probability of the event ID of the support event associated with the registered support card is set to be higher than the selection probability of the event ID of the support event not associated with the registered support card. Accordingly, the support event associated with the registered support card has a higher emergence probability than other support events.

Accordingly, on each turn, the emergence probability of a support event is not affected by a registered support card, but the details of the emerging support event are affected by the registered support card.

However, the emergence probability of a support event or the details (type) of the emerging support event may vary depending on the registered support card. Specifically, the number of events occurring during the main raising game or the occurrence probability thereof may vary depending on the registered support card.

On each turn, the emergence of a team member event is determined by lottery. A team member event to be determined by lottery is limited to an intensive-training event. An intensive-training event will be described in detail below.

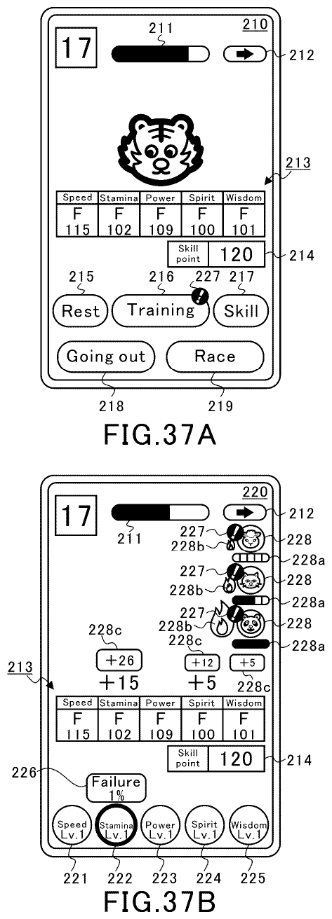

FIG. 37A is a third diagram illustrating the game screen 210. FIG. 37A indicates a case where an intensive-training event emerges on the relevant turn. In this case, as shown in FIG. 37A, the event notification indication 227 is displayed in the training operation section 216 on the game screen 210.

FIG. 37B is a third diagram illustrating the training screen 220. When the training operation section 216 on the game screen 210 is operated, the display 26 displays the training screen 220. When an intensive-training event occurs in correspondence with a character displayed in any of the allocated character icons 228 on the training screen 220, the event notification indication 227 is displayed in the allocated character icon 228 of the corresponding character. Furthermore, as shown in FIG. 37B, a bond gauge 228a and a special icon 228b are displayed for each of the allocated character icons 228 of the characters allocated to training. The bond gauge 228a indicates a parameter (referred to as “bond parameter” hereinafter) that increases in accordance with the number of times joint training is executed with a character of the corresponding team member. This bond parameter is originally set to zero and increases to a maximum of 100. The bond gauge 228a visually indicates a bond parameter value.

The special icon 228b indicates the number of times an intensive-training event related to a character of the corresponding team member is executed. As will be described in detail later, the special icon 228b is displayed in a display mode according to the number of times an intensive-training event has been executed with respect to a character of the allocated character icon 228 where the special icon 228b is displayed.

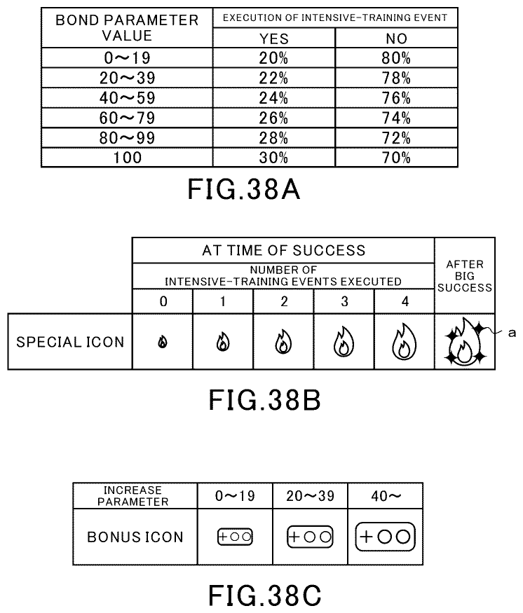

FIG. 38A illustrates an intensive-training event execution determination table. When allocation of a team member to each training item is determined, it is determined by lottery whether or not an intensive-training event is to be executed for every team member allocated to the corresponding training item based on the intensive-training execution determination table shown in FIG. 38A. A team member for which the execution of an intensive-training event has been determined may also be referred to as “intensive-training-target team member” hereinafter.

In detail, as shown in FIG. 38A, a selection probability indicating whether or not an intensive-training event is to be executed is set based on a bond parameter value of the intensive-training-target team member. The selection probability is set such that the execution of an intensive-training event is more likely to be selected as the bond parameter value increases. An intensive-training event can emerge by the same number of times as the number of team members selected by lottery. Alternatively, there may be a limit to the number of intensive-training-target team members that can simultaneously emerge per training item.

FIG. 38B illustrates a special-icon determination table. An intensive-training event includes a “successful” execution pattern and a “highly successful” execution pattern. When a fifth intensive-training event is executed with respect to each intensive-training-target team member, the intensive-training event is always executed in the “highly successful” execution pattern. On the other hand, when an intensive-training event other than the fifth intensive-training event is executed with respect to each intensive-training-target team member, the intensive-training event is always executed in the “successful” execution pattern. Specifically, for one intensive-training-target team member, an intensive-training event is executable only once in the “highly successful” execution pattern. The event notification indication 227 may be displayed in a mode that varies depending on the details (the “successful” execution pattern or the “highly successful” execution pattern) of an intensive-training event to be executed and the number of team members for which the execution of the intensive-training event has been determined.

As shown in FIG. 38B, if the number of times an intensive-training event related to each intensive-training-target team member is executed ranges between zero and four, that is, if the intensive-training event is not yet executed in the “highly successful” execution pattern, the special icon 228b is displayed in a larger size as the number of times the intensive-training event is executed increases.

Whether to execute an intensive-training event in the “successful” execution pattern or the “highly successful” execution pattern may be determined by lottery. In this case, the selection probability may be set such that the “highly successful” execution pattern is more likely to be selected as the number of times the intensive-training event is executed with respect to the intensive-training-target team member increases. In this case, since the “highly successful” execution pattern is more likely to be selected as the size of the special icon 228b increases, the special icon 228b indicates the likelihood of selection of the “highly successful” execution pattern.

After the intensive-training event is executed in the “highly successful” execution pattern, that is, when the intensive-training event related to the intensive-training-target team member is executed five or more times, the special icon 228b is displayed in a larger size than when the number of times the intensive-training event related to the intensive-training-target team member is executed ranges between zero and four. Furthermore, as shown in FIG. 38B, an indication a indicating that the intensive-training event has been executed in the “highly successful” execution pattern is displayed.

If an intensive-training event emerges and the intensive-training event is to be executed in the “successful” execution pattern, the attribute parameters of the intensive-training-target team member and the attribute parameters of the main character increase within a predetermined range. If the intensive-training event is to be executed in the “highly successful” execution pattern, the attribute parameters of the intensive-training-target team member and the attribute parameters of the main character increase beyond the aforementioned predetermined range.

Furthermore, when the execution of an intensive-training event is determined, as shown in FIG. 37B, the status display section 213 on the training screen 220 displays bonus icons 228c each indicating a value by which the corresponding attribute parameter of the main character increases due to the intensive-training event.

FIG. 38C illustrates a bonus-icon determination table. Each bonus icon 228c is displayed in a different size depending on the value by which the corresponding attribute parameter of the main character increases due to the intensive-training event. The bonus icon 228c is displayed in a larger size when the value by which the attribute parameter of the main character increases due to the intensive-training event ranges between 20 and 39 than when the value ranges between 0 and 19. The bonus icon 228c is displayed in a larger size when the value by which the attribute parameter of the main character increases due to the intensive-training event is 40 or larger than when the value ranges between 20 and 39.

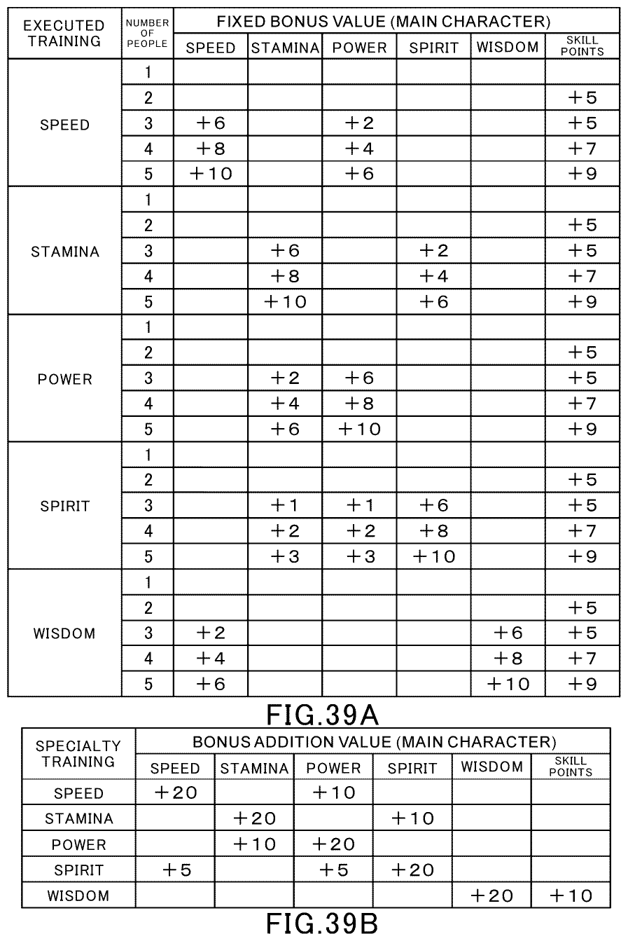

FIG. 39A illustrates a fixed-bonus-value (main-character) table. When the aforementioned intensive-training event is to be executed, a value (fixed bonus value) by which the corresponding attribute parameter of the main character increases due to the intensive-training event is determined in accordance with the number of team members for which the execution of the intensive-training event has been determined. As shown in FIG. 39A, the value (fixed bonus value) by which the attribute parameter of the main character increases due to the intensive-training event is set to increase with increasing number of team members for which the execution of the intensive-training event has been determined.

FIG. 39B illustrates a bonus-addition-value (main character) table. When an intensive-training event is to be executed in the “highly successful” execution pattern, a value (bonus addition value) by which the corresponding attribute parameter of the main character increases due to the intensive-training event in the “highly successful” execution pattern is determined in addition to the aforementioned fixed bonus value. As shown in FIG. 39B, the value (bonus addition value) by which the attribute parameter of the main character increases is set in accordance with specialty training of a team member for which the intensive-training event in the “highly successful” execution pattern is executed.

Specifically, the value by which the attribute parameter of the main character increases due to the intensive-training event is the sum of the aforementioned fixed bonus value and the bonus addition value.

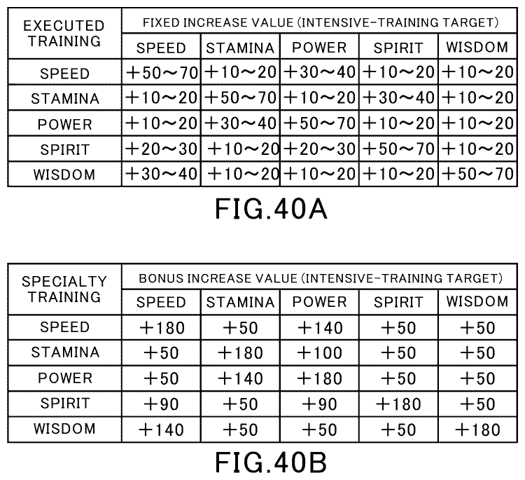

FIG. 40A illustrates a fixed-increase-value (intensive-training target) table. When the aforementioned intensive-training event is to be executed, a value (fixed increase value) by which the corresponding attribute parameter of the intensive-training-target team member increases due to the intensive-training event is determined. As shown in FIG. 40A, the range of the value (fixed increase value) by which the attribute parameter of the intensive-training-target team member increases is set in accordance with the type of executed training. In this case, the value (fixed increase value) within the range set in FIG. 40A is determined by lottery.

FIG. 40B illustrates a bonus-increase-value (intensive-training target) table. When an intensive-training event is to be executed in the “highly successful” execution pattern, a value (bonus increase value) by which the corresponding attribute parameter of the intensive-training-target team member increases due to the intensive-training event is determined in addition to the aforementioned fixed increase value. As shown in FIG. 40B, the value (bonus increase value) by which the corresponding attribute parameter of the intensive-training-target team member increases is set in accordance with specialty training of the intensive-training-target team member for which the intensive-training event in the “highly successful” execution pattern is executed.

When an intensive-training event is to be executed in the “highly successful” execution pattern, an increase event where the corresponding attribute parameter of the intensive-training-target team member and the corresponding attribute parameter of the main character additionally increase may be executed in accordance with the number of intensive-training events executed in the “highly successful” execution pattern. For example, a value by which the corresponding attribute parameter of the intensive-training-target team member or the corresponding attribute parameter of the main character additionally increases may increase with increasing number of intensive-training events executed in the “highly successful” execution pattern.

Accordingly, when an intensive-training event emerges, the attribute parameters of the main character and the intensive-training-target team member increase. If the main character or the intensive-training-target team member is a specific character, a predetermined addition rate may be integrated with the fixed increase value or the bonus increase value. Specifically, when the main character or the intensive-training-target team member is a specific character, the attribute parameter increases more than when the main character or the intensive-training-target team member is not a specific character.

Accordingly, in the main raising game, the player can increase the number of team members as the number of turns increases. Moreover, the player can increase the attribute parameters of the main characters and the team members as the number of turns increases. The attribute parameters increase as a result of successful training or emergence of various events. As mentioned above, in training, a bonus addition value is added when a specific character is allocated to a training item.

Although a detailed description will be omitted, if the main character or a support character is a specific character, a predetermined bonus addition value is added when an attribute event emerges. Therefore, by registering the specific character as the main character or a support character, the player can advantageously proceed with the main raising game.

If the team members include a specific character, a specific character event occurs on a branch turn. Therefore, by registering the specific character as the main character or a support character, the player can increase the options during the game and can enhance the enjoyment of the game.

In the aforementioned main raising game, when all of the turns are completed, the raising game ends. If a target set for each character is not achievable in mid-course of the main raising game, the raising game ends at that time point.

When the raising game ends, the main character raised in the raising game is stored as a raised character. More precisely, information (referred to as “raised character information” hereinafter) related to the raised character raised in the raising game is stored in association with the player ID. The raised character information is stored in both the player terminal 1 and the server 1000. The raised character information stored in association with the player ID includes attribute parameters, aptitude parameters, acquired skills, and inheritance information.

Furthermore, when the raising game ends, the score of the raised character is calculated. The score is calculated based on the attribute parameters, the aptitude parameters, the acquired skills, the individual-race record, and the team-race record at the end of the raising game. The method for calculating the score, that is, a calculation expression for calculating the score, is prepared in advance, and the score is calculated based on the predetermined calculation expression. The method for calculating the score and the calculation expression are not particularly limited. For example, the score may be calculated based only on parameters that affect the race result when the raised character participates in a race in a team competition game or another race game. Such parameters include the attribute parameters, the aptitude parameters, and the acquired skills at the end of the raising game.

The raised character has a raising rank set therefor based on the score. A raising rank is an indicator indicating the strength of the raised character. Each raising rank is associated with a score range. For example, a raised character with a score ranging between 13,000 and 14,499 is given a raising rank of “A+”, and a raised character with a score ranging between 14,500 and 15,499 is given a raising rank of “S”. Accordingly, a raising rank is given based on the score, so that the approximate strength of the raised character is ascertainable. The raised character information also includes the score and the raising rank.

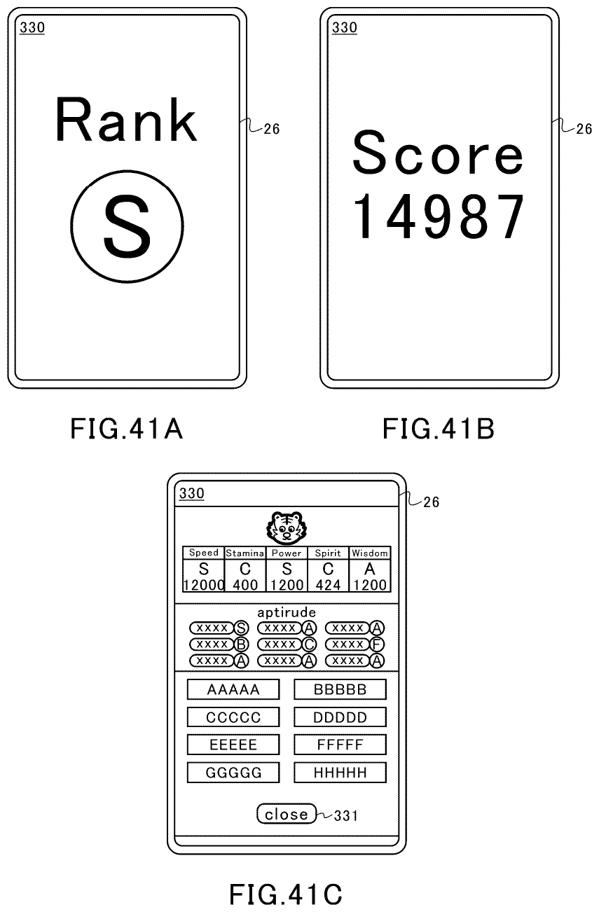

FIG. 41A is a first diagram illustrating a raising completion screen 330. FIG. 41B is a second diagram illustrating the raising completion screen 330. FIG. 41C is a third diagram illustrating the raising completion screen 330. As shown in FIG. 41A, when the raising game ends, the raising completion screen 330 is displayed on the display 26. The raising completion screen 330 first displays the raising rank of the raised character, and then displays the score, as shown in FIG. 41B.

After a predetermined time period elapses from when the score is displayed, the attribute parameters, the aptitude parameters, and the acquired skills of the raised character are displayed on the raising completion screen 330, as shown in FIG. 41C. In this case, the raising completion screen 330 is provided with a close operation section 331. When the close operation section 331 is tapped, the raising completion screen 330 is no longer displayed, and the home screen 100 is displayed on the display 26.

When the raising game ends, a lottery for factors to be acquired by the main character is performed, and factor information is stored in association with the raised character. Although not shown, the player can cause the raising completion screen 330 to display the factor information acquired by the raised character.

The raised character generated in this manner can participate in various races other than the raising game. In this embodiment, race games that the raised character can participate in include a team competition game, a practice match, a room match, a daily race, and an event race.

### (Team Competition Game)

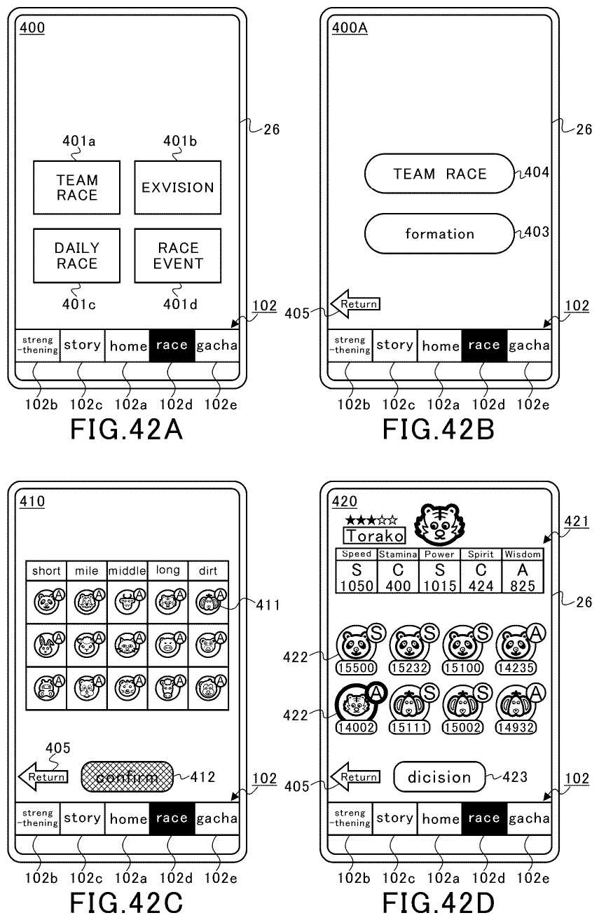

FIG. 42A illustrates a race-game selection screen 400. FIG. 42B illustrates a team competition game screen 400A. When the race-game selection operation section 102d is tapped, the race-game selection screen 400 shown in FIG. 42A is displayed. The race-game selection screen 400 displays a team-competition-game selection operation section 401a, a practice-race selection operation section 401b, a daily-race selection operation section 401c, and a race-event selection operation section 401d.

When the team-competition-game selection operation section 401a is tapped, the team competition game screen 400A shown in FIG. 42B is displayed. The team competition game screen 400A displays an organization selection operation section 403, a team-competition-game start operation section 404, and a return operation section 405. When the return operation section 405 is tapped, the screen transitions to the race-game selection screen 400 shown in FIG. 42A. When the organization selection operation section 403 is tapped, a team organization screen 410 is displayed on the display 26.

FIG. 42C illustrates the team organization screen 410. On the team organization screen 410, the player can organize a team to be used in a team competition game. A team competition game includes five categories of races, namely, a short-distance race, a mile race, a mid-distance race, a long-distance race, and a dirt-track race. Each race involves competition between the team (referred to as “player team” hereinafter) organized by the player and a team (referred to as “opponent team” hereinafter) serving as an opponent selected by the player. In each of the five categories of races, the team to which the raised character finishing at first place belongs is the winner. When the number of wins by the player team is larger than the number of wins by the opponent team, the player is the winner.

On the team organization screen 410, the player can organize each of a short-distance team corresponding to the short-distance race, a mile team corresponding to the mile race, a mid-distance team corresponding to the mid-distance race, a long-distance team corresponding to the long-distance race, and a dirt-track team corresponding to the dirt-track race. The maximum number of raised characters that can be registered in each team is three. The player can register the raised characters raised by the player in the teams. A raised character registered in a team will be referred to as “registered character” hereinafter.

As shown in FIG. 42C, the team organization screen 410 displays character icons 411 corresponding to the registered characters for each team. When any of the character icons 411 is tapped, the registered character corresponding to the tapped character icon 411 transitions to a provisionally selected state, and a raised-character-list screen 420 is displayed on the display 26.

FIG. 42D illustrates the raised-character-list screen 420. On the raised-character-list screen 420, the player can select a registered character. In detail, the upper part of the raised-character-list screen 420 displays an image of the raised character in the provisionally selected state and an attribute-parameter display field 421. The attribute-parameter display field 421 displays the attribute parameters of the provisionally-selected raised character.

The lower part of the attribute-parameter display field 421 displays raised character icons 422 corresponding to the raised characters owned by the player. When any of the raised character icons 422 is tapped, the raised character corresponding to the tapped raised character icon 422 transitions to a provisionally selected state. When the provisionally-selected raised character is changed in this manner, the display of the attribute-parameter display field 421 is also changed at the same time.

The raised-character-list screen 420 is provided with a decision operation section 423. When the decision operation section 423 on the raised-character-list screen 420 is tapped after a raised character different from a registered character transitions to a provisionally selected state, the registered characters are changed. When the registered characters are changed, the team organization screen 410 shown in FIG. 42C is displayed. In this case, the team organization screen 410 displays the character icons 411 corresponding to the registered characters after the change.

The team organization screen 410 is provided with a confirm operation section 412. In a state where the registered characters are not changed, the confirm operation section 412 is displayed in a grayed-out fashion, as shown in FIG. 42C. In this state, the confirm operation section 412 is operationally disabled. On the other hand, in a state where the registered characters are changed, the confirm operation section 412 is operationally enabled. When the confirm operation section 412 receives an operation, the changes to the registered characters are confirmed.

The team organization screen 410 and the raised-character-list screen 420 are each provided with the return operation section 405. When the return operation section 405 is tapped on the team organization screen 410, the team competition game screen 400A shown in FIG. 42B is displayed. If the return operation section 405 is tapped on the team competition game screen 400A in a state where the registered characters are changed, the changes in the registered characters are discarded. Accordingly, in this case, the team organization screen 410 is displayed without the registered characters being changed.

When the return operation section 405 is tapped on the raised-character-list screen 420, the raised-character-list screen 420 shown in FIG. 42C is displayed. If the return operation section 405 is tapped on the raised-character-list screen 420 in a state where the registered characters are changed, the changes in the registered characters are discarded. Accordingly, in this case, the team organization screen 410 is displayed without the registered characters being changed.

When any of the character icons 411 is long-pressed on the team organization screen 410 and when any of the raised character icons 422 is long-pressed on the raised-character-list screen 420, the character details dialog 185A is displayed on the display 26.

When the team-competition-game start operation section 404 is tapped on the team competition game screen 400A shown in FIG. 42B, an opponent-team selection screen 440 is displayed. As will be described in detail later, when the team-competition-game start operation section 404 is tapped, an opponent team is extracted in the server 1000.

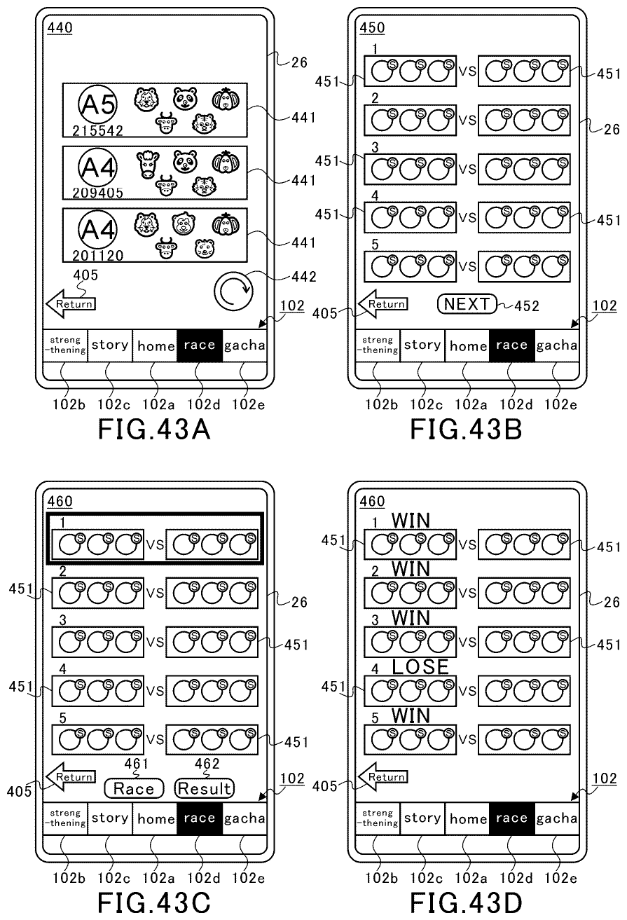

FIG. 43A illustrates the opponent-team selection screen 440. The opponent-team selection screen 440 displays an opponent team icon 441 corresponding to the opponent team. In this case, three opponent teams are extracted in the server 1000. Therefore, the opponent-team selection screen 440 displays three opponent team icons 441. Each opponent team icon 441 indicates an overall score of the team and a rank corresponding to the overall score. The overall score is calculated by combining, for example, the scores of all the registered characters organized in the team and the various aptitudes.

In the server 1000, each opponent team is extracted based on the overall score of the currently-set player team. In this case, one team with a score higher than the overall score of the player team within a first range (e.g., a range from +8,000 points to +10,000 points), one team with a difference in score with the overall score of the player team within a second range (e.g., a range from −2000 points to +2,000 points), and one team with a score lower than the overall score of the player team within a third range (e.g., a range from −8,000 points to −10,000 points) are extracted. Each of the teams extracted as the opponent teams is a team currently set as a player team by another player.

The opponent team icons 441 display character images of the leaders of the five teams respectively corresponding to the five categories of races. On the team organization screen 410, the registered character corresponding to the character icon 411 displayed at the highest level of each team serves as the leader.

The lower part of the opponent-team selection screen 440 is provided with a reload operation section 442. When the reload operation section 442 is tapped, the three opponent teams are extracted again in the server 1000, and the opponent team icons 441 are changed. When the return operation section 405 is tapped on the opponent-team selection screen 440, the team competition game screen 400A shown in FIG. 42B is displayed. When any of the opponent team icons 441 is tapped on the opponent-team selection screen 440, a start confirmation screen 450 is displayed.

FIG. 43B illustrates the start confirmation screen 450. The start confirmation screen 450 displays team icons 451 each indicating characters participating in the corresponding one of the five categories of races, namely, the short-distance race, the mile race, the mid-distance race, the long-distance race, and the dirt-track race. Team icons 451 is provided for each of the player team and the opponent team. The team icons 451 of the player team are displayed at the left side of the start confirmation screen 450, and the team icons 451 of the opponent team are displayed at the right side of the start confirmation screen 450.

The lower part of the start confirmation screen 450 is provided with the return operation section 405 and a start operation section 452. When the return operation section 405 is tapped, the team competition game screen 400A shown in FIG. 42B is displayed. However, even when the screen transitions to the team competition game screen 400A, the player is not able to remove an already-selected opponent team. Therefore, when the return operation section 405 is tapped on the start confirmation screen 450, the opponent team is saved. When the team-competition-game start operation section 404 is tapped on the team competition game screen 400A in the state where the opponent team is saved, the start confirmation screen 450 shown in FIG. 43B is displayed again.

When the start operation section 452 is tapped on the start confirmation screen 450, a result list screen 460 is displayed.

FIG. 43C is a first diagram illustrating the result list screen 460. FIG. 43D is a second diagram illustrating the result list screen 460. On the result list screen 460, the team icons 451 are displayed for each race category, similarly to the start confirmation screen 450, and the team icons 451 of the race for which a race result is to be displayed are highlighted. In FIG. 43C, the team icons 451 for the first race displayed at the uppermost location are highlighted.

The lower part of the result list screen 460 is provided with a race-video-playback selection section 461 and a result-display selection section 462. When the race-video-playback selection section 461 is tapped, a race video of the highlighted race is played back. When the race video is completely played back, an identification indicating whether the player team has won or lost is displayed, as shown in FIG. 43D. When the result-display selection section 462 is tapped, the race result alone is displayed, as shown in FIG. 43D, instead of the race video being played back. When the race result is displayed, the team icons 451 display the finished places of the participating registered characters.

The aforementioned five categories of races are executed in the team competition game, but the order in which they are executed is determined randomly by lottery. The race result of the race of each category (i.e., the ranks of the raised characters and the win-loss result of each race) is derived in the order determined by lottery. When the race results of the five categories of races are displayed on the result list screen 460, an overall race result screen 470 is displayed.

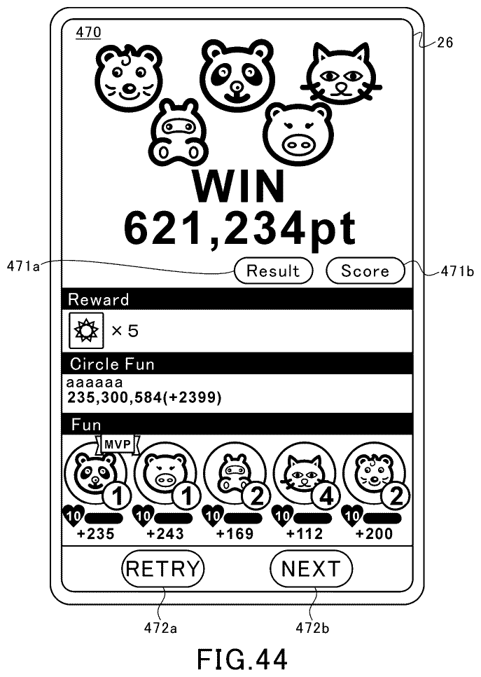

FIG. 44 illustrates the overall race result screen 470. The upper part of the overall race result screen 470 displays the character images of the leaders of the five categories of races, and displays therebelow the win-loss result of the team and the overall race points of the player team. Although a detail description will be omitted here, in the team competition game, race points are set for each registered character that has participated in the corresponding race in accordance with predetermined point addition conditions.

For example, the point addition conditions include various set conditions to be achieved during the race, such as the finished place and the number of skills activated during the race. Furthermore, for example, the point addition conditions for adding race points based on the ranks of characters with the same running style are set at a specific timing during the race. The race points are set for each registered character, and category race points obtained by combining the race points of registered characters participating in the same race category are calculated for each race category. Then, the race points of all the registered characters are combined, whereby overall race points with, for example, predetermined bonus points added thereto are calculated.

With regard to point addition conditions for the bonus points, for example, a consecutive-win bonus may be set such that bonus points are added in accordance with the number of consecutive wins when the team wins consecutively. Furthermore, for example, as a leader bonus, predetermined bonus points may be added to the race points of the registered character serving as the leader of each team. Moreover, for example, as an opponent bonus, bonus points may be added in accordance with the overall score of the opponent team. Furthermore, for example, as a support bonus, bonus points may be added in accordance with the level of a support card owned by the player.

When the team competition game is executed, a reward may be given to the player. The overall race result screen 470 displays the reward given to the player. Furthermore, when the team competition game is executed, each registered character that has participated in the race acquires a fan or fans. If the player belongs to a club, the total number of fans acquired by each registered character is added to the number of fans of the club. The overall race result screen 470 displays the number of fans of the club and the number of fans acquired in the current team competition game.

The lower part of the overall race result screen 470 displays, for each registered character that has participated in the race, an icon indicating the registered character, the finished place, the number of acquired fans, and a meter indicating an affinity level. Although FIG. 44 only illustrates five registered characters, the player can check information about all the registered characters by scrolling the screen in the vertical direction.

In the team competition game, the registered character that has acquired the most race points is selected as an MVP. The overall race result screen 470 displays an icon indicating “MVP” over the icon of the registered character that has acquired the MVP status.

The overall race result screen 470 is provided with a race-result display icon 471a and a score display icon 471b. When the race-result display icon 471a is tapped, the result list screen 460 shown in FIG. 43D is displayed. When the score display icon 471b is tapped, a score list screen 480 is displayed.

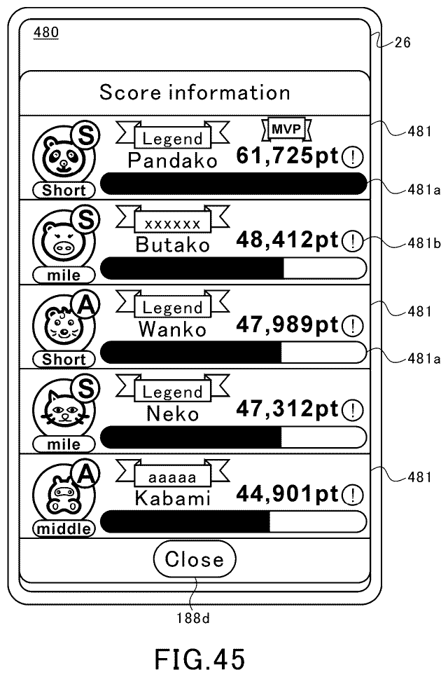

FIG. 45 illustrates the score list screen 480. The score list screen 480 displays a score display field 481 for each registered character that has participated in the race. Each score display field 481 displays, in an identifiable manner, an icon corresponding to the registered character, a raising rank, and a race category that the registered character has participated in. Furthermore, a second name and a character name of the registered character are also displayed. The score display field 481 also displays race points acquired by the registered character.

The score list screen 480 displays the score display fields 481 starting from the registered character that has acquired the highest race points. Assuming that the maximum race points acquired by the registered character, that is, the race points acquired by the registered character displayed at the highest level, are defined as 100, each score display field 481 displays a meter 481a indicating the percentage of race points acquired by another registered character.

Each score display field 481 is provided with a details icon 481b near the race points. When the details icon 481b is tapped, a score details screen (not shown) is displayed. The score details screen displays a breakdown of the race points, that is, detailed information indicating which of the point addition conditions has been achieved to acquire the race points.

Referring back to FIG. 44, the lowermost part of the overall race result screen 470 is provided with a retry operation section 472a and a next operation section 472b. When the retry operation section 472a is tapped, the opponent team is reselected, and the opponent-team selection screen 440 shown in FIG. 43A is displayed. When the next operation section 472b is tapped, the team competition game ends, and the team competition game screen 400A shown in FIG. 42B is displayed.

Accordingly, in the team competition game, the player can organize a team by using raised characters and make the team compete with a team organized by another player. Since the competition involves competing with another player for rankings in accordance with the overall race points acquired from this competition, the player is motivated to raise more enhanced raised characters.

The player can also readily check raised characters with high race points on the score list screen 480. Therefore, the player can readily ascertain how a team is to be organized for acquiring race points, thereby achieving enhanced player friendliness and higher ambition for the game.

In order to raise more enhanced raised characters in the raising game, it is necessary to select support cards and inheritance characters more appropriately. Therefore, it is desirable that the player collect information for raising enhanced raised characters. In the team competition game according to this embodiment, any of the team icons 451 of the opponent team displayed on the result list screen 460 may be long-pressed to browse the character details dialog 185A of the registered characters of the opponent team.

Accordingly, for example, the player can raise raised characters similar to the registered characters of the opponent team after confirming the inheritance information and the raising information about raised characters with high scores. However, such raised characters with high scores do not necessarily contribute to a high winning percentage in the team competition game, and it is difficult to acquire information for organizing an optimal team. The difficulty in acquiring appropriate information in this manner may lower the player's ambition for playing the game.

In this embodiment, the player can perform a practice match in which a raised character raised by another player is allowed to participate. In this practice match, a raised character owned by the player and a raised character owned by another player participate in a desired race, so that the player can check how the race result may turn out to be. Accordingly, the player can readily acquire information for raising more enhanced raised characters. The practice match will be described below.

### (Practice Match)

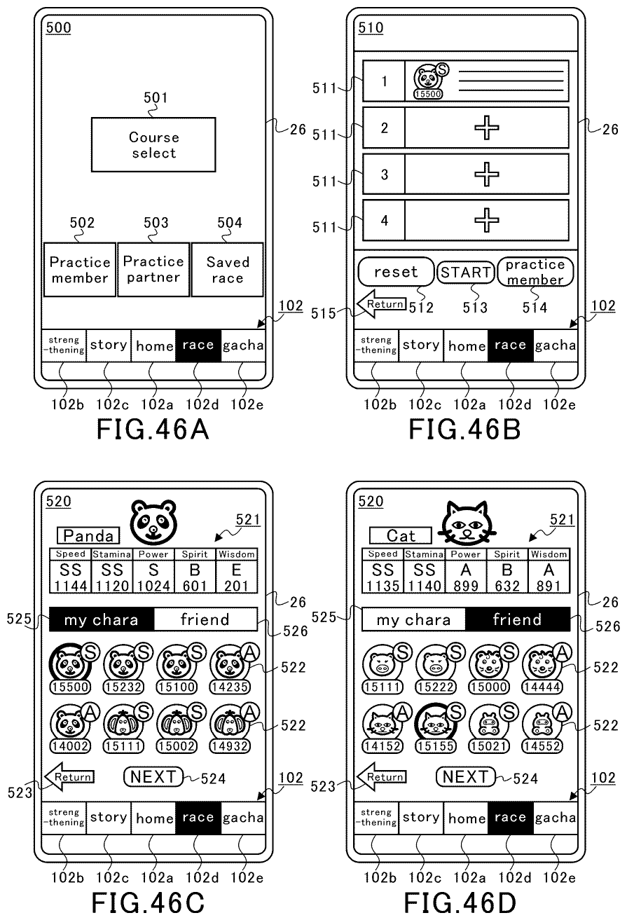

FIG. 46A illustrates a practice-match top screen 500. When the practice-race selection operation section 401b is tapped on the race-game selection screen 400 shown in FIG. 42A, an exhibition selection screen (not shown) is displayed. On the exhibition selection screen, the player can select a practice match or a room match. When the practice match is selected on the exhibition selection screen, the practice-match top screen 500 shown in FIG. 46A is displayed.

The player can set, for example, various race conditions, such as a course, and raised characters that are to participate in a race from the practice-match top screen 500. When a course selection operation section 501 is tapped on the practice-match top screen 500, a race-condition setting screen (not shown) is displayed.

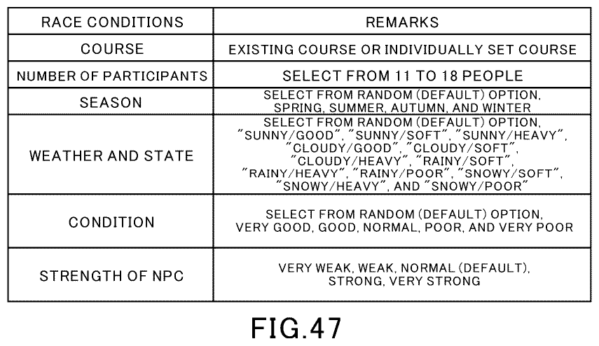

FIG. 47 illustrates the race conditions. The player can arbitrarily set the race conditions on the race-condition setting screen. In detail, the player can select a race course from existing courses or can set the race course individually. Moreover, the player can set the number of participants to any of 11 people to 18 people. The player can also set the season to any of a random option, spring, summer, autumn, and winter. If the random option is selected, the season is set randomly by lottery at the start of the race.

The player can set the weather and state to any of a random option and 12 patterns shown in the drawing. If the random option is selected, the weather and state are set randomly by lottery at the start of the race. The player can also set the condition to any of a random option and five patterns shown in the drawing. If the random option is selected, the condition is set randomly by lottery at the start of the race. If the condition is set to any of the patterns other than the random option, the conditions of all the participating characters are set uniformly to the selected condition. The player can set the strength of an NPC to any of five patterns shown in the drawing.

FIG. 46B illustrates a participating-character setting screen 510. When the race conditions are set on the race-condition setting screen, the participating-character setting screen 510 is displayed on the display 26. The participating-character setting screen 510 displays character setting tabs 511, a reset operation section 512, a start operation section 513, a practice-member display operation section 514, and a return operation section 515. The number of character setting tabs 511 displayed is equal to the number of participants set on the race-condition setting screen. At the start of display of the participating-character setting screen 510, all of the character setting tabs 511 are displayed as blank fields. When any of the character setting tabs 511 is tapped, a participating-character selection screen 520 is displayed.

FIG. 46C is a first diagram illustrating the participating-character selection screen 520. FIG. 46D is a second diagram illustrating the participating-character selection screen 520. On the participating-character selection screen 520, the player can select a raised character that is to participate in the practice match. In detail, the upper part of the participating-character selection screen 520 displays an image of a raised character in a provisionally-selected state and an attribute-parameter display field 521. The attribute-parameter display field 521 displays the attribute parameters of the provisionally-selected raised character.

The lower part of the attribute-parameter display field 521 displays raised character icons 522 corresponding to the raised characters owned by the player. When any of the raised character icons 522 is tapped, the raised character corresponding to the tapped raised character icon 522 transitions to a provisionally selected state. When the provisionally-selected raised character is changed in this manner, the display of the attribute-parameter display field 521 is also changed at the same time.

The participating-character selection screen 520 is provided with a return operation section 523 and a next operation section 524. When the return operation section 523 is tapped, the participating-character setting screen 510 shown in FIG. 46B is displayed. In this case, the provisionally-selected raised character is discarded. When the next operation section 524 is tapped, the provisionally-selected raised character is set as a participating character. In this case, the screen transitions from the participating-character selection screen 520 to the participating-character setting screen 510. As shown in FIG. 46B, information related to the raised character set as a participating character is displayed on one of the character setting tabs 511.

The participating-character selection screen 520 is provided with a my-character display tab 525 and a rental-character display tab 526. In a state where the my-character display tab 525 is tapped, the raised character icons 522 corresponding to the raised characters owned by the player are displayed, as shown in FIG. 46C. On the other hand, in a state where the rental-character display tab 526 is tapped, the raised character icons 522 corresponding to friend's representative characters or characters registered as practice partners, to be described below, are displayed, as shown in FIG. 46D.

The player can arbitrarily select multiple characters that are to participate in the practice match from among raised characters raised by the player, friend's representative characters, and practice partners. When two or more specific characters are set as participating characters, the practice match is executable. The specific characters may be an arbitrary combination of one or more of raised characters raised by the player, friend's representative characters, and practice partners. Accordingly, on the participating-character selection screen 520, the player can allow raised characters raised by another player to participate in the practice match, in addition to the raised characters owned by the player.

When any of the raised character icons 522 is long-pressed on the participating-character selection screen 520, the aforementioned character details dialog 185A is displayed. Accordingly, the player can also check detailed information about each raised character from the participating-character selection screen 520.

Accordingly, on the participating-character selection screen 520, the player can individually select raised characters that are to participate in the practice match for the number of participants. When the reset operation section 512 shown in FIG. 46B is tapped, the raised characters set as characters that are to participate in the practice match are discarded. When the start operation section 513 is tapped in the state where the raised characters are set for the number of participants, the practice match starts. When the return operation section 515 is tapped, the set raised characters are discarded, and the race-condition setting screen is displayed.

As mentioned above, the process for individually setting the raised characters that are to participate in the practice match for the number of participants is complicated. This embodiment is provided with a practice-member registration function for registering practice members including multiple raised characters and reading the registered practice members as raised characters that are to participate in the practice match. When the practice-member display operation section 514 is tapped on the participating-character setting screen 510, a practice-member selection screen 530 is displayed.

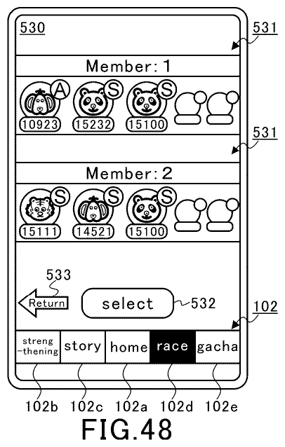

FIG. 48 illustrates the practice-member selection screen 530. As will be described later, the player can collectively register the characters that have participated in the practice match as practice members. The practice-member selection screen 530 displays a practice-member display field 531. The practice-member display field 531 is displayed for each registered practice member. The practice-member display field 531 displays an icon corresponding to a character included in the practice members. When this icon is long-pressed, the character details dialog 185A is displayed, similarly to the above.

When the practice-member display field 531 is tapped, the practice member corresponding to the practice-member display field 531 transitions to a provisionally selected state. When a select operation section 532 provided on the practice-member selection screen 530 is tapped in the state where any of the practice members is provisionally selected, a raised character included in the provisionally-selected practice members is set as a participating character of the practice match. More specifically, all of the raised characters serving as the practice members are set as participating characters. In this case, the screen transitions from the practice-member selection screen 530 to the participating-character setting screen 510. When a return operation section 533 provided on the practice-member selection screen 530 is tapped, the provisionally-selected practice members are discarded, and the participating-character setting screen 510 is displayed.

As shown in FIG. 46A, the practice-match top screen 500 is provided with a practice-member operation section 502, a practice-partner operation section 503, and a saved-race operation section 504. When the practice-member operation section 502 is tapped, a practice-member-list screen (not shown) is displayed. The practice-member-list screen displays a list of registered practice members.

As mentioned above, this embodiment is provided with a practice-partner registration function for registering a raised character raised by another player, such as a friend, as a practice partner. A raised character of another player registered as a practice partner by using the practice-partner registration function is displayed on the participating-character selection screen 520.

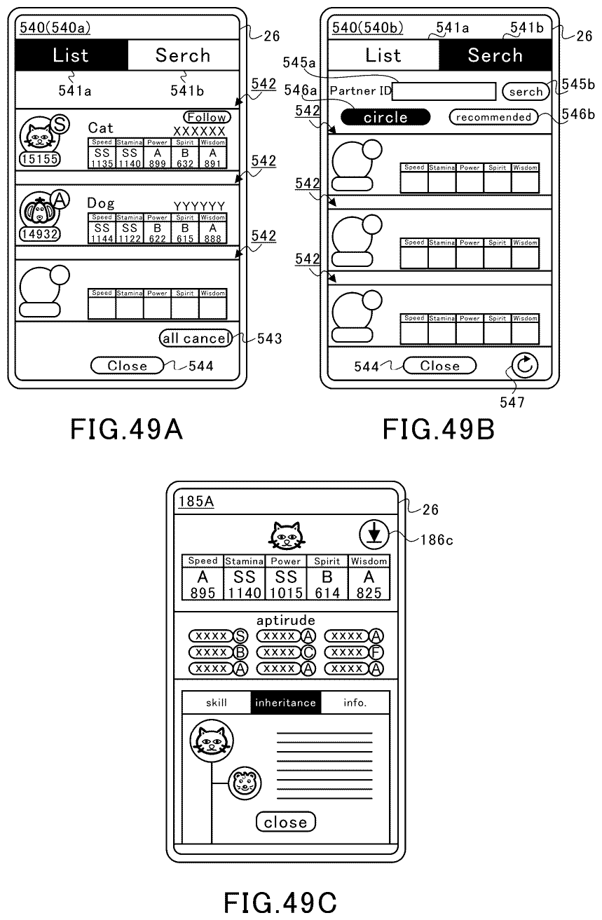

FIG. 49A is a first diagram illustrating a practice partner screen 540. FIG. 49B is a second diagram illustrating the practice partner screen 540. FIG. 49C is a fourth diagram illustrating the character details dialog 185A. When the practice-partner operation section 503 is tapped on the practice-match top screen 500 shown in FIG. 46A, the practice partner screen 540 is displayed. The practice partner screen 540 includes a practice-partner list screen 540a and a practice-partner search screen 540b. During a transition to the practice partner screen 540, the practice-partner list screen 540a is displayed on the display 26.

The practice partner screen 540 is provided with a list tab 541a and a search tab 541b. When the list tab 541a is tapped, the practice-partner list screen 540a is displayed. When the search tab 541b is tapped, the practice-partner search screen 540b is displayed. The practice-partner list screen 540a displays an information display field 542 for every character (referred to as “partner character” hereinafter) currently registered as a practice partner.

Each information display field 542 displays a character image of the partner character, a score, a rank, a character name, attribute parameters, and a player name of the player who has raised the partner character. For example, if another player has a predetermined relationship, such as a follower relationship, with the player, information indicating the relationship with the player is displayed. For example, the information display field 542 displayed at the highest level in FIG. 49A displays “Follow”. This indicates that the partner character has been raised by a player set as a follower.

A cancel operation section 543 is provided below the information display fields 542. By tapping on the cancel operation section 543, the player can cancel the registration of the partner characters. When a close operation section 544 provided on the practice partner screen 540 is tapped, the practice partner screen 540 is closed, and the screen transitions to the practice-match top screen 500.

As shown in FIG. 49B, the practice-partner search screen 540b is provided with an input field 545a to which a partner ID is inputtable, as well as a search operation section 545b. As will be described later, a partner ID is given to a raised character that any of the players has given permission to another player to register as a practice partner. When the input field 545a is tapped, an input screen (not shown) to which a numerical value is inputtable is displayed. When an operation is input to the input screen, a partner ID is inputtable to the input field 545a. When the search operation section 545b is tapped in a state where the partner ID is input to the input field 545a, information related to the raised character given the partner ID is displayed on the information display field 542.

The practice-partner search screen 540b is provided with a club tab 546a and a recommendation tab 546b. When the club tab 546a is tapped, information related to a representative character of another player belonging to the same club as the player is displayed in the information display field 542. When the recommendation tab 546b is tapped, information related to a raised character owned by another player is displayed in the information display field 542 in accordance with predetermined search conditions. Although the search conditions are not particularly limited, for example, a search for a raised character owned by a friend may be performed.

The practice-partner search screen 540b is provided with a reload operation section 547. When the reload operation section 547 is operated, for example, the search conditions are changed, and a re-search is performed.

When the information display field 542 is tapped on the practice partner screen 540, the character details dialog 185A is displayed, as shown in FIG. 49C. In this case, for example, the displayed character details dialog 185A is the same as when the team icon 451 of an opponent team is long-pressed on the result list screen 460 (see FIG. 43D) displayed in the team competition game.

The character details dialog 185A is displayed both when a raised character raised by the player is selected and when a raised character raised by another player is selected. In this case, different icons are displayed in the character details dialog 185A depending on whether the raised character has been raised by the player or by another.

In detail, the character details dialog 185A of a raised character raised by another player displays a partner registration icon 186c. By tapping on the partner registration icon 186c, the player can register the raised character as a partner character.

In contrast, the character details dialog 185A of a raised character raised by the player displays a share icon (not shown). The share icon is provided for asking another player to register the raised character as a practice partner.

Referring back to FIG. 46B, when the start operation section 513 is tapped on the participating-character setting screen 510 in the state where all of the participating characters are set in the above-described manner, the practice match starts. When the start operation section 513 is tapped, a race simulation result is derived based on, for example, the attribute parameters of the participating characters. A race video is played back based on the derived simulation result. Similar to the team competition game described above, in the practice match, the player is capable of selecting whether the race video is to be played back or the race result alone is to be displayed.

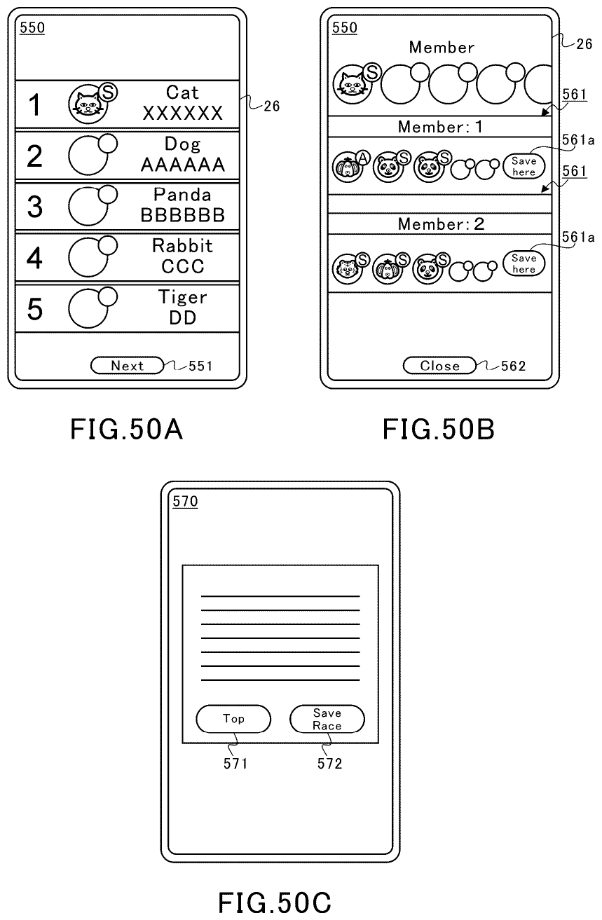

FIG. 50A illustrates a practice-match result screen 550. When an operation for terminating the playback of the race video or for displaying the race result is input, the practice-match result screen 550 shown in FIG. 50A is displayed. The practice-match result screen 550 displays the finished places of the participating characters, as shown in the drawing. When a next operation section 551 provided on the practice-match result screen 550 is tapped, a practice-member registration screen 560 is displayed.

FIG. 50B illustrates the practice-member registration screen 560. The uppermost level of the practice-member registration screen 560 displays icons of the characters that have participated in the current practice match, that is, all of the raised characters included in the current practice members. The practice-member registration screen 560 also displays a practice-member display field 561. The practice-member display field 561 is displayed for every registered practice member. Each practice-member display field 561 displays an icon corresponding to a raised character included in the practice members. When this icon is long-pressed, the character details dialog 185A is displayed, similarly to the above.

Each practice-member display field 561 is provided with a save operation section 561a. When the save operation section 561a is tapped, a currently-registered practice member is overwritten by a current practice member. In detail, in FIG. 50B, the practice-member display field 561 shown at the upper level corresponds to first practice members that are currently registered, and the practice-member display field 561 shown at the lower level corresponds to second practice members that are currently registered but are different from the first practice members. When the save operation section 561a provided in the practice-member display field 561 at the upper level is tapped, the current practice members are registered as new first practice members. Likewise, when the save operation section 561a provided in the practice-member display field 561 at the lower level is tapped, the current practice members are registered as new second practice members.

After the practice match ends and the practice-match result screen 550 is displayed in this manner, the player can register the practice members used in the current practice match. Then, when a close operation section 562 provided on the practice-member registration screen 560 is tapped, the practice-member registration screen 560 is closed, and a race-result save dialog 570 is displayed.

FIG. 50C illustrates the race-result save dialog 570. The race-result save dialog 570 is provided with an end button 571 and a race-result save button 572. The race-result save dialog 570 displays a message indicating that the race result can be saved. When the race-result save button 572 is tapped, the race result of the current practice match is saved.

By tapping on the saved-race operation section 504 on the practice-match top screen 500 shown in FIG. 46A, the player can repeatedly check the saved race result. The race result includes, for example, the information related to the participating characters and the simulation result, and the player can check the race result alone or play back the race video. When the end button 571 is tapped on the race-result save dialog 570, the race result of the current practice match is discarded, and the practice-match top screen 500 is displayed.

Accordingly, by executing the practice match, the player can obtain information for raising a more enhanced raised character. Furthermore, since the practice match involves causing raised characters raised by another player to compete with each other, the player does not have to own enhanced raised characters. Therefore, there is no bias in the obtained information among the players, so that all of the players can equally obtain required information.

### (Room Match)

This embodiment is provided with a room match as a race that a raised character raised by the player can participate in. A room match is a competition race in which a raised character raised by the player competes with raised characters of other multiple players.

In this embodiment, each player can enter into multiple competition races. “Entry” to a competition race is broadly divided into “hold” and “join”. The term “hold” means that the player holds a competition race. The term “join” means partaking in a competition race held by another player.

The term “join” includes the term “participate” in which a raised character owned by the player participates in a competition race held by another player and the term “watch” in which the player simply watches a competition race held by another player without making a raised character of the player participate in the competition race. When “holding” a competition race, the player needs to make a raised character of the player participate in the race. Alternatively, when a competition race is to be “held”, the “participate” option or the “watch” option may be selectable.

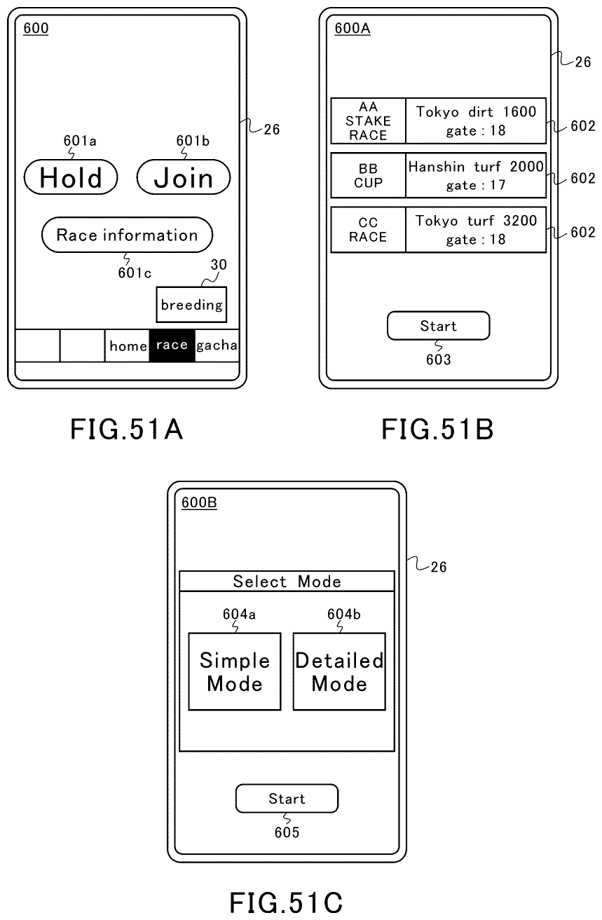

FIG. 51A illustrates a room-match top screen 600. As mentioned above, when the practice-race selection operation section 401b is tapped on the race-game selection screen 400 shown in FIG. 42A, an exhibition selection screen (not shown) is displayed. When a room match is selected on the exhibition selection screen, the room-match top screen 600 shown in FIG. 51A is displayed.

The room-match top screen 600 is provided with a hold tab 601a, a join tab 601b, and an entry information tab 601c. The hold tab 601a is an operation section for holding a competition race. When the hold tab 601a is operated, a held-race selection screen 600A shown in FIG. 51B is displayed.

FIG. 51B illustrates the held-race selection screen 600A. The held-race selection screen 600A displays multiple holdable race images 602 indicating holdable race categories. Each holdable race image 602 displays information related to the corresponding race. For each race, the race name, the course, the racetrack, the distance, and the maximum number of participants are set in advance. When any of the holdable race images 602 is tapped on the held-race selection screen 600A, the tapped race transitions to a provisionally selected state. When a start button 603 displayed on the held-race selection screen 600A is tapped in the state where the race is provisionally selected, the provisionally-selected race is set as a held race.

A player who holds a competition race may be referred to as a host player hereinafter, and the competition race held by the host player may be referred to as a held race hereinafter. A player partaking in a competition race held by another player may be referred to as a guest player.

FIG. 51C illustrates a mode selection screen 600B. When the held race is set on the held-race selection screen 600A, the mode selection screen 600B is displayed. In this embodiment, a simple mode and a detailed mode are provided as modes of the held race. In the simple mode, holding conditions serving as a general outline of the held race and race conditions, such as the conditions of the held race, are default conditions prepared in advance. On the other hand, in the detailed mode, the holding conditions and the race conditions can be set arbitrarily by the player.

The mode selection screen 600B displays a simple-mode selection operation section 604a and a detailed-mode selection operation section 604b. When the simple-mode selection operation section 604a is tapped, the simple mode transitions to a provisionally selected state. When the detailed-mode selection operation section 604b is tapped, the detailed mode transitions to a provisionally selected state. When a start button 605 displayed on the mode selection screen 600B is tapped in the state where one of the modes is provisionally selected, the provisionally-selected mode is officially set.

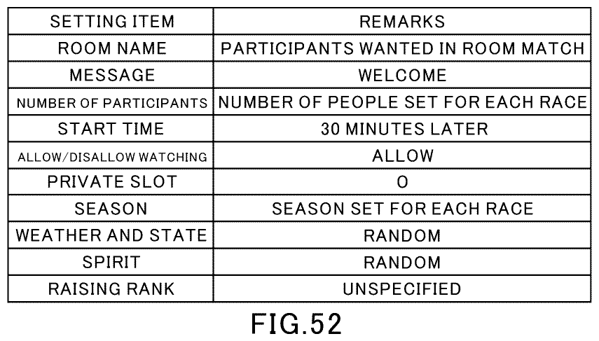

FIG. 52 illustrates the simple mode. When the simple mode is officially set, a simple-mode setting screen (not shown) is displayed. The player can input a room name and a message on the simple-mode setting screen. The room name and the message are information that can be browsed when searching for a competition race that another player partakes in. On the simple-mode setting screen, the room name is set to “participants wanted in room match” and the message is set to “welcome” as default settings. The player can edit and register the room name and the message on the simple-mode setting screen.

For the held race, the number of participants, a start time, an allow/disallow watching item, and a private slot item are set as the holding conditions.

The number of participants indicates the number of raised characters that are to participate in the held race. In the held race, if the number of raised characters registered for participation is smaller than the number of participants, an NPC or NPCs is/are added for the insufficient number. Therefore, a competition race in a room match is always executed by the set number of participants. Alternatively, a competition race may be executed only by raised characters made to participate therein by the player. If the number of raised characters registered for participation is smaller than a predetermined number, the held race may be cancelled.

In each holdable race category, a predetermined number may be set as the number of participants. When the simple mode is selected, a predetermined number preliminarily set for every race category of held race is set as the number of participants.

The start time is information indicating the time at which the held race starts. More specifically, the start time is information indicating the time at which a race result is derived. In this case, a time period until the race result is derived, that is, a remaining time period, is set as the start time. When the start time is set, the remaining time period decreases as time elapses, and the race result is derived when the remaining time period reaches zero. A start time point may be set in place of the start time, and the race result may be derived when the start time point is reached. Depending on the race category, the start time or the start time point may be set. When the simple mode is selected, the set start time is “30 minutes later”. The following description may relate to a case where the remaining time period is the start time.

The allow/disallow watching item indicates whether or not to allow a third person who does not make a character participate in the race to watch and view the race. When the simple mode is selected, the allow/disallow watching item is set to “allow”, so that a third person is allowed to watch the race.

The private slot item indicates a dedicated participation slot or slots for a player or players having a predetermined relationship with the host player. Although a detailed description will be omitted, examples of a player having a predetermined relationship includes a player set as a friend, such as a follower, by the host player and a player belonging to the same club as the host player.

For example, in a competition race where the number of participants is 18, it is assumed that the private slots are set to “3”. For a player not having the predetermined relationship with the host player, this competition race only allows participation of a maximum of 15 raised characters owned by the player. Accordingly, the private slot or slots is/are set for ensuring a participation slot or slots for a player having the predetermined relationship with the host player. When the simple mode is selected, the private slot is set to “0”.

For the held race, a season, weather and state, spirit, and raising rank are set as the race conditions.

The season is set to any of spring, summer, autumn, and winter, and the set season may have an effect on the race result. In other words, the season is one of parameters for deriving the race result. Each race category has a predetermined season set therefor. When the simple mode is selected, a predetermined season is set for every race category of held race.

The weather and state indicate the weather at the time of the race and the state of the racetrack, and the set weather and state have an effect on the race result. In other words, the weather and state are one of parameters for deriving the race result. When the simple mode is selected, the weather and state are randomly set by lottery at the start of the held race. The weather and state may be set at a predetermined timing prior to the start of the held race instead of being set at the start of the held race.

The spirit indicates the “condition” of a character participating in the race, and is provided with five levels, namely, “very good”, “good”, “normal”, “poor”, and “very poor”, similar to the aforementioned raising game. Since the spirit is calculated as a variable of an attribute parameter of the character participating in the race, the spirit has an effect on the race result. When the simple mode is selected, the spirit is set randomly by lottery at the start of the held race. The spirit may be set at a predetermined timing prior to the start of the held race instead of being set at the start of the held race. Furthermore, the spirit may be set for every participating character, or the set spirit may be set uniformly for all of the characters.

The raising rank is a parameter for classifying an attribute of a character and is derived based on, for example, an attribute parameter. In the held race, the player can set the raising rank of a character that can participate in a competition race to a predetermined rank or higher. However, when the simple mode is selected, the raising rank is set to “unspecified”. This “unspecified” option means that characters of all raising ranks can participate in the held race.

Accordingly, when the simple mode is selected, the holding conditions and the race conditions are set to default conditions. When the host player sets the held race in the simple mode, the host player can change the room name and the message in an ex-post fashion, but cannot change the holding conditions and the race conditions.

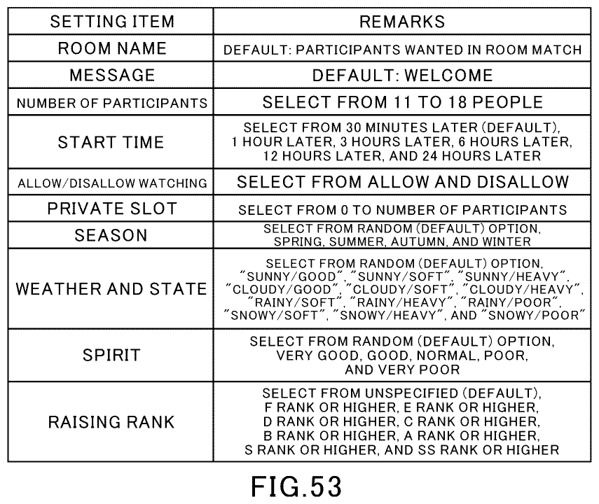

FIG. 53 illustrates the detailed mode. When the detailed mode is officially set, a detailed-mode setting screen (not shown) is displayed. The player can input a room name and a message on the detailed-mode setting screen. On the detailed-mode setting screen, the room name is set to “participants wanted in room match” and the message is set to “welcome” as default settings. The player can edit and register the room name and the message on the detailed-mode setting screen.

In the detailed mode, the player can arbitrarily set the aforementioned holding conditions. In detail, the player can set the number of participants to any of 11 people to 18 people. The player can also select the start time from a 30-minutes-later option, a 1-hour-later option, a 3-hours-later option, a 6-hours-later option, a 12-hours-later option, and a 24-hours-later option. The player can also select the allow/disallow watching item from an “allow” option and a “disallow” option. If the “disallow” option is selected, a third person is not allowed to watch and view the race. The player can also select the private slot item within a range between zero and the previously-selected number of participants.

In the detailed mode, the player can arbitrarily set the aforementioned race conditions. In detail, the player can set the season to any of a random option, spring, summer, autumn, and winter. If the random option is selected, the season is set randomly by lottery at the start of the race, similarly to the simple mode.

The player can set the weather and state to any of a random option and 12 patterns shown in the drawing. If the random option is selected, the weather and state are set randomly by lottery at the start of the race, similarly to the simple mode.

The player can set the spirit to any of a random option and five patterns shown in the drawing. If the random option is selected, the spirit is set randomly by lottery at the start of the race, similarly to the simple mode. If any of the patterns other than the random option is set, the spirit of all of the participating characters is uniformly set to the selected spirit.

The player can select the raising rank of each character that can participate in the held race. In this case, the raising rank of the participable character is set to any of the options shown in the drawings.

As described above, when various settings are completed on the simple-mode setting screen or the detailed-mode setting screen, a room-match participating-character selection screen 610 is displayed on the display 26. On the room-match participating-character selection screen 610, the host player can select a raised character that is to participate in the held race.

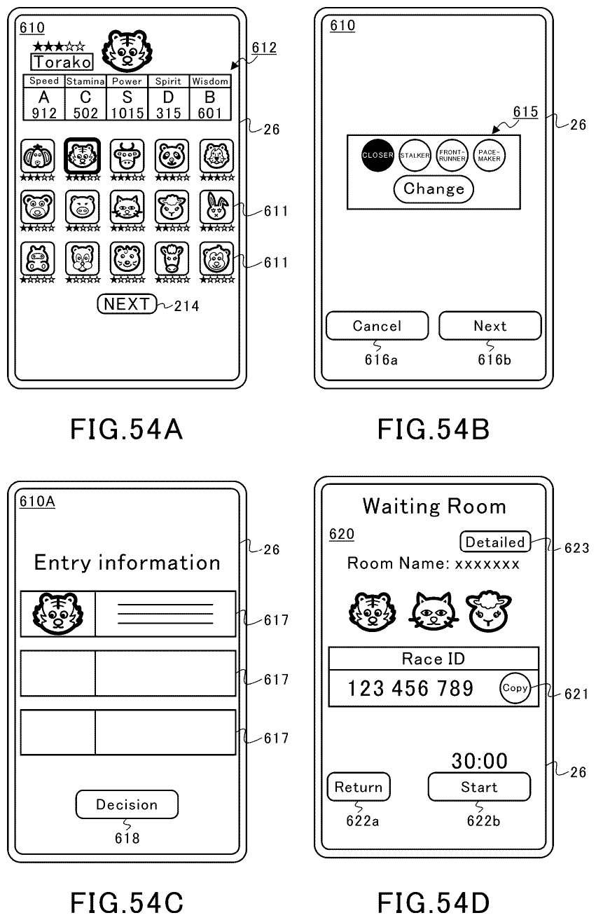

FIG. 54A illustrates the room-match participating-character selection screen 610. As shown in FIG. 54A, the room-match participating-character selection screen 610 displays character icons 611 corresponding to the raised characters raised by the player. When any of the character icons 611 is tapped, the raised character corresponding to the character icon 611 is provisionally selected, and the attribute parameters of the raised character are displayed in an attribute-parameter display field 612. The player can check the attribute parameters displayed in the attribute-parameter display field 612 and select the raised character that is to participate in the held race.

When a selection operation section 613 displayed on the room-match participating-character selection screen 610 is operated in the state where any of the raised characters is provisionally selected, the display 26 displays a strategy selection tab 615.

FIG. 54B illustrates the strategy selection tab 615. In the strategy selection tab 615, the player can set a strategy for the raised character. The lower part of the strategy selection tab 615 displays a cancel operation section 616a and an update operation section 616b. When the cancel operation section 616a is operated, the room-match participating-character selection screen 610 is displayed. When the update operation section 616b is operated, an entry information screen 610A is displayed.

FIG. 54C illustrates the entry information screen 610A. The entry information screen 610A displays participating-character information tabs 617. Each participating-character information tab 617 has information related to a raised character selected by the player. The player can allow a maximum of three raised characters to participate in a single held race. The entry information screen displays three participating-character information tabs 617. In a state where one raised character is selected, the participating-character information tab 617 disposed at the highest location has the information related to the raised character, as shown in FIG. 54C.

When a participating-character information tab 617 not having information related to a raised character is tapped, the room-match participating-character selection screen 610 shown in FIG. 54A is displayed, and a raised character can be added, similarly to the above. The entry information screen 610A is provided with a decision button 618. When the decision button 618 is operated, a registration process for holding a competition race in the room match is completed. Specifically, by operating the decision button 618, the holding conditions and the race conditions for the competition race to be held, the characters that are to participate in the held race, and the tactics of the characters are confirmed.

When the registration process for holding the competition race is completed, a race ID is issued in the server 1000. A race ID is given to each competition race, and a room is created in the server 1000 together with the issuing of the race ID. A room refers to an ID manageable in association with multiple player IDs for executing the room match, a storage area in the server 1000, and data. From the player's perspective, a room may be regarded as a virtual space where characters and players partaking in a competition race gather. In this embodiment, a single competition race is executed in a single room, so that a race ID is regarded as being synonymous with a room ID. When the room is created, the display 26 of the host player holding the competition race displays a waiting room screen 620.

FIG. 54D illustrates the waiting room screen 620 of the host player. As shown in FIG. 54D, the waiting room screen 620 displays the room name set by the host player, the images of the raised characters that are to participate in the competition race, and the race ID. A copy button 621 is provided near the race ID. Although a detailed description will be omitted, when the copy button 621 is operated, the race ID is copied. By copying the race ID, the player can transmit the race ID readily to another player by utilizing functions inside and outside the game application.

The waiting room screen 620 of the host player is also provided with a return operation section 622a and a start operation section 622b. When the return operation section 622a is operated, the screen transitions to a predetermined screen, such as the home screen 100 or the room-match top screen 600.

A remaining time period until the competition race starts is displayed near the start operation section 622b. In the player terminal 1 of the host player, the start operation section 622b is enabled regardless of the remaining time period. When the start operation section 622b is operated, the competition race can start regardless of the remaining time period. More specifically, by operating the start operation section 622b, the host player can derive the race result of the held race without waiting for the start time. When the race result is derived, a race screen is played back and displayed on the display 26.

When the entry information tab 601c is operated on the room-match top screen 600 shown in FIG. 51A, a list of entered competition races is displayed. The waiting room screen 620 is displayed again by tapping on any of the displayed competition races. Therefore, after registering that the competition race is to be held, the host player can execute the held race at an arbitrary timing while observing, for example, the degree of participation by other players.

The waiting room screen 620 is provided with a detailed display button 623. When the detailed display button 623 is operated, a race details screen 630 is displayed on the display 26.

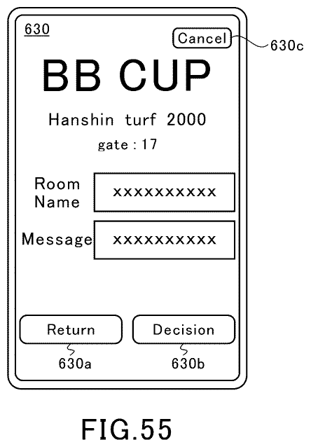

FIG. 55 illustrates the race details screen 630. The race details screen 630 displayed on the player terminal 1 of the host player displays, for example, the holding conditions and the race conditions for the competition race. On the race details screen 630, the host player can edit a room name and a message. Specifically, the host player can change the room name and the message of the held race in an ex-post fashion on the race details screen 630. Although the host player cannot change the holding conditions and the race conditions in an ex-post fashion in this case, the host player may alternatively be capable of changing either of or both of the holding conditions and the race conditions in an ex-post fashion.

The race details screen 630 is provided with a return operation section 630a, a decision operation section 630b, and a cancel operation section 630c. When the return operation section 630a is operated, the screen transitions to a predetermined screen, such as the waiting room screen 620 or the room-match top screen 600. The decision operation section 630b is enabled when a room name or a message is input. When the decision operation section 630b is operated, the changed room name or message is registered.

By operating the cancel operation section 630c, the host player can cancel the held race. However, the held race can only be cancelled until 15 minutes prior to the start thereof. Therefore, if the time remaining until the start of the held race is 15 minutes or longer, the cancel operation section 630c is enabled. When the remaining time period is shorter than 15 minutes, the cancel operation section 630c is disabled.

Accordingly, when the race ID is issued and the holding of the competition race is reserved, reception for participation of other players starts. The following description relates to an operation performed when one partakes as a guest player in a competition race held by another player.

The join tab 601b on the room-match top screen 600 shown in FIG. 51A is an operation section used for partaking in a competition race held by another player. When the join tab 601b is operated, a room search screen 640 is displayed.

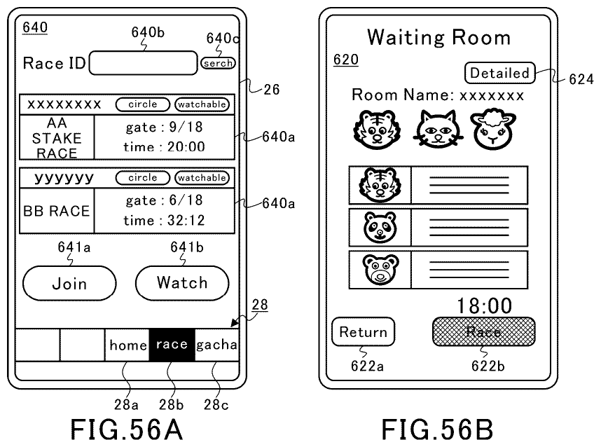

FIG. 56A illustrates the room search screen 640. The room search screen 640 displays a list of a predetermined number of randomly-extracted rooms, that is, a list of participable competition races that are planned to be held. In detail, the room search screen 640 displays a competition-race information interface 640a corresponding to a competition race extracted in accordance with a search. The competition-race information interface 640a displays various information, such as a room name, information indicating whether or not a private slot is set, an allow/disallow watching item, the race category, the number of registered current characters relative to the number of participants, and the time remaining until the start of the competition race.

The room search screen 640 is also provided with an input field 640b where a race ID is inputtable, and a search start button 640c. When the search start button 640c is operated after a race ID is input to the input field 640b, the competition-race information interface 640a corresponding to the input race ID is displayed. If the search start button 640c is operated without a race ID being input to the input field 640b, a search-condition input screen (not shown) is displayed. The search-condition input screen allows for an input of search conditions and a search for a competition race matching the search conditions.

For example, when the competition-race information interface 640a is long-pressed on the room search screen 640, detailed information about the relevant competition race is displayed. When the competition-race information interface 640a is tapped, the relevant competition race becomes selectable.

The room search screen 640 is provided with a reserve-participation operation section 641a and a reserve-watching operation section 641b. When the reserve-participation operation section 641a is operated in a state where any of the competition races is selected, a registration process for allowing a character to participate as a guest player in the selected competition race commences.

The registration process for allowing a character to participate as a guest player is similar to the registration process performed by the host player for holding a competition race in that the room-match participating-character selection screen 610 shown in FIG. 54A, the strategy selection tab 615 shown in FIG. 54B, and the entry information screen 610A shown in FIG. 54C are displayed. Similar to the host player, the guest player can set a character that is to participate in a competition race, as well as tactics. When the decision button 618 is operated on the entry information screen 610A, the registration process for participation as a guest player is completed, and the waiting room screen 620 of the guest player is displayed.

FIG. 56B illustrates the waiting room screen 620 of the guest player. As shown in FIG. 56B, the waiting room screen 620 of the guest player displays, for example, information related to the room name and the character planned to participate in the competition race set by the guest player. The waiting room screen 620 of the guest player is also provided with the return operation section 622a and the start operation section 622b. When the return operation section 622a is operated, the screen transitions to a predetermined screen, such as the home screen 100 or the room-match top screen 600.

The time remaining until the start of the competition race is displayed near the start operation section 622b. In the player terminal 1 of the guest player, the start operation section 622b is disabled until the start time is reached. When the start time is reached, the start operation section 622b is enabled. When the enabled start operation section 622b is operated, the race screen of the competition race is displayed.

The waiting room screen 620 of the guest player is provided with a detailed display button 624. When the detailed display button 624 is operated, the screen transitions to the race details screen 630 displaying detailed information about the competition race. On the race details screen 630 displayed on the player terminal 1 of the guest player, it is possible to cancel the participation in the competition race. Although a detailed description will be omitted, the guest player can only cancel the participation in the competition race until 15 minutes prior to the start of the competition race. Alternatively, the guest player may be capable of cancelling the participation in the competition race regardless of the remaining time period.

When the reserve-watching operation section 641b is operated in a state where any of the competition races is selected, the watching of the selected competition race is reserved. When the watching is reserved, for example, information related to characters planned to participate in the race is displayed on the waiting room screen 620. In this case, the start operation section 622b is provided on the waiting room screen 620, and the race screen becomes viewable when the start time is reached. Furthermore, the guest player can cancel the watching via the waiting room screen 620.

Accordingly, in this embodiment, it is possible to allow raised characters to participate in a competition race performed between multiple players or watch the competition race in accordance with room matching.

### (Daily Race)

In this embodiment, a daily race is provided as a race in which a raised character raised by a player can participate. An objective of a daily race is to cause a raised character raised by a player to participate in a race and acquire a predetermined reward. A daily race can be executed by consuming a daily ticket. A predetermined number (e.g., three) of daily tickets are distributed to a player every day. Therefore, a player can execute daily races for the number of distributed daily tickets.

A player can buy a daily ticket by consuming in-game currency. By buying daily tickets, the player can execute daily races larger in number than the number of daily tickets distributed per day.

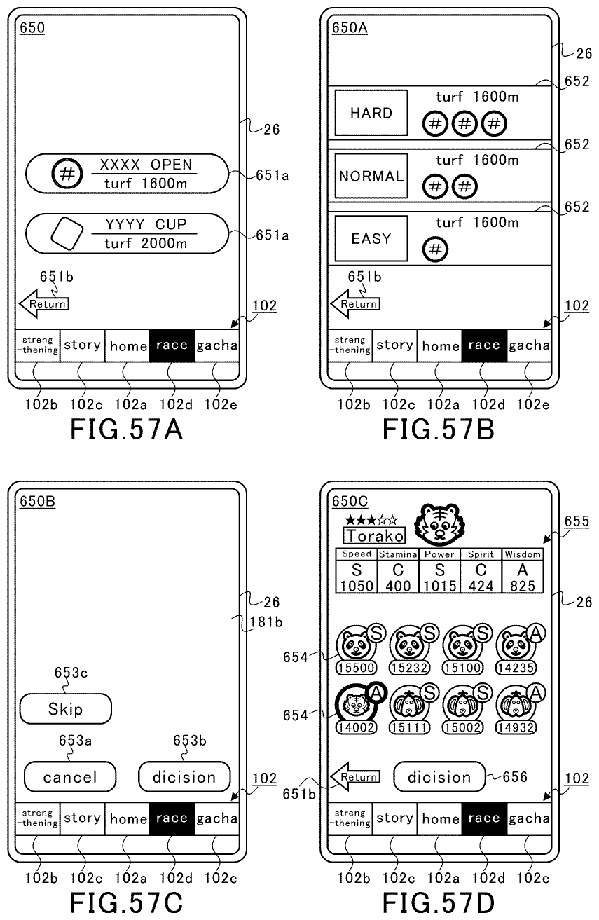

FIG. 57A illustrates a daily race screen 650. When the daily-race selection operation section 401c is tapped on the race-game selection screen 400 shown in FIG. 42A, the daily race screen 650 is displayed. The daily race screen 650 displays daily-race selection fields 651a. In this case, a total of two race categories, namely, a first daily race and a second daily race, are offered as daily races, and the daily-race selection fields 651a are displayed for the respective race categories.

The first daily race and the second daily race are different from each other in terms of rewards acquirable by the player. Each daily-race selection field 651a indicates an icon indicating a reward acquirable from the corresponding daily race. The daily-race selection field 651a also indicates the race name, the racetrack, and the distance. The daily race screen 650 is provided with a return operation section 651b. When the return operation section 651b is tapped, the race-game selection screen 400 is displayed.

The first daily race and the second daily race share the same daily tickets. Therefore, the player can select the first daily race or the second daily race within the range of daily tickets owned by the player. Alternatively, dedicated tickets may be provided individually for the first daily race and the second daily race.

FIG. 57B illustrates a difficulty-level selection screen 650A. When any of the daily-race selection fields 651a is tapped, the difficulty-level selection screen 650A shown in FIG. 57B is displayed. The difficulty-level selection screen 650A displays three difficulty-level selection fields 652. The first daily race and the second daily race are each provided with three difficulty levels, namely, hard, normal, and easy levels. The three difficulty-level selection fields 652 respectively correspond to the hard, normal, and easy levels.

The player can select a single raised character and make the raised character participate in a daily race. In this case, the higher the finished place of the raised character of the player, the greater the amount of reward acquirable by the player. Moreover, the higher the difficulty level of the selected daily race, the greater the amount of reward acquirable by the player. When any of the difficulty-level selection fields 652 is tapped, a play-mode selection screen 650B is displayed.

FIG. 57C illustrates the play-mode selection screen 650B. The play-mode selection screen 650B is provided with a cancel operation section 653a, a decision operation section 653b, and a skip operation section 653c. When the cancel operation section 653a is tapped, the difficulty-level selection screen 650A shown in FIG. 57B is displayed.

Each daily race is provided with a normal mode and a skip mode as play modes. When the decision operation section 653b is tapped, the daily race is executed in the normal mode. When the skip operation section 653c is tapped, the daily race is executed in the skip mode. The normal mode is a play mode involving executing the daily race one-by-one. When the normal mode is selected, a race video with respect to a single daily race can be played back, or a race result alone can be displayed without playing back the race video.

In contrast, the skip mode is a play mode involving executing one daily race or collectively executing multiple daily races. In the skip mode, a race video cannot be played back, and race results of multiple daily races are displayed. When the decision operation section 653b or the skip operation section 653c is tapped, a daily-race participating-character selection screen 650C shown in FIG. 57D is displayed.

FIG. 57D illustrates the daily-race participating-character selection screen 650C. The daily-race participating-character selection screen 650C displays character icons 654 corresponding to raised characters raised by the player. When any of the character icons 654 is tapped, the raised character corresponding to the character icon 654 is provisionally selected, and the attribute parameters of the raised character are displayed in an attribute-parameter display field 655. The player can check the attribute parameters displayed in the attribute-parameter display field 655 and select the raised character that is to participate in the daily race.

When a selection operation section 656 displayed on the daily-race participating-character selection screen 650C is operated in the state where any of the raised characters is provisionally selected, the screen transitions as follows depending on the selected play mode. In detail, when the selection operation section 656 is operated in a state where the normal mode is selected, an item selection screen (not shown) is displayed. On this item selection screen, an item to be used in the daily race can be selected. According to this item, for example, the parameters of the player's raised character that is to participate in the daily race can be enhanced. When a predetermined operation is subsequently performed on the item selection screen, the player can select whether to play back a race video or to display a race result. In contrast, when the selection operation section 656 is operated in a state where the skip mode is selected, a skip setting screen 660 is displayed.

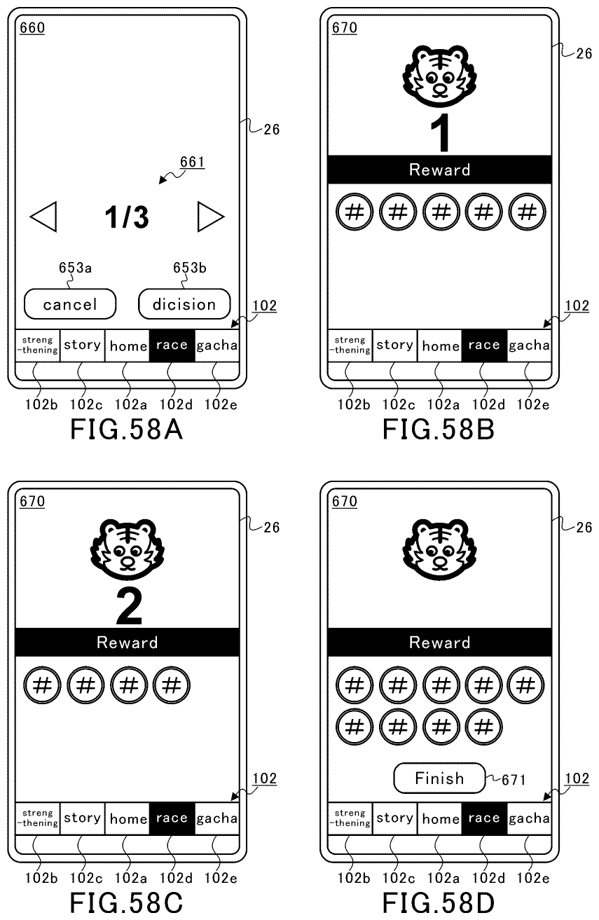

FIG. 58A illustrates the skip setting screen 660. The skip setting screen 660 is provided with a number-of-skips input interface 661. The number-of-skips input interface 661 displays a numerical value with the number of daily tickets owned by the player as a denominator and the number of skips as a numerator. By tapping on the right side of the numerical value on the number-of-skips input interface 661, the number of skips can be increased. By tapping on the left side of the numerical value, the number of skips can be decreased.

The skip setting screen 660 displays the cancel operation section 653a and the decision operation section 653b. When the cancel operation section 653a is tapped, the daily-race participating-character selection screen 650C is displayed. When the decision operation section 653b is tapped, a skip-result display screen 670 is displayed.

FIG. 58B is a first diagram illustrating the skip-result display screen 670. FIG. 58C is a second diagram illustrating the skip-result display screen 670. FIG. 58D is a third diagram illustrating the skip-result display screen 670. The skip-result display screen 670 displays the race result of a first daily race. The finished place is displayed below the character image of the raised character that has participated in the daily race. The skip-result display screen 670 also displays a reward acquired from the current daily race.

When an operation is input to the skip-result display screen 670 in the state shown in FIG. 58B, the race result of a second daily race is displayed on the skip-result display screen 670, as shown in FIG. 58C. Accordingly, the skip-result display screen 670 sequentially displays the race results of multiple daily races. When the race results are displayed for the number of skips, a list of rewards acquired from all the executed daily races is displayed, as shown in FIG. 58D. In this case, the skip-result display screen 670 displays a finish operation section 671. When the finish operation section 671 is tapped, the screen transitions to a predetermined screen, such as the difficulty-level selection screen 650A.

In this embodiment, a race event is held on an irregular basis. While the race event is being held, the race-event selection operation section 401d is enabled on the race-game selection screen 400 shown in FIG. 42A. By tapping on the race-event selection operation section 401d, the player can play the race event.

Although the contents of the race event vary, for example, the player can cause a raised character to participate in a legend race as a race event. In the legend race, a single NPC that is more enhanced than an NPC participating in a daily race at the hard level is set. By obtaining first place in the legend race, the player can acquire a predetermined reward.

Similar to a daily race, when the race event is being held, dedicated tickets for the legend race are distributed. The player can play the legend race by using the distributed dedicated ticket. Since the basic race contents are similar to those of a daily race, a detailed description thereof will be omitted here.

Next, the functional configurations of the player terminal 1 and the server 1000 for executing the raising game and the team competition game described above will be described.

### (Function Configuration of Player Terminal 1)

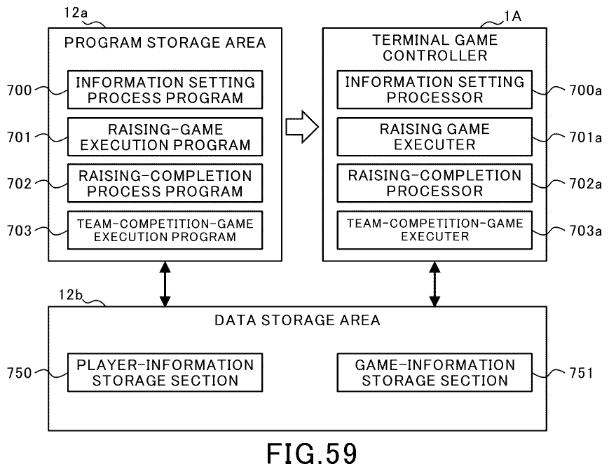

FIG. 59 illustrates the configuration of the memory 12 in the player terminal 1 and the function thereof as a computer. The memory 12 is provided with a program storage area 12a and a data storage area 12b. When a game starts, the CPU 10 stores a terminal game control program (module) in the program storage area 12a.

The terminal game control program includes an information setting process program 700, a raising-game execution program 701, a raising-completion process program 702, and a team-competition-game execution program 703. The programs listed in FIG. 59 are examples, and the terminal game control program may be provided with other multiple programs.

The data storage area 12b is provided with a player-information storage section 750 and a game-information storage section 751 as storage sections for storing data. The data storage area 12b is provided with other multiple storage sections. In this case, information directly related to a game (referred to as “game information” hereinafter), such as the raising game and the team competition game, is stored in the game-information storage section 751.

Various types of information during the progress of each game, such as the raising game, are also provisionally stored in the game-information storage section 751. Therefore, all pieces of information related to a raised character raised in the raising game are stored in the game-information storage section 751. Furthermore, for example, all pieces of information other than the game information, such as information related to the player or another player and setting information about the player terminal 1, are defined as player information. The player information is stored in the player-information storage section 750.

The CPU 10 activates each program stored in the program storage area 12a and updates the data in each storage section of the data storage area 12b. By activating each program stored in the program storage area 12a, the CPU 10 causes the player terminal 1 (computer) to function as a terminal game controller 1A. The terminal game controller 1A includes an information setting processor 700a, a raising game executer 701a, a raising-completion processor 702a, and a team-competition-game executer 703a.

In detail, the CPU 10 activates the information setting process program 700 to cause the computer to function as the information setting processor 700a. Likewise, the CPU 10 activates the raising-game execution program 701, the raising-completion process program 702, and the team-competition-game execution program 703 to cause the computer to function as the raising game executer 701a, the raising-completion processor 702a, and the team-competition-game executer 703a, respectively.

When various types of information are set in the player terminal 1, the information setting processor 700a stores the setting-related information as player information in the player-information storage section 750. When information in the player-information storage section 750 is updated, the information setting processor 700a transmits the updated information to the server 1000.

The raising game executer 701a executes all processes related to the raising game. In detail, the raising game executer 701a executes the preparation stage process and the raising stage process.

Upon completion of the raising game, the raising-completion processor 702a stores the raised character information including the attribute parameters of the raised character, the aptitude parameters, the acquired skills, the inheritance information, the factor information, and the type of character used in the raising.

The team-competition-game executer 703a executes a process allowing the player to organize a team and displays various types of screens in the team competition game.

### (Function Configuration of Server 1000)

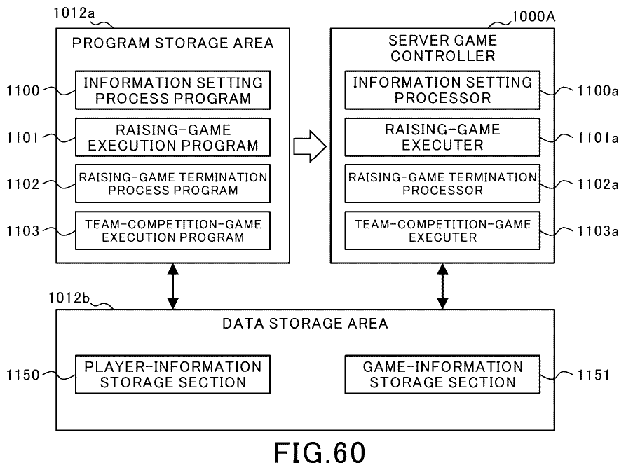

FIG. 60 illustrates the configuration of the memory 1012 in the server 1000 and the function thereof as a computer. The memory 1012 is provided with a program storage area 1012a and a data storage area 1012b. When a game starts, the CPU 1010 stores a server game control program (module) in the program storage area 1012a.

The server game control program includes an information setting process program 1100, a raising-game execution program 1101, a raising-game termination process program 1102, and a team-competition-game execution program 1103. The programs listed in FIG. 60 are examples, and the server game control program may be provided with other multiple programs.

The data storage area 1012b is provided with a player-information storage section 1150 and a game-information storage section 1151 as storage sections for storing data. The data storage area 1012b is provided with other multiple storage sections. In this case, game information about all the players is stored in the game-information storage section 1151 in association with the player IDs. Moreover, player information about all the players is stored in the player-information storage section 1150 in association with the player IDs.

The CPU 1010 activates each program stored in the program storage area 1012a and updates the data in each storage section of the data storage area 1012b. By activating each program stored in the program storage area 1012a, the CPU 1010 causes the server 1000 (computer) to function as a server game controller 1000A. The server game controller 1000A includes an information setting processor 1100a, a raising-game executer 1101a, a raising-game termination processor 1102a, and a team-competition-game executer 1103a.

In detail, the CPU 1010 activates the information setting process program 1100 to cause the computer to function as the information setting processor 1100a. Likewise, the CPU 1010 activates the raising-game execution program 1101, the raising-game termination process program 1102, and the team-competition-game execution program 1103 to cause the computer to function as the raising-game executer 1101a, the raising-game termination processor 1102a, and the team-competition-game executer 1103a, respectively.

When various types of information are set in the player terminal 1, the information setting processor 1100a updates the player information in the player-information storage section 1150 based on update information received from the player terminal 1. Moreover, the information setting processor 1100a measures the time and updates the game point of each player.

The raising-game executer 1101a executes all processes related to the raising game.

When the raising game ends, the raising-game termination processor 1102a derives the score and the raising rank of the raised character. The raising-game termination processor 1102a determines factors to be acquired by the raised character by lottery. Then, the raised character information including the attribute parameters of the raised character, the aptitude parameters, the acquired skills, the inheritance information, the factor information, and the type of character used in the raising is stored in the game-information storage section 1151 in association with the player ID.

The team-competition-game executer 1103a simulates a race result of each race in the team competition game, so as to derive a race-by-race win-loss result and a team's win-loss result as race results. The team-competition-game executer 1103a calculates the race points of each registered character, as well as the race points of each race and the team's overall race points.

Although the information setting processor 700a in the player terminal 1 and the information setting processor 1100a in the server 1000 are similar to each other in that they both store player information, they differ from each other in terms of detailed processing contents and the range of player information to be stored. Although the raising game executer 701a in the player terminal 1 and the raising-game executer 1101a in the server 1000 are similar to each other in that they both execute processing related to the raising game, the two have different roles, that is, the two are responsible for different jobs.

The processes carried out by the functional units in the player terminal 1 and the server 1000 described above will be described below by using flowcharts.

### (Processing By Player Terminal 1 and Server 1000) (Raising-Game-Related Process)

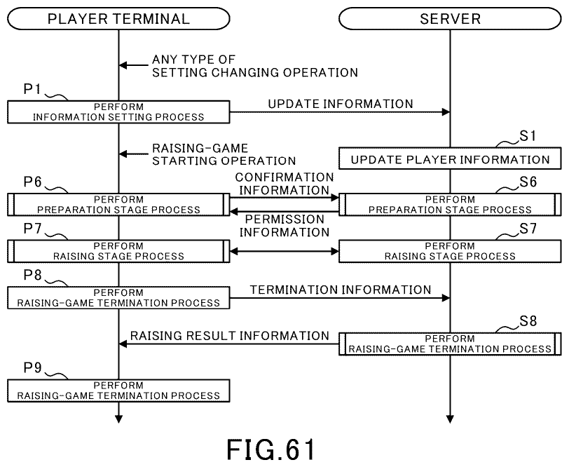

FIG. 61 is a sequence diagram illustrating the processing by the player terminal 1 and the server 1000 involved with the raising game. In the following description, a process in the player terminal 1 will be indicated as Pn (n being an arbitrary integer). A process in the server 1000 will be indicated as Sn (n being an arbitrary integer).

When the player performs any type of setting changing operation on the player terminal 1, the information setting processor 700a of the player terminal 1 performs an information setting process (P1) for updating the player-information storage section 750 based on the operation input by the player. This information setting process involves transmitting update information to the server 1000. When the server 1000 receives the update information, the information setting processor 1100a updates the player information in the player-information storage section 1150 (S1).

An example of the player information updated in P1 and S1 is profile information settable by the player. Furthermore, for example, when an operation for adding another player as a friend or an operation for removing a friend is input as the setting changing operation, friend information as friend-related information is updated. In P1 and S1, the information setting processor 700a and the information setting processor 1100a individually manage game points to be consumed for executing the raising game. If the game points are below an upper limit value, each of the information setting processors 700a and 1100a measures the time and adds a predetermined value of game points to the player at predetermined intervals.

When a raising-game starting operation for starting the raising game is input to the player terminal 1, the raising game executer 701a executes a preparation stage process (P6). During this preparation stage process, a communication process is performed between the player terminal 1 and the server 1000. In the server 1000, the raising-game executer 1101a executes a preparation stage process (S6) based on information received from the player terminal 1.

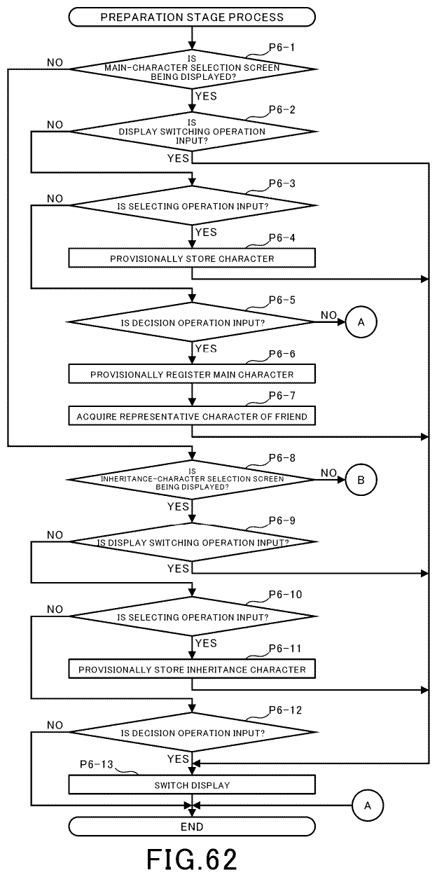

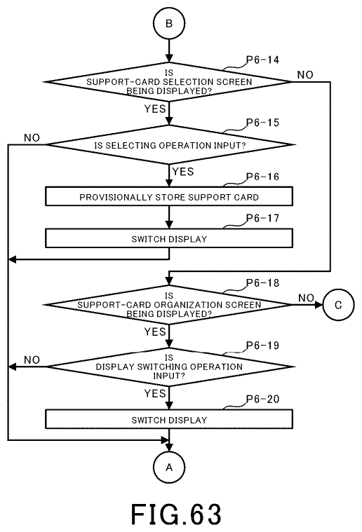

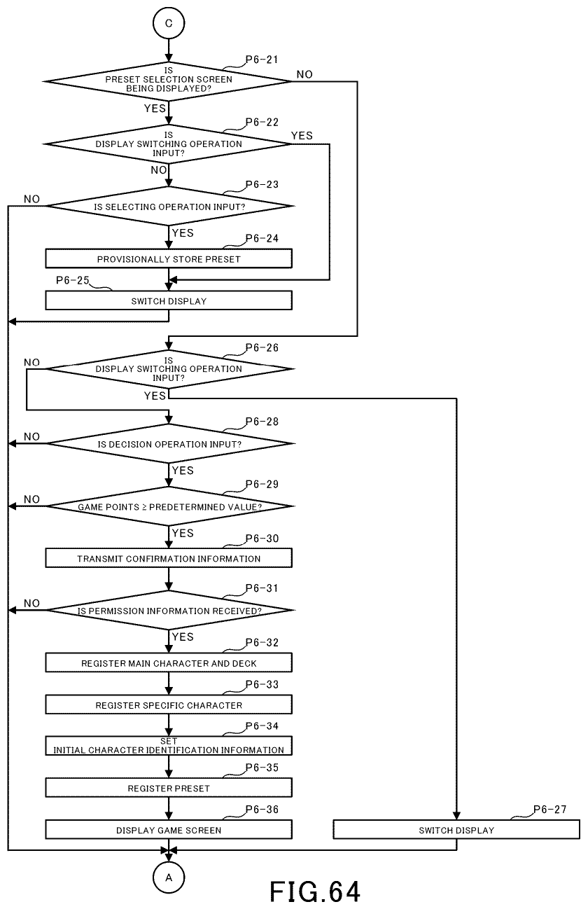

FIG. 62 is a first flowchart illustrating the preparation stage process (P6) in the player terminal 1. FIG. 63 is a second flowchart illustrating the preparation stage process (P6) in the player terminal 1. FIG. 64 is a third flowchart illustrating the preparation stage process (P6) in the player terminal 1. The raising game executer 701a of the player terminal 1 determines whether the main-character selection screen 150 is being displayed on the display 26 (P6-1).

If the main-character selection screen 150 is being displayed (YES in P6-1) and a display switching operation for switching the display on the screen is input (YES in P6-2), the raising game executer 701a switches the display screen on the display 26 (P6-13).

When a selecting operation is input (i.e., any of the character icons 151 is tapped) on the main-character selection screen 150 (YES in P6-3), the raising game executer 701a provisionally stores the character corresponding to the character icon 151 to which the selecting operation has been input (P6-4), and switches the display screen (P6-13).

When a decision operation is input (i.e., the next operation section 154 is tapped) on the main-character selection screen 150 (YES in P6-5), the raising game executer 701a provisionally registers the character provisionally stored in P6-4 above as the main character (P6-6). Furthermore, the raising game executer 701a acquires, from the server 1000, information related to a representative character, such as a representative character of a friend (P6-7), extracted in accordance with the predetermined extraction condition, and switches the display screen (P6-13).

If the inheritance-character selection screen 170 or the raised-character-list screen 180 is being displayed (YES in P6-8) and the display switching operation for switching the display of the screen is input (YES in P6-9), the raising game executer 701a switches the display screen of the display 26 (P6-13).

The display switching operation on the inheritance-character selection screen 170 or the raised-character-list screen 180 includes tapping on the skill display button 172 shown in FIG. 10B, long-pressing of any of the raised character icons 182, and tapping on the second-name change button 186a, the memo input button 186b, the skill display tab 188a, the inheritance-information display tab 188b, the raising-information display tab 188c, or the close operation section 188d in the character details dialog 185A shown in FIG. 15.

For example, if the skill display button 172 is tapped on the raised-character-list screen 180, the raising game executer 701a displays the skill display dialog 185B in P6-13. If any of the raised character icons 182 is long-pressed on the raised-character-list screen 180, the raising game executer 701a displays the character details dialog 185A in P6-13. If any of the second-name change button 186a, the memo input button 186b, the skill display tab 188a, the inheritance-information display tab 188b, the raising-information display tab 188c, or the close operation section 188d is tapped on the character details dialog 185A, the screen is switched to the one corresponding to the relevant operation section.

When a selecting operation is input (i.e., any of the raised character icons 182 is tapped) on the raised-character-list screen 180 (YES in P6-10), the raising game executer 701a provisionally stores the character corresponding to the raised character icon 182 to which the selecting operation has been input (P6-11), and switches the display screen (P6-13).

When a decision operation is input (i.e., the next operation section 154 is tapped) on the inheritance-character selection screen 170 (YES in P6-12), the raising game executer 701a displays the support-card organization screen 190 on the display 26 (P6-13).

When the support-card selection screen 200 is being displayed (YES in P6-14 in FIG. 63) and a selecting operation is input (i.e., any of the card icons 201 of the support cards is tapped) on the support-card selection screen 200 (YES in P6-15), the raising game executer 701a provisionally stores the support card corresponding to the card icon 201 on which the selecting operation has been performed (P6-16), and switches the display screen (P6-17).

If the support-card organization screen 190 is being displayed (YES in P6-18) and the display switching operation for switching the display of the screen is input (YES in P6-19), the raising game executer 701a switches the display screen of the display 26 (P6-20).

If the preset selection screen 205A is being displayed (YES in P6-21 in FIG. 64) and the display switching operation for switching the display of the screen is input (YES in P6-22), the raising game executer 701a switches the display screen of the display 26 (P6-25).

If a selecting operation is input (i.e., the select operation section 206c is tapped) on the preset selection screen 205A (YES in P6-23), the raising game executer 701a provisionally stores reservation selection information corresponding to the preset to which the selecting operation has been input (P6-24), and switches the display screen (P6-25).

If the final confirmation screen 205 is being displayed (NO in P6-21) and the display switching operation for switching the display of the screen is input (YES in P6-26), the raising game executer 701a switches the display screen of the display 26 (P6-27).

When a decision operation is input (i.e., the start operation section 205b is tapped) on the final confirmation screen 205 (YES in P6-28), the raising game executer 701a determines whether the game points are higher than or equal to a predetermined value (e.g., 30) (P6-29). If the game points are higher than or equal to the predetermined value (YES in P6-29), the raising game executer 701a transmits confirmation information to the server 1000 (P6-30).

The confirmation information includes information for identifying a provisionally-registered main character, inheritance characters, and support cards. Upon receiving the confirmation information, the server 1000 determines in the preparation stage process (S6) whether to permit execution of a main raising game using the provisionally-registered main character, inheritance characters, and support cards.

When the player terminal 1 having transmitted the confirmation information (P6-30) subsequently receives permission information (YES in P6-31), the raising game executer 701a registers the main character provisionally registered in P6-6 above (P6-32). Moreover, the raising game executer 701a registers the raised characters provisionally stored as inheritance characters in P6-11 above and the support cards provisionally stored in P6-16 above in a deck.

Furthermore, the raising game executer 701a registers the character ID of a character set as a specific character based on specific character information (P6-33). The raising game executer 701a sets initial character identification information (P6-34). The raising game executer 701a registers the reservation selection information of the preset provisionally stored in P6-24 above (P6-35). The raising game executer 701a displays the game screen 210 on the display 26 (P6-36).

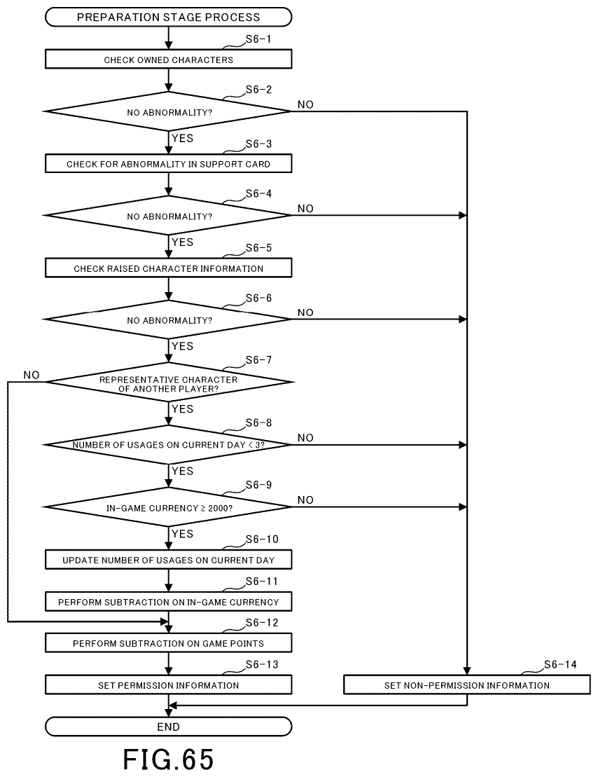

FIG. 65 is a flowchart illustrating the preparation stage process (S6) in the server 1000. Upon receiving the confirmation information, the raising-game executer 1101a checks player's owned characters stored in the player-information storage section 1150 (S6-1). If the main character selected by the player is included in the owned characters, the raising-game executer 1101a determines that there is no abnormality (S6-2).

If there is no abnormality in the main character selected by the player (YES in S6-2), the raising-game executer 1101a checks whether there is no abnormality in the support card selected by the player (S6-3). In S6-3, it is determined that there is an abnormality if a support card not owned by the player is selected, if a rental card selected by the player is not associated with the player ID of the player, or if a support character is redundant with the main character.

If there is no abnormality in the support card selected by the player (YES in S6-4), the raising-game executer 1101a checks the raised character information stored in the game-information storage section 1151 (S6-5). Then, if the raised character selected as an inheritance character by the player is associated with the player ID of the player, that is, if a raised character raised by the player is selected as an inheritance character, the raising-game executer 1101a determines that there is no abnormality in the inheritance character (YES in S6-6).

When it is determined that there is no abnormality in the inheritance character, the raising-game executer 1101a determines whether the raised character selected as an inheritance character by the player includes a representative character of another player (S6-7). If a representative character of another player is included (YES in S6-7), the raising-game executer 1101a determines whether the number of usages on the current day is fewer than three (S6-8).

If the number of usages on the current day is fewer than three (YES in S6-8), the raising-game executer 1101a determines whether the predetermined in-game currency owned by the player is 2000 or more (S6-9). Specifically, in S6-8 and S6-9, it is determined whether an organizing condition is satisfied. If the in-game currency owned by the player is 2000 or more (YES in S6-9), the raising-game executer 1101a adds “1” to the number of current-day usages (S6-10). Moreover, the raising-game executer 1101a subtracts 2000 from the owned number of predetermined in-game currency stored in the player-information storage section 1150 (S6-11).

Furthermore, the raising-game executer 1101a subtracts a predetermined value (e.g., 30) from the game points of the player (S6-12). Then, if there is no abnormality in the main character, inheritance character, and support card and if the organizing condition for using the representative character of another player is satisfied, the raising-game executer 1101a sets permission information (S6-13) and causes the player terminal 1 to receive the permission information. In contrast, if there is an abnormality in any of the main character, inheritance character, and support card or if the organizing condition for using the representative character of another player is not satisfied, the raising-game executer 1101a sets non-permission information (S6-14) and causes the player terminal 1 to receive the non-permission information.

Referring back to FIG. 61, when the preparation stage process (P6) ends, the raising game executer 701a executes a raising stage process (P7). During this raising stage process, a communication process is performed between the player terminal 1 and the server 1000. In the server 1000, the raising-game executer 1101a executes a raising stage process (S7) based on information received from the player terminal 1. In actuality, the roles are shared between the player terminal 1 and the server 1000, and the main raising game progresses in the raising stage process (P7) at the player terminal 1 and in the raising stage process (S7) at the server 1000. However, it will be described here assuming that all the processes are carried out in the raising stage process (P7) at the player terminal 1 to facilitate the understanding. Alternatively, the processes in the raising stage process (P7) to be described below may partially or entirely be carried out in the raising stage process (S7) at the server 1000.

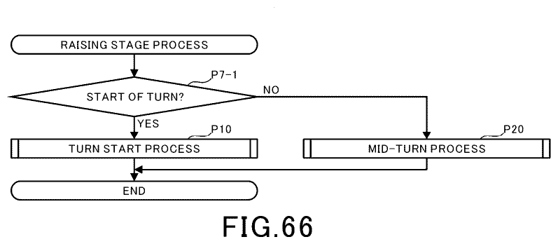

FIG. 66 is a flowchart illustrating the raising stage process in the player terminal 1. The raising game executer 701a of the player terminal 1 executes a turn start process (P10) if at the start of a turn (YES in P7-1), or executes a mid-turn process (P20) if not at the start of a turn.

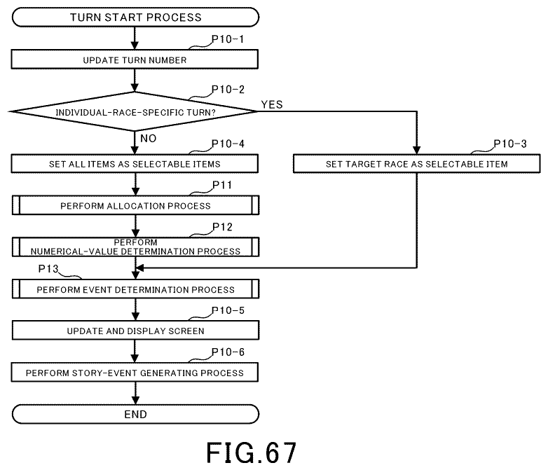

FIG. 67 is a flowchart illustrating the turn start process in the player terminal 1. The raising game executer 701a updates the current turn number stored in the game-information storage section 751 (P10-1). The raising game executer 701a refers to the selection item table (FIG. 24) stored in the data storage area 12b and determines whether the current turn is a turn (individual-race-specific turn) where only an individual race is selectable (P10-2).

If the current turn is an individual-race-specific turn (YES in P10-2), that is, if a race that allows for participation on the relevant turn is set as a target race, the raising game executer 701a sets the target race as a selectable item selectable by the player (P10-3), and causes the process to proceed to P13. Accordingly, the player can only operate the individual-race operation section 219 and the skill operation section 217 on the relevant turn, whereas operations on other operation sections are limited.

If the current turn is not an individual-race-specific turn (NO in P10-2), the raising game executer 701a sets all items as selectable items selectable by the player (P10-4). Then, the raising game executer 701a sequentially executes an allocation process (P11), a numerical-value determination process (P12), and an event determination process (P13).

It is assumed here that the allocation process (P11), the numerical-value determination process (P12), and the event determination process (P13) are executed only in the player terminal 1. Alternatively, the allocation process (P11), the numerical-value determination process (P12), and the event determination process (P13) may partially or entirely be executed in the server 1000. Processes, to be described below, in the allocation process (P11), the numerical-value determination process (P12), and the event determination process (P13) may partially be executed in the server 1000. If the aforementioned processes are to be executed in the server 1000, a process based on information received from the server 1000 is carried out in the player terminal 1.

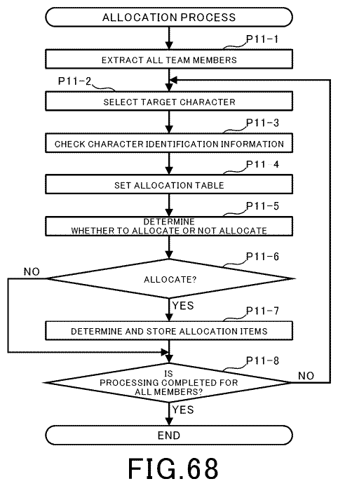

FIG. 68 is a flowchart illustrating the allocation process in the player terminal 1. The raising game executer 701a refers to the character-identification-information table (FIG. 22, FIG. 23) to extract all characters registered as team members (P11-1). Then, from the team members extracted in P11-1, the raising game executer 701a selects a character that has not undergone processes in P11-3 to P11-7 to be described below as a target character on which the processes are to be carried out (P11-2).

The raising game executer 701a refers to the character-identification-information table to check character identification information about the target character selected in P11-2 above (P11-3). The raising game executer 701a sets the allocation table (FIG. 33) based on the character identification information checked in P11-3 above (P11-4). The raising game executer 701a determines whether to “allocate” or “not allocate” by lottery based on the allocation table set in P11-4 above (P11-5).

If determining to “allocate” (YES in P11-6), the raising game executer 701a determines and stores training items to which the target character is to be allocated (P11-7). If the process is not completed for all of the team members extracted in P11-1 above (NO in P11-8), the raising game executer 701a repeats the processing from P11-2 until the process is completed for all of the team members. In contrast, when the process is completed for all of the team members (YES in P11-8), the raising game executer 701a ends the allocation process and executes the numerical-value determination process (P12).

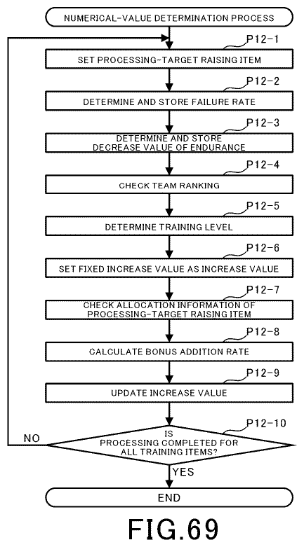

FIG. 69 is a flowchart illustrating the numerical-value determination process in the player terminal 1. The raising game executer 701a sets a processing target item that has not undergone processes in P12-2 to P12-9 to be described below from training items for “Speed”, “Stamina”, “Power”, “Spirit”, and “Wisdom” (P12-1).

With regard to the processing target item set in P12-1, the raising game executer 701a determines and stores a failure rate if training is to be executed based on the current endurance of the main character (P12-2). Moreover, the raising game executer 701a determines and stores a decrease value in the endurance if training is to be executed with regard to the processing target item set in P12-1 (P12-3).

The raising game executer 701a checks the current team ranking (P12-4), and determines a training level by referring to the training level table (FIG. 34A) based on the team ranking (P12-5).

The raising game executer 701a refers to the fixed-increase-value table (FIG. 34B, FIG. 34C) corresponding to the processing target item set in P12-1, and determines and sets a fixed increase value based on the training level determined in P12-5 (P12-6). With regard to the training of the processing target item, the raising game executer 701a checks information (allocation information) about the character for which the allocation is determined in P11 (P12-7).

Then, the raising game executer 701a calculates a bonus addition rate by referring to the bonus-addition-rate table (FIG. 34D) based on the allocation information checked in P12-7 (P12-8). With regard to the training of the processing target item, the raising game executer 701a updates an increase value based on the bonus addition rate calculated in P12-8 (P12-9).

If the processing from P12-2 to P12-9 is not completed for all of the training items (NO in P12-10), the raising game executer 701a repeats the processing from P12-1. In contrast, when the process is completed for all of the training items (YES in P12-10), the raising game executer 701a ends the numerical-value determination process and executes the event determination process (P13).

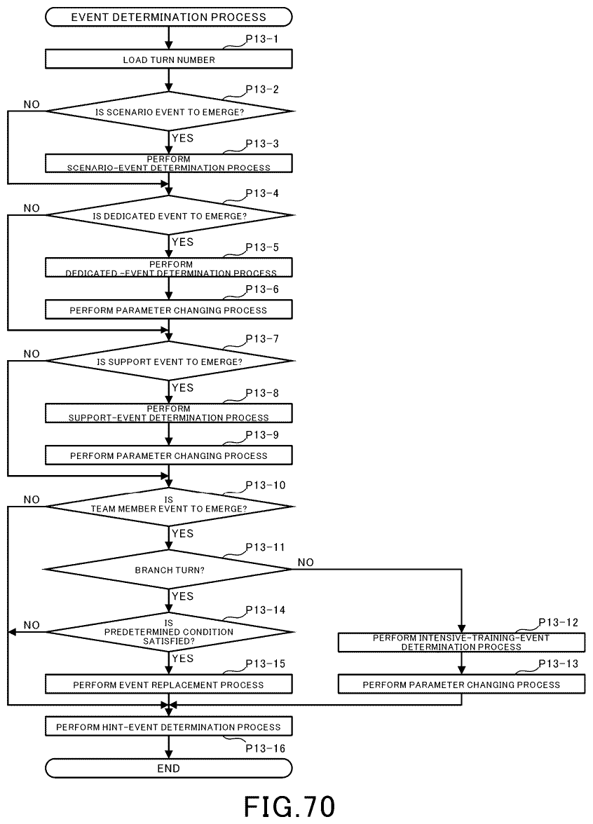

FIG. 70 is a flowchart illustrating the event determination process in the player terminal 1. The raising game executer 701a loads the current turn number (P13-1). The raising game executer 701a refers to the event-emergence determination table stored in the data storage area 12b and determines whether or not to cause a scenario event to emerge (P13-2). If it is determined that a scenario event is to emerge, that is, if a scenario-event emergence turn is reached (YES in P13-2), a detail (event ID) of the scenario event is determined and stored based on the event-detail determination table (P13-3).

In detail, the raising game executer 701a generates a lottery table using the event ID of the scenario event that can emerge based on the event-detail determination table. Then, the raising game executer 701a uses the generated lottery table to determine the detail, that is, the event ID, of the scenario event by lottery. If the determined scenario event is an event, such as an attribute event, which causes a parameter to vary, a variation thereof is determined.

The raising game executer 701a refers to the event-emergence determination table to determine whether or not to cause a dedicated event to emerge (P13-4). If it is determined that a dedicated event is to emerge, that is, if a dedicated-event emergence turn is reached (YES in P13-4), the detail (event ID) of the dedicated event is determined and stored based on the event-detail determination table (P13-5).

In detail, the raising game executer 701a generates a lottery table using the event ID of the dedicated event that can emerge based on the event-detail determination table. Then, the raising game executer 701a uses the generated lottery table to determine the detail, that is, the event ID, of the dedicated event by lottery. If the determined dedicated event is an event, such as an attribute event, which causes a parameter to vary, a variation thereof is determined.

If the main character is a specific character, the raising game executer 701a executes a parameter changing process (P13-6) for changing the variation in the parameter that varies due to the dedicated event. For example, the parameter changing process involves adding or subtracting a predetermined fixed value to or from the variation determined in P13-5, or multiplying the variation by a predetermined multiplying factor. In this case, the variation changes to make the player more advantageous. Accordingly, when the main character is a specific character, the parameter varies more advantageously in accordance with the dedicated event. The raising game executer 701a refers to the event-emergence determination table to determine whether or not to cause a support event to emerge (P13-7). If it is determined that a support event is to emerge, that is, if a support-event emergence turn is reached (YES in P13-7), a detail (event ID) of the support event is determined and stored based on the event-detail determination table (P13-8).

In detail, the raising game executer 701a generates a lottery table using the event ID of the support event that can emerge based on the event-detail determination table. In this case, the selection probability of the support event associated with the registered support card is set to be higher than the selection probability of other support events. Then, the raising game executer 701a uses the generated lottery table to determine the detail, that is, the event ID, of the support event by lottery. If the determined support event is an event, such as an attribute event, which causes a parameter to vary, a variation thereof is determined.

If the main character or a support character associated with the support event is a specific character, the raising game executer 701a executes a parameter changing process (P13-9) for changing the variation in the parameter that varies due to the support event.

The raising game executer 701a refers to the event-emergence determination table to determine whether or not to cause a team member event to emerge (P13-10). If it is determined that a team member event is to emerge, that is, if a team-member-event emergence turn is reached (YES in P13-10), the raising game executer 701a determines whether the current turn is a branch turn (P13-11).

If the current turn is not a branch turn (NO in P13-11), the raising game executer 701a determines and stores an intensive-training event corresponding to the current turn number as an event to emerge based on the event-detail determination table (P13-12). In this case, various increase values related to the intensive-training event are determined.

If the main character or an intensive-training-target character is a specific character, the raising game executer 701a executes a parameter changing process (P13-13) for changing a variation in a parameter that varies due to the intensive-training event.

If the current turn is a branch turn (YES in P13-11), the raising game executer 701a determines whether a predetermined condition is satisfied (P13-14). In this case, as mentioned above, it is determined whether the number of specific characters included in the team members is a predetermined number defined for every turn number. If the predetermined condition is satisfied (YES in step P13-14), the raising game executer 701a replaces the scenario event stored in P13-3 with a specific character event (P13-15). In this case, the specific character event as the replacement may be determined by lottery, or a specific character event preset for every turn may be set.

The raising game executer 701a performs a hint-event determination process related to a hint event for every character allocated to training (P13-16). In this case, it is determined by lottery whether or not to cause a hint event to emerge for every character allocated to training. If a hint event is to emerge, it is determined which of hint events is to emerge.

Referring back to FIG. 67, the raising game executer 701a updates the screen displayed on the display 26 (P10-5). If a story event is to be generated at the start of a turn, the story event is generated from events determined in P13 (P10-6).

Referring back to FIG. 66, if not at the start of a turn (NO in P7-1), the raising game executer 701a executes the mid-turn process (P20).

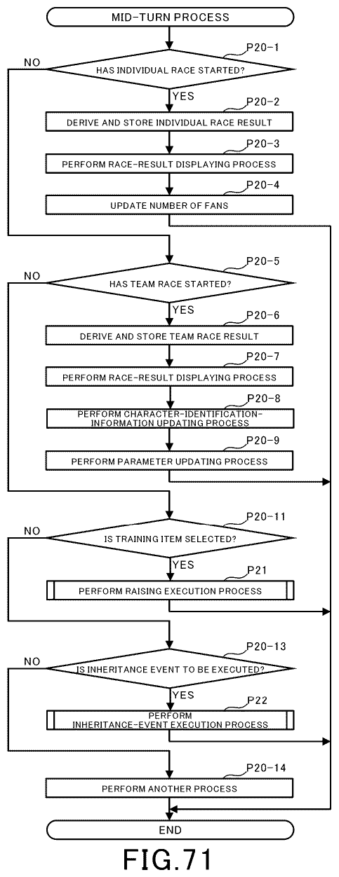

FIG. 71 is a flowchart illustrating the mid-turn process in the player terminal 1. The raising game executer 701a determines whether an individual race has started in response to an operation performed on the result operation section 253 or the race operation section 254 on the individual-race start screen 250 (P20-1). If an individual race has started (YES in P20-1), the raising game executer 701a derives a result of the individual race, and updates and stores the parameters related to the race result in the game-information storage section 751 (P20-2).

In detail, for example, a calculation expression in which weights are assigned to the attribute parameters and the acquired skills of each of NPCs and the main character is preliminarily set, and the ranks in the individual race are determined in accordance with the calculation result. The aforementioned calculation result may be set such as to be different from race to race. Furthermore, for example, the attribute parameters of each NPC may be provided in multiple patterns for each race, and it may be determined which of the attribute parameters is to be used by lottery. Specifically, even if the attribute parameters of the main character, the acquired skills thereof, and the race to participate in by the main character are completely the same, the race result is not necessarily the same. Furthermore, the calculation expression, such as weighting, may be in multiple patterns for each race, and the result may vary depending on the selected calculation expression.

It is assumed here that the individual race result is derived in the player terminal 1. Alternatively, the individual race result may be derived in the server 1000. In this case, request information for deriving the individual race result and information necessary for deriving the individual race result are transmitted from the player terminal 1 to the server 1000. Then, the individual race result derived in the server 1000 may be received by the player terminal 1.

The raising game executer 701a executes a race-result displaying process (P20-3) for displaying the individual-race-result screen 260 or a race video on the display 26 based on the individual race result derived in P20-2.

Based on the race result, the raising game executer 701a derives the number of fans to be newly acquired and adds the number of fans to the number of already-acquired fans (P20-4).

The raising game executer 701a determines whether a team race has started in response to an operation performed on the result operation section 291 or the race operation section 292 on the team-race start screen 290 (P20-5). As a result, the process proceeds to step P20-6 if a team race has started, or the process proceeds to step P20-11 if a team race has not started.

The raising game executer 701a derives a team race result and stores the team race result in the game-information storage section 751 (P20-6). In detail, for example, a calculation expression in which weights are assigned to the attribute parameters and the acquired skills of each of NPCs, the main character, and other team members is preliminarily set, and the ranks in the team race are determined in accordance with the calculation result. The aforementioned calculation result may be set such as to be different from race to race. Furthermore, for example, the attribute parameters of each NPC may be provided in multiple patterns for each race, and it may be determined which of the attribute parameters is to be used by lottery. Specifically, even if the attribute parameters of each of the main character and other team members, the acquired skills thereof, and the race to participate in by each of the main character and other team members are completely the same, the race result is not necessarily the same. Furthermore, the calculation expression, such as weighting, may be in multiple patterns for each race, and the result may vary depending on the selected calculation expression.

It is assumed here that the team race result is derived in the player terminal 1. Alternatively, the team race result may be derived in the server 1000. In this case, request information for deriving the team race result and information necessary for deriving the team race result are transmitted from the player terminal 1 to the server 1000. Then, the team race result derived in the server 1000 may be received by the player terminal 1.

The raising game executer 701a executes a race-result displaying process (P20-7) for displaying the team-race interim-result screen 300, the team-race detailed-result screen 310, and the team-race overall-result screen 320 on the display 26 based on the team race result derived in P20-6 above.

The raising game executer 701a executes a character-identification-information updating process (P20-8). In this case, a predetermined number of characters are extracted from characters currently registered as sub members in accordance with a predetermined condition. Then, character identification information of each extracted character is updated to a team member. In other words, in this embodiment, the number of team members increases every time a team race ends.

The raising game executer 701a executes a parameter updating process for updating information related to the team ranking based on the team race result derived in P20-6 above (P20-9).

If any of the training items is selected (YES in P20-11), the raising game executer 701a carries out a raising execution process (P21). If any of the training items is not selected (NO in P20-11), it is determined whether a timing for executing an inheritance event is reached (P20-13). If the timing for executing an inheritance event is reached (YES in P20-13), the raising game executer 701a carries out an inheritance-event execution process (P22). If the timing for executing an inheritance event is not reached (NO in P20-13), the raising game executer 701a executes another process, such as acquiring a skill by consuming skill points (P20-14).

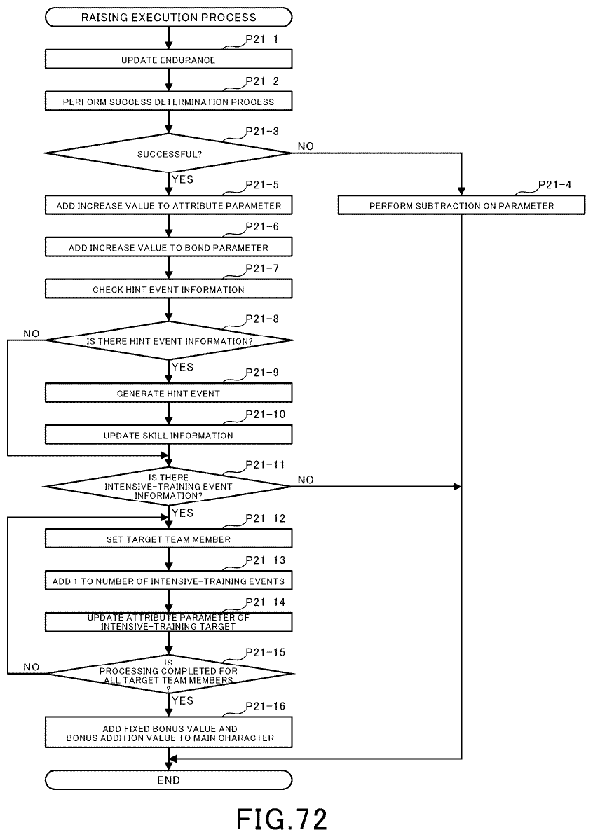

FIG. 72 is a flowchart illustrating the raising execution process in the player terminal 1. With regard to the selected training item, the raising game executer 701a updates the endurance of the main character based on the decrease value in the endurance determined in P12-3 above (P21-1).

With regard to the selected training item, the raising game executer 701a executes a success determination process for determining whether or not the training is successful based on the failure rate determined in P12-2 above (P21-2). If the training has failed (NO in P21-3), the raising game executer 701a performs a subtraction on an attribute parameter by, for example, decreasing the condition based on the failure in the training (P21-4).

In contrast, if the training is successful (YES in P21-3), the raising game executer 701a adds the increase value derived in P12-9 above to the attribute parameter of the main character (P21-5). The raising game executer 701a adds the increase value to the bond parameter value determined in P13-12 and P13-13 (P21-6). The raising game executer 701a checks hint event information stored in the hint-event determination process (P21-7).

If the hint event information is stored with regard to the selected training item (YES in P21-8), the raising game executer 701a causes a hint event to emerge based on the hint event information related to the selected training item (P21-9). If multiple pieces of hint event information are stored with regard to the selected training item, any one of the hint events emerges. The raising game executer 701a updates skill information related to the main character stored in the game-information storage section 751 based on the hint event information emerged in P21-9 (P21-10).

If intensive-training event information is stored with regard to the selected training item (YES in P21-11), the raising game executer 701a sets a team member targeted for an intensive-training event based on the intensive-training event information related to the selected training item (P21-12).

The raising game executer 701a adds “1” to the number of instruction events for the target team member set in P21-12 above (P21-13). The raising game executer 701a updates the intensive-training-target attribute parameter (P21-14). When the processing from P21-13 to P21-14 is completed for all the team members targeted for the intensive-training event (YES in P21-15), the raising game executer 701a adds a bonus addition value to the attribute parameter of the main character based on the selected training item and the intensive-training event information (P21-16).

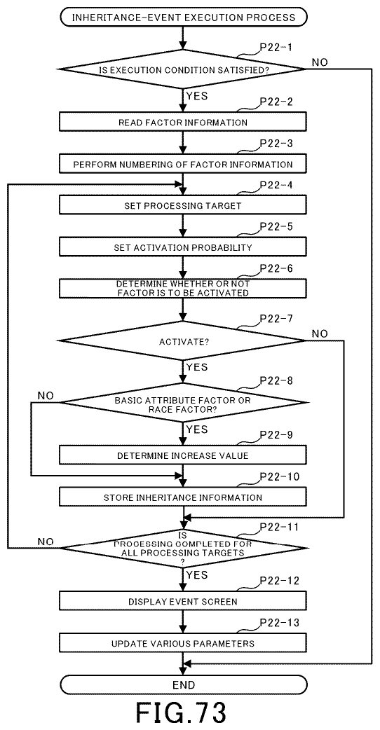

FIG. 73 is a flowchart illustrating the inheritance-event execution process in the player terminal 1. The raising game executer 701a determines whether a condition for executing an inheritance event is satisfied (P22-1). The condition for executing an inheritance event varies depending on the factor activation turn. For example, the condition for executing the first turn is the start of the main raising game, and the condition for executing the 30th turn and the 54th turn is an operation performed on an operation section (see FIG. 27A) displayed on the event screen 220b.

When the condition for executing an inheritance event is satisfied (YES in P22-1), the raising game executer 701a reads factor information associated with raised characters of the first inheritance generation and the second inheritance generation (P22-2). The raising game executer 701a sets numbers indicating the processing order for sequentially determining whether or not each piece of the read factor information is to be activated (P22-3). Then, based on the number set for each piece of factor information in P22-3, the raising game executer 701a sets one factor as a processing target (P22-4) and sets the activation probability thereof (P22-5).

The activation probability is set based on the factor level, the factor information, and the compatibility level. Based on the activation probability set in P22-5, the raising game executer 701a determines by lottery whether or not the factor serving as the processing target is to be activated (P22-6). If it is determined that the factor serving as the processing target is to be activated (YES in P22-7), it is determined whether the factor type is a basic attribute factor or a race factor (P22-8). If the factor type is a basic attribute factor or a race factor (YES in P22-8), an increase value of the target attribute parameter is determined based on the factor type and the factor level (P22-9). The raising game executer 701a stores inheritance information including increase values of the attribute parameters and the aptitude parameters, as well as skill hints to be acquired (P22-10).

If the processing from P22-4 to P22-10 is not completed for all the processing targets (NO in P22-11), the raising game executer 701a sets a new processing target (P22-4) and repeats the same process as above. When the process is completed for all the processing targets (YES in P22-11), the raising game executer 701a displays the event screen 220b related to the inheritance event (P22-12). Then, the raising game executer 701a updates various parameters based on the inheritance information stored in P22-10 (P22-13).

In this case, in order to facilitate the understanding, the raising game executer 701a in the player terminal 1 executes the process for determining whether or not a factor is to activated. Alternatively, the raising-game executer 1101a in the server 1000 may determine whether or not a factor is to activated. In this case, information determined in the server 1000 may be received by the player terminal 1, and the raising game executer 701a may perform the process for displaying the event screen 220b based on the received information.

Referring back to FIG. 61, when the aforementioned raising stage process is completed, the raising game executer 701a in the player terminal 1 executes a raising-game termination process (P8). In the raising-game termination process, the raising game executer 701a stores information related to the raised character raised in the raising game in the game-information storage section 751. The raising game executer 701a transmits termination information to the server 1000. This termination information includes information related to the raised character. When the server 1000 receives the termination information, the raising-game termination processor 1102a executes a raising-game termination process (S8).

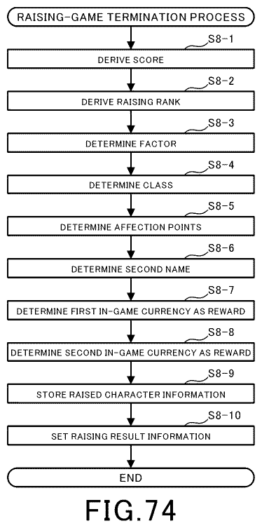

FIG. 74 is a flowchart illustrating the raising-game termination process in the server 1000. The raising-game termination processor 1102a derives a score based on the termination information received from the player terminal 1 (S8-1). The raising-game termination processor 1102a derives a raising rank based on the derived score (S8-2).

The raising-game termination processor 1102a determines a factor to be acquired by the raised character (S8-3). The raising-game termination processor 1102a determines a class based on the number of acquired fans (S8-4). The raising-game termination processor 1102a determines affection points based on a predetermined parameter, such as the raising rank or the number of fans (S8-5). Although a detailed description will be omitted, the affection points are points given not to a raised character but to a character serving as an origin of a raised character.

Multiple story screens mentioned above are provided for respective characters, and a release condition is set for some of the story screens. Some of the story screens have affection points set therefor as a release condition. When the affection points reach a threshold value or higher, the player can view the story screens.

The raising-game termination processor 1102a determines a second name (S8-6). In this case, a condition achieved in the main raising game is checked, and a second name to be acquired by the raised character is determined. The raising-game termination processor 1102a determines an amount of first in-game currency to be given based on the number of acquired fans (S8-7), and determines an amount of second in-game currency to be given based on other information (S8-8). For example, the second in-game currency can be used for enhancing the level of a support card, and the amount to be given is determined based on the support card used in the current raising game.

The raising-game termination processor 1102a stores raised character information including the score, the raising rank, the attribute parameters, the aptitude parameters, the acquired skills, the inheritance information, the factor information, the class, and the second name in the game-information storage section 1151 in association with the player ID of the player (S8-9). The raising-game termination processor 1102a sets raising result information and causes the player terminal 1 to receive the raising result information (S8-10).

Referring back to FIG. 61, upon receiving the raising result information, the raising-completion processor 702a executes a raising-game termination process (P9). In this case, the raising-completion processor 702a stores the received raising result information in the game-information storage section 751. Based on the raising result information, the raising-completion processor 702a displays the raising completion screen 330 (FIG. 41A, FIG. 41B, and FIG. 41C) on the display 26.

The above-described raising game is achieved in accordance with the above process. The raised character information related to the raised character raised (created) in accordance with the raising game is stored in association with the player ID. The processes in the player terminal 1 and the server 1000 described above are merely examples. The above-described processes may be executed in the player terminal 1 alone or may be executed in the server 1000 alone.

### (Team-Competition-Game-Related Process)

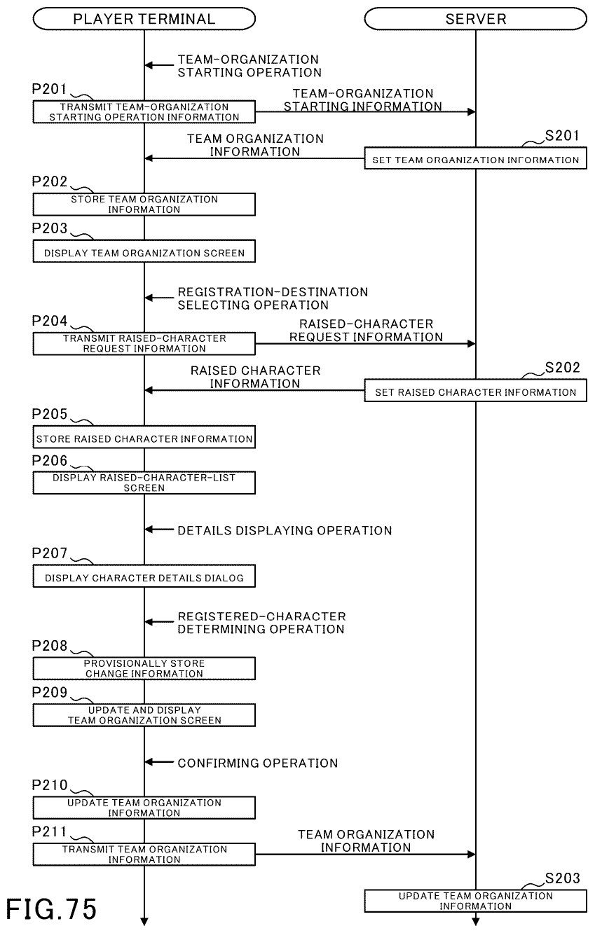

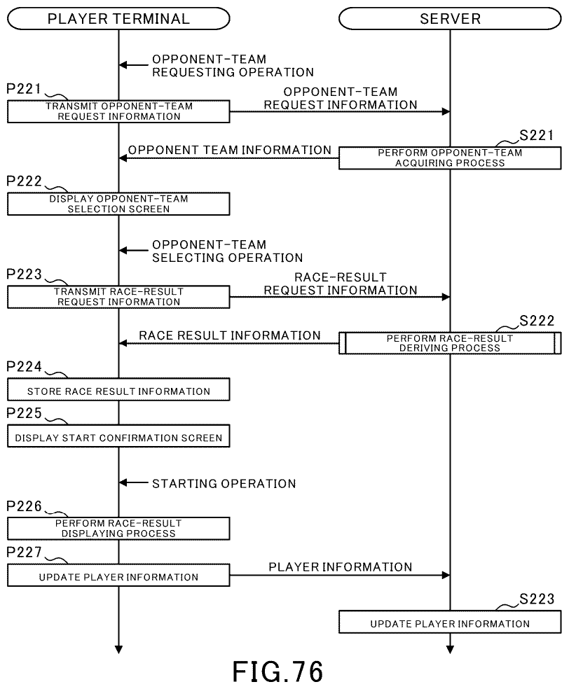

FIG. 75 is a first sequence diagram illustrating a process related to a team competition game in the player terminal 1 and the server 1000. FIG. 76 is a second sequence diagram illustrating the process related to the team competition game in the player terminal 1 and the server 1000. As shown in FIG. 75, when a team-organization starting operation is input (i.e., the organization selection operation section 403 is tapped) on the team competition game screen 400A, the team-competition-game executer 702a transmits team-organization start information to the server 1000 (P201).

When the server 1000 receives the team-organization start information, the team-competition-game executer 1103a acquires team organization information and sets the player terminal 1 in a receivable state (S201). In this case, the team-competition-game executer 1103a identifies the player ID from the received team-organization start information and acquires and sets the team organization information associated with the identified player ID from the game-information storage section 1151.

When the player terminal 1 receives the team organization information, the team-competition-game executer 702a stores the received team organization information in the game-information storage section 751 (P202). The team-competition-game executer 702a displays the team organization screen 410 on the display 26 based on the received team organization information (P203).

In this case, when the team-organization starting operation is input, the team-competition-game executer 702a displays the team organization screen 410 based on the team organization information received from the server 1000. Alternatively, when the team-organization starting operation is input, the team-competition-game executer 702a may display the team organization screen 410 based on the team organization information stored in the game-information storage section 751 without communicating with the server 1000.

When a registration-destination selecting operation is input (i.e., any of the character icons 411 is tapped) on the team organization screen 410, the team-competition-game executer 702a transmits raised-character request information to the server 1000 (P204). When the server 1000 receives the raised-character request information, the team-competition-game executer 1103a acquires raised character information and sets the player terminal 1 in a receivable state (S202). In this case, the team-competition-game executer 1103a identifies the player ID from the received raised-character request information and acquires and sets the raised-character information associated with the identified player ID from the game-information storage section 1151.

When the player terminal 1 receives the raised character information, the team-competition-game executer 702a stores the received raised character information in the game-information storage section 751 (P205). The team-competition-game executer 702a displays the raised-character-list screen 420 on the display 26 based on the received raised character information (P206).

When the registration-destination selecting operation is input, the team-competition-game executer 702a displays the raised-character-list screen 420 based on the raised character information received from the server 1000. Alternatively, when the registration-destination selecting operation is input, the team-competition-game executer 702a may display the raised-character-list screen 420 based on the raised character information stored in the game-information storage section 751 without communicating with the server 1000.

When a details displaying operation is input (i.e., any of the character icons 411 or any of the raised character icons 422 is long-pressed) on the team organization screen 410 or the raised-character-list screen 420, the team-competition-game executer 702a displays the character details dialog 185A on the display 26 (P207).

When any of the raised character icons 422 is tapped on the raised-character-list screen 420, the team-competition-game executer 702a sets the raised character corresponding to the tapped raised character icon 422 in a provisionally-selected state. When a registered-character determining operation is input (i.e., the decision operation section 423 is tapped), the team-competition-game executer 702a provisionally stores the provisionally-selected raised character as change information (P208). The team-competition-game executer 702a updates and displays the team organization screen 410 on the display 26 (P209). In this update display, the character icon 411 corresponding to the raised character provisionally stored as change information is displayed on the team organization screen 410.

When a confirming operation is input (i.e., the confirm operation section 412 is tapped) on the team organization screen 410, the team-competition-game executer 702a updates the team organization information in the game-information storage section 751 based on the change information (P210). The team-competition-game executer 702a transmits the updated team organization information to the server 1000 (P211). In the server 1000, the team-competition-game executer 1103a updates the team organization information in the game-information storage section 1151 based on the received team organization information (S203).

As shown in FIG. 76, when an opponent-team requesting operation is input (i.e., the team-competition-game start operation section 404 on the team competition game screen 400A is tapped or the reload operation section 442 on the opponent-team selection screen 440 is tapped), the team-competition-game executer 702a transmits opponent-team request information to the server 1000 (P221). When the server 1000 receives the opponent-team request information, the team-competition-game executer 1103a executes an opponent-team acquiring process (S221).

In the opponent-team acquiring process, the team-competition-game executer 1103a extracts three pieces of team organization information from the team organization information stored in the game-information storage section 1151. In this case, teams having overall scores within a first range, a second range, and a third range relative to the overall score of the player team are extracted in accordance with a predetermined condition. Then, the team-competition-game executer 1103a selects one of the teams extracted within the above respective ranges by lottery, so as to select three opponent teams. The team-competition-game executer 1103a sets opponent team information including information related to the three selected opponent teams.

When the player terminal 1 receives the opponent team information, the team-competition-game executer 702a displays the opponent-team selection screen 440 on the display 26 (P222). When an opponent-team selecting operation is input (i.e., any of the opponent team icons 441 is tapped) to the player terminal 1, the team-competition-game executer 702a transmits race-result request information to the server 1000 (P223). When the server 1000 receives the race-result request information, the team-competition-game executer 1103a executes a race-result deriving process (S222).

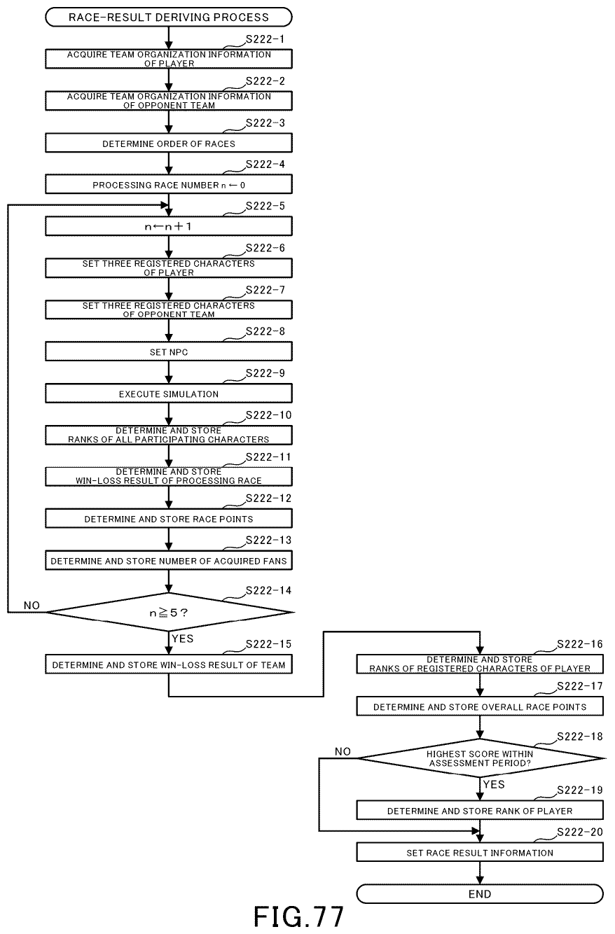

FIG. 77 is a flowchart illustrating the race-result deriving process in the server 1000. The team-competition-game executer 1103a acquires the team organization information of the player from the game-information storage section 1151 (S222-1). The team-competition-game executer 1103a acquires the team organization information of each opponent team selected by the player from the game-information storage section 1151 (S222-2). The team-competition-game executer 1103a determines the execution sequence of five categories of races, that is, the order of the races, by lottery (S222-3). In this case, race numbers from “1” to “5” are given, starting from the earliest race in the execution sequence.

The team-competition-game executer 1103a sets “0” to a processing race number n indicating a race (processing race) targeted for a process for deriving a race result (S222-4). Then, the team-competition-game executer 1103a adds “1” to the processing race number n (S222-5). The team-competition-game executer 1103a sets information about three registered characters of the player registered in the race category given the same race number as the processing race number n (S222-6). Of information associated with the registered characters, for example, information having an effect on the race result, such as the attribute parameters, aptitude parameters, and acquired skills, is set.

Then, the team-competition-game executer 1103a sets information about three registered characters of the opponent team registered in the race category given the same race number as the processing race number n (S222-7). Similar to S222-6, information having an effect on the race result is set. Then, the team-competition-game executer 1103a sets information about an NPC character other than the registered characters of the player and the opponent team (S222-8).

Subsequently, the team-competition-game executer 1103a executes a simulation based on the information set in S222-6 to S222-8 (S222-9), and determines and stores the ranks of all the participating characters (S222-10). Then, the team-competition-game executer 1103a determines and stores the win-loss result of the processing race based on the ranks of all the participating characters determined in S222-10 (S222-11). Subsequently, the team-competition-game executer 1103a determines and stores race points of each of the three registered characters of the player based on the simulation result in S222-9 (S222-12). In this case, category-by-category race points are determined and stored. Then, the team-competition-game executer 1103a determines and stores the number of acquired fans for each of the three registered characters of the player based on the simulation result (S222-13). The order of the processes from S222-9 to S222-13 shown in FIG. 77 is merely an example, and the order of processes is changeable, where appropriate, so long as required information can be derived.

The team-competition-game executer 1103a repeats the processing from S222-5 to S222-13 described above until the processing race number n becomes 5 or more (NO in S222-14). When the processing race number n becomes 5 or more (YES in S222-14), that is, when the race results of all of the five categories of races are derived, the team-competition-game executer 1103a determines and stores the win-loss result of the player team based on the race results (S222-15).

With regard to all the registered characters of the player participated in each race, the team-competition-game executer 1103a determines and stores the ranks based on the race points acquired by the registered characters (S222-16). Specifically, of the registered characters of the player, the registered character with the most race points is ranked first, whereas the registered characters with the least race points is ranked fifteenth. The team-competition-game executer 1103a determines and stores overall race points (S222-17).

If the overall race points determined in S222-17 are the highest score (i.e., highest points) within an assessment period (YES in S222-18), the team-competition-game executer 1103a compares the highest score with that of another player during the assessment period and determines and stores the ranking of the player among all the players (S222-19). The overall race points of the player are stored in the game-information storage section 1151 in association with the player ID.

Specifically, during the assessment period, the highest overall race points acquired by each player are stored, and the ranking of each player is derived in accordance with the highest overall race points. The assessment period is, for example, one week, and the overall race points of each player are reset every week at a predetermined timing. In other words, the rankings are derived on a weekly basis.

The players are sorted into classes in accordance with the rankings during the assessment period. For example, there are six classes provided, and each player is classified into any of the classes. The ranking of each player is the ranking within the class. Players in upper predetermined ranks in each class are promoted, whereas players in lower predetermined ranks in each class are demoted. Alternatively, the classification is not mandatory, and all the players may compete for their rankings.

The team-competition-game executer 1103a sets race result information including the information determined and stored in S222-9 to S222-19, and causes the player terminal 1 to receive the race result information (S222-20).

Referring back to FIG. 76, when the player terminal 1 receives the race result information, the team-competition-game executer 702a stores the received race result information in the game-information storage section 751 (P224). The team-competition-game executer 702a displays the start confirmation screen 450 on the display 26 (P225).

When a starting operation is input (i.e., the start operation section 452 is tapped) on the start confirmation screen 450, the team-competition-game executer 702a executes a race-result displaying process (P226). The team-competition-game executer 703a displays the result list screen 460 on the display 26. When the race-video-playback selection section 461 is tapped on the result list screen 460, the team-competition-game executer 702a plays back a race video. When the result-display selection section 462 is tapped on the result list screen 460, the team-competition-game executer 702a displays a race result. The team-competition-game executer 702a displays the overall race result screen 470 and the score list screen 480 based on an operation input by the player.

When the race result is displayed in the player terminal 1, the team-competition-game executer 702a updates the player information in the player-information storage section 750 (P227). In this case, for example, information related to the number of team competition games and information related to the highest points of the overall race points acquired within the assessment period are included. Furthermore, the team-competition-game executer 702a transmits the updated player information to the server 1000. When the server 1000 receives the player information, the team-competition-game executer 1103a updates the player information in the player-information storage section 1150 (S223).

The above-described team competition game is achieved in accordance with the above process. The processes in the player terminal 1 and the server 1000 described above are merely examples. The above-described processes may be executed in the player terminal 1 alone or may be executed in the server 1000 alone.

Although the embodiment has been described above with reference to the appended drawings, the present invention is not limited to the above embodiment. It is obvious to a skilled person that various modifications or alterations may be achieved within the scope defined in the claims, and it is to be understood that such modifications or alterations naturally belong to the technical scope.

The gameplay described in the above embodiment and the processes in the player terminal 1 and the server 1000 are merely examples. In any case, an information processing program may involve causing a computer (either of or both of the player terminal 1 and the server 1000 in the embodiment) to carry out the following processes.

### (Processes to be Carried Out by Computer)

A process (i.e., P203 in the embodiment) involves allowing a player to select a character (i.e., a raised character in the embodiment) to be used in each of multiple category games in a specific game (i.e., a team competition game in the embodiment) including the multiple category games (i.e., a short-distance race, a mile race, a mid-distance race, a long-distance race, and a dirt-track race in the embodiment).

A process (i.e., S222-6 in the embodiment) involves setting the character selected by the player for each category game.

A process (i.e., S222-10 and S222-11 in the embodiment) involves deriving an individual game result (i.e., a win-loss result of each of five categories of races and the ranks of registered characters in the embodiment) serving as a game result of the category game.

A process (i.e., S222-12 in the embodiment) involves determining a predetermined parameter (i.e., race points in the embodiment) associated with the character used in the category game.

A process (i.e., S222-16 in the embodiment) involves ranking multiple characters used in the specific game in accordance with the selection by the player based on the predetermined parameter.

A process (i.e., S222-15, S222-17, and S222-19 in the embodiment) involves deriving an overall game result (i.e., a win-loss result of a team (player), overall race points, and the ranking of the player in the embodiment) serving as a game result of the specific game based on the individual game result of each of the multiple category games or the predetermined parameter.

Although a raising game is described in the above embodiment, the game genre and the game contents are not particularly limited. Although a raised character raised by the player is used in the specific game in the above embodiment, a character owned by the player may simply be used in the specific game.

In the above embodiment, a race that involves competing with an opponent team for finished places is executed as a category game. However, the contents of the category game are not particularly limited. The number of characters to be used in each category game is not limited so long as the number is one or more. In the above embodiment, the individual game result to be derived includes the ranks of the registered characters and the win-loss result of the race. Alternatively, information to be derived as the individual game result is not limited to this. For example, a parameter, such as the time or the score of a character to be used in each category game, may be derived.

In the above embodiment, the predetermined parameter (i.e., race points in the embodiment) associated with the character used in the category game are determined based on the individual game result (i.e., finished place in the embodiment). Alternatively, the race points may simply be derived based on, for example, the number of activated skills or the time alone instead of being based on the finished place.

In the above embodiment, the overall game result to be derived includes the win-loss result of the team, the overall race points, and the ranking of the player. Alternatively, information to be derived as the overall game result is not limited to this. For example, the ranking of the player alone may be derived as the overall game result.

In the above embodiment, the win-loss result of the team serving as the overall game result is derived based on the individual game result (i.e., the number of wins and losses in the races). Alternatively, the overall game result may be derived based on a predetermined parameter (race points). For example, overall race points may be derived for each of the player team and the opponent team, and the team with the higher overall race points may be set to be the winner.

The process for deriving the overall game result includes a deriving process (i.e., S222-17 in the embodiment) involving calculating total points (i.e., overall race points in the embodiment) as the overall game result in one specific game based on a predetermined parameter.

Furthermore, a process involving ranking (i.e., ranking in S222-19 in the embodiment) multiple players in accordance with the total points in the specific game is executed.

The process for deriving the individual game result for each category game involves deriving individual game results of multiple category games in a predetermined order. As an alternative to the above embodiment where the execution sequence of the five categories of races is determined randomly by lottery, the races may constantly be executed in the same order.

The information processing program for executing the processing in the above embodiment and various modifications may be provided as a storage medium by being stored in a non-transitory computer readable storage medium. Furthermore, a game terminal device including this storage medium may be provided. Moreover, the above embodiment and the modifications may each be an information processing method that realizes the functions and the steps indicated in the flowcharts.

Next, a second embodiment will be described.

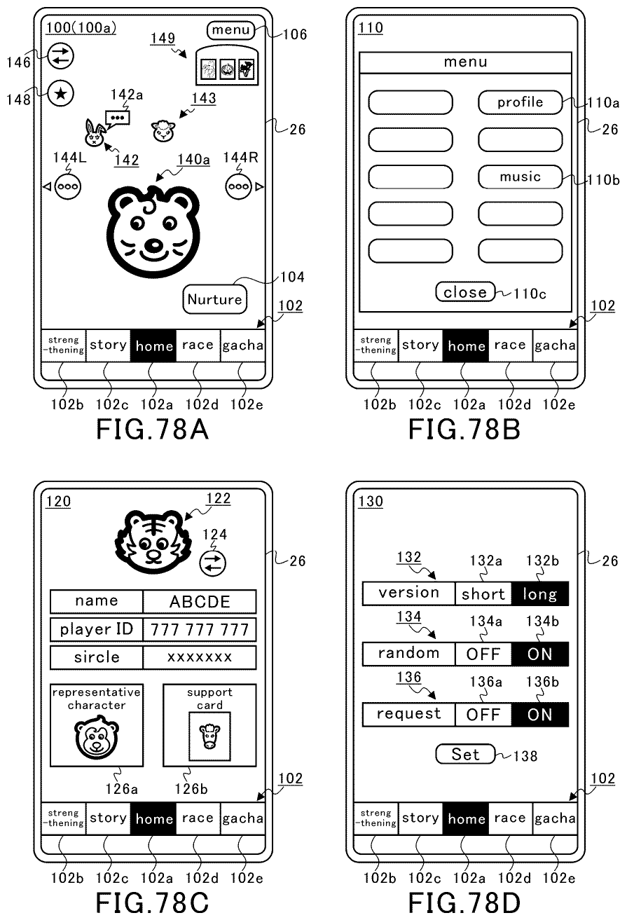

FIG. 78A illustrates an example of the home screen 100. When the game application is activated in the player terminal 1, the home screen 100 is displayed on the display 26. The home screen 100 displays various information and operation sections that can be operated (tapped) by the player. For example, the home screen 100 may display information related to a parameter (stamina) required for playing a raising game or a race (team competition game, to be described later), information related to a team ranking based on a game result in the team competition game, information related to the score of an organized team, information related to an in-game currency owned by the player, information (banner) related to an event being executed, an operation section for displaying a details screen of the event being executed, and an operation section for purchasing the in-game currency.

The lower part of the home screen 100 displays the menu bar 102. The menu bar 102 is provided with a plurality of operation sections that can be operated (tapped) by the player.

The menu bar 102 is provided with the home-screen selection operation section 102a, the enhancement-screen selection operation section 102b, the story-screen selection operation section 102c, a team-competition-field-screen selection operation section 102d, and the gacha-screen selection operation section 102e. On the menu bar 102, the operation section corresponding to the screen being displayed on the display 26 is highlighted so that the screen being displayed can be identified.

When the home-screen selection operation section 102a is tapped, the home screen 100 shown in FIG. 78A is displayed on the display 26.

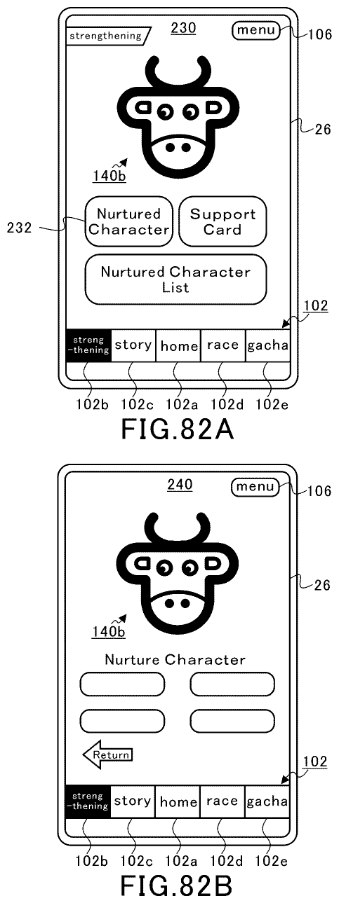

When the enhancement-screen selection operation section 102b is tapped, an enhancement screen 230 (FIG. 82A), to be described later, serving as a screen (intermediate screen) for executing (displaying) character-enhancement-related game content (content screen) is displayed.

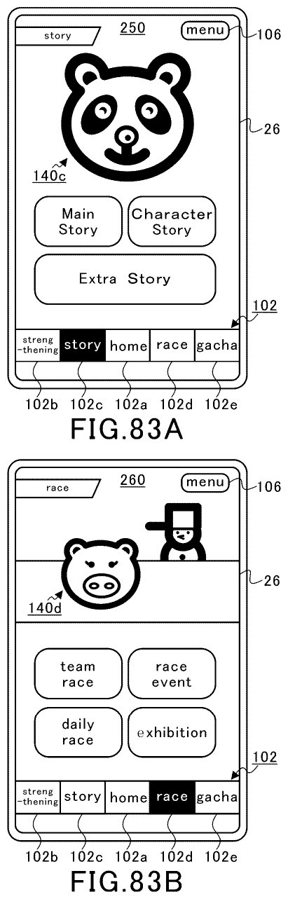

When the story-screen selection operation section 102c is tapped, a story screen 250 (FIG. 83A), to be described later, serving as a screen (intermediate screen) for executing (displaying) story-viewing-related game content (content screen) is displayed.

When the team-competition-field-screen selection operation section 102d is tapped, a team-competition-field screen 260 (FIG. 83B), to be described later, serving as a screen (intermediate screen) for executing (displaying) race-related game content (content screen) is displayed.

When the gacha-screen selection operation section 102e is tapped, a gacha screen (not shown) serving as game content (content screen) related to the so-called gacha lottery is displayed. On the gacha screen, the player can consume the in-game currency to perform the so-called gacha lottery that involves obtaining a character or a support card by lottery.

The home screen 100 is also provided with the raising-game operation section 104 above the menu bar 102. When the raising-game operation section 104 is tapped, a raising game screen (not shown) is displayed. A raising game is roughly divided into a preparation stage and a raising stage. First, in the preparation stage, the player selects a single character from characters that the player owns, so as to set the selected character as a target character to be raised. Furthermore, in the preparation stage, the player sets a support card to be used when raising the target character to be raised.

When the target character to be raised and the support card are completely set, the preparation stage transitions to the raising stage, and the game for raising the target character to be raised starts. The player can own a character raised in the raising game as a raised character. As mentioned above, the player can include the raised character that the player owns in a team and use the raised character in the team competition game.

Accordingly, the main objective of the game according to the second embodiment is to raise a raised character in accordance with the raising game and to move up the rankings in the team competition game by using the raised character.

The second embodiment is provided with a function for sharing information between a plurality of players and a function for sharing a raised character or a support card. The player can set a raised character and a support card that are usable by another player in the raising game. In detail, as shown in FIG. 78A, the setting operation section 106 is provided at the upper right part of the home screen 100. When the setting operation section 106 is tapped, the option setting screen 110 is displayed.

FIG. 78B illustrates an example of the option setting screen 110. The option setting screen 110 can be used for checking and setting various types of information. The option setting screen 110 is provided with a plurality of operation sections. When any of the operation sections is tapped, information corresponding to the operation section can be checked and set.

The operation sections on the option setting screen 110 include the profile-setting operation section 110a, a music-playback-condition-setting operation section 110b, and a close operation section 110c. When the close operation section 110c is tapped, the option setting screen 110 is closed, and the home screen 100 is displayed. When the profile-setting operation section 110a is tapped, the profile setting screen 120 is displayed.

FIG. 78C illustrates an example of the profile setting screen 120. The player can check and set profile information of the player on the profile setting screen 120. The profile information includes a profile character, a player name, a player ID, an affiliated club, a representative character, and a rental card.

The profile character functions as a character to be displayed when information about the player is browsed by another player. For example, the profile character is displayed when a club function serving as a place where information is shared with another player is being used. The profile setting screen 120 displays the currently-set profile character image 122. The change button 124 is provided near the profile character image 122. When the change button 124 is tapped, a profile-character change screen (not shown) is displayed. The player can change the profile character on the profile-character change screen.

The profile setting screen 120 also displays the player name set by the player, the player ID given to the player, and the name of the club to which the player belongs. Furthermore, the profile setting screen 120 is provided with the representative-character setting operation section 126a and the rental-card setting operation section 126b.

When the representative-character setting operation section 126a is tapped, a representative-character setting screen (not shown) is displayed. On the representative-character setting screen, the player can set any one of raised characters raised by the player as a representative character. The representative-character setting operation section 126a displays an icon image indicating the currently-set representative character. As mentioned above, the representative character can be used in a raising game played by another player.

When the rental-card setting operation section 126b is tapped, a rental-card setting screen (not shown) is displayed. On the rental-card setting screen, the player can set any one of the support cards owned by the player as a rental card. The rental-card setting operation section 126b displays an icon image indicating the currently-set rental card. As mentioned above, the support card set as the rental card can be used in a raising game played by another player.

Although a detailed description will be omitted, when the setting of the profile information is changed on the profile setting screen 120, setting change information is transmitted to the server 1000. In the server 1000, the profile information is saved for every player.

When the music-playback-condition-setting operation section 110b is tapped on the option setting screen 110, a music-playback-condition setting screen 130 is displayed.

FIG. 78D illustrates an example of the music-playback-condition setting screen 130. Although a detailed description will be provided later, in the second embodiment, a jukebox function is provided. Various character images are displayed during a game. For example, on each content screen, the screen transitions from one screen to another in response to an operation input by the player. Furthermore, during the game, music (content) is played back under various conditions. Examples of the music to be played back during the game include music corresponding to a game type, such as a raising game or a team competition game, and music corresponding to a character displayed on the game screen. The player can use the jukebox function to listen to music selected by the player from a plurality of pieces of music prepared in advance. Moreover, the player can play the game in a state where the selected music is played back as BGM (background music).

However, the game screens on which the BGM can be played back by the jukebox function are limited. For example, when each content screen is being displayed, dedicated BGM is output. Therefore, the music selected by the player is output as BGM while a screen other than each content screen is being displayed. Furthermore, each content screen may display a dedicated background image different from the background image displayed on the home screen 100.

The music-playback-condition setting screen 130 is provided with a version-setting operation section 132, a random-selection-setting operation section 134, an another-player's-request-setting operation section 136, and a setting-completion operation section 138. The version-setting operation section 132 includes a short-version-selection operation section 132a and a long-version-selection operation section 132b. Each piece of music that can be played back by the jukebox function has a short version with a short playback time and a long version with a long playback time. The player can select the version of the music to be played back by inputting an operation to the version-setting operation section 132.

In detail, the short version is selected when the short-version-selection operation section 132a is tapped, and the long version is selected when the long-version-selection operation section 132b is tapped. In the state where the short version is selected, the short version of the music is played back. In the state where the long version is selected, the long version of the music is played back.

The random-selection-setting operation section 134 includes an off operation section 134a and an on operation section 134b. The player can switch a random selection function between an on mode and an off mode by inputting an operation to the random-selection-setting operation section 134. The random selection function is a function involving randomly selecting music when the content screen transitions to a screen other than the content screen during a game and outputting the selected music as BGM.

When the random selection function is in the on mode, the random selection function is enabled. The player can set the random selection function to the on mode by tapping on the on operation section 134b. In contrast, when the random selection function is in the off mode, the random selection function is disabled. The player can set the random selection function to the off mode by tapping on the off operation section 134a.

The another-player's-request-setting operation section 136 includes an off operation section 136a and an on operation section 136b. The player can switch an another-player's requesting function between an on mode and an off mode by inputting an operation to the another-player's-request-setting operation section 136. The another-player's requesting function is a function involving outputting music selected and played back by the jukebox function of another player's player terminal 1 as BGM from the player terminal 1 of the player. The BGM being output by this another-player's requesting function brings about an impression as if the jukebox is being shared with another player.

When the another-player's requesting function is in the on mode, the another-player's requesting function is enabled. The player can set the another-player's requesting function to the on mode by tapping on the on operation section 136b. In contrast, when the another-player's requesting function is in the off mode, the another-player's requesting function is disabled. The player can set the another-player's requesting function to the off mode by tapping on the off operation section 136a.

The player can set the another-player's requesting function to the on mode so long as the random selection function is set in the on mode. Therefore, when the random selection function is set in the on mode, the player can set the another-player's requesting function to the on mode or the off mode. In contrast, when the player taps on the off operation section 134a and sets the random selection function to the off mode, the another-player's requesting function is simultaneously set to the off mode.

Accordingly, the player can select and set any one of the following three states, namely, a state where both the random selection function and the another-player's requesting function are in the on mode, a state where both the random selection function and the another-player's requesting function are in the off mode, and a state where the random selection function is in the on mode and the another-player's requesting function is in the off mode.

When operations are input to the version-setting operation section 132, the random-selection-setting operation section 134, and the another-player's-request-setting operation section 136, the settings are changed, and the setting-completion operation section 138 is enabled. When the enabled setting-completion operation section 138 is tapped, the changed modes are stored, and the setting changing process is completed. When the setting changing process is completed, the music-playback-condition setting screen 130 is closed, and the option setting screen 110 is displayed. Moreover, when the setting changing process is completed, setting change information indicating the changed modes is transmitted to the server 1000. In the server 1000, the modes set by the player are stored.

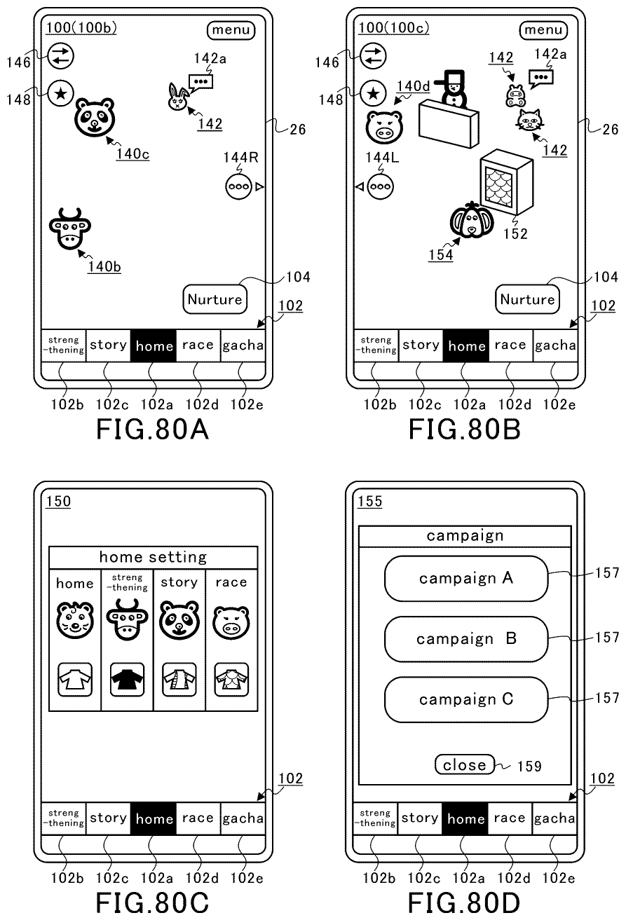

Next, the home screen 100 will be described. The home screen 100 includes a center home screen 100a, a left home screen 100b (FIG. 80A), to be described later, and a right home screen 100c (FIG. 80B), to be described later.

When the home screen 100 is first displayed, the center home screen 100a shown in FIG. 78A is displayed on the display 26. The center home screen 100a displays a first set character 140a of the set characters set by the player.

Although a detailed description will be provided later, the player can set four characters as set characters displayed on the home screen 100. The four characters are the first set character 140a, a second set character 140b, a third set character 140c, and a fourth set character 140d.

The center home screen 100a displays one (first set character 140a) of the four set characters. When the first set character 140a displayed on the center home screen 100a is tapped, a predetermined audio message is output, and the home screen 100 (center home screen 100a) is displayed on the display 26.

The output timing of the aforementioned predetermined audio message corresponding to the first set character 140a displayed on the home screen 100a (center home screen 100a) is not limited to the aforementioned timing. In detail, for example, the aforementioned predetermined audio message corresponding to the first set character 140a may be output at a timing at which the home screen 100a (center home screen 100a) is displayed on the display 26 from a state where a screen other than the home screen 100a (center home screen 100a) is displayed on the display 26, that is, a timing at which a screen transition to the home screen 100a (center home screen 100a) is carried out. Furthermore, the aforementioned predetermined audio message corresponding to the first set character 140a may be output every time a predetermined time period (e.g., 15 seconds) set in advance elapses in a state where the home screen 100a (center home screen 100a) is displayed on the display 26.

The home screen 100 (i.e., the center home screen 100a, the left home screen 100b, and the right home screen 100c) displays a first unset character 142 and a second unset character 143 as unset characters selected by lottery.

Specifically, the unset characters are not selectable by the player, and are randomly set by lottery. In the second embodiment, the characters set as the unset characters are limited so as not to be redundant with each other.

The lottery for determining the unset characters can be executed every time a predetermined lottery timing is reached. For example, a timing at which the home screen 100 is first displayed after a predetermined time point is reached can be set as the lottery timing. Alternatively, a timing at which the home screen 100 is displayed in response to tapping on the home-screen selection operation section 102a or the first set character 140a can be set as the lottery timing.

Accordingly, various characters are displayed as unset characters on the home screen 100, so that the characters to be in contact with the player can be diversified, thereby reducing the possibility of the player losing interest in the game. A speech balloon image 142a is displayed on the first unset character 142.

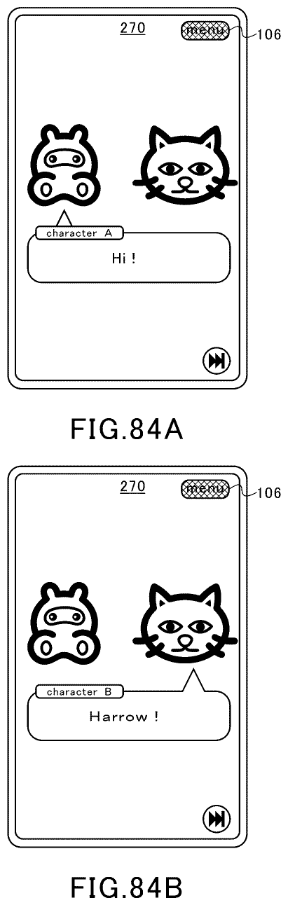

Although a detailed description will be provided later, when the first unset character 142 or the speech balloon image 142a is tapped, the first unset character 142 is displayed in a magnified fashion, and a conversation screen 270 (FIG. 84A), to be described later, is displayed.

The second unset character 143 moves within the home screen 100 (i.e., the center home screen 100a, the left home screen 100b, and the right home screen 100c) based on any of a plurality of preset movement patterns. Although the details of the movement patterns are not particularly limited, an example involves walking within the home screen 100 (i.e., the center home screen 100a, the left home screen 100b, and the right home screen 100c).

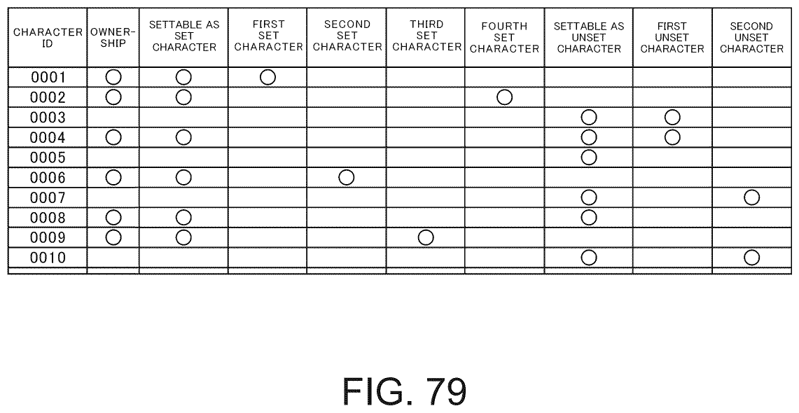

FIG. 79 illustrates a character management table. In the second embodiment, a character management table is set for each player, that is, each player ID. A character management table is stored in each of the storage unit 18 of the player terminal 1 and the storage unit 1018 of the server 1000. When the character management table stored in the storage unit 18 of the player terminal 1 is updated, update information is transmitted from the player terminal 1 to the server 1000. Upon receiving the update information, the server 1000 updates the character management table stored in the storage unit 1018 of the server 1000 based on the received update information.

In a case where the character management table is updated in the server 1000, specifically, for example, in a case where a lottery process involving the so-called gacha lottery is to be executed in the server 1000, when the character management table stored in the storage unit 1018 of the server 1000 is updated, the player terminal 1 acquires update information of the character management table stored (updated) in the storage unit 1018 of the server 1000, and updates the character management table stored in the storage unit 18 of the player terminal 1 based on the acquired update information.

As shown in FIG. 79, in the character management table, ownership information indicating whether or not an ownership condition is satisfied is stored for every character ID. In other words, when a predetermined ownership condition is satisfied, ownership information about an object is stored. Furthermore, in the character management table, information indicating whether or not a character is settable as a set character is stored for every character ID. As shown in FIG. 79, in the second embodiment, characters that satisfy the ownership condition are settable as set characters.

In the second embodiment, the characters set as the four set characters are limited so as not to be redundant with one another.

The set characters may entirely or partially be selected by lottery. Accordingly, the player can set a desired character as a set character or can randomly set a set character (by lottery). In this case, of the characters not set as set characters by the player from the characters that satisfy the ownership condition, a character (set character) may be selected by lottery.

In the character management table, information indicating the characters set as the first set character 140a, the second set character 140b, the third set character 140c, and the fourth set character 140d is stored.

In the character management table, information indicating whether or not a character is settable as an unset character is stored for every character ID. As shown in FIG. 79, in the second embodiment, characters not set as the first set character 140a, the second set character 140b, the third set character 140c, and the fourth set character 140d are settable as unset characters regardless of whether or not the ownership condition is satisfied. In other words, the home screen 100 may display a character not owned by the player as an unset character.

In the character management table, information indicating the characters set as the first unset character 142 and the second unset character 143 is stored.

The home screen 100 displays a background image (not shown). Since a character is raised in accordance with a raising game, for example, a background image bringing about an impression as if the character exists in a school building is displayed in conformity to the atmosphere of the game. Therefore, the player tapping on the first set character 140a or the first unset character 142 brings about an impression as if the player is having a conversation with the character in the school building. Furthermore, changing the background image in accordance with the time of year (i.e., the season or an annual event) or the time (i.e., morning, noon, or evening) enhances oneness with the reality, thus offering an immersive game experience.

The center home screen 100a displays notification icons 144L and 144R. The notification icons 144L and 144R provide notifications about whether or not new information can be checked on the left home screen 100b and the right home screen 100c, respectively. The left home screen 100b is displayed when a rightward swiping operation, dragging operation, or flicking operation is input on the center home screen 100a, and the right home screen 100c is displayed when a leftward swiping operation, dragging operation, or flicking operation is input.

FIG. 80A illustrates an example of the left home screen 100b, and FIG. 80B illustrates an example of the right home screen 100c. As shown in FIG. 80A, the left home screen 100b displays two set characters (i.e., the second set character 140b and the third set character 140c), one unset character (i.e., the first unset character 142), and the notification icon 144R. When a leftward swiping operation, dragging operation, or flicking operation is input to the left home screen 100b, the center home screen 100a is displayed.

As shown in FIG. 80B, the right home screen 100c displays one set character (i.e., the fourth set character 140d), two unset characters (i.e., first unset characters 142), and the notification icon 144L. When a rightward swiping operation, dragging operation, or flicking operation is input to the right home screen 100c, the center home screen 100a is displayed.

The set characters (i.e., the first set character 140a, the second set character 140b, the third set character 140c, and the fourth set character 140d) displayed on the home screen 100 function as operation sections for switching the screen.

In detail, a function identical to that of the home-screen selection operation section 102a is allocated to the first set character 140a displayed on the center home screen 100a. Functions identical to those of the enhancement-screen selection operation section 102b and the story-screen selection operation section 102c are respectively allocated to the second set character 140b and the third set character 140c displayed on the left home screen 100b. Moreover, a function identical to that of the team-competition-field-screen selection operation section 102d is allocated to the fourth set character 140d displayed on the right home screen 100c.

Therefore, for example, when the third set character 140c displayed at the upper left side is tapped on the left home screen 100b, the screen transitions from the home screen 100 to the story screen 250 (FIG. 83A). Likewise, when the second set character 140b displayed at the lower left side is tapped on the left home screen 100b, the screen transitions from the home screen 100 to the enhancement screen 230 (FIG. 82A). When the fourth set character 140d is tapped on the right home screen 100c, the screen transitions from the home screen 100 to the team-competition-field screen 260 (FIG. 83B). When the first set character 140a is tapped on the center home screen 100a, the center home screen 100a is displayed again on the display 26.

Accordingly, in the second embodiment, desired characters set as set characters (i.e., the first set character 140a, the second set character 140b, the third set character 140c, and the fourth set character 140d) by the player are displayed on the home screen 100 serving as a screen frequency visited by the player, thereby suppressing a decrease in the player's ambition for playing the game and achieving an enhanced entertainment effect on the home screen 100.

Furthermore, the operation sections (i.e., the home-screen selection operation section 102a, the enhancement-screen selection operation section 102b, the story-screen selection operation section 102c, and the team-competition-field-screen selection operation section 102d) on the menu bar 102 are allocated to the set characters (i.e., the first set character 140a, the second set character 140b, the third set character 140c, and the fourth set character 140d), thereby achieving improved operability in addition to the aforementioned entertainment effect.

In the second embodiment, the contents displayed in the home-screen selection operation section 102a, the enhancement-screen selection operation section 102b, the story-screen selection operation section 102c, and the team-competition-field-screen selection operation section 102d do not change regardless of the set contents of the first set character 140a, the second set character 140b, the third set character 140c, and the fourth set character 140d. In other words, the menu bar 102 including the operation sections (the home-screen selection operation section 102a, the enhancement-screen selection operation section 102b, the story-screen selection operation section 102c, and the team-competition-field-screen selection operation section 102d) corresponding to the respective pieces of game content is displayed regardless of the set corresponding objects (i.e., the first set character 140a, the second set character 140b, the third set character 140c, and the fourth set character 140d). The home screen 100 displays a setting icon 146.

When the setting icon 146 is tapped, a home setting screen 150 is displayed. FIG. 80C illustrates an example of the home setting screen 150. On the home setting screen 150, the player can set each of the set characters (i.e., the first set character 140a, the second set character 140b, the third set character 140c, and the fourth set character 140d) to be displayed on the home screen 100. In other words, the player can set the first set character 140a, the second set character 140b, the third set character 140c, and the fourth set character 140d to which the functions of the operation sections are allocated.

As shown in FIG. 80C, the home setting screen 150 displays character images corresponding to four currently-set characters and operation sections corresponding thereto in an identifiable manner. When any of the character images displayed on the home setting screen 150 is tapped, a character selection screen (not shown) is displayed. The player can select any of the set characters on the character selection screen. Moreover, the player can set a costume for each set character on the home setting screen 150. In the second embodiment, a predetermined costume (e.g., a costume for each season or a costume for each annual event) is set for an unset character. For example, a costume different from that of an unset character may be selectable as the costume for each set character. Accordingly, this creates specialness in each costume set by the player, thereby achieving an enhanced entertainment effect.

The predetermined costume is not limited to the above example and may be a costume selected based on time information (i.e., information related to the current time point) (e.g., a costume corresponding to a morning time frame, a costume corresponding to a noon time frame, or a costume corresponding to an evening time frame), or may be a costume according to a background image, to be described later.

The home screen 100 also displays a campaign icon 148. When the campaign icon 148 is tapped, a campaign screen 155 is displayed.

FIG. 80D illustrates an example of the campaign screen 155. As shown in FIG. 80D, the campaign screen 155 displays a campaign operation section 157. When the campaign operation section 157 is tapped, a campaign details screen (not shown) corresponding to the tapped campaign operation section 157 is displayed on the display 26. The campaign details screen displays detailed information about a campaign currently being carried out.

Although the details of the campaign to be carried out are not particularly limited, for example, the campaign may be such that each piece of game content can be favorably executed. Specific examples include a campaign in which a reward acquirable by the player in the raising game or the team competition game increases and a campaign in which the raising conditions, such as various types of selection probabilities, in the raising game change.

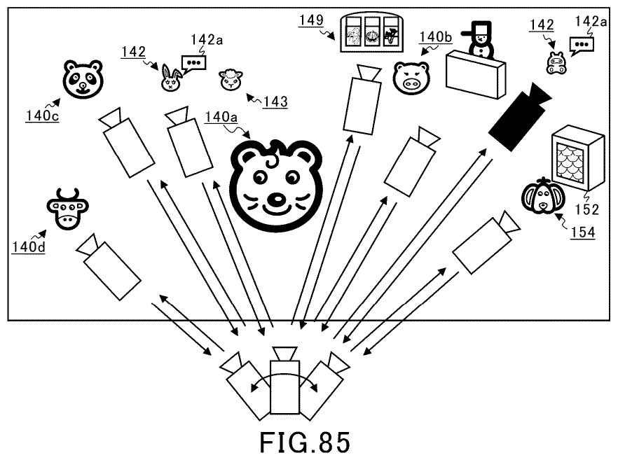

Furthermore, as shown in FIG. 78A, the home screen 100 (center home screen 100a) displays a bulletin board 149 on which posters are posted. When the bulletin board 149 is tapped, a bulletin board screen 280 (FIG. 85A), to be described later, is displayed on the display 26.

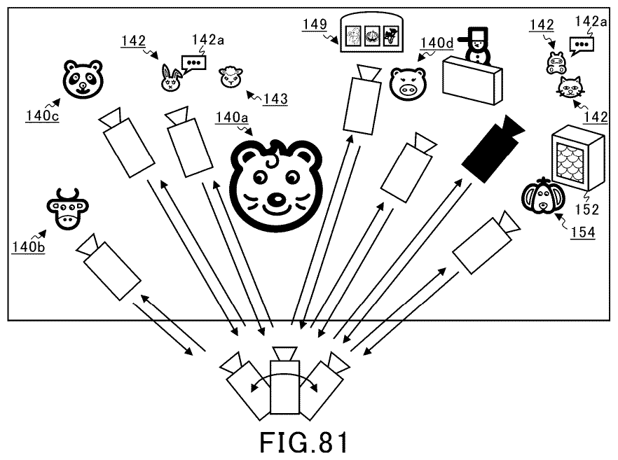

FIG. 81 is a first diagram illustrating viewpoints for capturing an image of a virtual game space. As shown in FIG. 81, in the second embodiment, by capturing an image of an object, such as a character, disposed within the virtual game space from a virtual camera, the aforementioned home screen 100 (i.e., each of the center home screen 100a, the left home screen 100b, and the right home screen 100c) is displayed, and each of screens (the enhancement screen 230, the story screen 250, the team-competition-field screen 260, the conversation screen 270, the bulletin board screen 280, and the poster screen 290), to be described later, is displayed.

In detail, for example, a screen captured by the camera facing the virtual space is displayed on the display 26, so that the center home screen 100a is displayed on the display 26. When a leftward swiping operation, dragging operation, or flicking operation is input, a screen captured by the camera spanning leftward is displayed on the display 26, so that the left home screen 100b is displayed on the display 26. When a rightward swiping operation, dragging operation, or flicking operation is input, a screen captured by the camera spanning rightward is displayed on the display 26, so that the right home screen 100c is displayed on the display 26.

When the enhancement-screen selection operation section 102b or the second set character 140b is tapped, a screen captured by the camera moving close to the second set character 140b is displayed on the display 26, as shown in FIG. 81, so that the enhancement screen 230 is displayed on the display 26. In other words, the home screen 100 includes a screen (i.e., the enhancement screen 230) for executing game content.

FIG. 82A illustrates an example of the enhancement screen 230. The enhancement screen 230 displays the second set character 140b and is provided with a plurality of operation sections.

FIG. 82B illustrates an example of a raised character screen 240. For example, when a raised-character-screen selection operation section 232 is tapped on the enhancement screen 230 shown in FIG. 82A, the raised character screen 240 shown in FIG. 82B is displayed.

The raised character screen 240 displays the second set character 140b and is provided with an operation section for displaying a content screen for enhancing a character owned by the player. By operating this operation section, the content screen for enhancing the character owned by the player can be displayed. In other words, each of the screens (i.e., the enhancement screen 230 and the raised character screen 240) for executing game content displays an object (second set character 140b) that corresponds to the game content and that is of the same type as the corresponding object (second set character 140b) displayed on the home screen 100.

By enhancing a character, the player can increase the level set for the character. Each character has various types of parameters set therefor, and each parameter increases by increasing the level. By increasing the parameter of the character, the player can raise the character having a higher status in the raising game. By using this enhanced character, it is possible to favorably proceed with raising-related game content or race-related game content. In other words, in either game content, an object (character) with ownership information stored therein becomes usable among the objects (characters). The object (character) with the ownership information stored therein becomes settable as a corresponding object (i.e., the first set character 140a, the second set character 140b, the third set character 140c, or the fourth set character 140d).

When the story-screen selection operation section 102c or the third set character 140c is tapped, a screen captured by the camera moving close to the third set character 140c is displayed on the display 26, as shown in FIG. 81, so that the story screen 250 is displayed on the display 26. In other words, the home screen 100 includes a screen (i.e., the story screen 250) for executing game content.

FIG. 83A illustrates an example of the story screen 250. The story screen 250 displays the third set character 140c and is provided with a plurality of operation sections. In other words, the screen (i.e., the story screen 250) for executing game content displays an object (third set character 140c) that corresponds to the game content and that is of the same type as the corresponding object (third set character 140c) displayed on the home screen 100.

In the second embodiment, a story image is provided for each character appearing in the game. On the story screen 250, the player can operate each operation section to execute (display) story-viewing-related game content (content screen) and to select and view the character and the story image.

When the team-competition-field-screen selection operation section 102d or the fourth set character 140d is tapped, a screen captured by the camera moving close to the fourth set character 140d is displayed on the display 26, as shown in FIG. 81, so that the team-competition-field screen 260 is displayed on the display 26. In other words, the home screen 100 includes a screen (i.e., the team-competition-field screen 260) for executing game content.

FIG. 83B illustrates an example of the team-competition-field screen 260. The team-competition-field screen 260 displays the fourth set character 140d and is provided with a plurality of operation sections. In other words, the screen (i.e., the team-competition-field screen 260) for executing game content displays an object (fourth set character 140d) that corresponds to the game content and that is of the same type as the corresponding object (fourth set character 140d) displayed on the home screen 100.

In the second embodiment, the player can organize a team by using the characters raised by the player. By operating a predetermined operation section, race-related game content (content screen) can be executed (displayed), and a team competition game where the team organized by the player and a team of another player selected by the computer compete against each other can be played. The team competition game has gameplay involving competing with another player for rankings.

When the first unset character 142 or the speech balloon image 142a is tapped, a screen captured by the camera moving close to the first unset character 142 is displayed on the display 26, as shown in FIG. 81, so that the conversation screen 270 is displayed on the display 26.

FIG. 84A is a first diagram illustrating an example of the conversation screen 270. FIG. 84B is a second diagram illustrating an example of the conversation screen 270. As shown in FIG. 84A, the conversation screen 270 displays the tapped first unset character 142 or a predetermined message image of the first unset character 142 corresponding to the tapped speech balloon image 142a, and outputs conversational audio of the character.

By tapping on the conversation screen 270, the player can sequentially proceed with the conversation between characters, as shown in FIG. 84B. As shown in FIGS. 84A and 84B, when the conversation screen 270 is being displayed, the setting operation section 106 is grayed out and becomes non-operable. Accordingly, the player's attention can be directed toward the conversation between the characters, thereby achieving an enhanced entertainment effect.

Although the above description relates to a case where the conversation screen displayed involves a conversation between two first unset characters 142, the conversation screen 270 may display a speech (monologue) by one first unset character 142, or the conversation screen 270 may display a conversation among three or more first unset characters 142.

The details of the conversation may be set in advance for each character or each combination of characters. In this case, the distance by which the camera moves may be adjusted in accordance with the number of first unset characters 142 displayed on the conversation screen 270.

FIG. 85 is a second diagram illustrating viewpoints for capturing an image of the virtual game space. For example, the moving distance may be shorter for the position of the camera (shaded camera in FIG. 85) that captures an image of one first unset character 142 at the upper right side, as shown in FIG. 85, than for the position of the camera (shaded camera in FIG. 81) that captures an image of two first unset characters 142 at the upper right side, as shown in FIG. 81. In other words, the moving distance for the position of the camera that captures an image of the first unset characters 142 may decrease with increasing number of first unset characters 142 displayed on the conversation screen 270. Specifically, the distance between the one first unset character 142 at the upper right side in FIG. 85 and the camera (shaded camera in FIG. 85) that captures an image thereof may be shorter than the distance between the two first unset characters 142 at the upper right side in FIG. 81 and the camera (shaded camera in FIG. 81) that captures an image thereof. Accordingly, each first unset character 142 can be displayed with an appropriate size on the conversation screen 270.

When the bulletin board 149 is tapped, a screen captured by the camera moving close to the bulletin board 149 is displayed on the display 26, as shown in FIG. 81, so that the bulletin board screen 280 is displayed on the display 26.

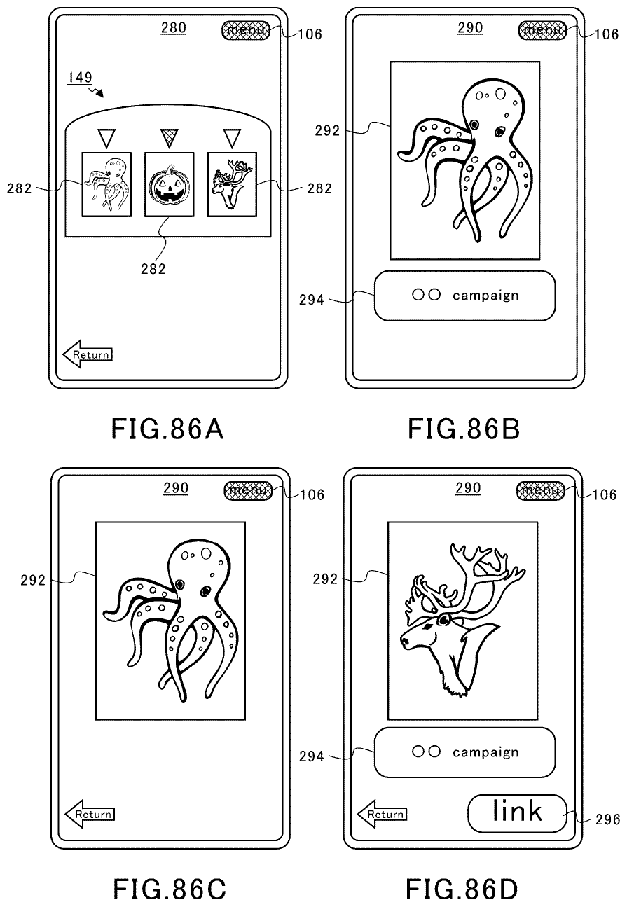

FIG. 86A illustrates an example of the bulletin board screen 280. As shown in FIG. 86A, the bulletin board screen 280 displays a poster selection operation section 282 mimicking a poster. When the poster selection operation section 282 is tapped, the position of the camera further moves, and the poster screen 290 is displayed on the display 26.

FIG. 86B is a first diagram illustrating an example of the poster screen 290. FIG. 86C is a second diagram illustrating an example of the poster screen 290. As shown in FIG. 86B, the poster screen 290 displays a poster image 292 corresponding to the tapped poster selection operation section 282 in a magnified fashion, and also displays a message image 294 indicating an explanation of the displayed poster image 292. When the poster screen 290 is tapped in this state, the message image 294 transitions to a non-displayed state, as shown in FIG. 86C. Accordingly, the player can readily capture the poster image 292 by using a so-called screenshot function.

FIG. 86D is a third diagram illustrating an example of the poster screen 290. As shown in FIG. 86D, when the poster screen 290 is displayed, an external-link operation section 296 for guiding to, for example, a homepage related to the poster screen 290 may be displayed. When the external-link operation section 296 is tapped, the screen transitions to, for example, the homepage corresponding to the external-link operation section 296. In this case, for example, the homepage may be displayed by activating the browser of the player terminal 1. Accordingly, the player viewing the poster image 292 and having an interest therein can be provided with more detailed information.

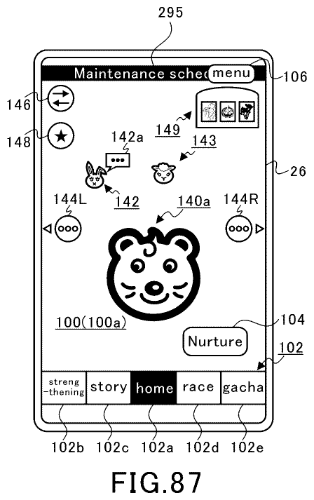

FIG. 87 illustrates an example of the home screen 100 when maintenance is scheduled. As shown in FIG. 87, when maintenance of the game application is scheduled, a predetermined caption 295 indicating that maintenance is scheduled can be displayed at the upper part of the home screen 100. This caption 295 is displayed preferentially (with a higher priority) over all the objects displayed on the home screen 100. Accordingly, the player can be appropriately notified that maintenance is scheduled.

As shown in FIG. 87, in the second embodiment, the caption 295 is displayed in a superposed fashion on the setting operation section 106. If the setting operation section 106 displayed with a lower priority than the caption 295 is operated (tapped), the operation (tapping) may be treated as effective, and the option setting screen 110 may be displayed based on the operation (tapping). If a portion (area) of the displayed caption 295 not superposed on the setting operation section 106 is operated (tapped), the displayed caption 295 may be set in a non-displayed state (deleted state) based on the operation (tapping).

Alternatively, if any of various types of operation sections displayed with a lower priority than the caption 295 is operated (tapped), the operation (tapping) may be treated as ineffective, and a transition to the corresponding screen based on the operation (tapping) does not have to be performed. In this case, when any area of the displayed caption 295 is operated (tapped), the displayed caption 295 may be set in a non-displayed state (deleted state) based on the operation (tapping).

As shown in FIG. 80B, the right home screen 100c displays a jukebox image 152 and a requesting character image 154. The jukebox image 152 functions as an operation section that receives an operation for activating the jukebox function. The requesting character image 154 is displayed near the jukebox image 152 when music is being played back by the jukebox function and when music to be played back is being selected.

Although a detailed description will be provided later, when music is to be played back by the jukebox function, a requester requesting the music is always determined. A requester is a character. A character serving as a requester will be referred to as a requesting character hereinafter. The requesting character image 154 corresponding to the requesting character is displayed near the jukebox image 152. This brings about an impression as if the requesting character is operating the jukebox. The jukebox function will be described in detail below.

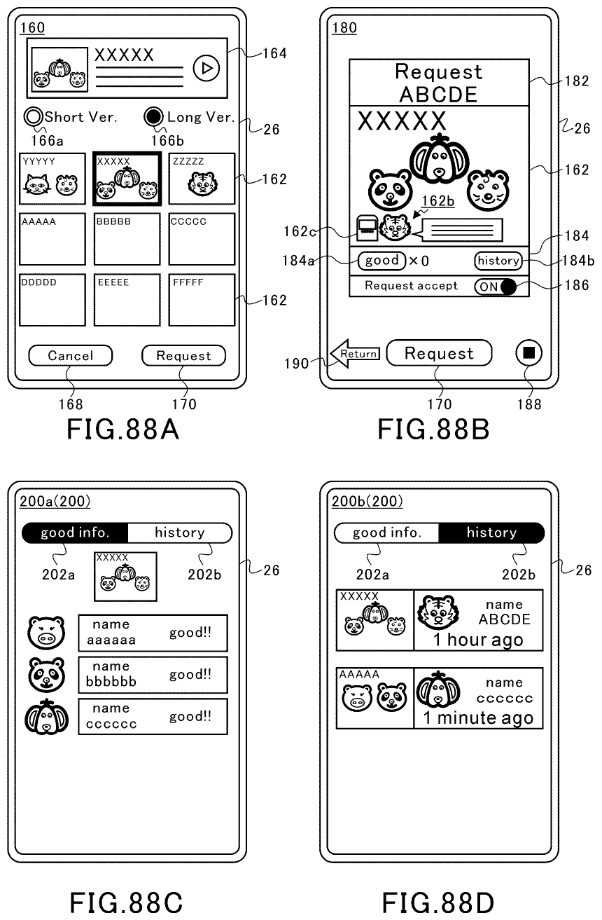

FIG. 88A illustrates an example of a music selection screen 160. On the music selection screen 160, the player can select music to be played back while the game is being played. The music selection screen 160 displays a plurality of jacket images 162. Each piece of music that can be played back by the jukebox function is provided with a jacket image 162.

When any of the jacket images 162 is tapped, the tapped jacket image 162 is displayed in a highlighted fashion. In this case, the music corresponding to the tapped jacket image 162 is set as selected music.

The upper part of the music selection screen 160 is provided with a music-information display field 164. The music-information display field 164 displays music information associated with the currently-selected music. The music information includes, for example, the title name of the music, the jacket image 162, the name of the lyricist, the name of the composer, and information related to the music. When the jacket image 162 or the music-information display field 164 is tapped, the selected music may be played back for listening.

The music selection screen 160 is also provided with version switching toggles 166a and 166b. By tapping on the version switching toggle 166a or 166b, the player can switch the version of music to be played back, similarly to the version-setting operation section 132.

The lower part of the music selection screen 160 is provided with a cancel operation section 168 and a request operation section 170. When the cancel operation section 168 is tapped, the music selection screen 160 transitions to a non-displayed state, and the previously displayed screen (i.e., a selected-music information screen 180, to be described later) is displayed. When the cancel operation section 168 is tapped after a changing operation is input by tapping on the jacket image 162 or the version switching toggle 166a or 166b, the changed information is discarded without being saved.

When the request operation section 170 is tapped, the requested playback mode is switched. A requested playback mode is used for identifying whether or not music is being played back by the jukebox function. A playback mode indicating that music is being played back and a stop mode indicating that playback is stopped, that is, music is not being played back, are provided as requested playback modes.

When the request operation section 170 is tapped in the playback mode, the requested playback mode changes from the playback mode to the stop mode. In this case, the playback of the selected music is stopped, and selected music information indicating the selected music is deleted. When the request operation section 170 is tapped in the stop mode, the selected music information is stored, the requested playback mode is changed from the stop mode to the playback mode, and the playback of the selected music is started. In this case, the screen transitions from the music selection screen 160 to the selected-music information screen 180. When the cancel operation section 168 is tapped and the screen transitions from the music selection screen 160 to the selected-music information screen 180, the requested playback mode may be changed to the playback mode.

Although a detailed description will be omitted, in the second embodiment, default BGM is provided in addition to the music that can be played back by the jukebox function. When the requested playback mode is in the stop mode, default BGM is output. The player can set the sound volume of the BGM on the option setting screen 110. In a state where the sound volume of the BGM is set to a mute mode, the output of the default BGM is stopped.

FIG. 88B illustrates an example of the selected-music information screen 180. When the request operation section 170 is tapped on the music selection screen 160 and the playback of the selected music starts, the selected-music information screen 180 in FIG. 88B is displayed. When the jukebox image 152 is tapped on the home screen 100, the selected-music information screen 180 shown in FIG. 88B is displayed. The selected-music information screen 180 is provided with a jacket image 162, the request operation section 170, a requester's-name display field 182, an evaluation-information display field 184, an another-player's-request setting toggle 186, a playback stop button 188, and a return operation section 190.

The selected-music information screen 180 displays the jacket image 162 corresponding to the music being played back. When the jukebox image 152 is tapped on the home screen 100 while the default BGM is being output, the selected-music information screen 180 displays a default image in which the jacket image 162 and the like are not displayed. An entertainment image 162b and a miniature jukebox image 162c are displayed in a superposed fashion on the jacket image 162. The entertainment image 162b includes a miniature character icon corresponding to the requester and a comment display field.

The miniature character icon moves in conformity to the rhythm of the music. In the case where the player selects the music, a profile character set by the player becomes the requester. Therefore, in this case, the miniature character icon corresponding to the profile character is displayed. In the case where the player selects the music, a representative character set by the player may become the requester.

When the music is selected by the random selection function (excluding the time when the another-player's requesting function is activated), as mentioned above, the requesting character is determined. While the music selected by the random selection function (excluding the time when the another-player's requesting function is activated) is being played back, the miniature character icon corresponding to the requesting character is displayed as the entertainment image 162b.

When the another-player's requesting function is activated and the music is selected, a representative character set by another player is set as the requester, that is, the requesting character. Therefore, in this case, the miniature character icon corresponding to the representative character of the other player is displayed as the entertainment image 162b. Alternatively, a profile character set by the other player may be set as the requesting character.

The comment display field displays a comment corresponding to the music being played back. The miniature jukebox image 162c is provided with a plurality of display colors, and is displayed in a color corresponding to the music being played back.

When the request operation section 170 is tapped on the selected-music information screen 180, the music selection screen 160 shown in FIG. 88A is displayed. In this case, the playback of the selected music is stopped, and the selected music information indicating the selected music is deleted.

The requester's-name display field 182 displays the name of the requester. In the case where the player selects the music, the requester's-name display field 182 displays the player name set by the player. While music selected by the random selection function (excluding the time when the another-player's requesting function is activated) is being played back, the character name of the requesting character is displayed. In the case where the another-player's requesting function is activated and the music is selected, the player name set by the other player is displayed.

The evaluation-information display field 184 is provided with an evaluation operation section 184a and a history display button 184b. By tapping on the evaluation operation section 184a, the player can evaluate the music being played back. In the evaluation-information display field 184, the number of evaluations is displayed alongside the evaluation operation section 184a and indicates the number of times the music being played back has been evaluated.

As shown in FIG. 88B, at the start of the playback of the music, the number of evaluations of the music is displayed as 0. When the player taps on the evaluation operation section 184a in this state, the number of evaluations is updated to 1. In a period from when the selected music is set to when the selected music is changed, the player can evaluate the music only once. Therefore, when the evaluation operation section 184a is tapped by the player, the evaluation operation section 184a does not accept subsequent operations.

When the history display button 184b is tapped, a history information screen 200 related to the selected music is displayed.

FIG. 88C illustrates an example of an evaluation-history information screen 200a, and FIG. 88D illustrates an example of a playback-history information screen 200b. The history information screen 200 includes the evaluation-history information screen 200a and the playback-history information screen 200b. When the history display button 184b is tapped, the evaluation-history information screen 200a shown in FIG. 88C is displayed. The upper part of the history information screen 200 is provided with an evaluation history tab 202a and a playback history tab 202b.

Although a detailed description will be provided later, the evaluation-history information screen 200a displays a list of evaluators who have evaluated the music, as shown in FIG. 88C. Furthermore, as shown in FIG. 88D, the playback-history information screen 200b displays history information about the music played back by the jukebox function in the player terminal 1. When the playback history tab 202b is tapped while the evaluation-history information screen 200a is being displayed, the playback-history information screen 200b is displayed. When the evaluation history tab 202a is tapped while the playback-history information screen 200b is being displayed, the evaluation-history information screen 200a is displayed.

By tapping on the another-player's-request setting toggle 186 on the selected-music information screen 180 shown in FIG. 88B, the player can switch the random selection function between on and off modes, similarly to the random-selection-setting operation section 134 mentioned above.

The playback stop button 188 functions as an operation section for switching between playback and stop modes for the selected music. When the playback stop button 188 is tapped while the selected music is being played back, the requested playback mode switches to the stop mode, so that the music is stopped. In this case, the music is paused, and the selected music information is saved. Moreover, when the playback stop button 188 is tapped while the selected music is stopped, the requested playback mode switches to the playback mode, so that the music is played back.

When the return operation section 190 is tapped on the selected-music information screen 180, the selected-music information screen 180 transitions to a non-displayed state, and the home screen 100 is displayed. When the return operation section 190 is tapped while the music is being played back, the playback of the music continues even after the home screen 100 is displayed. Accordingly, the player can play the game while the music requested by the player is played back as BGM.

As mentioned above, in the jukebox function, the player can select and listen to desired music. Moreover, as mentioned above, the second embodiment is provided with the random selection function that randomly selects music when a transition is made from the content screen to a screen other than the content screen during the game, and that outputs the selected music as BGM. The random selection function will be described in further detail below.

In the second embodiment, an activation condition for the random selection function is provided, and the randomly-selected music is played back as BGM when the activation condition is satisfied. The activation condition for the random selection function includes a condition where a transition is made from the content screen to a screen other than the content screen, a condition where the random selection function is in the on mode, a condition where an activation time point of the random selection function has passed, and a condition where the requested playback mode is in the playback mode.

When the activation condition is satisfied during a transition from the content screen to a screen other than the content screen, music to be played back in the player terminal 1 is determined in the server 1000. During the transition from the content screen to a screen other than the content screen, the player terminal 1 receives, from the server 1000, information related to the music to be played back and plays back the music based on the received information.

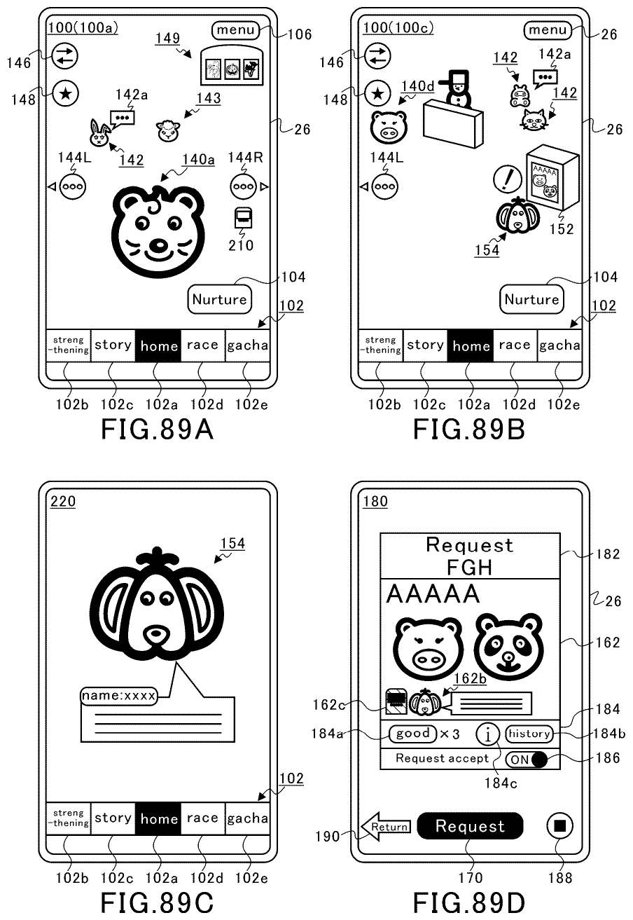

FIG. 89A illustrates an example of the home screen 100 when the random selection function is activated. For example, when a transition is made to the center home screen 100a, it is assumed that music selected in accordance with the random selection function is played back. In this case, the center home screen 100a displays an image prompting the player to check the right home screen 100c, more specifically, the jukebox image 152 displayed on the right home screen 100c.

In detail, the center home screen 100a displays the notification icon 144R in a highlighted fashion, and also displays a jukebox icon 210 near the notification icon 144R. The jukebox icon 210 is an image mimicking a jukebox. With the displaying of the notification icon 144R in a highlighted fashion and the displaying of the jukebox icon 210, the player is prompted to input an operation for displaying the right home screen 100c.

FIG. 89B illustrates an example of the right home screen 100c when the random selection function is activated. When a leftward swiping operation is input in the state shown in FIG. 89A, the right home screen 100c is displayed, as shown in FIG. 89B. In this case, an image similar to the jacket image 162 corresponding to the selected music is displayed in the jukebox image 152. Accordingly, the player can identify the currently-selected music in accordance with the jukebox image 152.

As mentioned above, when music is selected in accordance with the random selection function, the requester (requesting character) of the music is determined. The right home screen 100c displays the requesting character image 154 corresponding to the determined requesting character. Moreover, an exclamation mark icon is displayed near the requesting character image 154.

FIG. 89C illustrates an example of a requester's details screen 220. When the requesting character image 154 is tapped on the right home screen 100c, the requester's details screen 220 shown in FIG. 89C is displayed. The requester's details screen 220 displays the requesting character image 154, the name of the requester, and a comment. The comment displayed on the requester's details screen 220 may be associated with the music being played back or may be associated with the requesting character image 154. Moreover, the comment displayed on the requester's details screen 220 may be the same as or different from the comment displayed in the comment display field of the entertainment image 162b.

FIG. 89D illustrates an example of the selected-music information screen 180 when the random selection function is activated. When the jukebox image 152 is tapped on the right home screen 100c shown in FIG. 89B, the selected-music information screen 180 shown in FIG. 89D is displayed. The basic configuration of the selected-music information screen 180 is the same between the case where the music is selected by the player and the case where the random selection function is activated.

However, when the another-player's requesting function is activated, an information notification icon 184c is displayed in the evaluation-information display field 184 of the selected-music information screen 180. When the information notification icon 184c is tapped, an another-player's information screen (not shown) is displayed. The another-player's information screen displays information related to another player who has requested the music being played back. The information related to the other player includes, for example, the player name of the other player, a representative character, a profile character, and a message set by the other player.

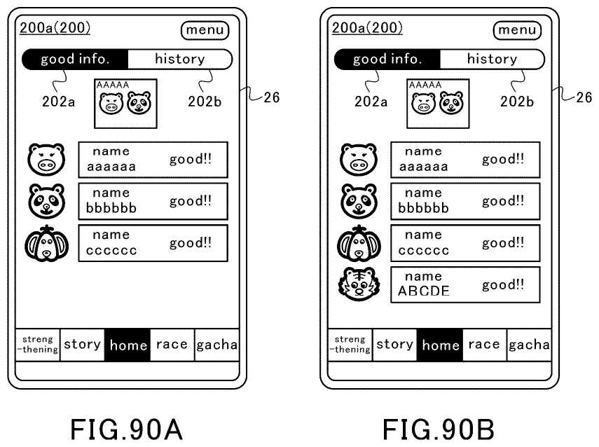

FIG. 90A illustrates an example of the evaluation-history information screen 200a when the another-player's requesting function is activated. FIG. 90B illustrates an example of the evaluation-history information screen 200a when the player evaluates the music. In the case where the another-player's requesting function is activated, one or more evaluations are set at the time point when the selected-music information screen 180 is first displayed.

For example, when the other player selects and plays back music, an evaluator (evaluating character) is determined in the player terminal 1. When the player selects and plays back the music in the player terminal 1, the music selected by the player and evaluation information serving as information indicating the evaluator is saved in the server 1000.

Then, the player can register the other player as a friend, and one friend is selected from registered friends in the another-player's requesting function. Then, the music last selected by the selected friend is played back in the player terminal 1.

In this case, the evaluation information associated with the music last selected by the friend is acquired, and the evaluation-history information screen 200a is displayed based on the acquired evaluation information, as shown in FIG. 90A. When the player taps on the evaluation operation section 184a in this state, evaluators are additionally displayed on the evaluation-history information screen 200a, as shown in FIG. 90B. In this case, the information about the evaluators is transmitted to the server 1000, and the evaluation information associated with the music last selected by the friend is updated.

It is assumed that the same friend is further selected as a requester in the player terminal 1 of another player. In this case, the evaluation-history information screen 200a shown in FIG. 90B is displayed from the beginning in the player terminal 1 of this other player.

Furthermore, for example, it is assumed that a transition is made to the raising game screen while the music selected by the friend is played back, that is, while the requested playback mode remains in the playback mode, in the player terminal 1 of the friend. Subsequently, when the raising game ends and the home screen 100 is displayed, the same music as the music before the start of the raising game is played back. It is assumed that the friend is selected as a requester in the player terminal 1 of another player during the raising game of the friend, and that the other player evaluates the music. In this case, in the player terminal 1 of the friend, the evaluation-history information screen 200a in FIG. 90A is displayed before the start of the raising game, and the evaluation-history information screen 200a in FIG. 90B is displayed after the end of the raising game.

Accordingly, in the second embodiment, when music is played back by the jukebox function, various kinds of entertainment are offered. Such entertainment is shared between multiple players and brings about an impression as if a single jukebox is used by multiple players. In other words, this brings about an impression as if the game is played simultaneously by multiple players, thereby enhancing the player's ambition for the game.

Next, functional configurations of the player terminal 1 and the server 1000 and processes executed in the player terminal 1 and the server 1000 will be described.

### (Functional Configuration of Player Terminal 1)

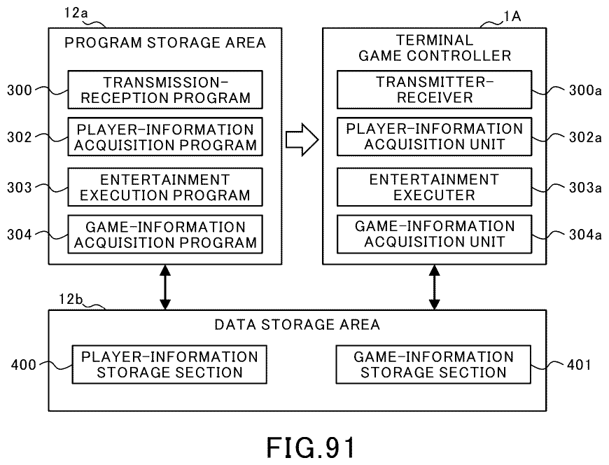

FIG. 91 illustrates the configuration of the memory 12 in the player terminal 1 and the function thereof as a computer. The memory 12 is provided with the program storage area 12a and the data storage area 12b. When a game starts, the CPU 10 stores the terminal game control program (module) in the program storage area 12a.

The terminal game control program includes a transmission-reception program 300, a player-information acquisition program 302, an entertainment execution program 303, and a game-information acquisition program 304. The programs listed in FIG. 91 are examples, and the terminal game control program may be provided with other multiple programs.

The data storage area 12b is provided with a player-information storage section 400 and a game-information storage section 401 as storage sections for storing data. The data storage area 12b is provided with other multiple storage sections.

The CPU 10 activates each program stored in the program storage area 12a and updates the data in each storage section of the data storage area 12b. By activating each program stored in the program storage area 12a, the CPU 10 causes the player terminal 1 (computer) to function as the terminal game controller 1A. The terminal game controller 1A includes a transmitter-receiver 300a, a player-information acquisition unit 302a, an entertainment executer 303a, and a game-information acquisition unit 304a.

In detail, the CPU 10 activates the transmission-reception program 300 to cause the computer to function as the transmitter-receiver 300a. Likewise, the CPU 10 causes the computer to function as the player-information acquisition unit 302a, the entertainment executer 303a, and the game-information acquisition unit 304a.

The transmitter-receiver 300a communicates with the player terminal 1 and the server 1000 and transmits various types of information from the player terminal 1 to the server 1000. Moreover, the transmitter-receiver 300a downloads various types of information from the server 1000.

The player-information acquisition unit 302a stores the information downloaded from the server 1000 in the player-information storage section 400.

The entertainment executer 303a executes display control of the display 26 as well as all entertainment-related processes, such as playback of music.

The game-information acquisition unit 304a stores the information downloaded from the server 1000 in the game-information storage section 401.

### (Functional Configuration of Server 1000)

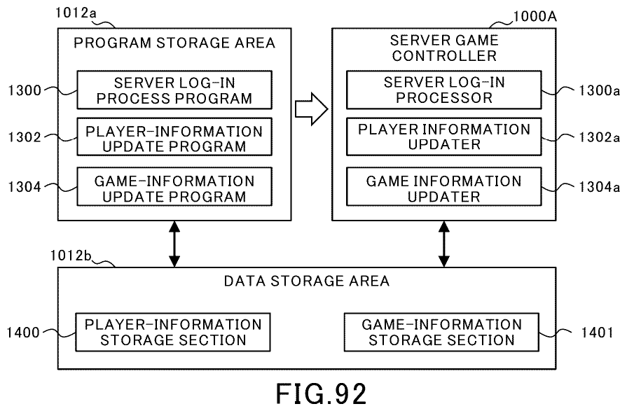

FIG. 92 illustrates the configuration of the memory 1012 in the server 1000 and the function thereof as a computer. The memory 1012 is provided with the program storage area 1012a and the data storage area 1012b. When a game starts, the CPU 1010 stores the server game control program (module) in the program storage area 1012a.

The server game control program includes a server log-in process program 1300 and a player-information update program 1302. The programs listed in FIG. 92 are examples, and the server game control program may be provided with other multiple programs.

The data storage area 1012b is provided with a player-information storage section 1400 and a game-information storage section 1401 as storage sections for storing data. The data storage area 1012b is provided with other multiple storage sections. In this case, the information stored in the data storage area 12b of the player terminal 1 is also entirely stored in the data storage area 1012b of the server 1000. Various types of information stored in the data storage area 12b of the player terminal 1 are stored in the player-information storage section 1400 and the game-information storage section 1401 of the server 1000.

The CPU 1010 activates each program stored in the program storage area 1012a and updates the data in each storage section of the data storage area 1012b. By activating each program stored in the program storage area 1012a, the CPU 1010 causes the server 1000 to function as a server game controller 1000A. The server game controller 1000A includes a server log-in processor 1300a, a player information updater 1302a, and a game information updater 1304a.

In detail, the CPU 1010 activates the server log-in process program 1300 to cause the computer to function as the server log-in processor 1300a. Likewise, the CPU 1010 activates the player-information update program 1302 to cause the computer to function as the player information updater 1302a and the game information updater 1304a.

When the server log-in processor 1300a receives log-in information from the player terminal 1, the server log-in processor 1300a causes the player terminal 1 to download various types of information stored in the player-information storage section 1400.

The player information updater 1302a updates the player information in the player-information storage section 1400 based on information received from the player terminal 1.

The game information updater 1304a updates the game information in the game-information storage section 1401.

The processes executed by the functional units in the player terminal 1 and the server 1000 described above will be described below by using flowcharts.

### (Communication Process Between Player Terminal 1 and Server 1000)

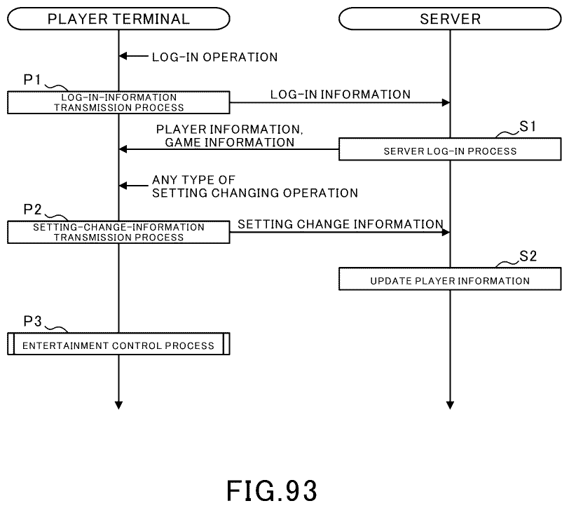

FIG. 93 is a sequence diagram illustrating basic processes in the player terminal 1 and the server 1000. In the following description, a process in the player terminal 1 will be indicated as Pn (n being an arbitrary integer). A process in the server 1000 will be indicated as Sn (n being an arbitrary integer). A process in the player terminal 1 of a friend will be indicated as Fn (n being an arbitrary integer).

When the player performs a log-in operation for activating a game application in the player terminal 1, a log-in-information transmission process (P1) is performed. In the log-in-information transmission process, the transmitter-receiver 300a transmits log-in information to the server 1000.

When the server 1000 receives the log-in information, the server log-in processor 1300a executes a server log-in process (S1). In the server log-in process, the player terminal 1 receives player information and game information saved in the server 1000.

When the player terminal 1 receives the player information from the server 1000, the player-information acquisition unit 302a stores the received player information in the player-information storage section 400.

When the player terminal 1 receives the game information from the server 1000, the game-information acquisition unit 304a stores the received player information in the game-information storage section 401.

When the player changes the settings by performing various kinds of setting changing operations on, for example, the option setting screen 110, information about the changed settings is stored in the player-information storage section 400. Moreover, the transmitter-receiver 300a transmits setting change information to the server 1000 (P2). When the server 1000 receives the setting change information, the player information updater 1302a updates the player information in the player-information storage section 1400 (S2).

The player information stored in the server 1000 includes information, such as information related to a character owned by the player, information related to a raised character, information settable on the option setting screen 110, information related to the jukebox function, and information related to the character management table.

The game information stored in the server 1000 includes information, such as information related to the type of poster image 292 to be displayed on the poster screen 290 (bulletin board screen 280), information related to scheduled maintenance, and information related to a campaign currently being carried out.

In the player terminal 1, an entertainment control process (P3) for controlling various types of entertainment in the player terminal 1 is executed.

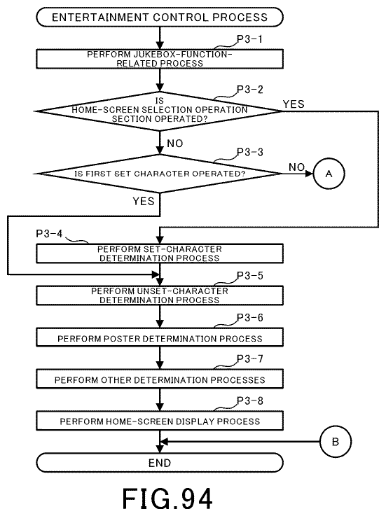

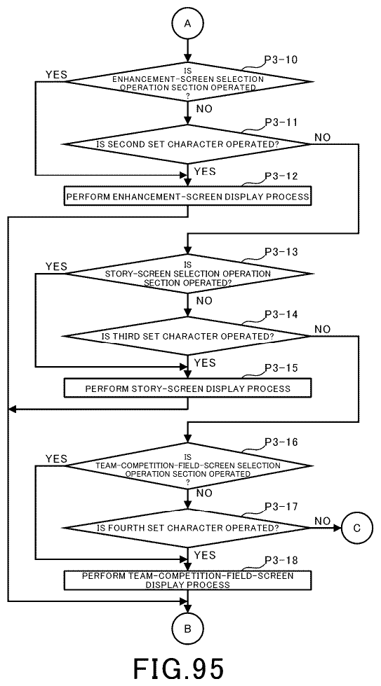

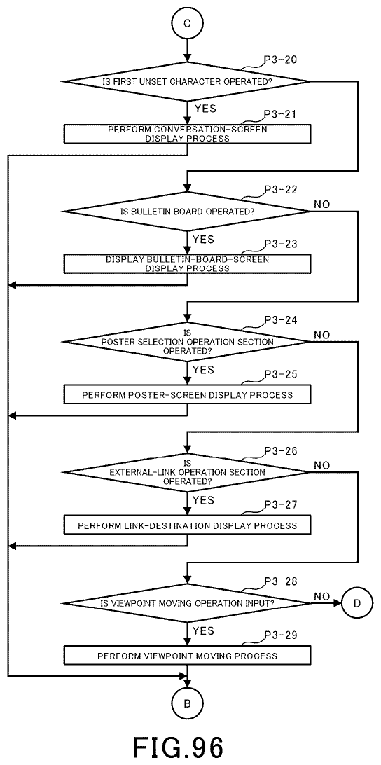

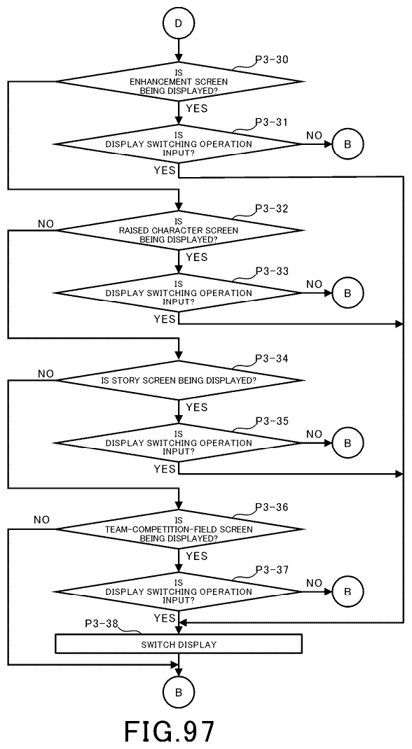

FIG. 94 is a first flowchart illustrating the entertainment control process in the player terminal 1. FIG. 95 is a second flowchart illustrating the entertainment control process in the player terminal 1. FIG. 96 is a third flowchart illustrating the entertainment control process in the player terminal 1. FIG. 97 is a fourth flowchart illustrating the entertainment control process in the player terminal 1. The entertainment executer 303a executes a jukebox-function-related process (P3-1) for executing processes related to the aforementioned jukebox function.

If an operation is performed on the home-screen selection operation section 102a (YES in P3-2), the entertainment executer 303a refers to the character management table (FIG. 79) stored in the player-information storage section 400 and executes a set-character determination process for determining a set character (P3-4). In other words, an object (character) selected by the player from a plurality of objects (characters) is set as a corresponding object corresponding to the game content.

After the set-character determination process (P3-4) or when an operation is performed on the first set character 140a (YES in P3-3), the entertainment executer 303a refers to the character management table (FIG. 79) stored in the player-information storage section 400 and executes an unset-character determination process for determining an unset character (P3-5). In this case, when a predetermined lottery timing is reached, the unset-character determination process involves determining the first unset character 142 and the second unset character 143 by lottery from characters not set as the first set character 140a, the second set character 140b, the third set character 140c, and the fourth set character 140d (P3-5).

In this case, information related to the updated character management table is transmitted as update information to the server 1000. In other words, non-corresponding objects (i.e., the first unset character 142 and the second unset character 143) to be displayed on the home screen 100 are selected from objects (characters) not set as corresponding objects (i.e., the first set character 140a, the second set character 140b, the third set character 140c, and the fourth set character 140d). Objects (characters) with ownership information stored therein and objects (characters) without ownership information stored therein are selectable as non-corresponding objects (i.e., the first unset character 142 and the second unset character 143). Information related to the non-corresponding objects (i.e., the first unset character 142 and the second unset character 143) in the character management table may be retained in the player terminal 1 without being transmitted to the server 1000.

The entertainment executer 303a refers to the information related to the type of poster image 292 to be displayed on the poster screen 290 (bulletin board screen 280) stored in the game-information storage section 401 and executes a poster determination process for determining the type of poster image 292 to be displayed on the poster screen 290 (bulletin board screen 280) (P3-6).

The entertainment executer 303a executes other determination processes including all other processes related to the display on the home screen 100 (P3-8). For example, the other determination processes include a process involving referring to the information related to scheduled maintenance stored in the game-information storage section 401 to determine whether or not the caption 295 is to be displayed. Moreover, for example, the other determination processes also include a process for setting a background image in accordance with the time of year (i.e., the season or an annual event) or the time (i.e., morning, noon, or evening). Furthermore, for example, the other determination processes also include a process for determining whether or not the campaign icon 148 is to be displayed based on whether or not there is information related to a currently-carried-out campaign stored in the game-information storage section 401.

The entertainment executer 303a executes a home-screen display process for displaying the home screen 100 on the display 26 based on results of the determination processes in P3-4 to P3-7 (P3-8). In other words, the corresponding objects (i.e., the first set character 140a, the second set character 140b, the third set character 140c, and the fourth set character 140d) are displayed on the home screen 100. Moreover, the non-corresponding objects (i.e., the first unset character 142 and the second unset character 143) serving as objects (characters) not corresponding to any game content are displayed on the home screen 100.

When an operation is performed on the enhancement-screen selection operation section 102b (YES in P3-10 in FIG. 95) and when an operation is performed on the second set character 140b (YES in P3-11), the entertainment executer 303a refers to the character management table stored in the player-information storage section 400 and executes an enhancement-screen display process for displaying the enhancement screen 230 on the display 26 (P3-12). In other words, based on a player's selecting operation for selecting a corresponding object (enhancement-screen selection operation section 102b) displayed on the home screen 100, a screen (enhancement screen 230) for executing the game content corresponding to the selected corresponding object (enhancement-screen selection operation section 102b) is displayed. Based on an operation for selecting an operation section (enhancement-screen selection operation section 102b) on the menu bar 102, a screen (enhancement screen 230) for executing the game content corresponding to the selected operation section (enhancement-screen selection operation section 102b) is displayed. When an operation is performed on the story-screen selection operation section 102c (YES in P3-13) and when an operation is performed on the third set character 140c (YES in P3-14), the entertainment executer 303a refers to the character management table stored in the player-information storage section 400 and executes a story-screen display process for displaying the story screen 250 on the display 26 (P3-15). In other words, based on a player's selecting operation for selecting a corresponding object (story-screen selection operation section 102c) displayed on the home screen 100, a screen (story screen 250) for executing the game content corresponding to the selected corresponding object (story-screen selection operation section 102c) is displayed. Based on an operation for selecting an operation section (story-screen selection operation section 102c) on the menu bar 102, a screen (story screen 250) for executing the game content corresponding to the selected operation section (story-screen selection operation section 102c) is displayed.

When an operation is performed on the team-competition-field-screen selection operation section 102d (YES in P3-16) and when an operation is performed on the fourth set character 140d (YES in P3-17), the entertainment executer 303a refers to the character management table stored in the player-information storage section 400 and executes a team-competition-field-screen display process for displaying the team-competition-field screen 260 on the display 26 (P3-18). In other words, based on a player's selecting operation for selecting a corresponding object (team-competition-field-screen selection operation section 102d) displayed on the home screen 100, a screen (team-competition-field screen 260) for executing the game content corresponding to the selected corresponding object (team-competition-field-screen selection operation section 102d) is displayed. Based on an operation for selecting an operation section (team-competition-field-screen selection operation section 102d) on the menu bar 102, a screen (team-competition-field screen 260) for executing the game content corresponding to the selected operation section (team-competition-field-screen selection operation section 102d) is displayed.

When an operation is performed on the first unset character 142 (YES in P3-20 in FIG. 96), the entertainment executer 303a executes a conversation-screen display process for displaying the conversation screen 270 on the display 26 (P3-21).

When an operation is performed on the bulletin board 149 (YES in P3-22), the entertainment executer 303a executes a bulletin-board-screen display process for displaying the bulletin board screen 280 on the display 26 (P3-23).

When an operation is performed on the poster selection operation section 282 (YES in P3-24), the entertainment executer 303a executes a poster-screen display process for displaying the poster screen 290 corresponding to the operated poster selection operation section 282 on the display 26 (P3-25).

When an operation is performed on the external-link operation section 296 (YES in P3-26), the entertainment executer 303a executes a link-destination display process for displaying, for example, the homepage corresponding to the operated external-link operation section 296 (P3-26).

When a viewpoint moving operation is input in accordance with a swiping operation, a dragging operation, or a flicking operation on the home screen 100 (the center home screen 100a, the left home screen 100b, or the right home screen 100c) (YES in P3-28), the entertainment executer 303a executes a viewpoint moving process for spanning the camera that captures an image of the virtual space (P3-29). For example, if a swiping operation or a dragging operation is input as the viewpoint moving operation, the camera capturing the image of the virtual space is slowly spanned in correspondence with the swiping operation or the dragging operation, or if a flicking operation is input as the viewpoint moving operation, the camera capturing the image of the virtual space is quickly spanned in correspondence with the flicking operation, so that any of the preset screens (i.e., the center home screen 100a, the left home screen 100b, and the right home screen 100c) may be displayed.

In the second embodiment, when a viewpoint moving operation is input, the camera capturing the image of the virtual space moves so that each screen is displayed. However, the second embodiment is not limited to this. For example, when a viewpoint moving operation is input, the viewpoint may be switched to a camera disposed at the position corresponding to the viewpoint moving operation among multiple cameras disposed within the virtual space (i.e., the camera capturing the image of the virtual space may be changed).

When a display switching operation involving tapping on an operation section is input while the enhancement screen 230 is being displayed (YES in P3-30 in FIG. 97), the entertainment executer 303a switches the display screen on the display 26 (P3-38). In this case, for example, the raised character screen 240 is displayed on the display 26.

When a display switching operation involving tapping on an operation section is input (YES in P3-33) while the raised character screen 240 is being displayed (YES in P3-32), the entertainment executer 303a switches the display screen on the display 26 and displays a content screen for enhancing a character owned by the player (P3-38).

When a display switching operation involving tapping on an operation section is input (YES in P3-35) while the story screen 250 is being displayed (YES in P3-34), the entertainment executer 303a switches the display screen on the display 26 and displays a story-viewing-related content screen (P3-38).

When a display switching operation involving tapping on an operation section is input (YES in P3-37) while the team-competition-field screen 260 is being displayed (YES in P3-36), the entertainment executer 303a switches the display screen on the display 26 and displays a race-related content screen (P3-38).

Although the second embodiment has been described above with reference to the appended drawings, the present invention is not limited to the second embodiment described above. It is obvious to a skilled person that various modifications or alterations may be achieved within the scope defined in the claims, and it is to be understood that such modifications or alterations naturally belong to the technical scope.

Although the second embodiment described above relates to a case where the game genre is a raising game, the game genre and the gameplay are not particularly limited.

The processes in the player terminal 1 and the server 1000 according to the second embodiment described above are merely examples, and the way in which they share the roles with respect to the processes is not particularly limited.

The information processing program for executing the processing in the second embodiment described above and various modifications may be provided as a storage medium by being stored in a non-transitory computer readable storage medium. Furthermore, a game terminal device including this storage medium may be provided. Moreover, the second embodiment described above and the modifications may each be an information processing method that realizes the functions and the steps indicated in the flowcharts.

Next, a third embodiment will be described. In the above embodiment, a specific event is held irregularly as a limited time event. When the specific event is being held, the specific event icon 108 is displayed on the home screen 100. When the raising game ends while the specific event is being held, specific event points are given to the player in addition to the usual reward. The specific event points acquired by the player are cumulated, and the player can acquire various items based on the cumulative value of the specific event points. When the specific event points reach a predetermined upper limit value, that is, when all acquirable items are acquired based on the specific event points, the addition of the specific event points may be stopped. Even in this case, a predetermined reward may be additionally given in accordance with acquirable specific event points.

For example, the player may be capable of acquiring various items by consuming the acquired specific event points. In other words, the player may be capable of exchanging the specific event points with various items.

However, the period in which the specific event points can be exchanged with the items is limited. Therefore, in order to acquire the specific event points while the specific event is being held, the player needs to repeatedly play the raising game multiple times. However, for a player with a limited time for playing the raising game, the acquirable specific event points are limited. This may possibly lead to a large disparity between players in accordance with the held specific event.

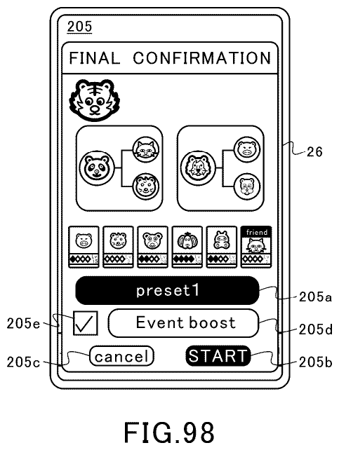

FIG. 98 illustrates the final confirmation screen 205 when the specific event is being held. When the specific event is being held, an event boosting function is provided to the player. An event boosting function involves doubling the consumption of game points to double the specific event points acquirable upon completion of the raising game.

When the raising game is executed while the specific event is being held and the final confirmation screen 205 is displayed in the preparation stage process, the final confirmation screen 205 is provided with an event-boosting selection section 205d. When the event-boosting selection section 205d is tapped, an explanation of the event boosting function is displayed. A checkbox 205e is provided to the left of the event-boosting selection section 205d.

By tapping on the checkbox 205e, the player can enable the event boosting function. When the start operation section 205b is tapped after the checkbox 205e is tapped, game points twice as many as usual game points are consumed as the main raising game starts. Accordingly, the player can select the consumption of game points prior to the start of the main raising game. A larger number of specific event points are given when the consumption of the game points is large than when the consumption of the game points is small.

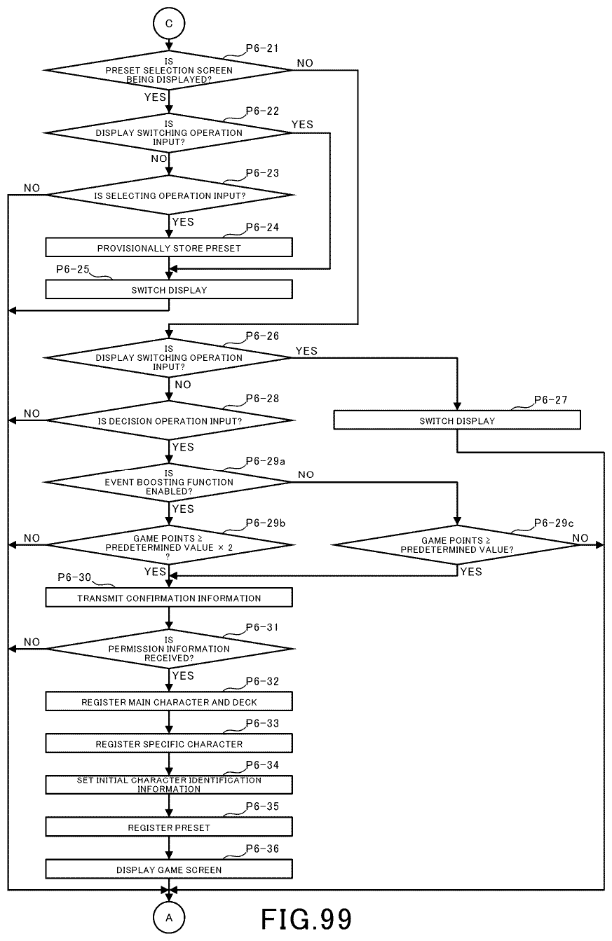

FIG. 99 is a flowchart illustrating a preparation stage process (P6) in the player terminal 1 when the specific event is being held. When the specific event is being held, the preparation stage process involves executing P6-29a, P6-29b, and P6-29c in place of P6-29. When the specific event is being held, only P6-29a, P6-29b, and P6-29c are different from the normal process. Therefore, P6-29a, P6-29b, and P6-29c will be described, whereas descriptions regarding the remaining processes will be omitted.

When a decision operation is input (i.e., the start operation section 205b is tapped) on the final confirmation screen 205 (YES in P6-28), the raising game executer 701a determines whether the event boosting function is enabled (P6-29a). It is determined whether the checkbox 205e is checked, that is, whether the checkbox 205e is operated and whether information indicating that the event boosting function is enabled is stored.

If the event boosting function is enabled (YES in P6-29a), the raising game executer 701a determines whether the game points are greater than or equal to twice a predetermined value (e.g., 30) (P6-29b). If the game points are greater than or equal to twice the predetermined value (YES in P6-29b), the raising game executer 701a transmits confirmation information to the server 1000 (P6-30).

In contrast, if the event boosting function is not enabled (NO in P6-29a), the raising game executer 701a determines whether the game points are equal to the predetermined value (e.g., 30) (P6-29c). If the game points are larger than or equal to the predetermined value (YES in P6-29c), the raising game executer 701a transmits confirmation information to the server 1000 (P6-30).

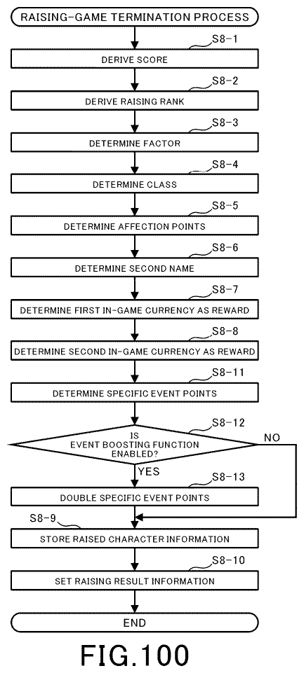

FIG. 100 is a flowchart illustrating a raising-game termination process in the server 1000 when the specific event is being held. When the specific event is being held, the raising-game termination process involves executing S8-11 to S8-13 between S8-8 and S8-9. When the specific event is being held, only S8-11 to S8-13 are different from the normal process. Therefore, S8-11 to S8-13 will be described, whereas descriptions regarding the remaining processes will be omitted.

The raising-game termination processor 1102a determines the specific event points (S8-11). Although the method for determining the specific event points is not particularly limited, for example, the specific event points are calculated based on, for example, the score, the raising rank, the number of fans, the main character, and the number of specific characters organized in the deck. Furthermore, for example, the specific event points given may increase with increasing number of acquired second names. Alternatively, by acquiring a predetermined second name, a specific event to be given may be added. Moreover, the specific event points to be given may increase in accordance with the type of owned support card or the number of support cards whose level has been increased to a maximum value.

If the event boosting function is enabled (YES in S8-12), the raising-game termination processor 1102a doubles the specific event points determined in S8-11 (S8-13).

Although the third embodiment has been described above with reference to the appended drawings, the present invention is not limited to the third embodiment described above. It is obvious to a skilled person that various modifications or alterations may be achieved within the scope defined in the claims, and it is to be understood that such modifications or alterations naturally belong to the technical scope.

The gameplay described in the third embodiment described above and the processes in the player terminal 1 and the server 1000 are merely examples. In any case, an information processing program may involve causing a computer (either of or both of the player terminal 1 and the server 1000 in the third embodiment) to carry out the following processes.

### (Processes to be Carried Out by Computer)

A process involves setting one character, selected by the player from multiple characters with multiple set targets to be cleared, as a target character to be raised (i.e., the main character in the third embodiment) in the raising game (i.e., the main raising game in the third embodiment) including multiple game segments (i.e., turns in the third embodiment) (P6-32 in the third embodiment).

A process involves allowing the player to select a predetermined one or more selection items (e.g., “Rest”, “Training”, “Going Out”, “Race”, and “Skill” in the third embodiment) for every game segment (P10-3 and P10-4 in the third embodiment).

A process involves deriving a game result based on the selection item or items selected by the player (e.g., P20-2 and P21-2 in the third embodiment).

A process involves updating the parameters associated with the target character to be raised based on the game result (e.g., P21-4, P21-5, and P20-2 in the third embodiment).

A process involves transitioning from one game segment to another when the game result is derived based on a selection item (“Rest”, “Training”, “Going Out”, or “Race” in the third embodiment) in which a transition from the current game segment to the next game segment is defined (P10-1 in the third embodiment).

A process involves selecting a specific selection item (i.e., an individual race in the third embodiment) that may become a target to be cleared from multiple selection items and adding predetermined points (i.e., the number of fans in the third embodiment) based on the specific selection item if the game result is derived based on the specific selection item (P20-4 in the third embodiment).

A process involves giving a reward to the player based on the predetermined points as the raising game ends (S8-7 in the third embodiment).

A process involves allowing the player to select the specific selection item serving as the target to be cleared in a game segment where the specific selection item serving as the target to be cleared, set as the target character to be raised, is set as a selection item to be selected by the player, and not allowing the player to select a selection item, other than the specific selection item, in which the transition from the current game segment to the next game segment is defined (P10-3 and P10-4 in the third embodiment).

In the third embodiment described above, a plurality of specific selection items with different difficulty levels are provided.

The characters include a first character (i.e., character A in FIG. 8B in the third embodiment) and a second character (i.e., character B in FIG. 8B in the third embodiment).

For the first character, a plurality of specific selection items with a difficulty level (GI in the third embodiment) higher than or equal to a predetermined difficulty level are set as targets to be cleared.

For the second character, the number of specific selection items, set as the targets to be cleared, with the difficulty level higher than or equal to the predetermined difficulty level is smaller than that for the first character.

If the second character is set as the target character to be raised, the specific selection items set as the targets to be cleared for the first character are selectable.

Alternatively, in the third embodiment described above, the difficulty levels of the races may all be the same. Moreover, the same target to be cleared may be set for all the characters.

Furthermore, a process for managing the game points to be consumed for executing the raising game is executed (P1, S1, and S6-12 in the third embodiment). The process for managing the game points involves giving game points to the player in accordance with a predetermined addition condition and allowing the player to select the consumption of the game points prior to the start of the raising game. The process for giving a reward to the player involves giving a larger amount of predetermined reward (i.e., specific event points in the third embodiment) when the consumption of the game points is large than when the consumption of the game points is small.

In the third embodiment described above, the event boosting function is limited to when the specific event is being held. Alternatively, the event boosting function may be executable in a period other than when the specific event is being held. In this case, for example, by enabling the event boosting function, the number of fans and the number of other rewards acquired may increase.

The information processing program for executing the processing in the third embodiment described above and various modifications may be provided as a storage medium by being stored in a non-transitory computer readable storage medium. Furthermore, a game terminal device including this storage medium may be provided. Moreover, the third embodiment described above and the modifications may each be an information processing method that realizes the functions and the steps indicated in the flowcharts.

What is claimed is:

1. A non-transitory computer readable medium storing a program causing a computer to execute:
a process in a specific game including a plurality of category games, the process allowing a player to select a character to be used in each of the plurality of category games;
a process for setting the character selected by the player for each category game;
a process for deriving an individual game result for each category game, the individual game result serving as a game result of the category game;
a process for determining, for each category game, a predetermined parameter associated with the character used in the category game;
a process for ranking a plurality of characters based on the predetermined parameters of the plurality of category games, the plurality of characters being used in the specific game in accordance with the selection by the player; and
a process for deriving an overall game result based on the individual game result of each of the plurality of category games or the predetermined parameters of the plurality of category games, the overall game result serving as a game result of the specific game.

2. The non-transitory computer readable medium according to claim 1,
wherein the process for deriving the overall game result includes a process for deriving total points as the overall game result by calculating the total points in the specific game based on the predetermined parameters of the plurality of category games, and
wherein the program causes the computer to further execute a process for ranking multiple players in accordance with the total points of the specific game.

3. The non-transitory computer readable medium according to claim 1,
wherein the process for deriving the individual game result for each category game includes deriving the individual game results of the plurality of category games in a predetermined order.

4. An information processing method executed by a computer,
wherein the computer executes:
a process in a specific game including a plurality of category games, the process allowing a player to select a character to be used in each of the plurality of category games;
a process for setting the character selected by the player for each category game;
a process for deriving an individual game result for each category game, the individual game result serving as a game result of the category game;
a process for determining, for each category game, a predetermined parameter associated with the character used in the category game;
a process for ranking a plurality of characters based on the predetermined parameters of the plurality of category games, the plurality of characters being used in the specific game in accordance with the selection by the player; and
a process for deriving an overall game result based on the individual game result of each of the plurality of category games or the predetermined parameters of the plurality of category games, the overall game result serving as a game result of the specific game.

5. A gaming device comprising:
at least one computer,
wherein the at least one computer executes:
a process in a specific game including a plurality of category games, the process allowing a player to select a character to be used in each of the plurality of category games;
a process for setting the character selected by the player for each category game;
a process for deriving an individual game result for each category game, the individual game result serving as a game result of the category game;
a process for determining, for each category game, a predetermined parameter associated with the character used in the category game;
a process for ranking a plurality of characters based on the predetermined parameters of the plurality of category games, the plurality of characters being used in the specific game in accordance with the selection by the player; and
a process for deriving an overall game result based on the individual game result of each of the plurality of category games or the predetermined parameters of the plurality of category games, the overall game result serving as a game result of the specific game.

6. An information processing system comprising:
at least one computer,
wherein the at least one computer executes:
a process in a specific game including a plurality of category games, the process allowing a player to select a character to be used in each of the plurality of category games;
a process for setting the character selected by the player for each category game;
a process for deriving an individual game result for each category game, the individual game result serving as a game result of the category game;
a process for determining, for each category game, a predetermined parameter associated with the character used in the category game;
a process for ranking a plurality of characters based on the predetermined parameters of the plurality of category games, the plurality of characters being used in the specific game in accordance with the selection by the player; and
a process for deriving an overall game result based on the individual game result of each of the plurality of category games or the predetermined parameters of the plurality of category games, the overall game result serving as a game result of the specific game.
